(19) United States
(12) Patent Application Publication
(10) Pub. No.: US 2012/0005030 A1
(43) Pub. Date: Jan. 5, 2012

(54) Apparatus for connecting Protect Anything Human Key identification mechanism to objects, content, and virtual currency for identification, tracking, delivery, advertising and marketing

(76) Inventors: David Valin, Flushing, NY (US); Alex Socolof, Briarcliff Manor, NY (US)

(21) Appl. No.: 12/860,936

(22) Filed: Aug. 23, 2010

Related U.S. Application Data
(63) Continuation of application No. 12/830,344, filed on Jul. 4, 2010.

(51) Int. Cl. G06Q 30/00; G06Q 99/00; G06Q 10/00; G06Q 40/00; G06F 15/16; G06Q 50/00

(52) U.S. Cl. 705/14.73; 709/219; 705/1.1; 705/313; 705/306; 705/44; 705/39; 705/35

(57) ABSTRACT

The current invention presented here is an apparatus for securely managing objects, content, and virtual currency for identification, tracking, delivery, advertising and marketing with a Protect Anything Human Key attached for ability to sell, buy, and enable transactions of properties, in a 2D or 3D virtual world.

### CROSS REFERENCE TO RELATED APPLICATION

this application claims the benefit of and is a continuation in part of application number:
   Ser. No. 12/830,344 filed on Jul. 4, 2010
   Title: Apparatus for secure recording and transformation of images to light for identification, and audio visual projection spatial point targeted area.

### BACKGROUND OF THE INVENTION

Dependent technologies are presented here for protecting virtual representatives in a virtual world, and enabling content and ideas to be marketed, shown, reviewed, sold, promoted, and voted on by real world humans, utilizing their virtual representation of themselves, in the system, and also allowing sales and marketing in the outside real world, through virtual world clearing houses utilizing open source and proprietary software platform software, and anyone can participate in a Virtual World Clearing House and receive or share in the sales that are, created, or transacted.

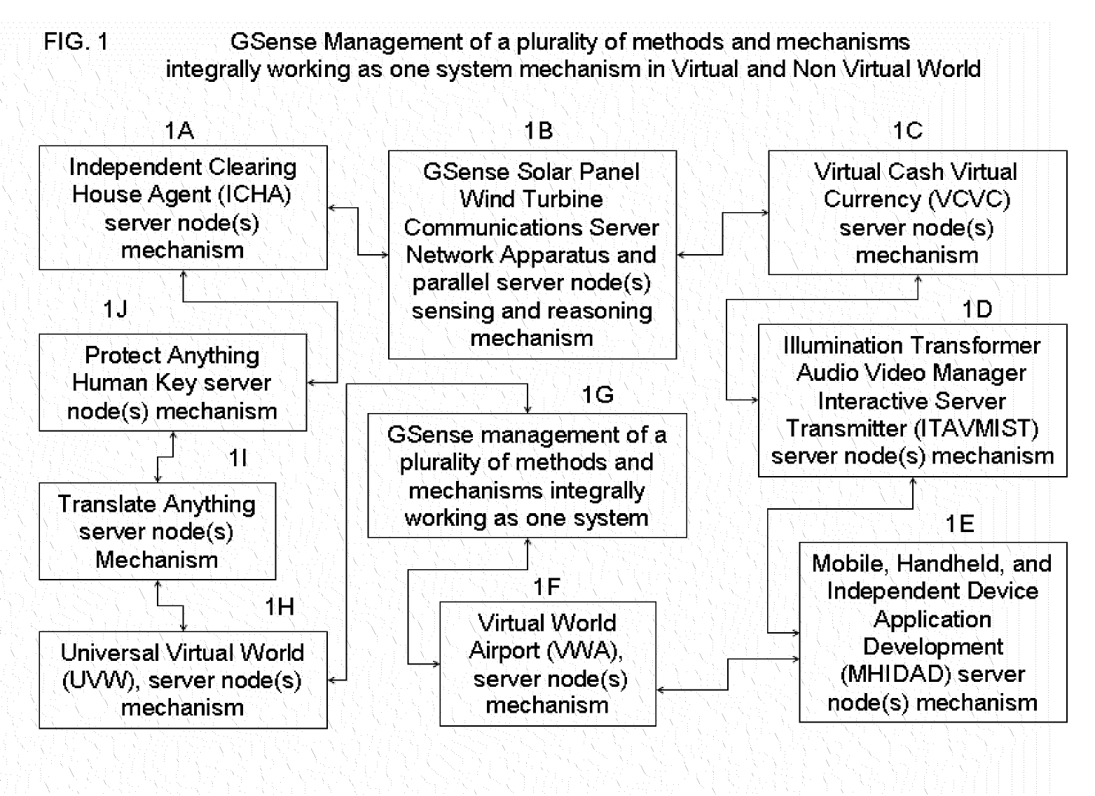

FIG. 1A Describes the GSense Management of a plurality of methods and mechanisms integrally working as one system mechanism in Virtual and Non Virtual World with Independent Clearing House Agent (ICHA) server node(s) mechanism.

FIG. 1B Describes the GSense Management of a plurality of methods and mechanisms integrally working as one system mechanism in Virtual and Non Virtual World with GSense Solar Panel Wind Turbine Communications Server Network Apparatus and parallel server node(s) sensing and reasoning mechanism.

FIG. 1C Describes the GSense Management of a plurality of methods and mechanisms integrally working as one system mechanism in Virtual and Non Virtual World with Virtual Cash Virtual Currency (VCVC) server node(s) mechanism.

FIG. 1D Describes the GSense Management of a plurality of methods and mechanisms integrally working as one system mechanism in Virtual and Non Virtual World with Illumination Transformer Audio Video Manager Interactive Server Transmitter (ITAVMIST) server node(s) mechanism.

FIG. 1E Describes the GSense Management of a plurality of methods and mechanisms integrally working as one system mechanism in Virtual and Non Virtual World with Mobile, Handheld, and Independent Device Application Development (MHIDAD) server node(s) mechanism.

FIG. 1F Describes the GSense Management of a plurality of methods and mechanisms integrally working as one system mechanism in Virtual and Non Virtual World with Virtual World Airport (VWA), server node(s) mechanism.

FIG. 1G Describes the GSense Management of a plurality of methods and mechanisms integrally working as one system mechanism in Virtual and Non Virtual World with GSense management of a plurality of methods and mechanisms integrally working as one system.

FIG. 1H Describes the GSense Management of a plurality of methods and mechanisms integrally working as one system mechanism in Virtual and Non Virtual World with Universal Virtual World (UVW), server node(s) mechanism.

FIG. 1I Describes the GSense Management of a plurality of methods and mechanisms integrally working as one system mechanism in Virtual and Non Virtual World with Translate Anything server node(s) Mechanism.

FIG. 1J Describes the GSense Management of a plurality of methods and mechanisms integrally working as one system mechanism in Virtual and Non Virtual World with Protect Anything Human Key server node(s) mechanism.

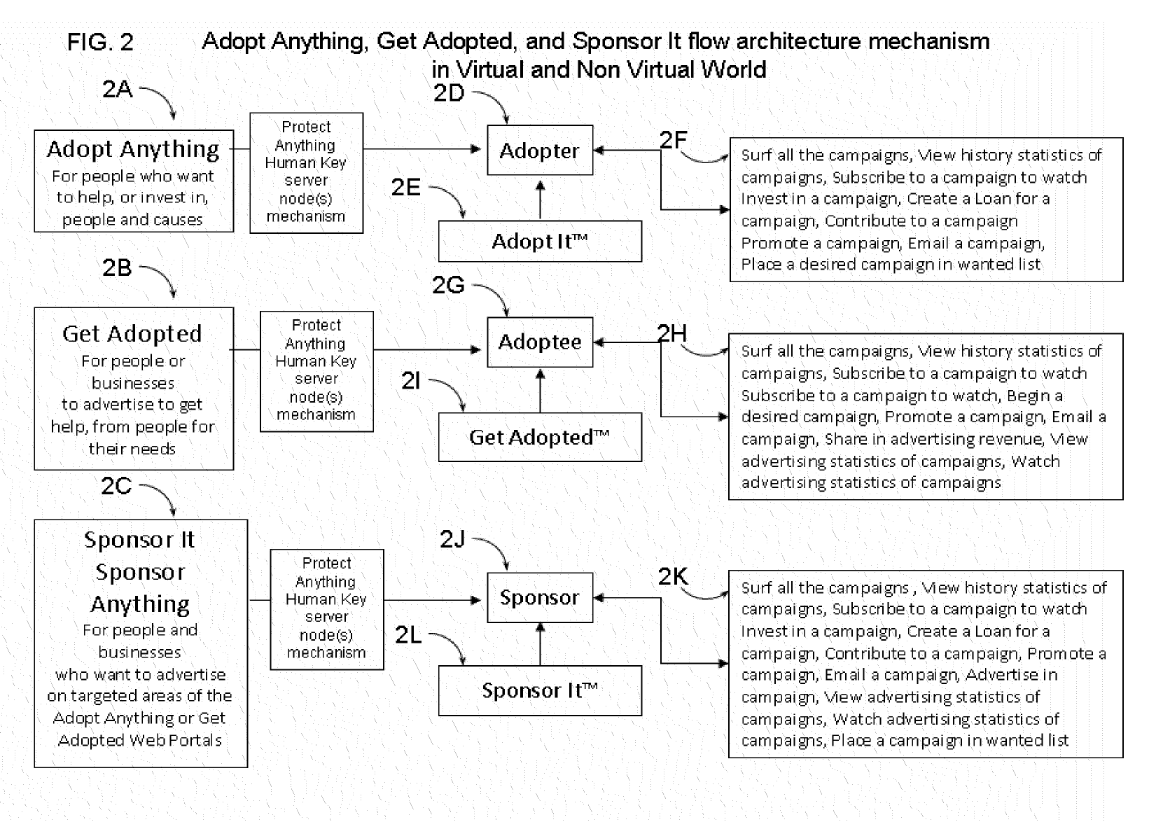

FIG. 2A identifies the mechanism and method by which this is all possible, namely Adopt Anything, utilizing the Protect Anything Human Key server node(s) mechanism, for security and identification.

FIG. 2B identifies a crucial element within the Adopt Anything network, namely the ability to get adopted utilizing the Protect Anything Human Key server node(s) mechanism for security and identification.

FIG. 2C identifies another crucial element within the Adopt anything network, namely the ability to sponsor an adoptee, utilizing the Protect Anything Human Key server node(s) mechanism for security and identification.

FIG. 2D identifies the ability of an individual to become an adopter.

FIG. 2E describes the functions that can be performed by the adopter within the Adopt Anything network.

FIG. 2F identifies the ability of an individual to adopt a potential adoptee.

FIG. 2G identifies the ability of an individual to get adopted.

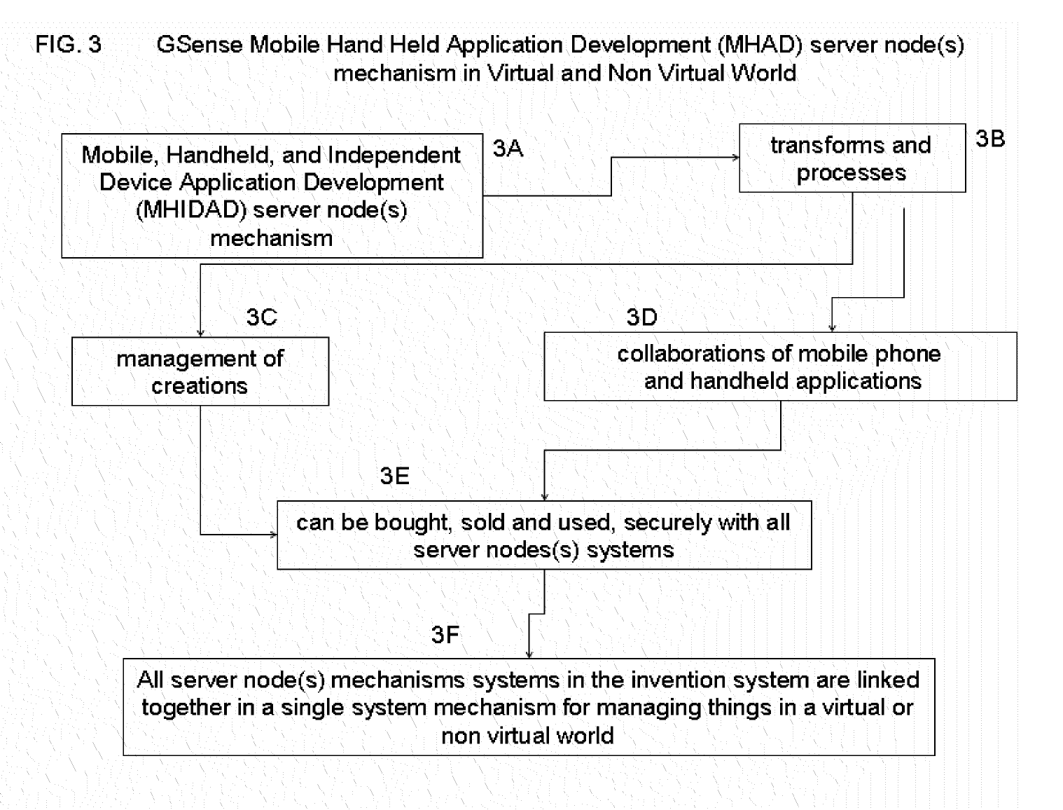

FIG. 3A describes the GSense Mobile, Handheld, and Independent Device Application Development (MHIDAD) server node(s) mechanism.

FIG. 3B describes the GSense Mobile, Handheld, and Independent Device Application Development (MHIDAD) server node(s) mechanism in Virtual and Non Virtual World where mechanism transforms and processes applications in the system.

FIG. 3C describes the GSense Mobile, Handheld, and Independent Device Application Development (MHIDAD) server node(s) mechanism in Virtual and Non Virtual World with management of applications creations that are made to work with the system.

FIG. 3D describes the GSense Mobile, Handheld, and Independent Device Application Development (MHIDAD) server node(s) mechanism in Virtual and Non Virtual World with collaborations of mobile phone and handheld applications as part of the management of making applications that work in the system.

FIG. 3E describes the GSense Mobile, Handheld, and Independent Device Application Development (MHIDAD) server node(s) mechanism in Virtual and Non Virtual World where applications can be bought, sold and used, securely with all server nodes(s) systems.

FIG. 3F describes the GSense Mobile, Handheld, and Independent Device Application Development (MHIDAD) server node(s) mechanism in Virtual and Non Virtual World where all server node(s) mechanisms systems in the invention system are linked together in a single system mechanism for managing things in a virtual or non virtual world, and applications created can work within all the mechanisms, and systems.

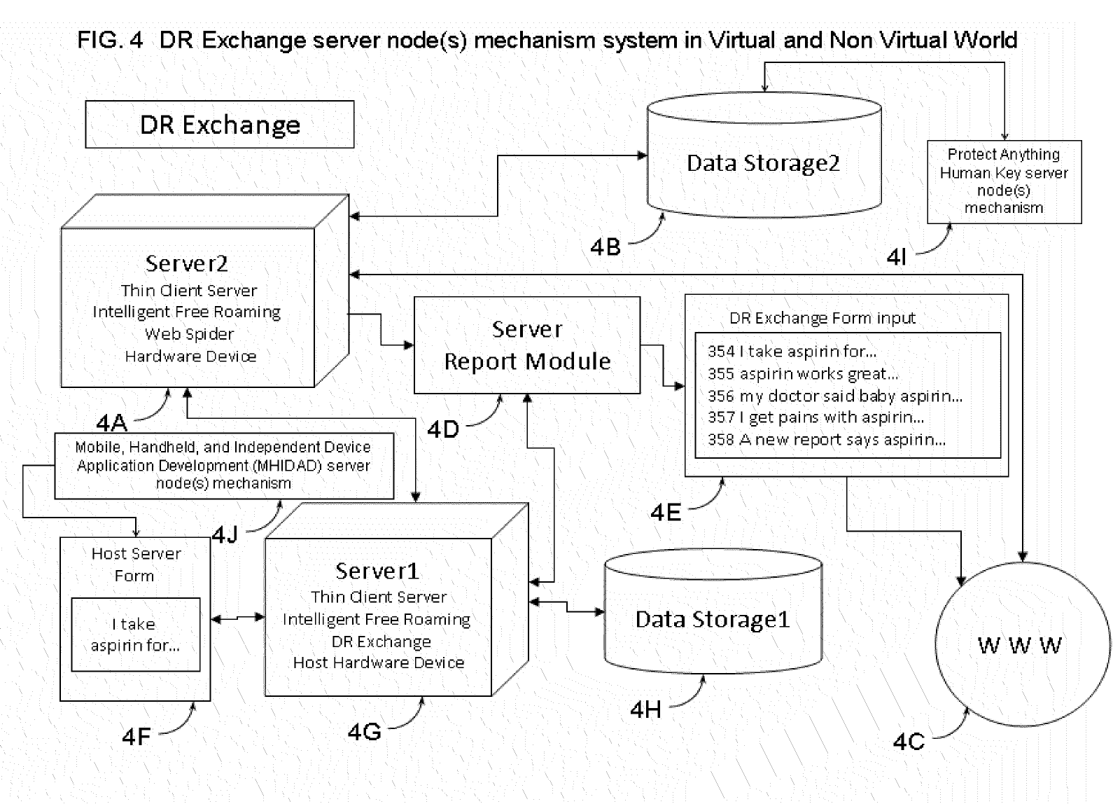

FIG. 4A illustrates server's main components, including thin client server, intelligent free roaming, web spider, and hardware device for the purpose of displaying the specifics of the system.

FIG. 4B illustrates the data storage unit, which will allow data to accompany this memory space.

FIG. 4C illustrates the www domain prefix, which will give the main internet address aspect.

FIG. 4D illustrates the server report module, which will report the server's main frame specifics.

FIG. 4E illustrates the DR Exchange form input, which maps out situations for a circumstance. In the case presented, the benefits and side effects of aspirin are explained including user and report statistics.

FIG. 4F illustrates the host server form, which depicts an event happening. In the case presented, user finds the information that one takes aspirin for something.

FIG. 4G illustrates server's main components, including thin client server, intelligent free roaming, DR Exchange, and Host Hardware Device. These system components depict the type specifics of server', and will allow users to find the advantages of the server.

FIG. 4H illustrates the second data storage unit, which will allow data to accompany this memory space.

FIG. 4I illustrates Protect Anything Human Key server node(s) mechanism.

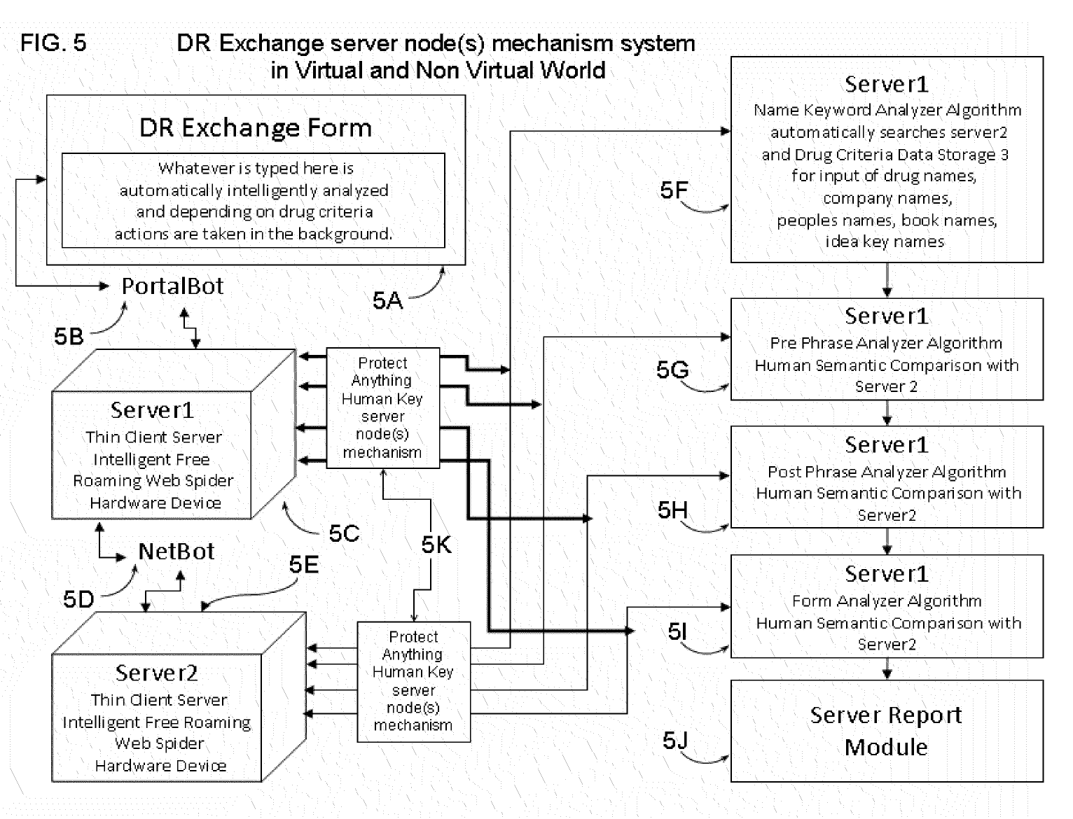

FIG. 5A illustrates the scenario that anything typed here will be automatically and intelligently analyzed and depending on drug criteria actions are to be taken in the background.

FIG. 5B illustrates the PortalBot, which will provide as a connection point between the DR Exchange Form and server 1.

FIG. 5C illustrates server I and its main components, including thin client server, intelligent free roaming, web spider, and hardware device. These system specifics will provide the user with better views of the mainframe's advantages.

FIG. 5D illustrates the NetBot, which will serve as a connection point between server I and server 2.

FIG. 5E illustrates server 2 and its main components, including thin client server, intelligent free roaming, web spider, and hardware device. These system specifics will provide the user with better views of the mainframe's advantages.

FIG. 5F illustrates server I and its main components including the name keyword analyzer algorithm, which will automatically search server 2 and drug criteria data storage 3 for input of drug names, company names, people's names, book names, and the idea key names.

FIG. 5G illustrates server's role within the DR Exchange, depicting the pre phrase analyzer algorithm and the human semantic comparison with server2.

FIG. 5H illustrates another one of server I's simultaneous roles within the DR Exchange, depicting the post phrase analyzer algorithm and the human semantic comparison with server 2.

FIG. 5I illustrates the third one of server I's simultaneous roles within the DR Exchange, depicting the form analyzer algorithm and the human semantic comparison with server 2.

FIG. 5J illustrates the server report module, which is the last step to the DR Exchange providing one last step to the reporting procedure.

FIG. 5K illustrates the Protect Anything Human Key server node(s) mechanism used in the mechanism at key points for protection, authentication and identification.

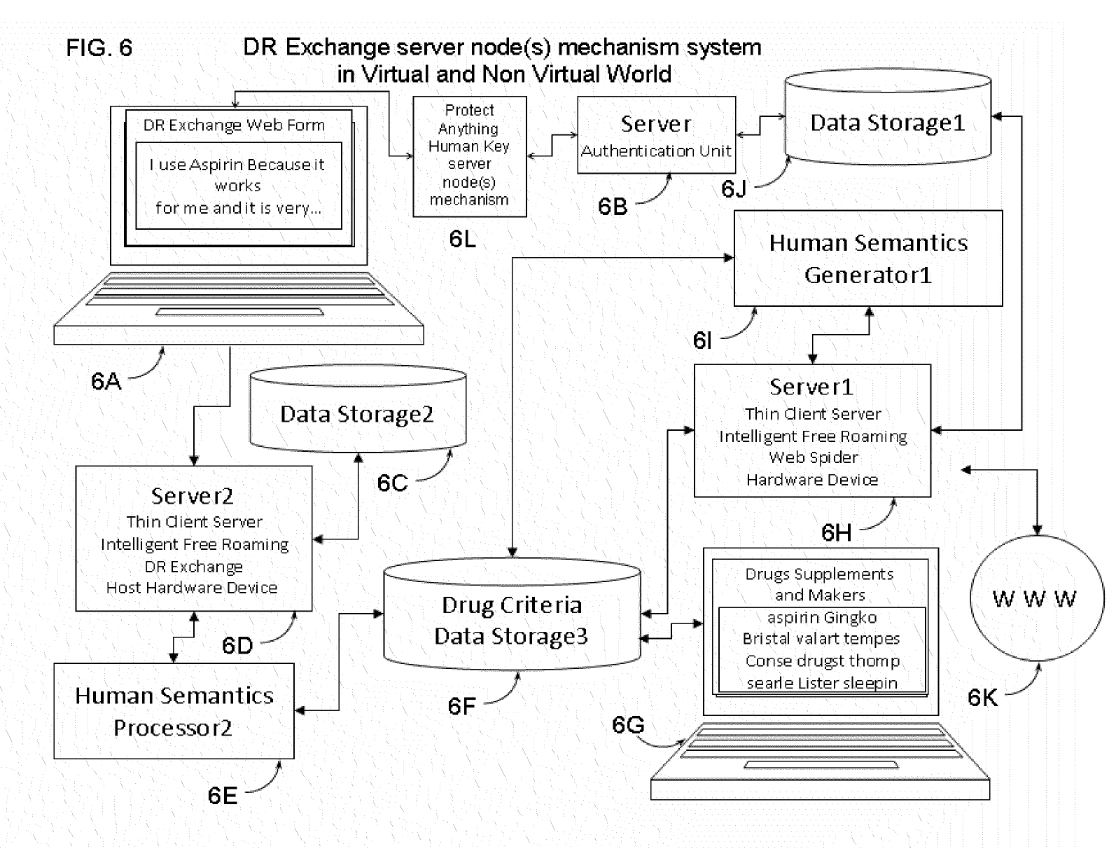

FIG. 6A illustrates the super computer DR Exchange Web Form, which displays a written cause statement, “I use Aspirin, because it works for me and it is very_.”

FIG. 6B illustrates the server authentication unit, which provides a security layer for proper access.

FIG. 6C illustrates data Storage 2, which will allow data to accompany this memory space.

FIG. 6D illustrates server 2's main components, including thin client server, intelligent free roaming, DR Exchange, and host hardware device. These system specifics will provide the user with better views of the mainframe's advantages.

FIG. 6E illustrates the human semantics processor 2, which connects to server 2 and the later Drug Criteria Data Storage 3. This processor will be a tool for giving the proper meaning of certain language paths typed on the computer.

FIG. 6F illustrates the Drug Criteria Data Storage 3, which enables certain drug information to be stored onto the data storage unit's memory space.

FIG. 6G illustrates the Drugs Supplements and Makers on screen layout, which will give a three part word series of available information.

FIG. 6H illustrates server's main components, including thin client server, intelligent free roaming, web spider, and hardware device. These system specifics will provide the user with better views of the mainframe's advantages.

FIG. 6I illustrates the Human Semantics Generator, which works in connection with Drug Criteria Data Storage 3 and server 1. This generator will work out meanings of word meanings and map out semantic word language.

FIG. 6J illustrates the data storage 1 unit, which is connected only to server 1. This storage unit will allow data to accompany this memory space.

FIG. 6K illustrates the www domain prefix, which will give the main internet address aspect.

FIG. 6L illustrates the Protect Anything Human Key server node(s) mechanism used in the mechanism at key points for protection, authentication and identification.

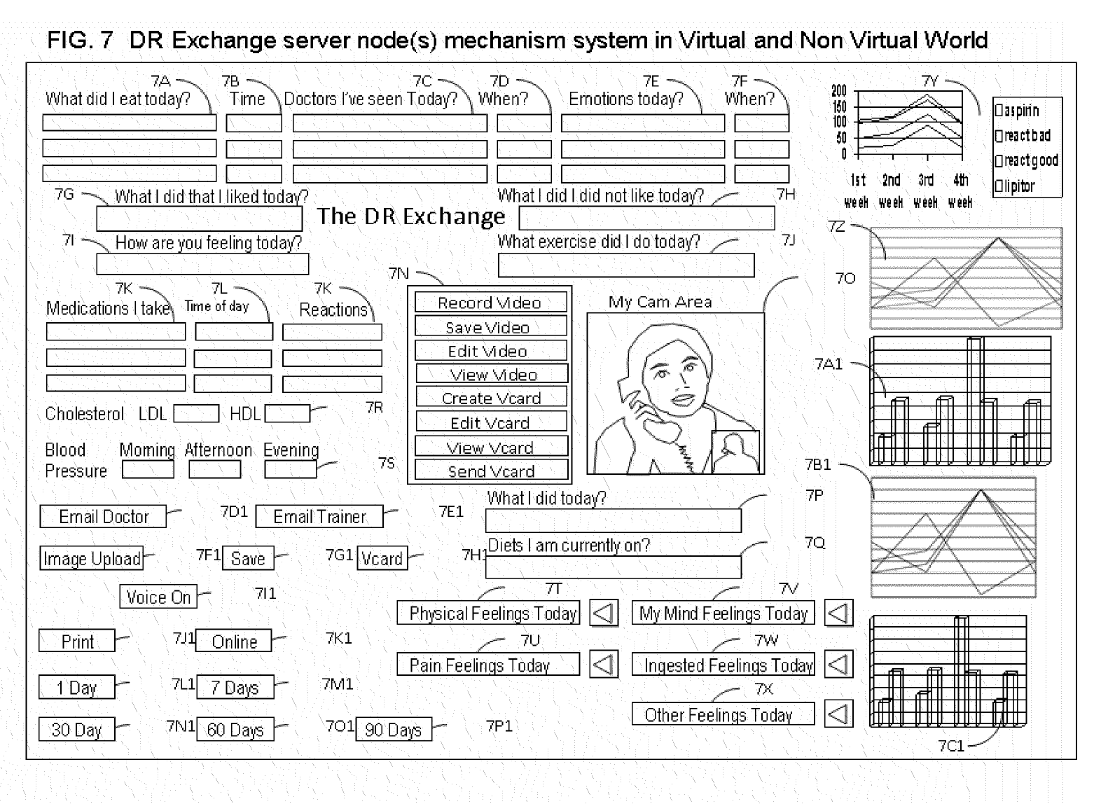

FIG. 7A illustrates an input form field where an individual to write about what he or she has eaten that day.

FIG. 7B illustrates an input form field where an individual to list the time corresponding to the items he or she has eaten that day.

FIG. 7e illustrates an input form field where an individual can list the doctors he or she has seen that day.

FIG. 7D illustrates an input form field where an individual can list the time at which he or she visited the doctor.

FIG. 7E illustrates an input form field where an individual can list the emotions he or she has felt throughout the course of the day.

FIG. 7F illustrates an input form field where an individual can list the times at which he or she felt a particular emotion.

FIG. 7G illustrates an input form field where an individual can write about what he or she did during that course of the day that was positive.

FIG. 7H illustrates an input form field where an individual can write about what he or she did that day that was negative.

FIG. 7I illustrates an input form field where an individual can write an overarching summary of how he or she felt that day.

FIG. 7J illustrates an input form field where an individual can write about the exercise he or she performed that day.

FIG. 7K illustrates an input form field where an individual can list the medications he or she took that day.

FIG. 7L illustrates an input form field where an individual can list the time at which he or she took a specific medication.

FIG. 7M illustrates an input form field where an individual can list the reactions he or she had to the medications taken that day.

FIG. 7N illustrates the eight functions that can be performed within the “My Cam Area” video application.

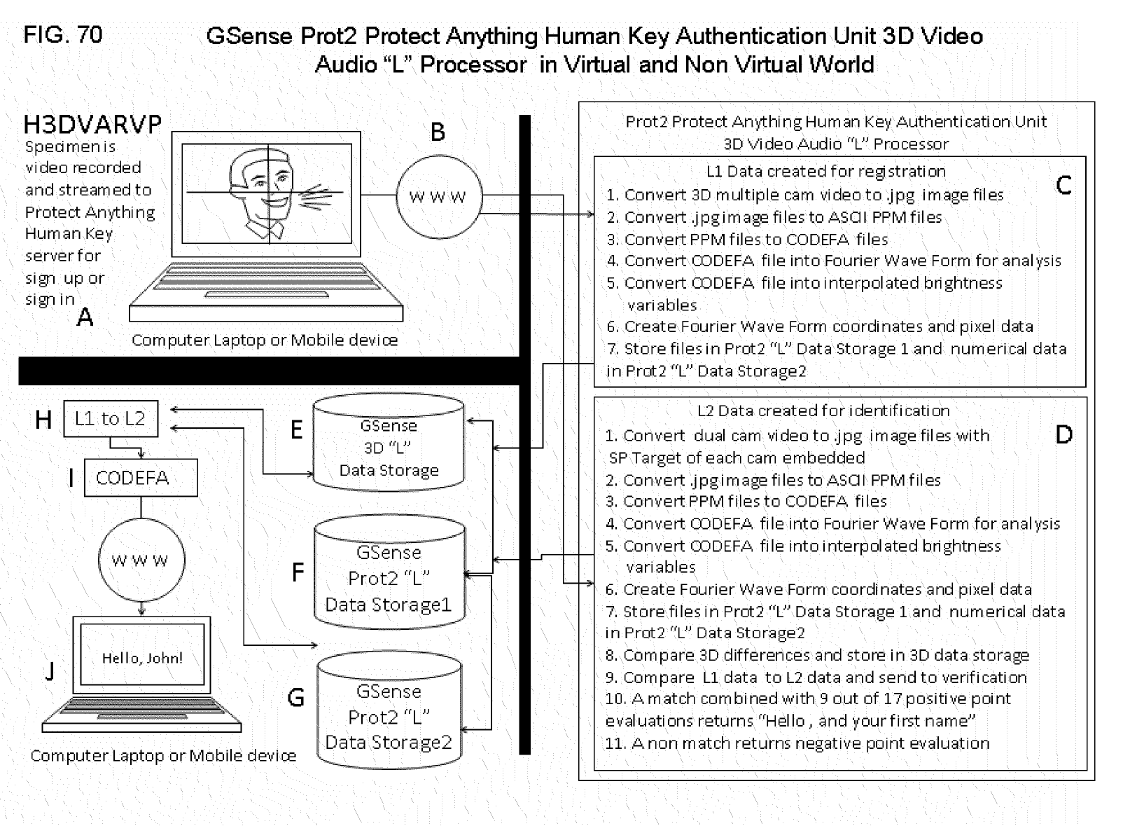

FIG. 70 illustrates the “My Cam Area” mechanism where an individual can record, save, edit, view, create, edit, view and send video within The DR Exchange.

FIG. 7P illustrates an input form field where an individual can write about what he or she did that day.

FIG. 7Q illustrates an input form field where an individual can write about the diets he or she is currently on.

FIG. 7R illustrates an input form field where an individual can write in what his or her HDL and LDL cholesterol levels are at presently.

FIG. 7S illustrates an input form field where an individual can list what his or her blood pressure was at three points throughout the day, namely morning, afternoon and evening.

FIG. 7T illustrates a field where an individual can identify his or her physical feelings experienced that day and find descriptions written on previous days,

FIG. 7U illustrates a field where an individual can identify his or her painful physical feelings experienced that day and fil1d written descriptions from on previous days, FIG. 7V illustrates a field where an individual can identify his or her mental feelings experienced that day and find written descriptions written from previous days,

FIG. 7W illustrates a field where an individual can identify his or her ingested feelings experienced that day and find written descriptions from previous days.

FIG. 7X illustrates a field where an individual can identify his or her miscellaneous feelings experienced that day and find written descriptions from previous days,

FIG. 7Y illustrates a graph that displays the drugs an individual has been taking and the reactions he or she has had over time,

FIG. 7Z illustrates a graph that displays the severity of the feelings an individual has experience over the course of the day,

FIG. 7A1 illustrates a graph that displays the likes and dislikes of an individual over a period of time,

FIG. 7B1 illustrates a graph that displays an individual's, blood pressure, cholesterol and diet habits over a period of time,

FIG. 7C1 illustrates a graph that displays a variety of factors over a period of time,

FIG. 7D1 illustrates a link through which an individual will be able to e-mail his or her doctor.

FIG. 7E1 illustrates a link through which an individual will be able to e-mail his or her trainer.

FIG. 7F1 illustrates a link through which an individual will be able to upload an image of anything.

FIG. 7G1 illustrates a link through which an individual will be able to save his or her The DR Exchange page after working on it.

FIG. 7HI illustrates a link through which an individual will be able to send a VCard.

FIG. 7I1 illustrates a link through which an individual will be able to turn on or off the sound on the “My Cam Area” video application.

FIG. 7J1 illustrates a link through which an individual will be able to print anything on The DR Exchange page.

FIG. 7KI illustrates a link through which an individual will be able to sign out of his or her The DR Exchange page.

FIG. 7LI illustrates a link through which an individual will be able to call up information from one day ago

FIG. 7M1 illustrates a link through which an individual will be able to call up information from seven day ago

FIG. 7NI illustrates a link through which an individual will be able to call up information from 30 days ago.

FIG. 7O1 illustrates a link through which an individual will be able to call up information from 60 days ago.

FIG. 7PI illustrates a link through which an individual will be able to call up information from 90 days ago.

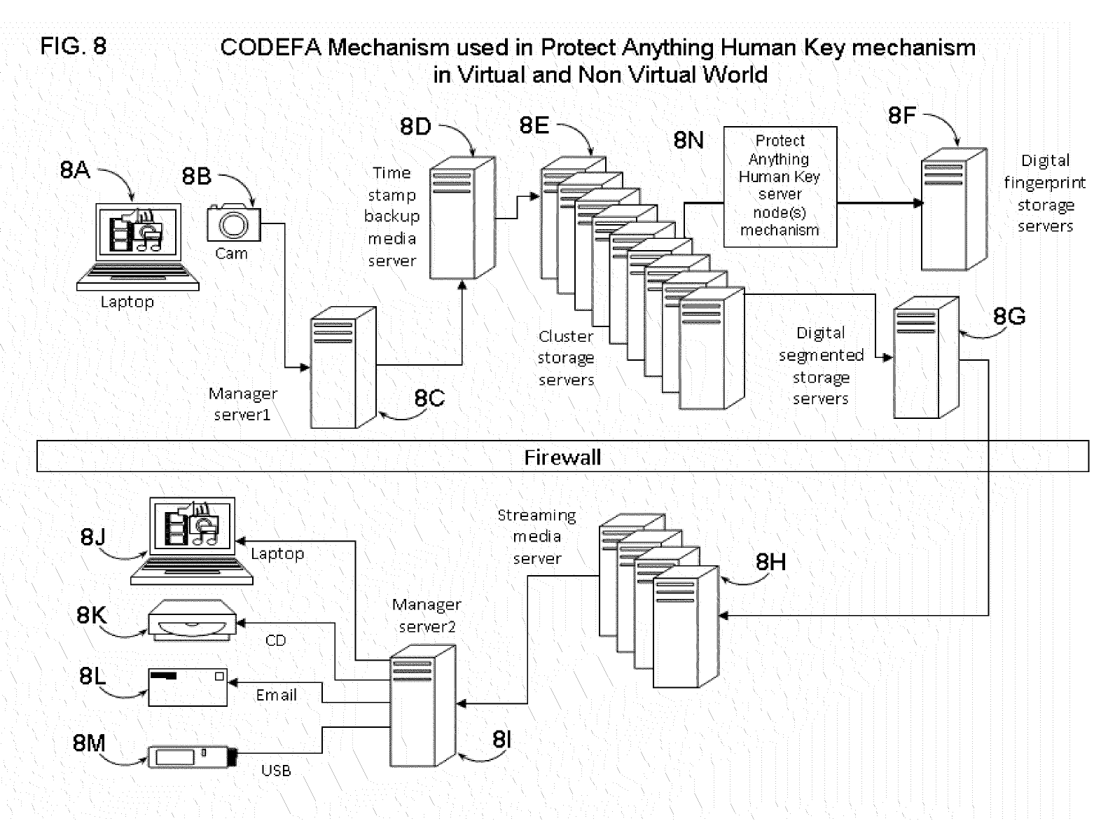

FIG. 8A illustrates a computer capable of processing different forms of multimedia including digital pictures, video and music.

FIG. 8B illustrates a camera which can be used to upload pictures onto a computer.

FIG. 8C illustrates the entry manager server where the data is initially processed.

FIG. 8D illustrates the backup media server where the data is given a time stamp.

FIG. 8E illustrates the cluster of servers where the data is stored.

FIG. 8F illustrates the server where a digital fingerprint is issued to the data

FIG. 8G illustrates the server where the data is digitally segmented.

FIG. 8H illustrates the series of servers used to stream video.

FIG. 8I illustrates the second manager server where data passes as it is downloaded onto the computer or other device.

FIG. 8J illustrates a computer capable of processing different forms of multimedia including digital pictures, video and music.

FIG. 8K illustrates a CD drive.

FIG. 8L illustrates e-mail which would be processed through the servers.

FIG. 8M illustrates a USB storage device.

FIG. 8N illustrates the Protect Anything Human Key server node(s) mechanism used in the mechanism at key points for protection, authentication and identification.

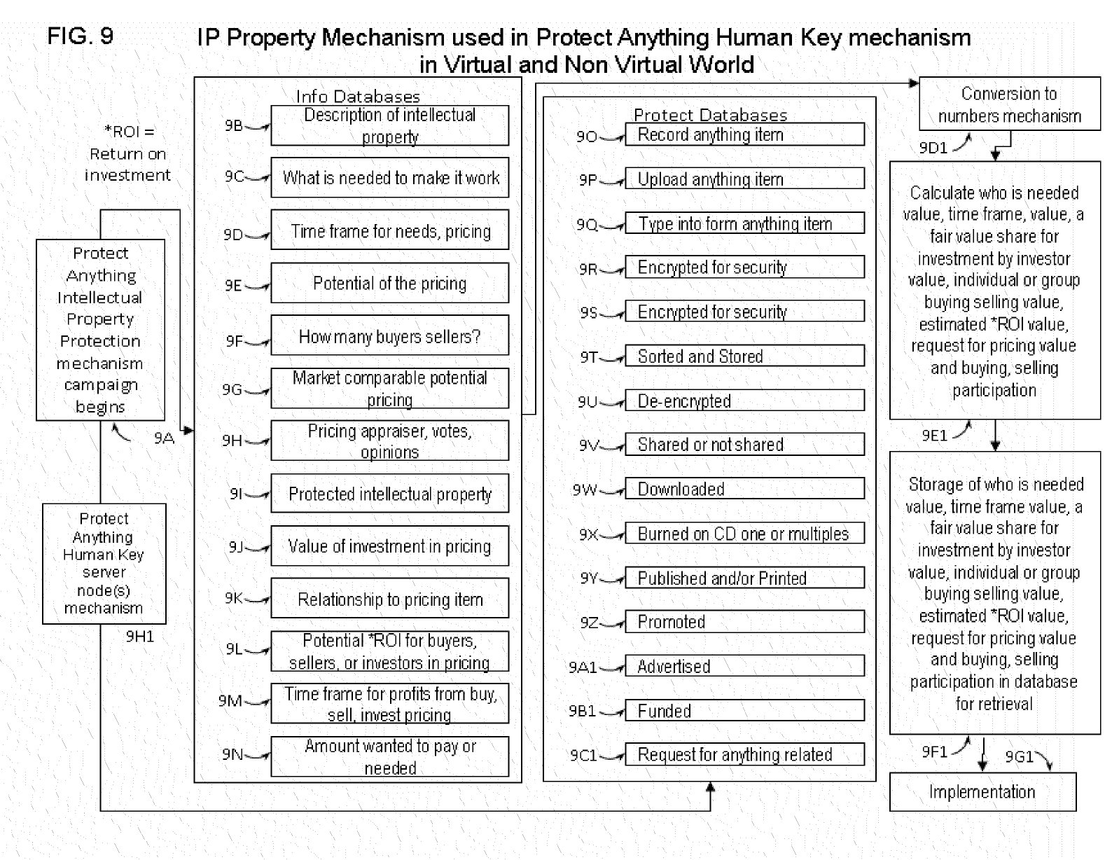

FIG. 9A describes the method by which all information that an individual needs or wants to be protected, can and will be protected, namely Protect Anything.

FIG. 9B illustrates the process by which an individual will describe his or her intellectual property.

FIG. 9C describes the process by which an individual decides what is needed to build and successfully operate the thing.

FIG. 9D describes the process by which an individual evaluates the time needed to construct the thing.

FIG. 9E describes the process by which an individual determines the price of the thing.

FIG. 9F describes the process by which an individual establishes how many buyers and sellers will constitute the initial market for the thing.

FIG. 9G describes the process by which an individual determines competitive pricing for the thing.

FIG. 9H describes the process by which an individual appraises the previously determined price of the thing.

FIG. 9I describes the process by which an individual seeks to protect his or her intellectual property.

FIG. 9J describes the process by which an individual evaluates the importance and or necessity of investment.

FIG. 9K describes the process by which an individual determines the relationship to pricing item.

FIG. 9L describes the process by which an individual evaluates the potential ROI for buyers, sellers and investors in pricing.

FIG. 9M describes the process by which an individual estimates how long it will take to turn a profit based on buying, selling and investing pricing.

FIG. 9N describes the process by which an individual determines how much customers would be willing to pay versus how much they need to pay.

FIG. 9O describes the process by which an individual can protect any recorded item within the Protect Anything database.

FIG. 9P describes the process by which an individual can protect any uploaded item within the Protect Anything database.

FIG. 9Q describes the process by which an individual can protect anything he or she types into an input field form within the Protect Anything database.

FIG. 9R describes the process by which any data is encoded to protect quality within the Protect Anything database.

FIG. 9S describes the process by which data is protected through encryption within the Protect Anything database.

FIG. 9T describes the process by which data is sorted and stored within the Protect Anything database.

FIG. 9U describes the process by which data is de-encrypted within the Protect Anything database.

FIG. 9V describes the process by which an individual can choose to share or not share his or her data within the Protect Anything database.

FIG. 9W describes the process by which data is downloaded within the Protect Anything database.

FIG. 9X describes the process by which data is burned onto one or multiple CD's within the Protect Anything database.

FIG. 9Y describes the process by which an individual chooses to publish and or print his or her data within the Protect Anything database.

FIG. 9Z describes the process by which data is promoted within the Protect Anything database.

FIG. 9A1 describes the process by which data is advertised within the Protect Anything database.

FIG. 9B1 describes the process by which data is funded within the Protect Anything database.

FIG. 9C1 describes the process by which a request for anything related to the requested subject, is stored within the Protect Anything database.

FIG. 9D1 identifies the conversion and transformation of info databases data to numbers mechanism.

FIG. 9E1 identifies the aspect where the mechanism calculates who is needed value, time frame, value, a fair value share for investment by investor value, individual or group buying selling value, estimated *ROI value, request for pricing value and buying, selling participation in the mechanism system.

FIG. 9F1 identifies where storage of who is needed value, time frame value, a fair value share for investment by investor value, individual or group buying selling value, estimated *ROI value, request for pricing value and buying, selling participation data in database for retrieval is implemented in the mechanism.

FIG. 9G1 shows implementation of all data aggregated in the mechanism.

FIG. 9H1 illustrates the Protect Anything Human Key server node(s) mechanism used in the mechanism at key points for protection, authentication and identification.

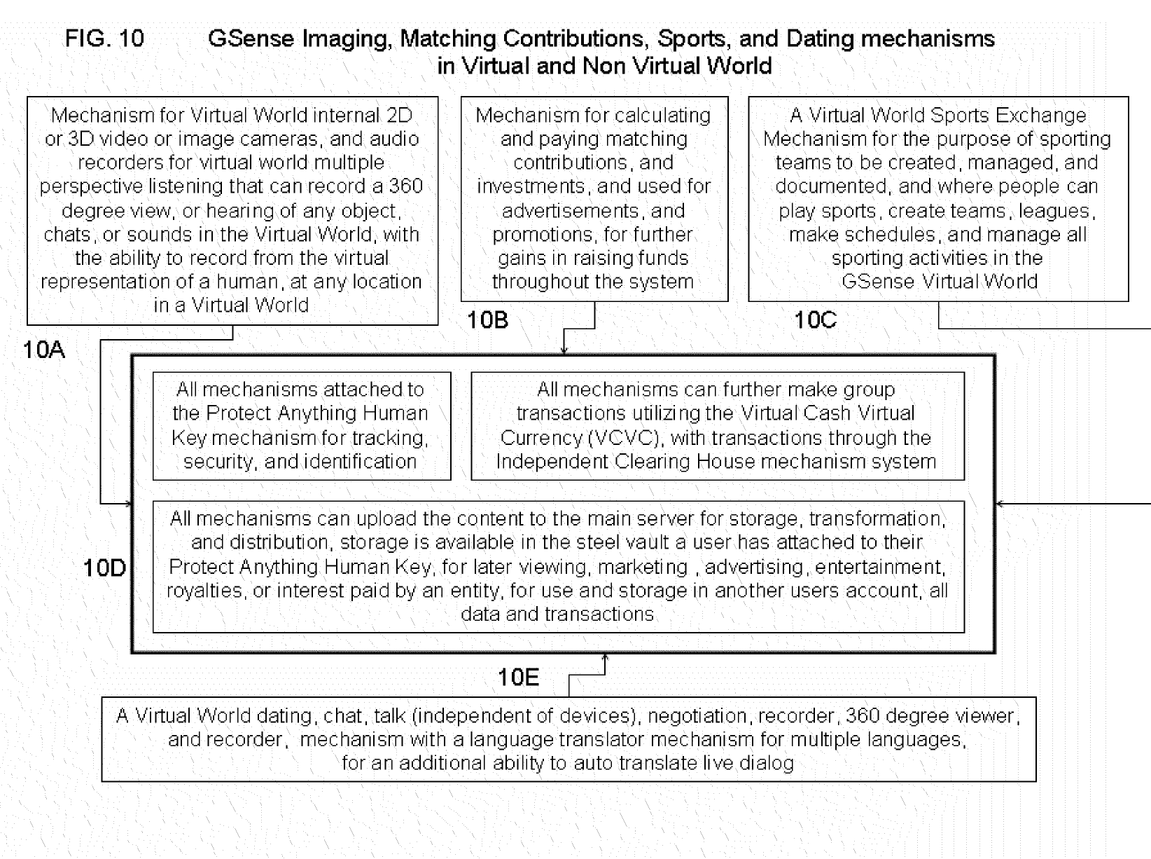

FIG. 10A illustrates GSense Imaging, Matching Contributions, Sports, and Dating mechanisms in Virtual and Non Virtual World with a Mechanism for Virtual World internal 2D or 3D video or image cameras, and audio recorders for virtual world multiple perspective listening that can record a 360 degree view, or hearing of any object, chats, or sounds in the Virtual World, with the ability to record from the virtual representation of a human, at any location in a Virtual World.

FIG. 10B illustrates GSense Imaging, Matching Contributions, Sports, and Dating mechanisms in Virtual and Non Virtual World with Mechanism for calculating and paying matching contributions, and investments, and used for advertisements, and promotions, for further gains in raising funds throughout the system.

FIG. 10C illustrates GSense Imaging, Matching Contributions, Sports, and Dating mechanisms in Virtual and Non Virtual World with A Virtual World Sports Exchange Mechanism for the purpose of sporting teams to be created, managed, and documented, and where people can play sports, create teams, leagues, make schedules, and manage all sporting activities in the GSense Virtual World.

FIG. 10D illustrates GSense Imaging, Matching Contributions, Sports, and Dating mechanisms in Virtual and Non Virtual World with All mechanisms attached to the Protect Anything Human Key mechanism for tracking, security, and identification, and All mechanisms can further make group transactions utilizing the Virtual Cash Virtual Currency (VCVC), with transactions through the Independent Clearing House mechanism system, and All mechanisms can upload the content to the main server for storage, transformation, and distribution, storage is available in the steel vault a user has attached to their Protect Anything Human Key, for later viewing, marketing, advertising, entertainment, royalties, or interest paid by an entity, for use and storage in another users account, all data and transactions.

FIG. 10E illustrates GSense Imaging, Matching Contributions, Sports, and Dating mechanisms in Virtual and Non Virtual World with A Virtual World dating, chat, talk (independent of devices), negotiation, recorder, 360 degree viewer, and recorder, mechanism with a language translator mechanism for multiple languages, for an additional ability to auto translate live dialog.

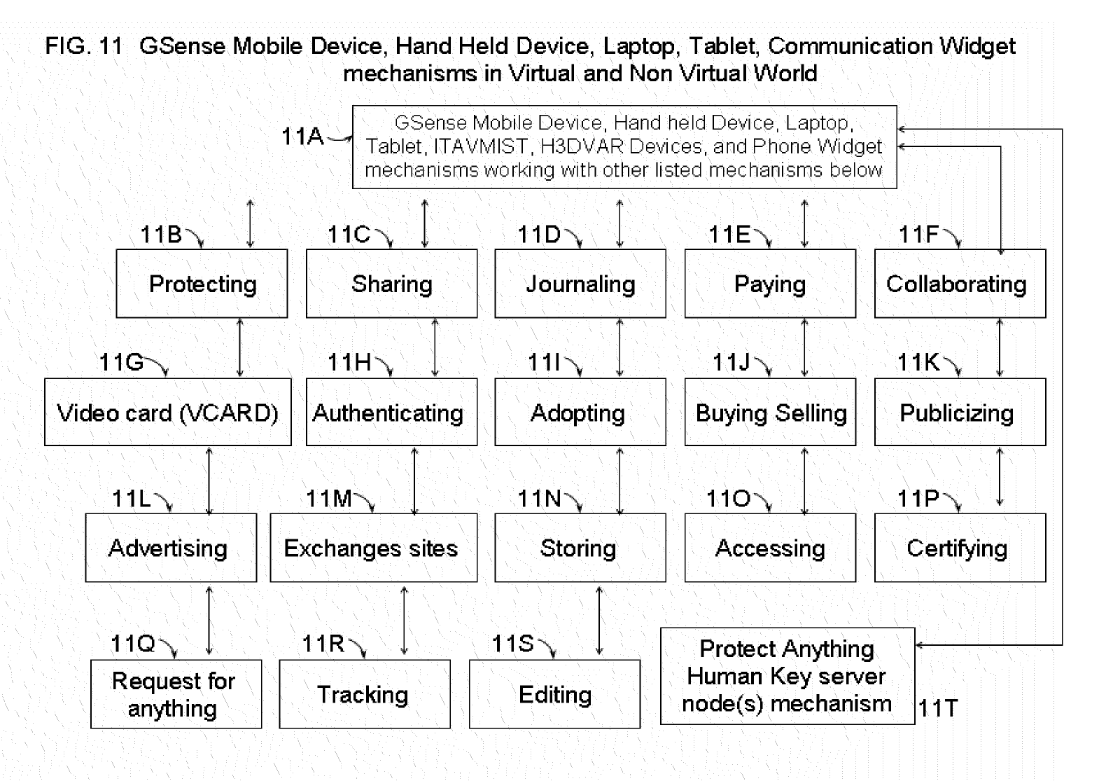

FIG. 11A describes the devices through which the widget mechanism, GSense Mobile Device, Hand held Device, Laptop, Tablet, ITAVMIST, H3DVAR Devices, and Phone Widget mechanisms and invention will be able to operate on.

FIG. 11B illustrates a link through which an individual can protect his or her data.

FIG. 11C illustrates a link through which an individual can share his or her data.

FIG. 11D illustrates a link through which an individual can access his or her journal.

FIG. 11E illustrates a link through which an individual can make payments.

FIG. 11F illustrates a link through which an individual can collaborate with other individuals.

FIG. 11G illustrates a link through which an individual can access his or her VCard

FIG. 11H illustrates a link through which an individual can authenticate anything.

FIG. 11I illustrates a link through which an individual can'access Adopt Anything TM.

FIG. 11J illustrates a link through which an individual can access Buy And Sell Anything. FIG. 11K illustrates a link through which an individual can publicize whatever he or she wants to.

FIG. 11L illustrates a link through which an individual can access his or her advertisements or look at others advertisements.

FIG. 11M illustrates a link through which an individual can access his or her exchanges.

FIG. 11N illustrates a link through which an individual can access an online store.

FIG. 11O illustrates a link through which an individual can access an authenticated network.

FIG. 11P illustrates a link through which an individual can certify him or herself.

FIG. 11Q illustrates a link through which an individual can request anything.

FIG. 11R illustrates a link through which an individual can track anything.

FIG. 11S illustrates a link through which an individual can edit anything.

FIG. 11T illustrates the Protect Anything Human Key server node(s) mechanism used in the mechanism at key points for protection, authentication and identification.

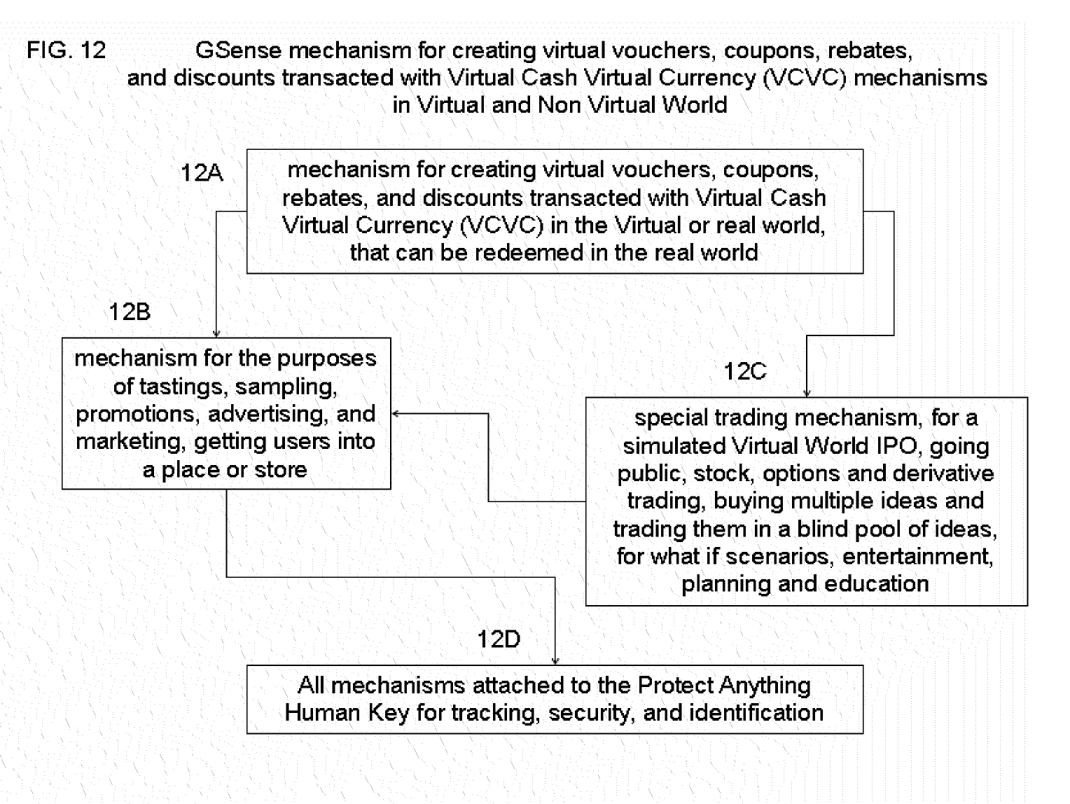

FIG. 12A illustrates GSense mechanism for creating virtual vouchers, coupons, rebates, and discounts transacted with Virtual Cash Virtual Currency (VCVC) mechanisms in Virtual and Non Virtual World and a mechanism for creating virtual vouchers, coupons, rebates, and discounts transacted with Virtual Cash Virtual Currency (VCVC) in the Virtual or real world that can be redeemed in the real world.

FIG. 12B illustrates GSense mechanism for creating virtual vouchers, coupons, rebates, and discounts transacted with Virtual Cash Virtual Currency (VCVC) mechanisms in Virtual and Non Virtual World and a mechanism for the purposes of tastings, sampling, promotions, advertising, and marketing, getting users into a place or store.

FIG. 12C illustrates GSense mechanism for creating virtual vouchers, coupons, rebates, and discounts transacted with Virtual Cash Virtual Currency (VCVC) mechanisms in Virtual and Non Virtual World and a special trading mechanism, for a simulated Virtual World IPO, going public, stock, options and derivative trading, buying multiple ideas and trading them in a blind pool of ideas, for what if scenarios, entertainment, planning and education.

FIG. 12D illustrates GSense mechanism for creating virtual vouchers, coupons, rebates, and discounts transacted with Virtual Cash Virtual Currency (VCVC) mechanisms in Virtual and Non Virtual World and where all mechanisms are attached to the Protect Anything Human Key for tracking, security, and identification.

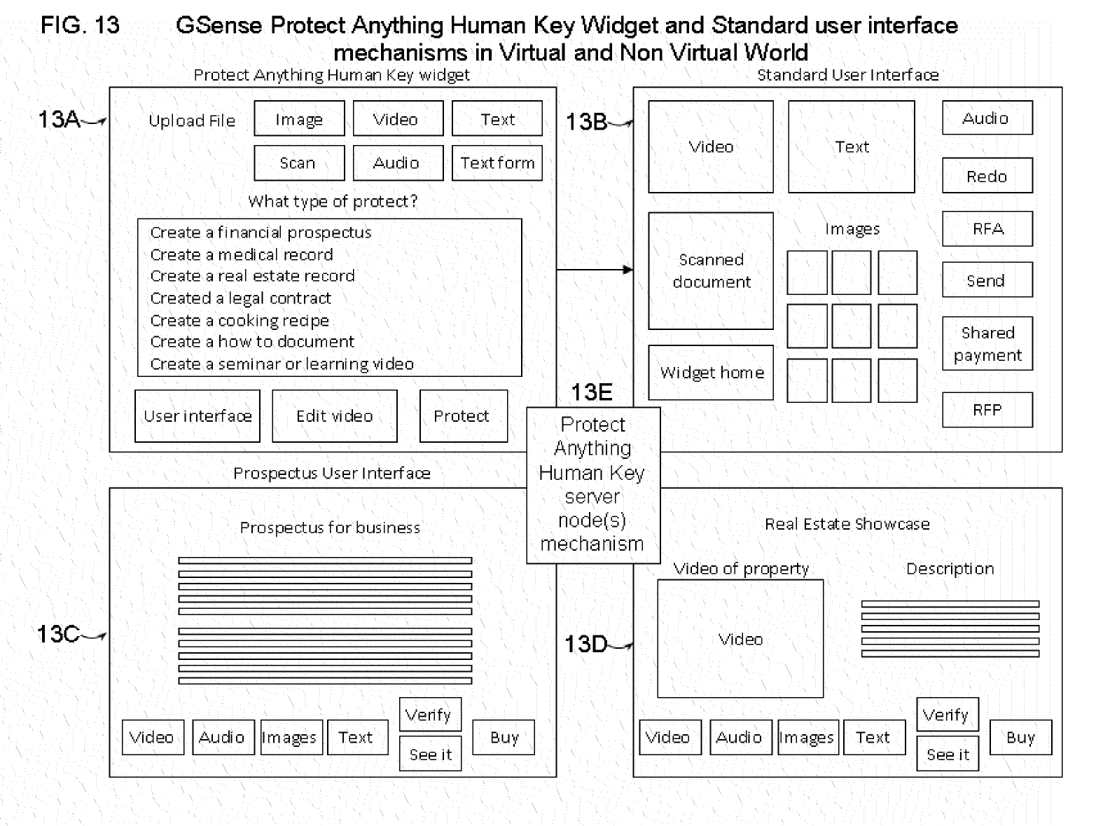

FIG. 13A illustrates a graphical user interface of the Protect Anything widget. It displays the different areas through which data can be loaded and stored securely.

FIG. 13B illustrates the standard graphical user interface that will greet the user.

FIG. 13C illustrates the graphical user interface for the ‘Prospectus for Business’ zone of the widget.

FIG. 13D illustrates the graphical user interface for the ‘Real Estate Record’ zone of the widget.

FIG. 13E illustrates the Protect Anything Human Key server node(s) mechanism used in the mechanism at key points for protection, authentication and identification.

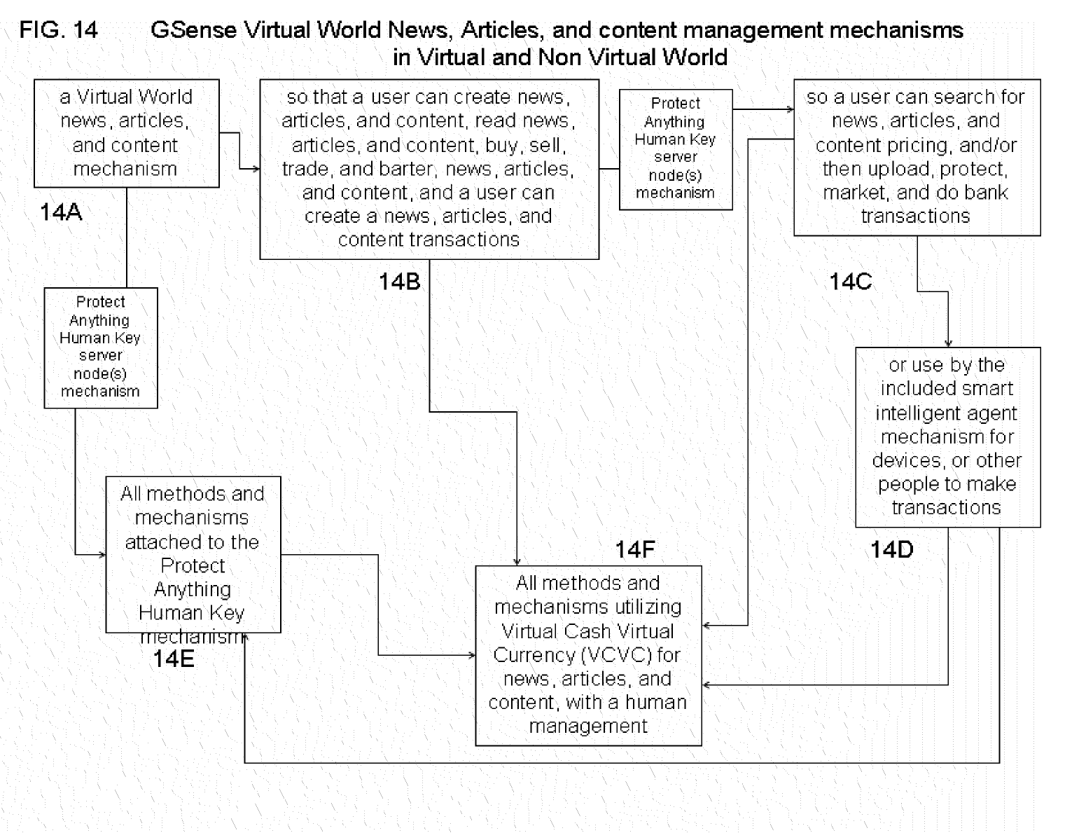

FIG. 14A illustrates GSense Virtual World News, Articles, and content management mechanisms in Virtual and Non Virtual World, connected to a Virtual World news, articles, and content mechanism, linked to the Protect Anything Human Key server node(s) mechanism used in the mechanism at key points for protection, authentication and identification.

FIG. 14B illustrates GSense Virtual World News, Articles, and content management mechanisms in Virtual and Non Virtual World so that a user can create news, articles, and content, read news, articles, and content, buy, sell, trade, and barter, news, articles, and content, and a user can create a news, articles, and content transactions.

FIG. 14C illustrates GSense Virtual World News, Articles, and content management mechanisms in Virtual and Non Virtual World connected to Protect Anything Human Key, so a user can search for news, articles, and content pricing, and/or then upload, protect, market, and do bank transactions.

FIG. 14D illustrates GSense Virtual World News, Articles, and content management mechanisms in Virtual and Non Virtual World where system can be used by the included smart intelligent agent mechanism for devices, or other people to make transactions.

FIG. 14E illustrates GSense Virtual World News, Articles, and content management mechanisms in Virtual and Non Virtual World where all methods and mechanisms attached to the Protect Anything Human Key mechanism.

FIG. 14F illustrates GSense Virtual World News, Articles, and content management mechanisms in Virtual and Non Virtual World where all methods and mechanisms are utilizing Virtual Cash Virtual Currency (VCVC) for news, articles, and content, with a human management.

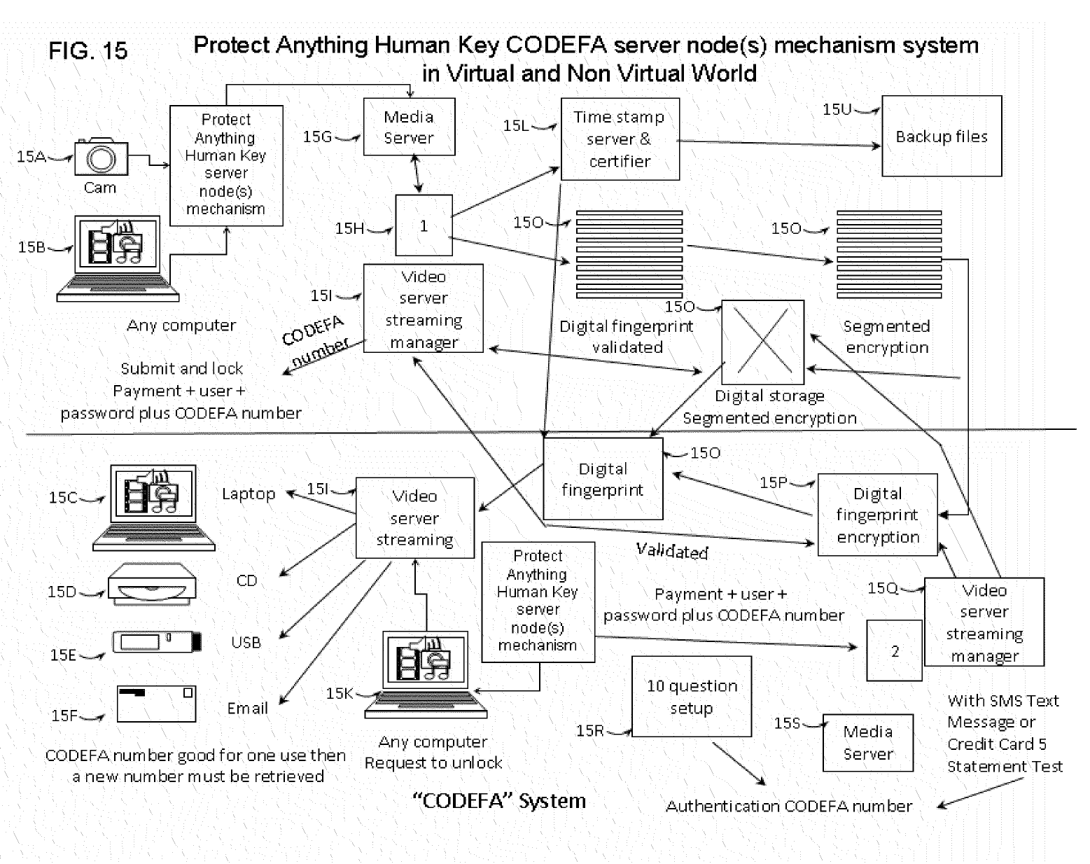

FIG. 15A describes Protect Anything Human Key CODEFA server node(s) mechanism system in Virtual and Non Virtual World where the camera's primary location within the system and where it will act as a video taking tool.

FIG. 15B illustrates the literal meaning, “any computer,” which describes these computer's possible connections with the cam and video and media servers.

FIG. 15C illustrates the video terminal, which will act as a guiding point for video server streaming.

FIG. 15D illustrates the CD's role within the video server streaming interface.

FIG. 15E illustrates the USB's role within video server streaming, whereby an external tool will allow for extra storage, usage, and external connection points.

FIG. 15F illustrates the email system within video server streaming, whereby users are able to compose and receive email through their member pages.

FIG. 15G illustrates the media server which connects to point 1, where video server streaming manager will take instance with the Protect Anything Human Key.

FIG. 15H illustrates the point 1 instance, where three outgoing signals will connect to media server, time stamp server and certifier, digital fingerprint validated. Three incoming signals will pass the point 1 instance, which are digital storage segmented encryption, digital fingerprint encryption, and media server again. This video server streaming manager enables the managing of video server's streaming network.

FIG. 15I illustrates video server streaming, which will perform functions related to video streaming maintenance.

FIG. 15J Video server streaming connects to five outgoing points, which only connecting to one incoming point. Video terminal, CD, USB, email, Request to & unlock is the outgoing signals, while the digital fingerprint is the only one incoming.

FIG. 15K illustrates the request to & unlock feature, which will allow the system to perform commands.

FIG. 15L illustrates the time stamp server & certifier, which will give precision time keeping, and recording responses from the video server streaming manager to the backup files.

FIG. 15M illustrates the digital fingerprint validated tool, which will act as a security liaison between the video server streaming manager and the digital storage segmented encryption.

FIG. 15N illustrates the digital storage segmented encryption, which has one digital fingerprint output and input, and has two inputs consisting of video server streaming manager with segmented encryption, and also the video server streaming manager.

FIG. 15O illustrates the digital finger print point, which will input from digital storage segmented encryption, digital fingerprint encryption, and time stamp server & certifier, and output to video server streaming.

FIG. 15P illustrates digital fingerprint encryption, which has two outputs the digital fingerprint, video server streaming manager and two inputs from video server streaming manager 1 and video server streaming manager 2.

FIG. 15Q illustrates the video server streaming manager, which has only two inputs the media server and request to & unlock. The three outputs it has are the digital fingerprint encryption, digital storage segmented encryption and the media server.

FIG. 15R illustrates to question setup point, which relies on authentication CODEFA to secure program's users.

FIG. 15S illustrates media server, which allows media types to be transmitted on a network. This server will have an input with output connection to video server streaming manager.

FIG. 15T illustrates segmented encryption, which has a one way input from digital fingerprint validated and an output towards digital storage segmented encryption.

FIG. 15U illustrates the backup files point, which has one input from time stamp server & certifier.

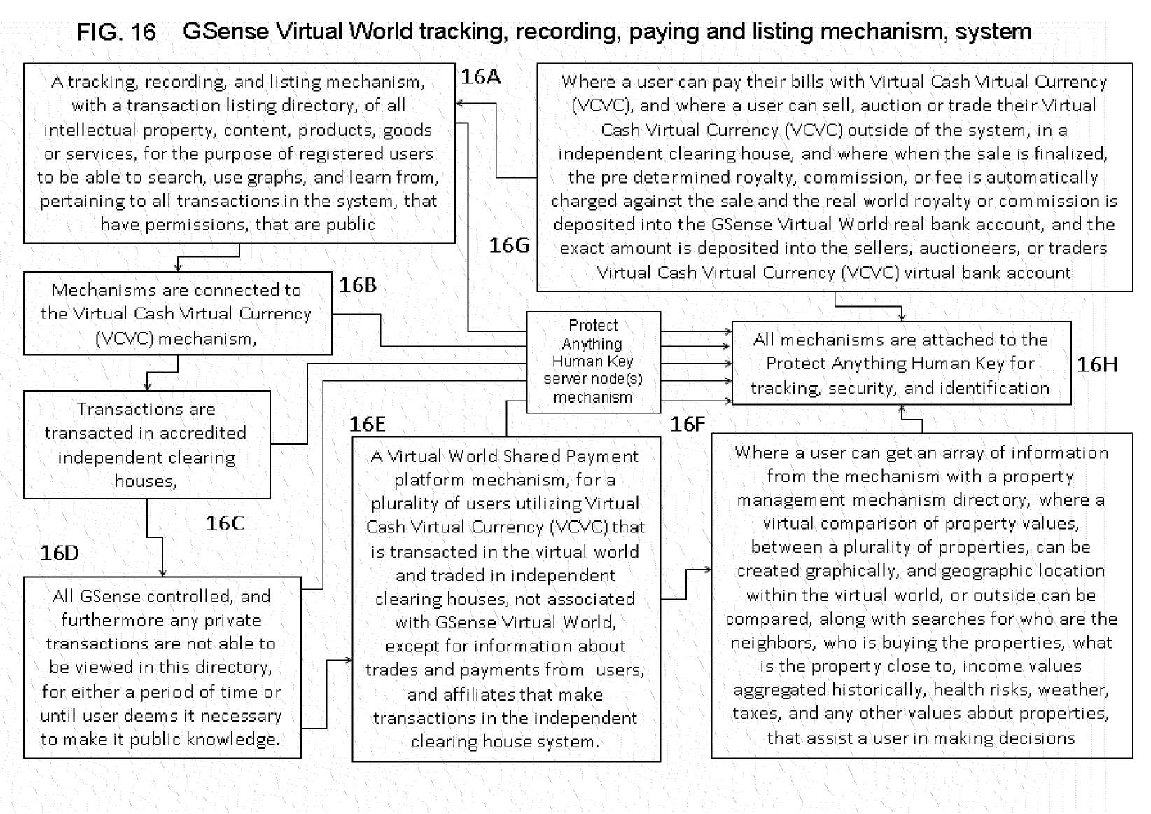

FIG. 16A illustrates the GSense Virtual World tracking, recording, paying and listing mechanism, system with a tracking, recording, and listing mechanism, with a transaction listing directory, of all intellectual property, content, products, goods or services, for the purpose of registered users to be able to search, use graphs, and learn from, pertaining to all transactions in the system, that have permissions, that are public.

FIG. 16B illustrates the GSense Virtual World tracking, recording, paying and listing mechanism, system with mechanisms that are connected to the Virtual Cash Virtual Currency (VCVC) mechanism.

FIG. 16C illustrates the GSense Virtual World tracking, recording, paying and listing mechanism, system where Transactions are transacted in accredited independent clearing houses.

FIG. 16D illustrates the GSense Virtual World tracking, recording, paying and listing mechanism, system where all GSense controlled, and furthermore any private transactions are not able to be viewed in this directory, for either a period of time or until user deems it necessary to make it public knowledge.

FIG. 16E illustrates the GSense Virtual World tracking, recording, paying and listing mechanism, system where a Virtual World Shared Payment platform mechanism, for a plurality of users utilizing Virtual Cash Virtual Currency (VCVC) that is transacted in the virtual world and traded in independent clearing houses, not associated with GSense Virtual World, except for information about trades and payments from users, and affiliates that make transactions in the independent clearing house system.

FIG. 16F illustrates the GSense Virtual World tracking, recording, paying and listing mechanism, system where a user can get an array of information from the mechanism with a property management mechanism directory, where a virtual comparison of property values, between a plurality of properties, can be created graphically, and geographic location within the virtual world, or outside can be compared, along with searches for who are the neighbors, who is buying the properties, what is the property close to, income values aggregated historically, health risks, weather, taxes, and any other values about properties, that assist a user in making decisions.

FIG. 16G illustrates the GSense Virtual World tracking, recording, paying and listing mechanism, system where a user can pay their bills with Virtual Cash Virtual Currency (VCVC), and where a user can sell, auction or trade their Virtual Cash Virtual Currency (VCVC) outside of the system, in a independent clearing house, and where when the sale is finalized, the pre determined royalty, commission, or fee is automatically charged against the sale and the real world royalty or commission is deposited into the GSense Virtual World real bank account, and the exact amount is deposited into the sellers, auctioneers, or traders Virtual Cash Virtual Currency (VCVC) virtual bank account.

FIG. 16H illustrates the GSense Virtual World tracking, recording, paying and listing mechanism, system where all mechanisms are attached to the Protect Anything Human Key for tracking, security, and identification.

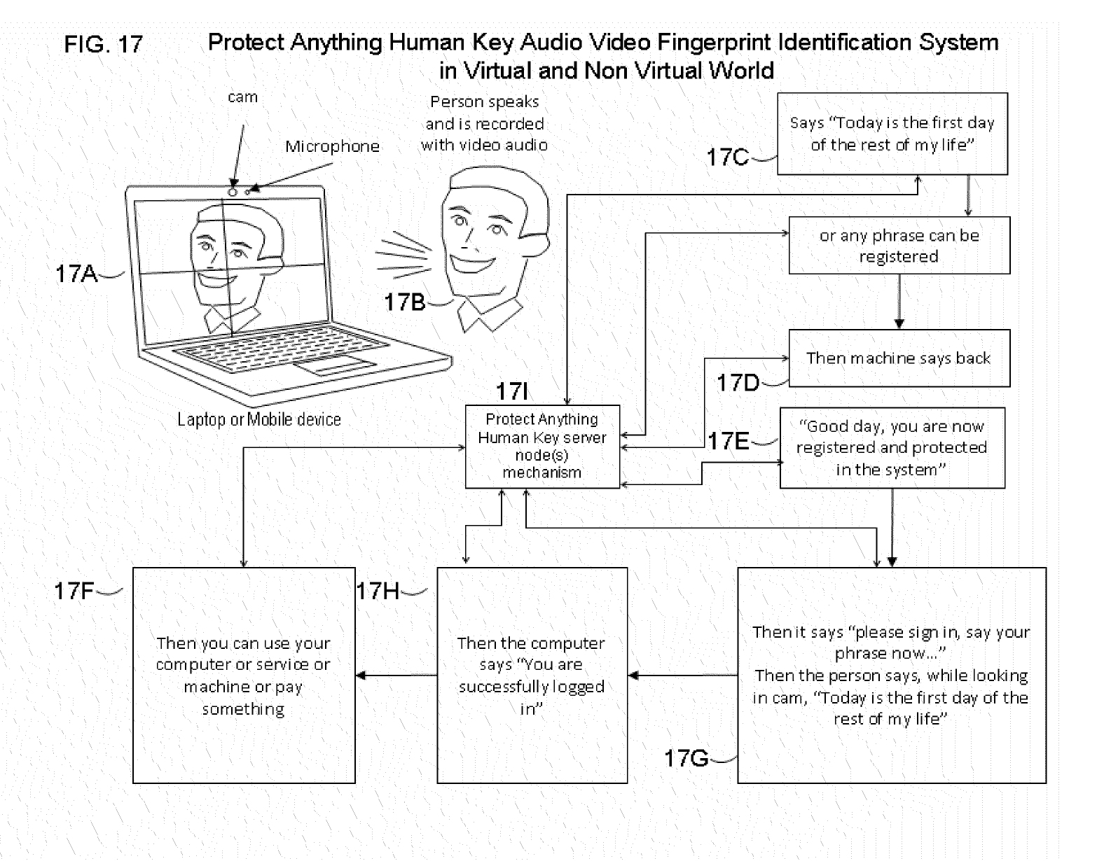

FIG. 17A describes Protect Anything Human Key audio video digital fingerprint identification system laptop with video cam and audio microphone.

FIG. 17B describes Protect Anything Human Key audio video digital fingerprint identification person speaks and is recorded with audio and video.

FIG. 17C describes Protect Anything Human Key audio video digital fingerprint identification where a person says “today is the first day of the rest of my life” or any key phrase can be registered.

FIG. 17D describes Protect Anything Human Key audio video digital fingerprint identification describes then machine says back.

FIG. 17E describes Protect Anything Human Key audio video digital fingerprint identification describes how the machine says back “Good day, you are now registered and protected in the system”.

FIG. 17F describes Protect Anything Human Key audio video digital fingerprint identification once you are signed in and authenticated that its only you, then you can use your computer or service or machine or pay something.

FIG. 17G describes Protect Anything Human Key audio video digital fingerprint identification follows with then the computer says “you're successfully logged in”.

FIG. 17H describes Protect Anything Human Key audio video digital fingerprint identification then it, the machine says “please sign in, say your key phrase now . . . ” then the person says, while looking at the cam, “today is the first day of the rest of my life” and if you are in the system registered and that is your key phrase, it will let you into whatever you are trying to securely get into.

FIG. 17I describes the Protect Anything Human Key server node(s) mechanism.

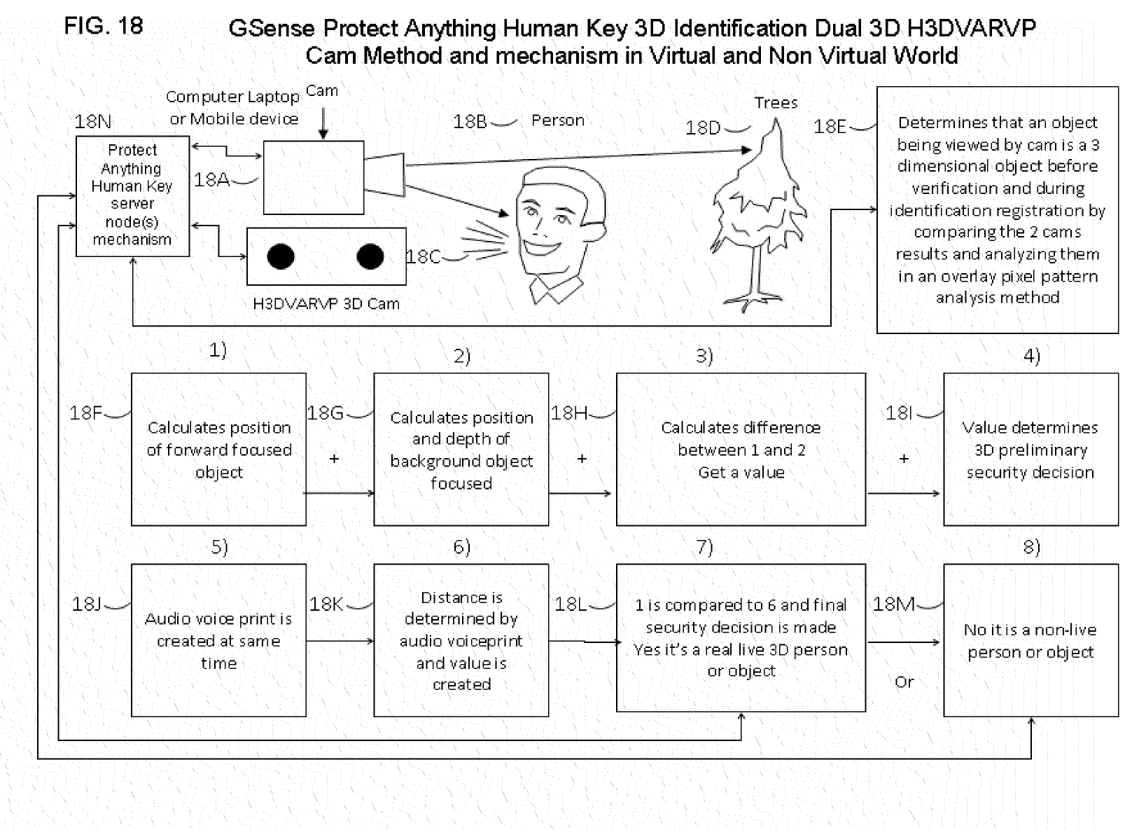

FIG. 18A, describes the Protect Anything Human Key 3-D identification method Dual 3D PA3D cam.

FIG. 18B describes the Protect Anything Human Key 3-D identification method Dual 3D PA3D person looking at the cam.

FIG. 18C describes the Protect Anything Human Key 3-D identification method Dual 3D PA3D person talking or saying a phrase.

FIG. 18D describes the Protect Anything Human Key 3-D identification method Dual 3D PA3D background trees, objects, people, or things.

FIG. 18E describes the Protect Anything Human Key 3-D identification method. Dual 3D PA3D and how it determines that object being viewed by cam is a three-dimensional object for verification and during identification registration by comparing the 2 cams results and analyzing them in an overlay pixel pattern analysis method.

FIG. 18F describes the Protect Anything Human Key 3-D identification method Dual 3D PA3D the 1) mechanism calculates position of forward focused object.

FIG. 18G describes the Protect Anything Human Key 3-D identification method Dual 3D PA3D the 2) mechanism that calculates position and depth of background object focused.

FIG. 18H describes the Protect Anything Human Key 3-D identification method Dual 3D PA3D the 3) mechanism that calculates the difference between one and two and gets a value.

FIG. 181 describes the Protect Anything Human Key 3-D identification method Dual 3D PA3D the 4) mechanism where a value determines 3-D preliminary security decision.

FIG. 18J describes the Protect Anything Human Key 3-D identification method .Dual 3D PA3D the 5) mechanism or audio voice print is created at the same time.

FIG. 18K describes the Protect Anything Human Key 3-D identification method Dual 3D PA3D the 6) mechanism businesses determined by audio voice print and value is created.

FIG. 18L describes the Protect Anything Human Key 3-D identification method Dual 3D PA3D the 7) mechanism than one is compared to six and file security decision is made yes it's a real live 3-D person or object with other Dual 3D PA3D GSense thermal, smell, mechanisms combined.

FIG. 18M describes the Protect Anything Human Key 3-D identification method Dual 3D PA3D the 8) and mechanism can say now is a non-live person or object.

FIG. 18N describes the Protect Anything Human Key server node(s) mechanism connected to the 3D camera system.

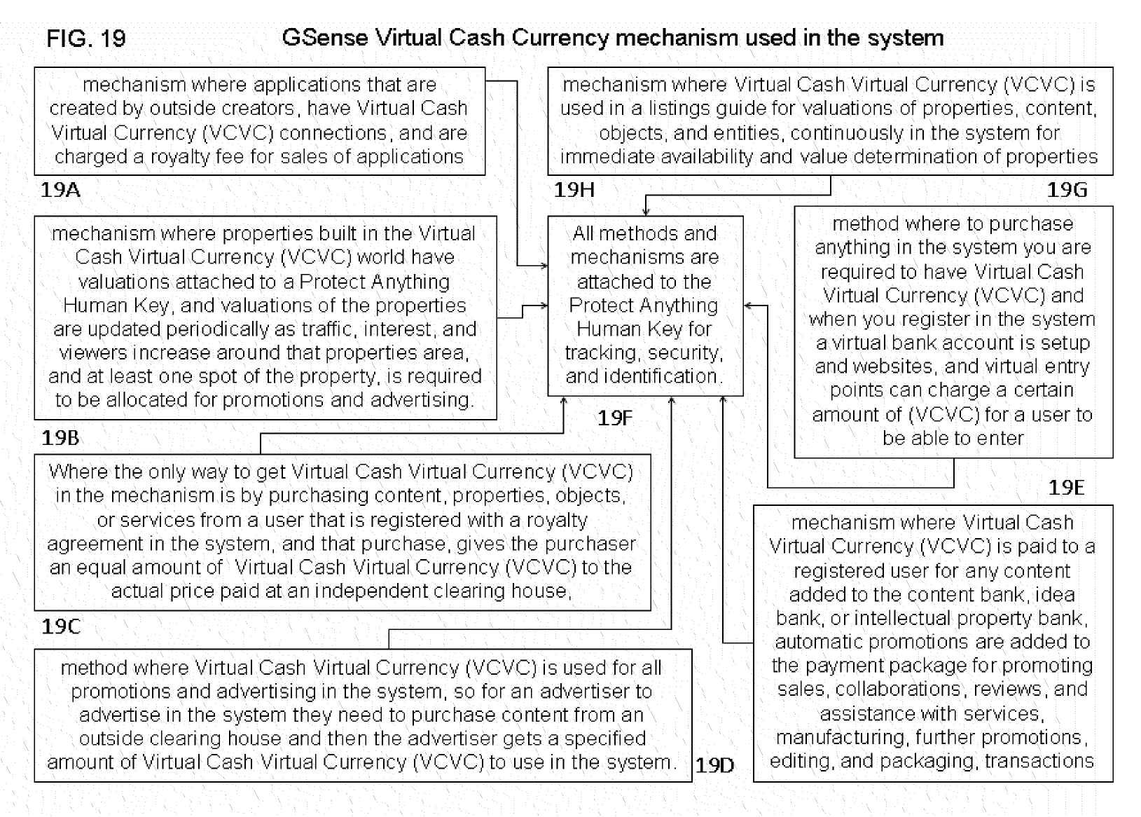

FIG. 19A illustrates the GSense Virtual Cash Currency mechanism used in the system and the mechanism where applications that are created by outside creators, have Virtual Cash Virtual Currency (VCVC) connections, and are charged a royalty fee for sales of applications.

FIG. 19B illustrates the GSense Virtual Cash Currency mechanism used in the system and the mechanism where properties built in the Virtual Cash Virtual Currency (VCVC) world have valuations attached to a Protect Anything Human Key, and valuations of the properties are updated periodically as traffic, interest, and viewers increase around that properties area, and at least one spot of the property, is required to be allocated for promotions and advertising.

FIG. 19C illustrates the GSense Virtual Cash Currency mechanism used in the system where the only way to get Virtual Cash Virtual Currency (VCVC) in the mechanism is by purchasing content, properties, objects, or services from a user that is registered with a royalty agreement in the system, and that purchase, gives the purchaser an equal amount of Virtual Cash Virtual Currency (VCVC) to the actual price paid at an independent clearing house.

FIG. 19D illustrates the GSense Virtual Cash Currency mechanism used in the system with the method where Virtual Cash Virtual Currency (VCVC) is used for all promotions and advertising in the system, so for an advertiser to advertise in the system they need to purchase content from an outside clearing house and then the advertiser gets a specified amount of Virtual Cash Virtual Currency (VCVC) to use in the system.

FIG. 19E illustrates the GSense Virtual Cash Currency mechanism used in the system with the mechanism where Virtual Cash Virtual Currency (VCVC) is paid to a registered user for any content added to the content bank, idea bank, or intellectual property bank, automatic promotions are added to the payment package for promoting sales, collaborations, reviews, and assistance with services, manufacturing, further promotions, editing, and packaging, transactions.

FIG. 19F illustrates the GSense Virtual Cash Currency mechanism used in the system where all methods and mechanisms are attached to the Protect Anything Human Key for tracking, security, and identification.

FIG. 19G illustrates the GSense Virtual Cash Currency mechanism used in the system with the method where to purchase anything in the system you are required to have Virtual Cash Virtual Currency (VCVC) and when you register in the system a virtual bank account is setup and websites, and virtual entry points can charge a certain amount of (VCVC) for a user to be able to enter.

FIG. 19H illustrates the GSense Virtual Cash Currency mechanism used in the system and a mechanism where Virtual Cash Virtual Currency (VCVC) is used in a listings guide for valuations of properties, content, objects, and entities, continuously in the system for immediate availability and value determination of properties.

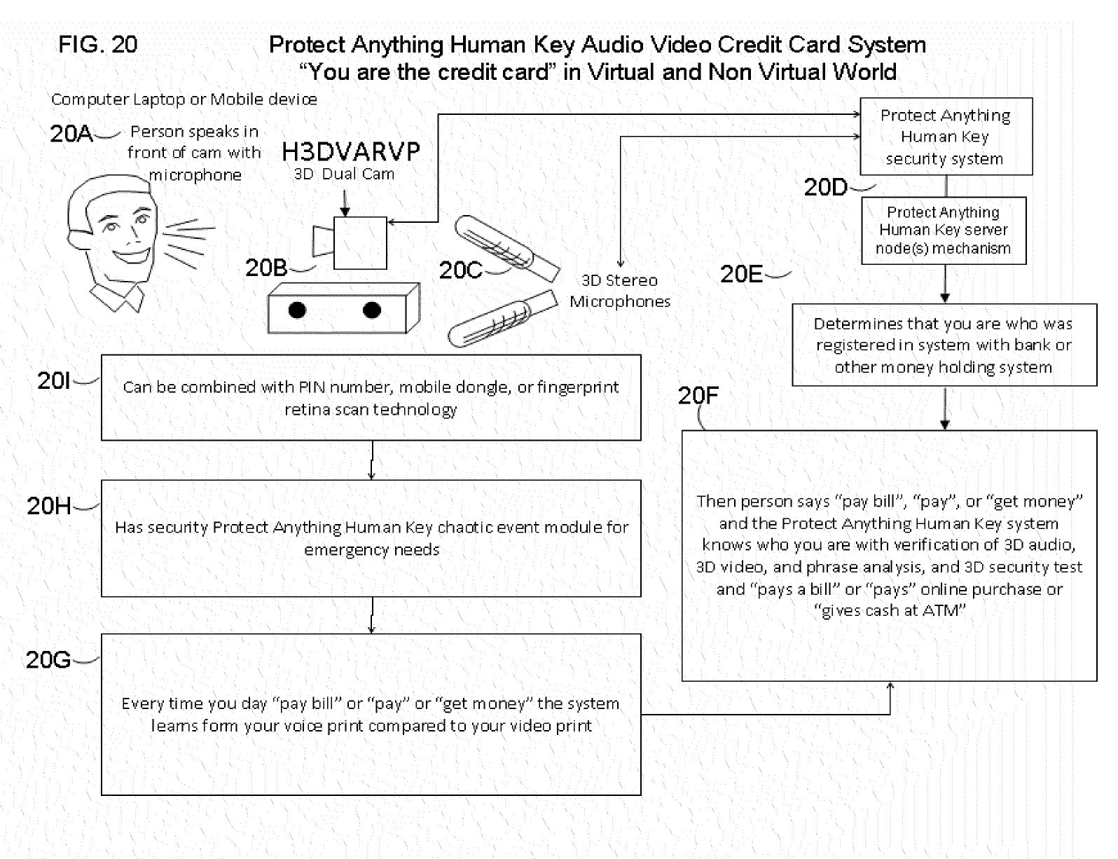

FIG. 20A describes the Protect Anything Human Key Audio Video Credit Card System “You are the credit card” the person speaks at the H3DVARV 3D Human Video Audio Stereo Viewing and Recording Mechanism cams and microphones.

FIG. 20B describes the Protect Anything Human Key Audio Video Credit Card System with H3DVARV 3D Human Video Audio Stereo Viewing and Recording Mechanism cams.

FIG. 20C describes the Protect Anything Human Key Audio Video Credit Card System with H30VARV 3D Human Video Audio Stereo Viewing and Recording Mechanism microphones.

FIG. 20D describes the Protect Anything Human Key Audio Video Credit Card System with H30VARV 3D Human Video Audio Stereo Viewing and Recording .Mechanism Protect Anything Human Key security system.

FIG. 20E describes the Protect Anything Human Key Audio Video Credit Card System with H30VARV 3D Human Video Audio Stereo Viewing and Recording Mechanism determines that you are who is registered in mechanism of bank rather money holding system.

FIG. 20F describes the Protect Anything Human Key Audio Video Credit Card System with H30VARV 3D Human Video Audio Stereo Viewing and Recording Mechanism where person says “pay Bill”, “pay”, or “get money” in the Protect Anything Human Key system does for your verification of audio, video, and phrase analysis, with three security test and “pays the bill” or “pays” online purchase or “gives cash at ATM”,

FIG. 20G describes the Protect Anything Hu˜an Key Audio Video Credit Card System with H30VARV 3D Human Video Audio Stereo Viewing and Recording Mechanism where every time you say “a bill” or “pay” or “get money” system learns from your voice print compared to your video print.

FIG. 20H describes the Protect Anything Human Key Audio Video Credit Card System with H3DVARV 3D Human Video Audio Stereo Viewing and Recording Mechanism where a security Protect Anything Human Key chaotic event module for emergency needs.

FIG. 20I describes the Protect Anything Human Key Audio Video Credit Card System with H3DVARV 3D Human Video Audio Stereo Viewing and Recording Mechanism where the system can be combined with pin number, mobile dongle, or biometrics fingerprint retina scan technology.

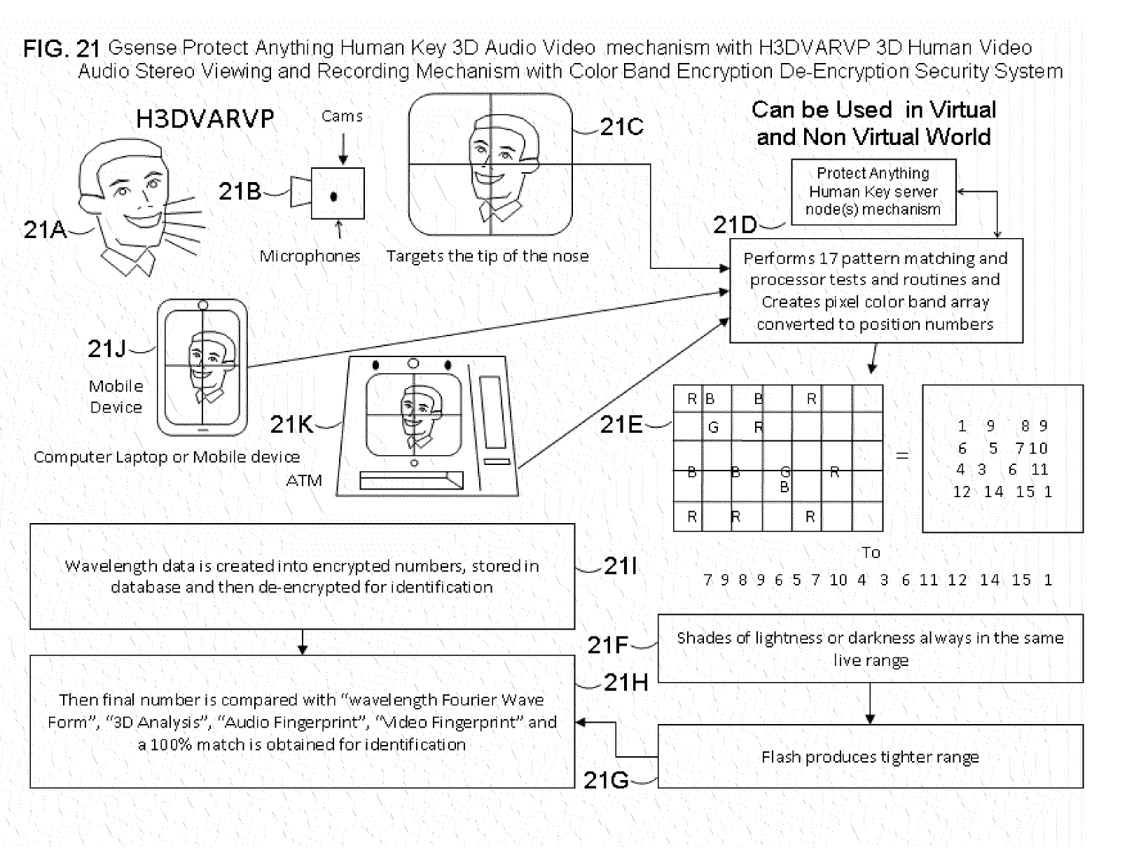

FIG. 21A describes the, Protect Anything Human Key 3D Audio Video Color Band Encryption De-Encryption Security System with H3DVARV 3D Human Video Audio Stereo Viewing and Recording Mechanism where a person speaks.

FIG. 21B describes the Protect Anything Human Key 3D Audio Video Color Band Encryption De-Encryption Security System with H3DVARV 3D Human Video Audio Stereo Viewing and Recording Mechanism cams.

FIG. 21C describes the Protect Anything Human Key 3D Audio Video Color Band Encryption De-Encryption Security System with H3DV ARV 3D Human Video Audio Stereo Viewing and Recording Mechanism where crosshairs target the tip of the human's nose.

FIG. 21D describes the Protect Anything Human Key 3D Audio Video Color Band Encryption De-Encryption Security System with H3DVARV 3D Human Video Audio Stereo Viewing and Recording Mechanism where the mechanism automatically does 16 tests and creates pixel color band array converted to position numbers.

FIG. 21E describes the Protect Anything Human Key 3D Audio Video Color Band Encryption De-Encryption Security System with H3DVARV 3D Human Video Audio Stereo Viewing and Recording Mechanism where the red, green, and blue is converted to numbers.

FIG. 21F describes the Protect Anything Human Key 3D Audio Video Color Band Encryption De-Encryption Security System with H3DVARV 3D Human Video Audio Stereo Viewing and Recording Mechanism where the shades of lightness or darkness always in the same live range during conversion with mechanisms algorithm.

FIG. 21G describes the Protect Anything Human Key 3D Audio Video Color Band Encryption De-Encryption Security System with H3DVARV 3D Human Video Audio Stereo Viewing and Recording Mechanism where the flash produces tighter range during recognition.

FIG. 21H describes the Protect Anything Human Key 3D Audio Video Color Band Encryption De-Encryption Security System with H3DVARV 3D Human Video Audio Stereo Viewing and Recording Mechanism where then the final numbers are compared with wavelength Fourier wave form 3-D analysis, audio fingerprint, video fingerprint, and a 100% match is obtained for identification.

The 21I describes the Protect Anything Human Key 3D Audio Video Color Band Encryption De-Encryption Security System with H3DVARV 3D Human Video Audio Stereo Viewing and Recording Mechanism where the wavelength data is created into encrypted numbers, stored in database and then decrypted for identification.

FIG. 21J describes the Protect Anything Human Key 3D Audio Video Color Band Encryption De-Encryption Security System with H3DVARV 3D Human Video Audio Stereo• Viewing and Recording Mechanism is utilized with mobile device, laptop or computer.

FIG. 21K describes the Protect Anything Human Key 3D Audio Video Color Band Encryption De-Encryption Security System with H3DVARV 3D Human Video Audio Stereo Viewing and Recording Mechanism where is utilizing in bank ATM with 3D cams and 3D Stereo Microphones.

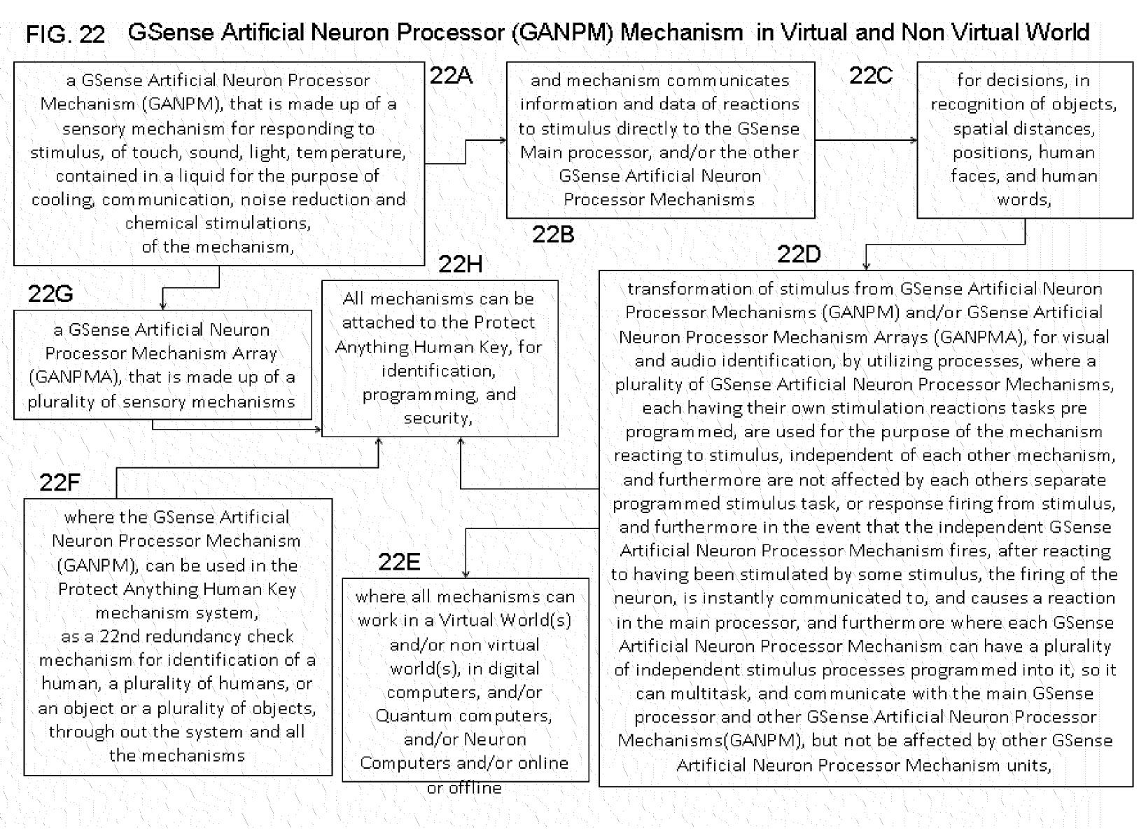

FIG. 22A illustrates the GSense Artificial Neuron Processor (GANPM) Mechanism in Virtual and Non Virtual World where a GSense Artificial Neuron Processor Mechanism (GANPM), that is made up of a sensory mechanism for responding to stimulus, of touch, sound, light, temperature, contained in a liquid for the purpose of cooling, communication, noise reduction and chemical stimulations, of the mechanism.

FIG. 22B illustrates the GSense Artificial Neuron Processor (GANPM) Mechanism in Virtual and Non Virtual World and the mechanism communicates information and data of reactions to stimulus directly to the GSense Main processor, and/or the other GSense Artificial Neuron Processor Mechanisms.

FIG. 22C illustrates the GSense Artificial Neuron Processor (GANPM) Mechanism in Virtual and Non Virtual World and used for decisions, in recognition of objects, spatial distances, positions, human faces, and human words.

FIG. 22D illustrates the GSense Artificial Neuron Processor (GANPM) Mechanism in Virtual and Non Virtual World and the mechanism creates a transformation of stimulus from GSense Artificial Neuron Processor Mechanisms (GANPM) and/or GSense Artificial Neuron Processor Mechanism Arrays (GANPMA), for visual and audio identification, by utilizing processes, where a plurality of GSense Artificial Neuron Processor Mechanisms, each having their own stimulation reactions tasks pre programmed, are used for the purpose of the mechanism reacting to stimulus, independent of each other mechanism, and furthermore are not affected by each others separate programmed stimulus task, or response firing from stimulus, and furthermore in the event that the independent GSense Artificial Neuron Processor Mechanism fires, after reacting to having been stimulated by some stimulus, the firing of the neuron, is instantly communicated to, and causes a reaction in the main processor, and furthermore where each GSense Artificial Neuron Processor Mechanism can have a plurality of independent stimulus processes programmed into it, so it can multitask, and communicate with the main GSense processor and other GSense Artificial Neuron Processor Mechanisms (GANPM), but not be affected by other GSense Artificial Neuron Processor Mechanism units.

FIG. 22E illustrates the GSense Artificial Neuron Processor (GANPM) Mechanism in Virtual and Non Virtual World where all mechanisms can work in a Virtual World(s) and/or non virtual world(s), in digital computers, and/or Quantum computers, and/or Neuron Computers and/or online or offline.

FIG. 22F illustrates the GSense Artificial Neuron Processor (GANPM) Mechanism in Virtual and Non Virtual World where the GSense Artificial Neuron Processor Mechanism (GANPM), can be used in the Protect Anything Human Key mechanism system, as a 22nd redundancy check mechanism for identification of a human, a plurality of humans, or an object or a plurality of objects, throughout the system and all the mechanisms.

FIG. 22G illustrates the GSense Artificial Neuron Processor (GANPM) Mechanism in Virtual and Non Virtual World and a GSense Artificial Neuron Processor Mechanism Array (GANPMA), that is made up of a plurality of sensory mechanisms.

FIG. 22H illustrates the GSense Artificial Neuron Processor (GANPM) Mechanism in Virtual and Non Virtual World where all mechanisms can be attached to the Protect Anything Human Key, for identification, programming, and security.

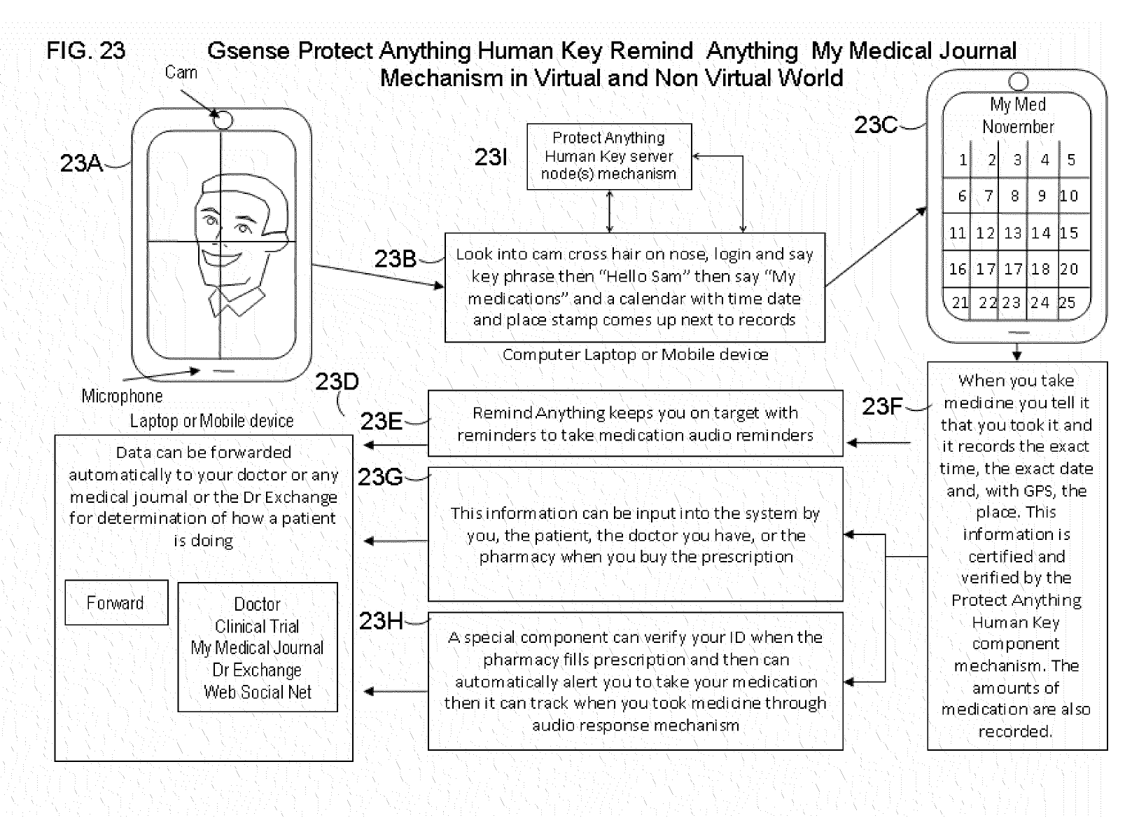

FIG. 23A describes Protect Anything Human Key Remind Anything My Medical Journal Module mechanism used with laptop or mobile device of any kind with cam and microphone showing target crosshairs for identification.

FIG. 23B describes Protect Anything Human Key Remind Anything My Medical Journal Module mechanism we look into the cam crosshair on your nose, .login as a key phrase then “hello 8 am” then say limy medications” and a calendar with a time date and place stamp comes up next to records.

FIG. 23C describes Protect Anything Human Key Remind Anything My Medical Journal Module mechanism calendar for my med November in touch screen mobile device.

FIG. 23D describes Protect Anything Human Key Remind Anything My Medical •Journal Module mechanism where data can be forwarded automatically to your Dr. or any medical Journal or the doctor exchange for determination of how patients are doing.

FIG. 23E describes Protect Anything Human Key Remind Anything My Medical Journal Module mechanism where Remind Anything keeps you on target with reminders to take medication, audio reminders, text reminders, video reminders.

FIG. 23F describes Protect Anything Human Key Remind Anything My Medical Journal Module mechanism where when you take medicine you tell it what you took and it records the exact time, the exact date, but GPS the exact place, this ‘information is certified and verified by the Protect Anything Human Key component mechanism the amounts medications are also recorded.

FIG. 23G describes Protect Anything Human Key Remind Anything My Medical Journal Module mechanism was information can be input into the system by you, the patient, the doctor you have, or the pharmacy when you buy the prescription.

FIG. 23H describes Protect Anything Human Key Remind Anything My Medical Journal Module mechanism where a special component can verify your ID when the Pharmacy fills prescription and they can automatically alert you to take your medication to a contract when you took medication to audio response mechanism.

FIG. 23I describes the Protect Anything Human Key server node(s) mechanism used in all processes for protection and identification processing.

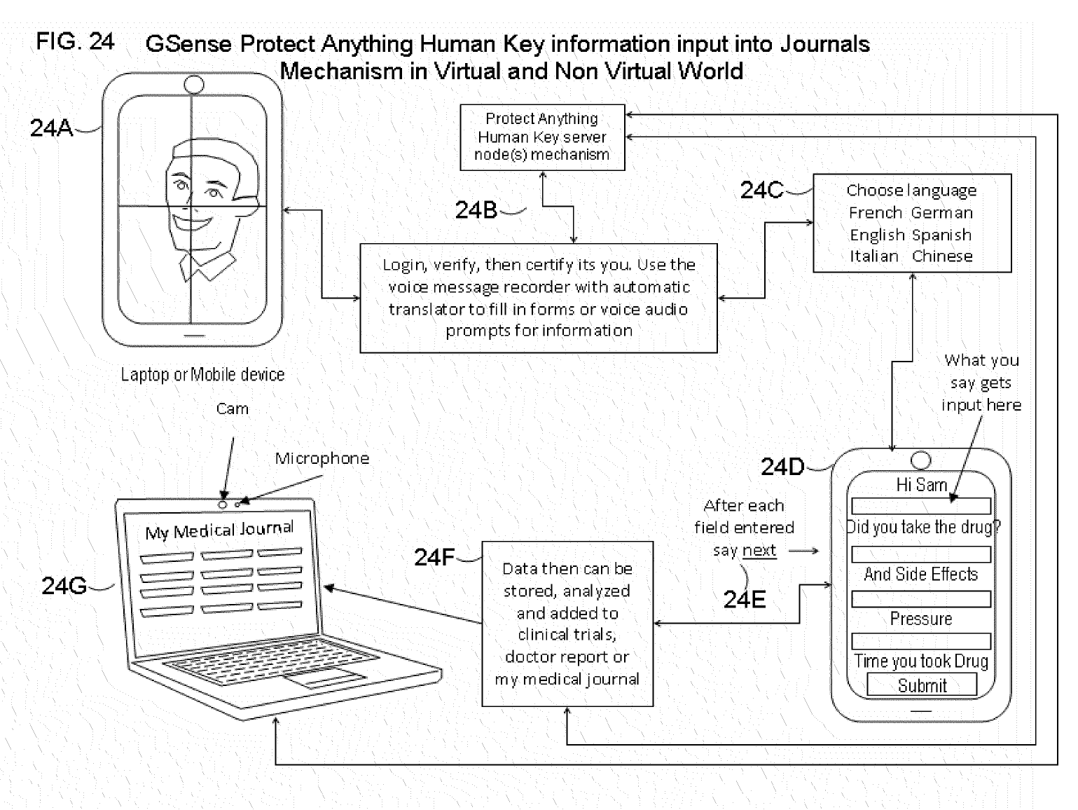

FIG. 24A describes the Protect Anything ‘Human Key automatic entry into form fields mechanism where any laptop any mobile device with cam and Mike can be used’ to edit and add secure protected information to Journal or any form fields.

FIG. 24B describes the Protect Anything Human Key automatic entry into form fields mechanism where you login, verify, and certify its you, use the voice message recorder with automatic translator to fill in forms or voice audio prompts for information.

FIG. 24C describes the Protect Anything Human Key automatic entry into form fields mechanism where you can choose any language.

FIG. 24D describes the Protect Anything Human Key automatic entry into form fields mechanism were what you say gets input into the form starts with high Sam did you take your medication you respond yes no then say next, any side effects you say what side effects, then say next, how is your pressure, you say numbers, you say next, what time did you take medication, you say time, you say next, you say submit.

FIG. 24E always saying next after each field you fill in.

FIG. 24F describes the Protect Anything Human Key automatic entry into form fields mechanism where data then can be stored, analyzed, and added to clinical trials, doctors report, or my medical Journal, or with permission to any of the disease exchanges.

FIG. 24G describes the Protect Anything Human Key automatic entry into form fields mechanism and shows a laptop with a camera microphone and at the my medical Journal website.

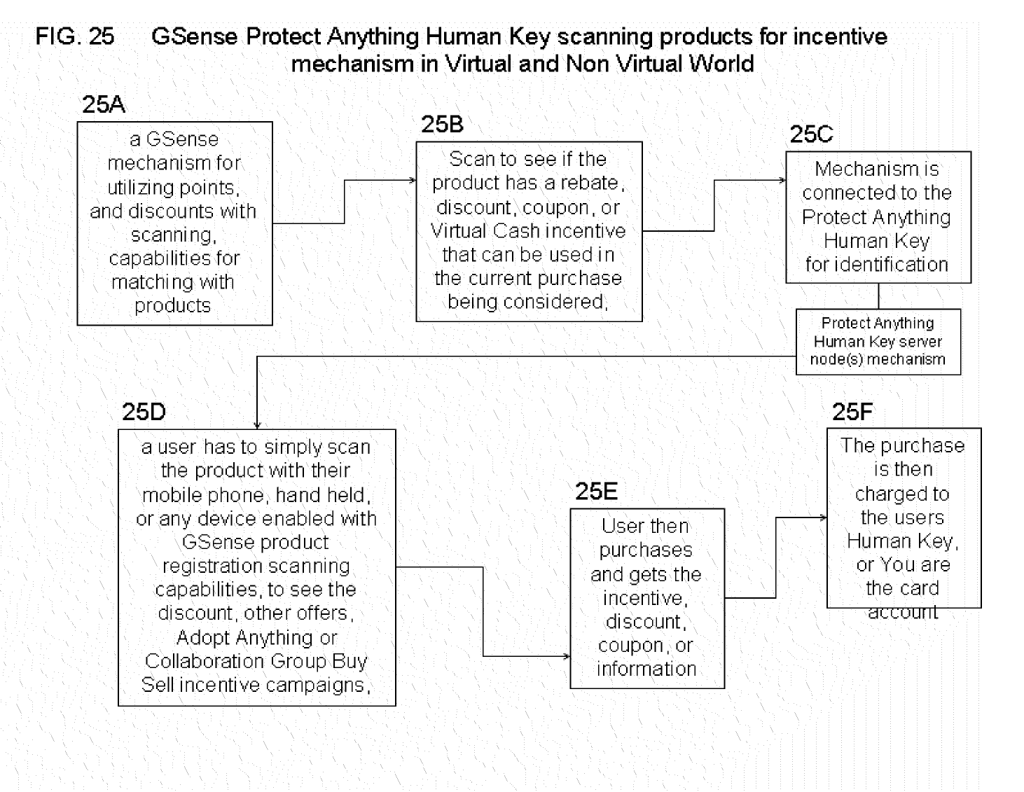

FIG. 25A illustrates the GSense Protect Anything Human Key scanning products for incentive mechanism in Virtual and Non Virtual World and a GSense mechanism for utilizing points, and discounts with scanning, capabilities for matching with products.

FIG. 25B illustrates the GSense Protect Anything Human Key scanning products for incentive mechanism in Virtual and Non Virtual World where user can scan to see if the product has a rebate, discount, coupon, or Virtual Cash incentive that can be used in the current purchase being considered.

FIG. 25C illustrates the GSense Protect Anything Human Key scanning products for incentive mechanism in Virtual and Non Virtual World where Mechanism is connected to the Protect Anything Human Key for identification.

FIG. 25D illustrates the GSense Protect Anything Human Key scanning products for incentive mechanism in Virtual and Non Virtual World where a user has to simply scan the product with their mobile phone, hand held, or any device enabled with GSense product registration scanning capabilities, to see the discount, other offers, Adopt Anything or Collaboration Group Buy Sell incentive campaigns.

FIG. 25E illustrates the GSense Protect Anything Human Key scanning products for incentive mechanism in Virtual and Non Virtual World where user then purchases and gets the incentive, discount, coupon, or information.

FIG. 25F illustrates the GSense Protect Anything Human Key scanning products for incentive mechanism in Virtual and Non Virtual World where The purchase is then charged to the users “Human Key”, or “You are the card” account.

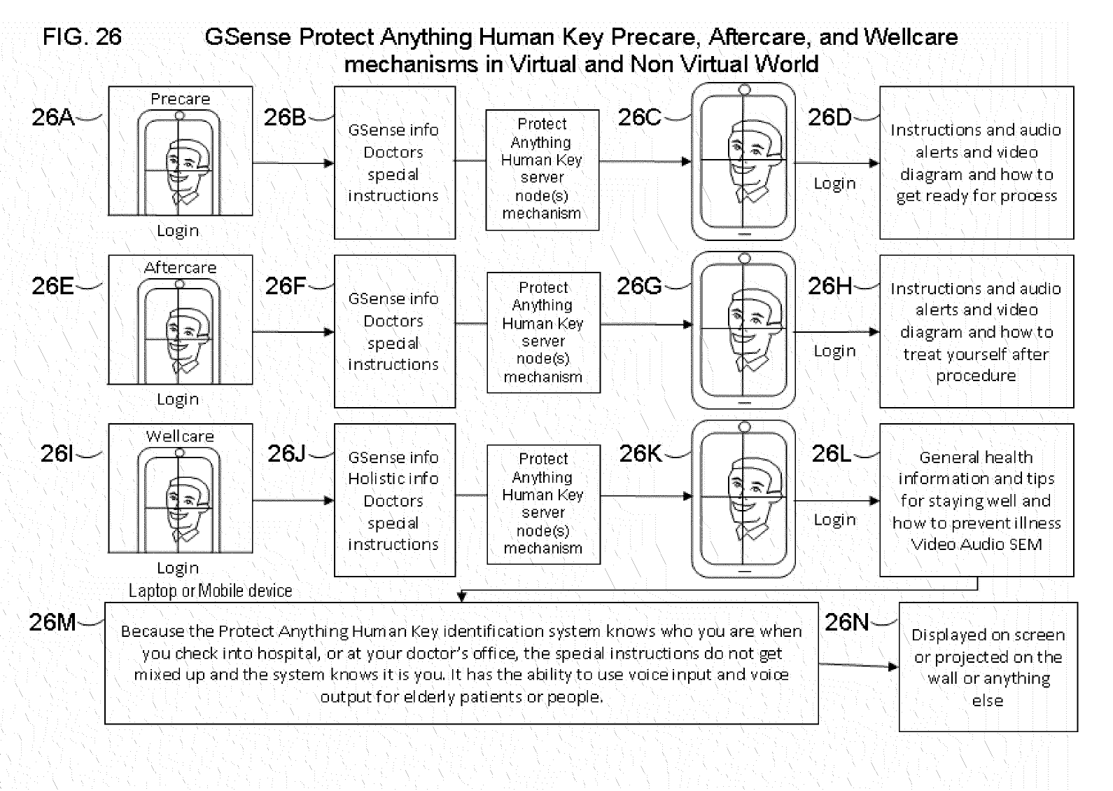

FIG. 26A describes GSense Pre care, mechanisms utilizing Protect Anything Human Key with laptop or any mobile device with cam and microphone, and shows pre care login in handheld device.

FIG. 26B describes GSense Pre care, mechanisms utilizing Protect Anything Human Key with laptop or any mobile device with cam and microphone, and shows GSense info doctors special instructions.

FIG. 26C describes GSense Pre care, mechanisms utilizing Protect Anything Human Key with laptop or any mobile device with cam and microphone, and shows the Protect Anything Human Key login.

FIG. 26D describes GSense Pre care, mechanisms utilizing Protect Anything• Human Key with laptop or any mobile device with cam and microphone, and shows holistic practitioners, doctors, medical people and others instructions and audio alerts and video diagram and how to get ready for procedure.

FIG. 26E describes GSense Aftercare, mechanisms utilizing Protect Anything Human Key with laptop or any mobile device with cam and microphone, and shows after care login.

FIG. 26F describes GSense Aftercare, mechanisms utilizing Protect Anything Human Key with laptop or any mobile device with cam and microphone, and shows GSense info doctors special instructions.

FIG. 26G describes GSense Aftercare, mechanisms utilizing Protect Anything Human Key with laptop or any mobile device with cam and microphone, and shows Protect Anything Human Key login.

FIG. 26H describes GSense Aftercare, mechanisms utilizing Protect Anything Human Key with laptop or any mobile device with cam and microphone, and shows doctors, medical people, and holistic practitioners instructions audio alerts and video diagrams and how to treat yourself after a procedure.

FIG. 26I describes GSense Wellcare mechanisms utilizing Protect Anything Human Key with laptop or any mobile device with cam and microphone, and shows the .well care login.

FIG. 26J describes GSense Wellcare mechanisms utilizing Protect Anything Human Key with laptop or any mobile device with cam and microphone, and shows the GSense info holistic info doctors special instructions.

FIG. 26K describes GSense Wellcare mechanisms utilizing Protect Anything Human Key with laptop or any mobile device with cam and microphone, and shows the Protect Anything Human Key login.

FIG. 26L describes GSense Wellcare mechanisms utilizing Protect Anything Human Key with laptop or any mobile device with cam and microphone, and shows doctors, medical people, holistic practitioners general health information and tips for staying well and how to prevent illness video audio SMS text information or SP delivery and virtual AR SP delivery.

FIG. 26M describes GSense Precare, Aftercare, and Wellcare mechanisms utilizing Protect Anything Human Key with laptop or any mobile device with cam and microphone, and shows because the Protect Anything Human Key identification system, knows who you are when you check into hospital, or at your doctor's office, the special instructions do not get mixed up in the system knows it is you. It has the ability to use voice input and voice output for elderly patients or people.

FIG. 26N describes GSense Precare, Aftercare, and Wellcare mechanisms utilizing Protect Anything Human Key with laptop or any mobile device with cam and microphone, and shows the ability of the mechanism to be displayed on screen are projected on the wall or anything else.

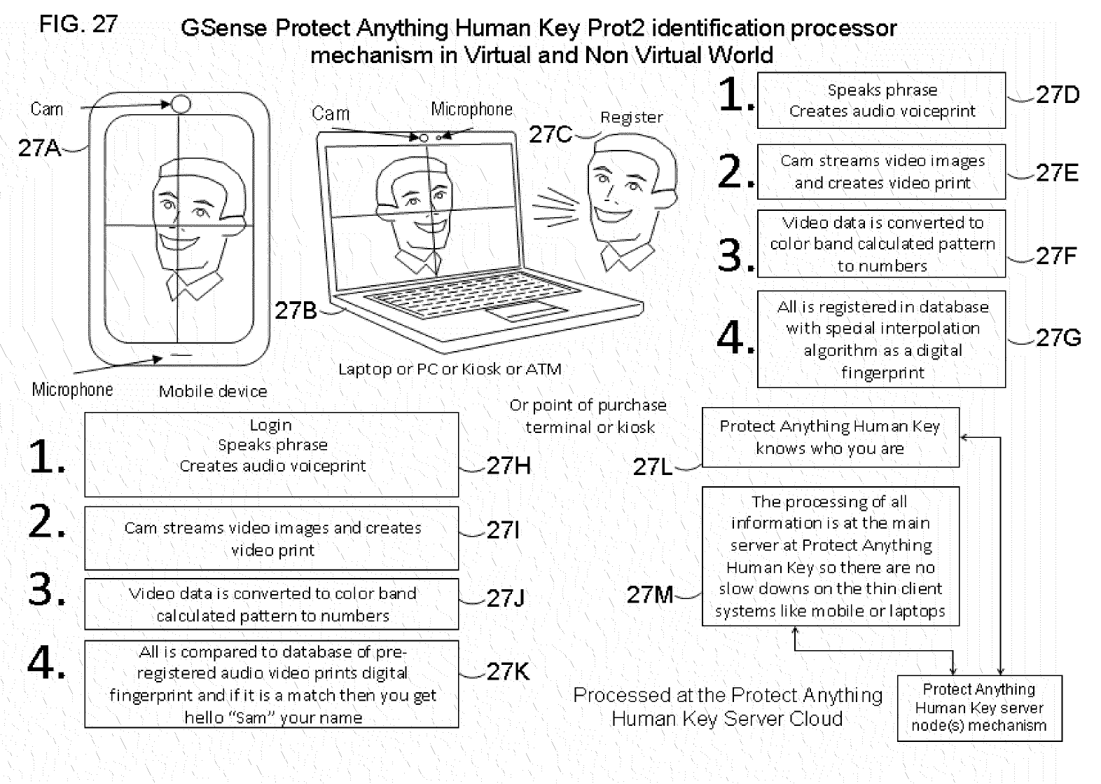

FIG. 27A describes How Protect Anything Human Key works utilizing processing at the Protect Anything Human Key Server Cloud with laptop or any mobile device with cam and microphone, and shows cam and microphone with crosshairs on mobile device.

FIG. 27B describes How Protect Anything Human Key works utilizing processing at the Protect Anything Human Key Server Cloud with laptop or any mobile device with cam and microphone, and shows laptop or PC or Kiosk or ATM for pay portal or locks, or identification with cam and microphone.

FIG. 27C describes How Protect Anything Human Key works ‘utilizing processing at the Protect Anything Human Key Server Cloud with laptop or any mobile device with cam and microphone, and shows registering with voice and video of you.

FIG. 27D 1. describes How Protect Anything Human Key works utilizing processing at the Protect Anything Human Key Server Cloud with laptop or any mobile device with cam and microphone, and shows how a person speaks phrase and creates an audio voice print.

FIG. 27E 2. describes How Protect Anything Human Key works utilizing processing at the Protect Anything Human Key Server Cloud with laptop or any mobile device with cam and microphone, and shows how the cam streams video images and creates video print.

FIG. 27F 3. describes How Protect Anything Human Key works utilizing processing at the Protect Anything Human Key Server Cloud with laptop or any mobile device with cam and microphone, and shows how video data is converted to color band calculated pattern to numbers and a 3D human analysis is made.

FIG. 27G 4. describes How Protect Anything Human Key works utilizing processing at the Protect Anything Human Key Server Cloud with laptop or any mobile device with cam and microphone, and shows all is registered in database and system with special interpolation algorithm as a digital fingerprint.

FIG. 27H 1. describes How Protect Anything Human Key works utilizing processing at the Protect Anything Human Key Server Cloud with laptop or any mobile device with cam and microphone, and shows the login where one speaks phrase, and creates audio voiceprint.

FIG. 27I 2. describes How Protect Anything Human Key works utilizing processing at the Protect Anything Human Key Server Cloud with laptop or any mobile device with cam and microphone, and shows where the cam streams video images and creates a video print.

FIG. 27J 3. describes How Protect Anything Human Key works utilizing processing at the Protect Anything Human Key Server Cloud with laptop or any mobile device with cam and microphone, and shows where video data is converted to color band calculated pattern to numbers, and 3D human analysis is made.

FIG. 27K 4. describes How ProteCt Anything Human Key works utilizing processing at the Protect Anything Human Key Server Cloud with laptop or any mobile device with cam and microphone, and shows where all is compared to database of pre registered audio video prints digital fingerprint and if it is a match then you get hello “Sam” your name.

FIG. 27L describes How Protect Anything Human Key works utilizing processing at the Protect Anything Human Key Server Cloud with laptop or any mobile device with cam and microphone, and shows where Protect Anything Human Key knows who you are 100% of the time.

FIG. 27M describes How Protect Anything Human Key works utilizing processing at the Protect Anything Human Key Server Cloud with laptop or any mobile device with cam and microphone, and shows where the processing of all information is at the main server at Protect Anything Human Key so there are no slow downs on the thin client systems like mobile or laptops.

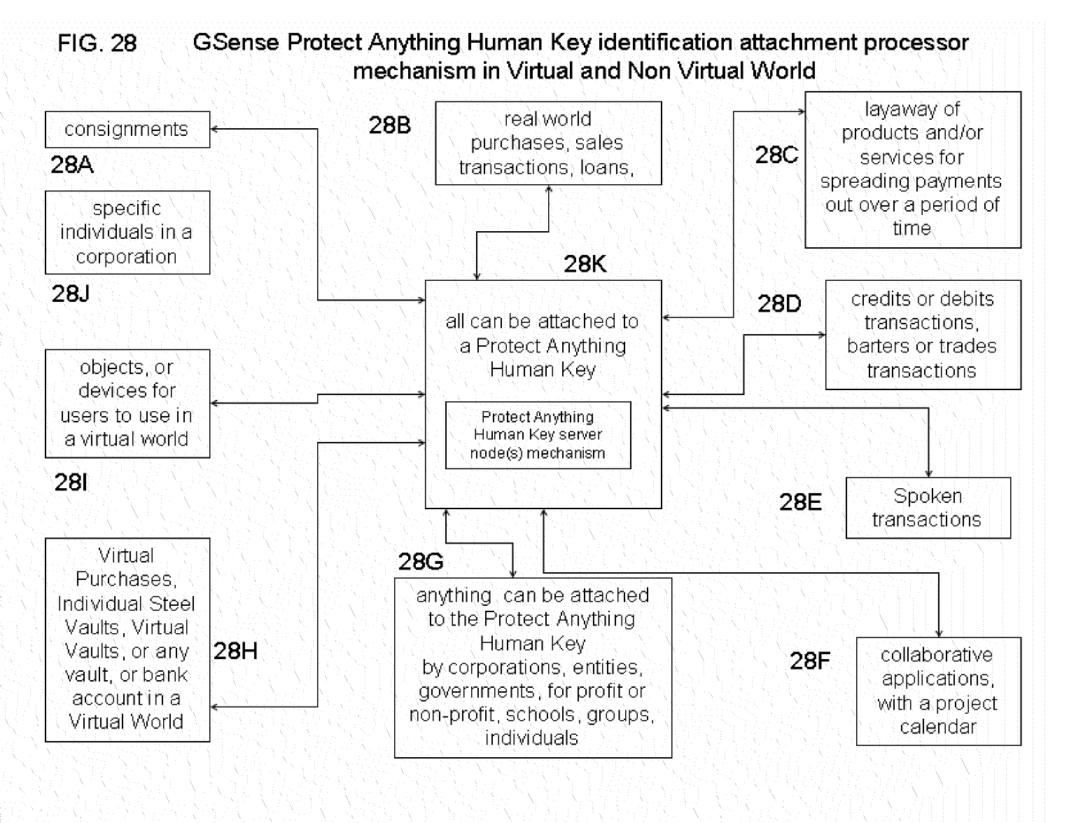

FIG. 28A illustrates the GSense Protect Anything Human Key identification attachment processor mechanism in Virtual and Non Virtual World protecting consignments.

FIG. 28B illustrates the GSense Protect Anything Human Key identification attachment processor mechanism in Virtual and Non Virtual World protecting real world purchases, sales transactions, loans.

FIG. 28C illustrates the GSense Protect Anything Human Key identification attachment processor mechanism in Virtual and Non Virtual World protecting layaway of products and/or services for spreading payments out over a period of time.

FIG. 28D illustrates the GSense Protect Anything Human Key identification attachment processor mechanism in Virtual and Non Virtual World protecting credits or debits transactions, barters or trades transactions.

FIG. 28E illustrates the GSense Protect Anything Human Key identification attachment processor mechanism in Virtual and Non Virtual World protecting Spoken transactions.

FIG. 28F illustrates the GSense Protect Anything Human Key identification attachment processor mechanism in Virtual and Non Virtual World protecting collaborative applications, with a project calendar.

FIG. 28G illustrates the GSense Protect Anything Human Key identification attachment processor mechanism in Virtual and Non Virtual World and anything can be attached to the Protect Anything Human Key by corporations, entities, governments, for profit or non-profit, schools, groups, individuals.

FIG. 28H illustrates the GSense Protect Anything Human Key identification attachment processor mechanism in Virtual and Non Virtual World protecting Virtual Purchases, Individual Steel Vaults, Virtual Vaults, or any vault, or bank account in a Virtual World.

FIG. 28I illustrates the GSense Protect Anything Human Key identification attachment processor mechanism in Virtual and Non Virtual World protecting objects, or devices for users to use in a virtual world.

FIG. 28J illustrates the GSense Protect Anything Human Key identification attachment processor mechanism in Virtual and Non Virtual World protecting specific individuals in a corporation.

FIG. 28K illustrates the GSense Protect Anything Human Key identification attachment processor mechanism in Virtual and Non Virtual World where all can be attached to a Protect Anything Human Key.

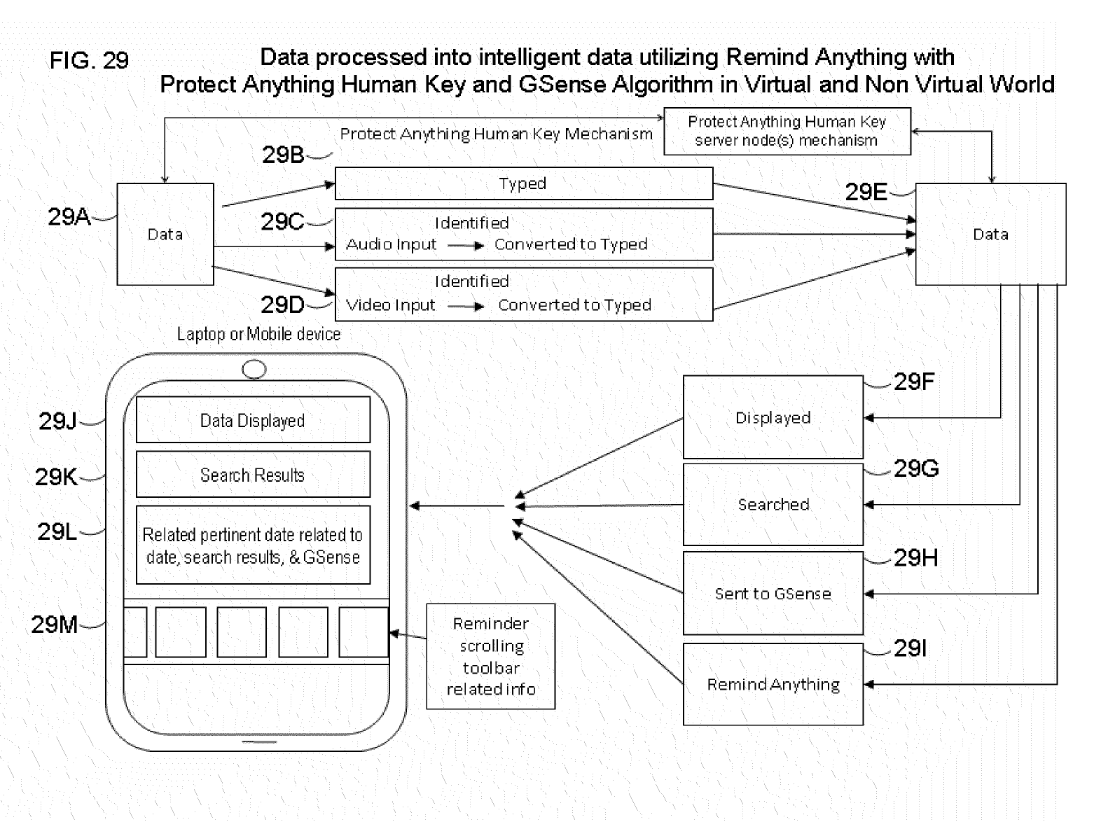

FIG. 29A describes How Data is processed into intelligent data Remind Anything with Protect Anything Human Key Server Cloud and GSense Algorithm and shows data.

FIG. 29B describes How Data is processed into intelligent data Remind Anything with Protect Anything Human Key Server Cloud and GSense Algorithm and shows typed data in the Protect Anything Human Key mechanism.

FIG. 29C describes How Data is processed into intelligent data Remind Anything with Protect Anything Human Key Server Cloud and GSense Algorithm and shows identified audio input converted to typed data in the Protect Anything Human Key mechanism.

FIG. 29D describes How Data is processed into intelligent data Remind Anything with Protect Anything Human Key Server Cloud and GSense Algorithm and shows identified video input converted to typed data in the Protect Anything Human Key mechanism.

FIG. 29E describes How Data is processed into intelligent data Remind Anything with Protect Anything Human Key Server Cloud and GSense Algorithm and shows converted to data.

FIG. 29F describes How Data is processed into intelligent data Remind Anything with Protect Anything Human Key Server Cloud and GSense Algorithm and shows data flow to displayed data.

FIG. 29G describes How Data is processed into intelligent data Remind Anything with Protect Anything Human Key Server cloud and GSense Algorithm and shows data flow to search results searched.

FIG. 29H describes How Data is processed into intelligent data Remind Anything with Protect Anything Human Key Server Cloud and GSense Algorithm and shows data flow from sent to GSense.

FIG. 29I describes How Data is processed into intelligent data Remind Anything with Protect Anything Human Key Server Cloud and GSense Algorithm and shows data uploaded to Remind Anything.

FIG. 29J describes How Data is processed into intelligent data Remind Anything with Protect Anything Human Key Server Cloud and GSense Algorithm and shows protected data is displayed in mobile device.

FIG. 29K describes How Data is processed into intelligent data Remind Anything with Protect Anything Human Key Server Cloud and GSense Algorithm and shows protected search results are displayed in mobile device.

FIG. 29L describes How Data is processed into intelligent data Remind Anything with Protect Anything Human Key Server Cloud and GSense Algorithm and shows protected related perfect date related to date, search results, and GSense is displayed in mobile device.

FIG. 29M describes How Data is processed into intelligent data Remind Anything with Protect Anything Human Key Server Cloud and GSense Algorithm and shows a reminders scrolling toolbar with related information scrolls across the bottom of the mobile device.

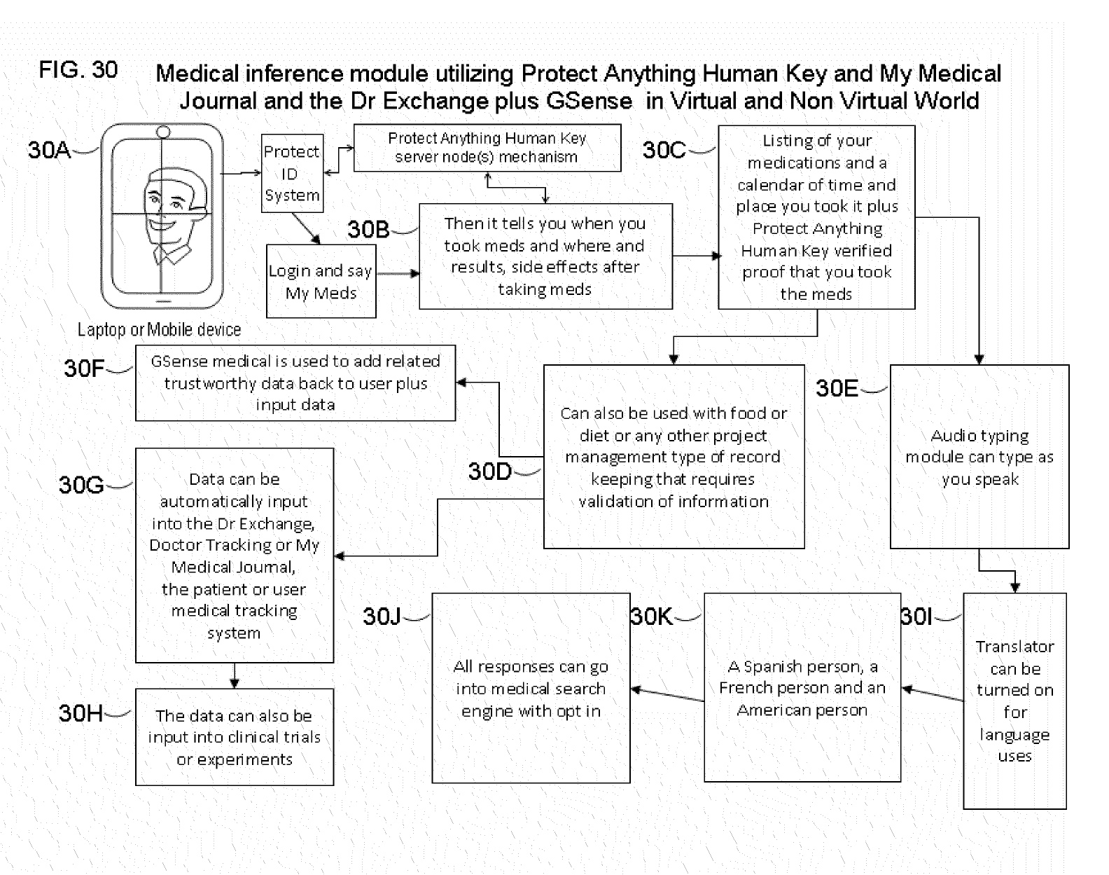

FIG. 30A Describes the Medical inference module utilizing Protect Anything Human Key and My Medical Journal and the DR Exchange plus GSense and shows a mobile device with crosshairs and microphone cam running through the protect ID system after logging saying my meds.

FIG. 30B Describes the Medical inference module utilizing Protect Anything Human Key and My Medical Journal and the DR Exchange plus GSense and shows good so she knows when a user took meds and where and results, side effects after taking meds.

FIG. 30C Describes the Medical inference module utilizing Protect Anything Human Key and My Medical Journal and the DR Exchange plus GSense and shows listing of your medications in a calendar of time and place you took it plus Protect Anything Human Key verify proof that you took to medications.

FIG. 30D Describes the Medical inference module utilizing Protect Anything Human Key and My Medical Journal and the DR Exchange plus GSense and shows can also be used with food or diet or any other project management type of record keeping that requires validation of information.

FIG. 30E Describes the Medical inference module utilizing Protect Anything Human Key and My Medical Journal and the DR Exchange plus GSense and shows audio typing module can type as you speak.

FIG. 30F Describes the Medical inference module utilizing Protect Anything Human Key and My Medical Journal and the DR Exchange plus GSense and shows GSense medical is used to related trustworthy data back to user plus input data.

FIG. 30G Describes the Medical inference module utilizing Protect Anything Human Key and My Medical Journal and the DR Exchange plus GSense and shows data can be automatically input into the Dr. exchange Dr. tracking or My Medical Journal, the patient or user medical tracking system.

FIG. 30H Describes the Medical inference module utilizing Protect Anything Human Key and My Medical Journal and the DR Exchange plus GSense and shows, The data can also be input into clinical trials or experiments involving medical social networks or other or any social network or doctor's files.

FIG. 30I Describes the Medical inference module utilizing Protect Anything Human Key and My Medical Journal and the DR Exchange plus GSense and shows all responses can go into medical search engine with opt in.

FIG. 30J Describes the Medical inference module utilizing Protect Anything Human Key and My Medical Journal and the DR Exchange plus GSense and shows rare a Spanish person, a French person in American person can all compare data and have their data compared with opt in.

FIG. 30K Describes the Medical inference module utilizing Protect Anything Human Key and My Medical Journal and the DR Exchange plus GSense and shows translator can be turned on for language uses all languages included.

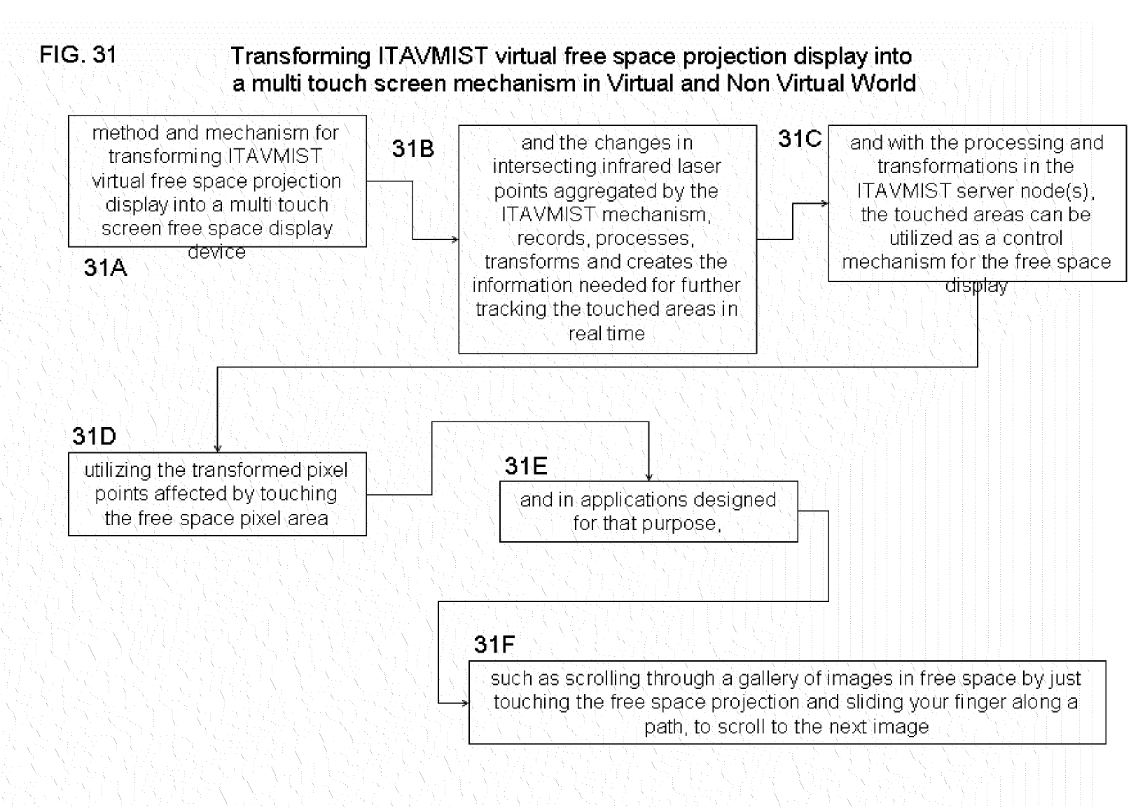

FIG. 31A illustrates Transforming ITAVMIST virtual free space projection display into a multi touch screen mechanism in Virtual and Non Virtual World and method and mechanism for transforming ITAVMIST virtual free space projection display into a multi touch screen free space display device.

FIG. 31B illustrates Transforming ITAVMIST virtual free space projection display into a multi touch screen mechanism in Virtual and Non Virtual World and the changes in intersecting infrared laser points aggregated by the ITAVMIST mechanism, records, processes, transforms and creates the information needed for further tracking the touched areas in real time.

FIG. 31C illustrates Transforming ITAVMIST virtual free space projection display into a multi touch screen mechanism in Virtual and Non Virtual World and with the processing and transformations in the ITAVMIST server node(s), the touched areas can be utilized as a control mechanism for the free space display.

FIG. 31D illustrates Transforming ITAVMIST virtual free space projection display into a multi touch screen mechanism in Virtual and Non Virtual World utilizing the transformed pixel points affected by touching the free space pixel area.

FIG. 31E illustrates Transforming ITAVMIST virtual free space projection display into a multi touch screen mechanism in Virtual and Non Virtual World and in applications designed for that purpose, of free space touch screen controls.

FIG. 31F illustrates Transforming ITAVMIST virtual free space projection display into a multi touch screen mechanism in Virtual and Non Virtual World and purposes such as scrolling through a gallery of images in free space by just touching the free space projection and sliding your finger along a path, to scroll to the next image.

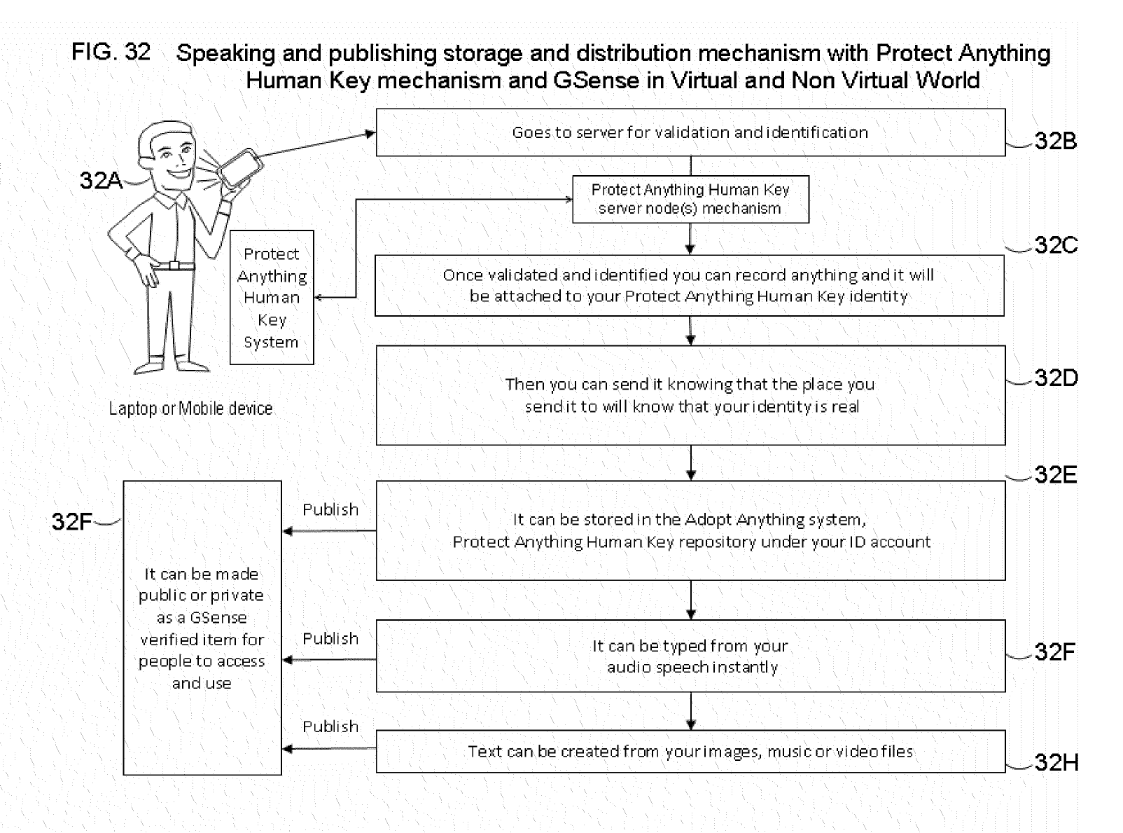

FIG. 32A describes speaking and publishing storage and distribution mechanism with Protect Anything Human Key Server Cloud and GSense Algorithm and shows a person speaking into their mobile device and accessing protect ID system.

FIG. 32B describes speaking and publishing storage and distribution mechanism with Protect Anything Human Key Server Cloud and GSense Algorithm and shows goes to server for validation and identification.

FIG. 32C describes speaking and publishing storage and distribution mechanism with Protect Anything Human Key Server Cloud and GSense Algorithm and shows once validated and identified you can record anything that will be attached to Protect Anything Human Key identity.

FIG. 32D describes speaking and publishing storage and distribution mechanism with Protect Anything Human Key Server Cloud and GSense Algorithm and shows then you can send it knowing that the place descended to will know that your identity is real.

FIG. 32E describes speaking and publishing storage and distribution mechanism with Protect Anything Human Key Server Cloud and GSense Algorithm and shows it can be stored in the Adopt Anything campaign or any campaign system, and the Protect Anything Human Key repository under your ID account in the published through publish anything or license anything.

FIG. 32F describes speaking and publishing storage and distribution mechanism with Protect Anything Human Key Server Cloud and GSense Algorithm and shows you can be typed from your audio speech instantly and then published.

FIG. 32G describes speaking and publishing storage and distribution mechanism with Protect Anything Human Key Server Cloud and GSense Algorithm and shows text can be created from your images, music or video files and then published.

FIG. 32H describes speaking and publishing storage and distribution mechanism with Protect Anything Human Key Server Cloud and GSense Algorithm and shows it can be made public or private as a GSense verified item for people to access and use that relevant times and places.

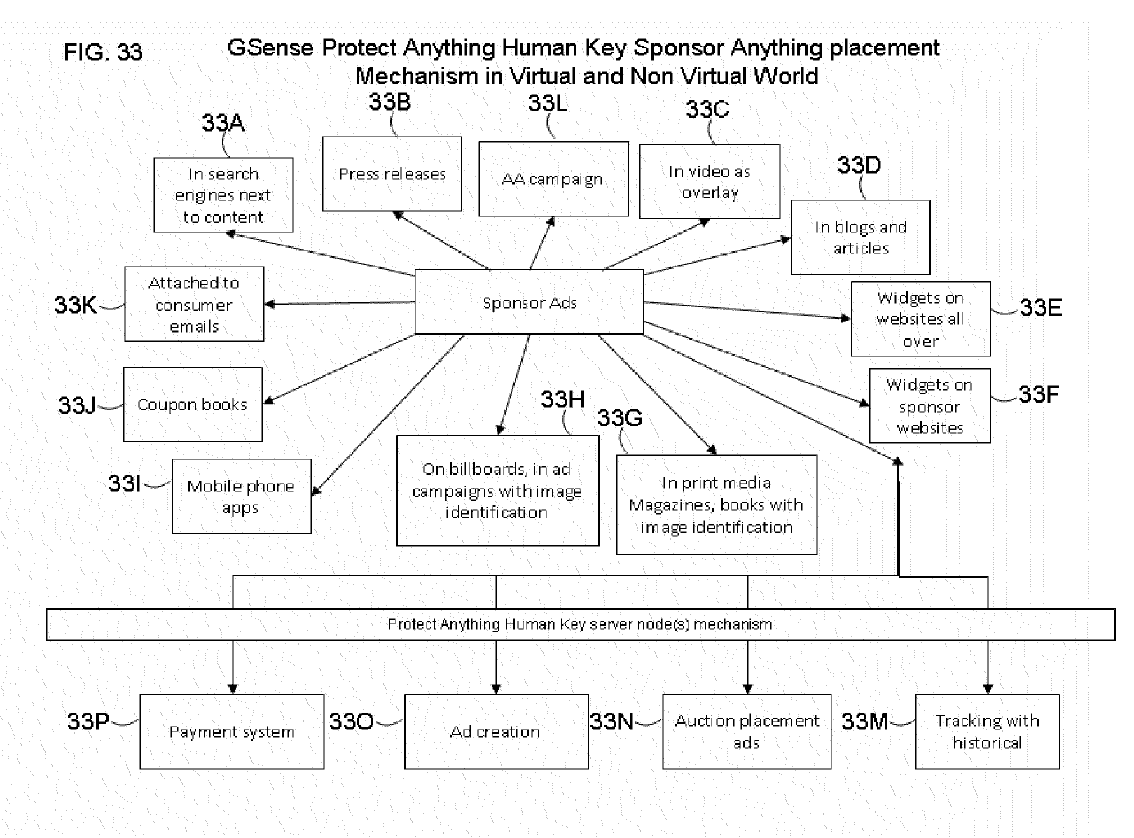

FIG. 33A describes how sponsor advertisements become content and what you can do with them with Protect Anything Human Key Server Cloud, file anything, protect and insure connected to GSense and shows Adopt Anything campaign or any campaign or independent sponsor ads in search engines next to content.

FIG. 33B describes how sponsor advertisements become content and what you can do with them with Protect Anything Human Key Server Cloud, file anything, protect and insure connected to GSense and shows Adopt Anything campaign or any campaign or independent sponsor ads in press releases.

FIG. 33C describes how sponsor advertisements become content, and what you can do with them with Protect Anything Human Key Server Cloud, file anything, protect and insure connected to GSense and shows Adopt Anything campaign or any campaign or independent sponsor ads in video as overlay ads.

FIG. 33D describes how sponsor advertisements become content and what you can do with them with Protect Anything Human Key Server Cloud, file anything, protect and insure connected to GSense and Adopt Anything campaign or any campaign or independent sponsor ads in blogs and articles.

FIG. 33E describes how sponsor advertisements become content and what you can do with them with Protect Anything Human Key Server Cloud, file anything, protect and insure connected to GSense and Adopt Anything campaign or any campaign or independent sponsor ads in widgets on websites all over the web.

FIG. 33F describes how sponsor advertisements become conte˜t and what you can do with them with Protect Anything Human Key Server Cloud, file anything, protect and insure connected to GSense and Adopt Anything campaign or any campaign or independent sponsor ads in widgets on sponsored websites.

FIG. 33G describes how sponsor advertisements become content and what you can do with them with Protect Anything Human Key Server Cloud, file anything, protect and insure connected to GSense and Adopt Anything campaign or any campaign or independent sponsor ads in print media, magazines, books with images medication.

FIG. 33H describes how sponsor advertisements become content and what you can do with them with Protect Anything Human Key Server Cloud, file anything, protect and insure connected to GSense.and Adopt Anything campaign or any campaign or independent sponsor ads in on billboards, in ad campaigns with images medication.

FIG. 33I describes how sponsor advertisements become content and what you can do with them with Protect Anything Human Key Server Cloud, file anything, protect and insure connected to GSense and Adopt Anything campaign or any campaign or independent sponsor ads in mobile phone applications.

FIG. 33J describes how sponsor advertisements become content and what you can .do with them with Protect Anything Human Key Server Cloud, file anything, protect and insure connected to GSense and Adopt Anything campaign or any campaign or independent sponsor ads in coupon books.

FIG. 33K describes how sponsor advertisements become content and what you can do with them with Protect Anything Human Key Server Cloud, file anything, protect and insure connected to GSense and Adopt Anything campaign or any campaign or independent sponsor ads in attach to consumer e-mails.

FIG. 33L describes how sponsor advertisements become content and what you can do with them with Protect Anything Human Key Server Cloud, file anything, protect and insure connected to GSense and Adopt Anything campaign or any campaign or independent sponsor ads in sponsor ads.

FIG. 33M describes how sponsor advertisements become content and what you can do with them with Protect Anything Human Key Server Cloud, file anything, protect and insure connected to GSense and Adopt Anything campaign or any campaign or independent sponsor ads in tracking with historical data systems.

FIG. 33N describes how sponsor advertisements become content and what you can do with them with Protect Anything Human Key Server Cloud, file anything, protect and insure connected to GSense and Adopt Anything campaign or any campaign or independent sponsor ads in auction placement ads.

FIG. 33O describes how sponsor advertisements become content and what you can do with them with Protect Anything Human Key Server Cloud, file anything, protect and insure connected to GSense and Adopt Anything campaign or any campaign or independent sponsor ads in ad creations mechanisms.

FIG. 33P describes how sponsor advertisements become content and what you can do with them with Protect Anything Human Key Server Cloud, file anything, protect and insure connected to GSense and Adopt Anything campaign or any campaign or independent sponsor ads in payment systems interfaces.

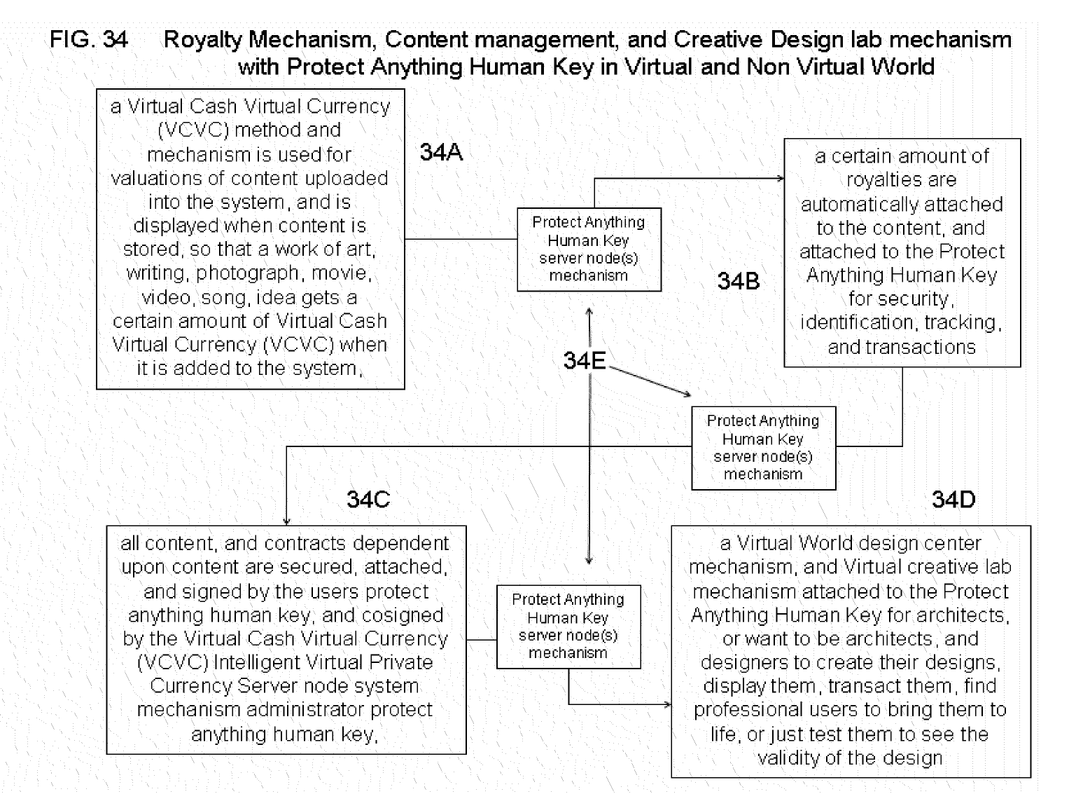

FIG. 34A illustrates the Royalty Mechanism, Content management, and Creative Design lab mechanism with Protect Anything Human Key in Virtual and Non Virtual World and a Virtual Cash Virtual Currency (VCVC) method and mechanism is used for valuations of content uploaded into the system, and is displayed when content is stored, so that a work of art, writing, photograph, movie, video, song, idea gets a certain amount of Virtual Cash Virtual Currency (VCVC) when it is added to the system.

FIG. 34B illustrates the Royalty Mechanism, Content management, and Creative Design lab mechanism with Protect Anything Human Key in Virtual and Non Virtual World where a certain amount of royalties are automatically attached to the content, and attached to the Protect Anything Human Key for security, identification, tracking, and transactions.

FIG. 34C illustrates the Royalty Mechanism, Content management, and Creative Design lab mechanism with Protect Anything Human Key in Virtual and Non Virtual World where all content, and contracts dependent upon content are secured, attached, and signed by the users protect anything human key, and cosigned by the Virtual Cash Virtual Currency (VCVC) Intelligent Virtual Private Currency Server node system mechanism administrator protect anything human key.

FIG. 34D illustrates the Royalty Mechanism, Content management, and Creative Design lab mechanism with Protect Anything Human Key in Virtual and Non Virtual World where a Virtual World design center mechanism, and Virtual creative lab mechanism attached to the Protect Anything Human Key for architects, or want to be architects, and designers to create their designs, display them, transact them, find professional users to bring them to life, or just test them to see the validity of the design.

FIG. 34E illustrates the Royalty Mechanism, Content management, and Creative Design lab mechanism with Protect Anything Human Key in Virtual and Non Virtual World and Protect Anything Human Key server node(s) mechanisms.

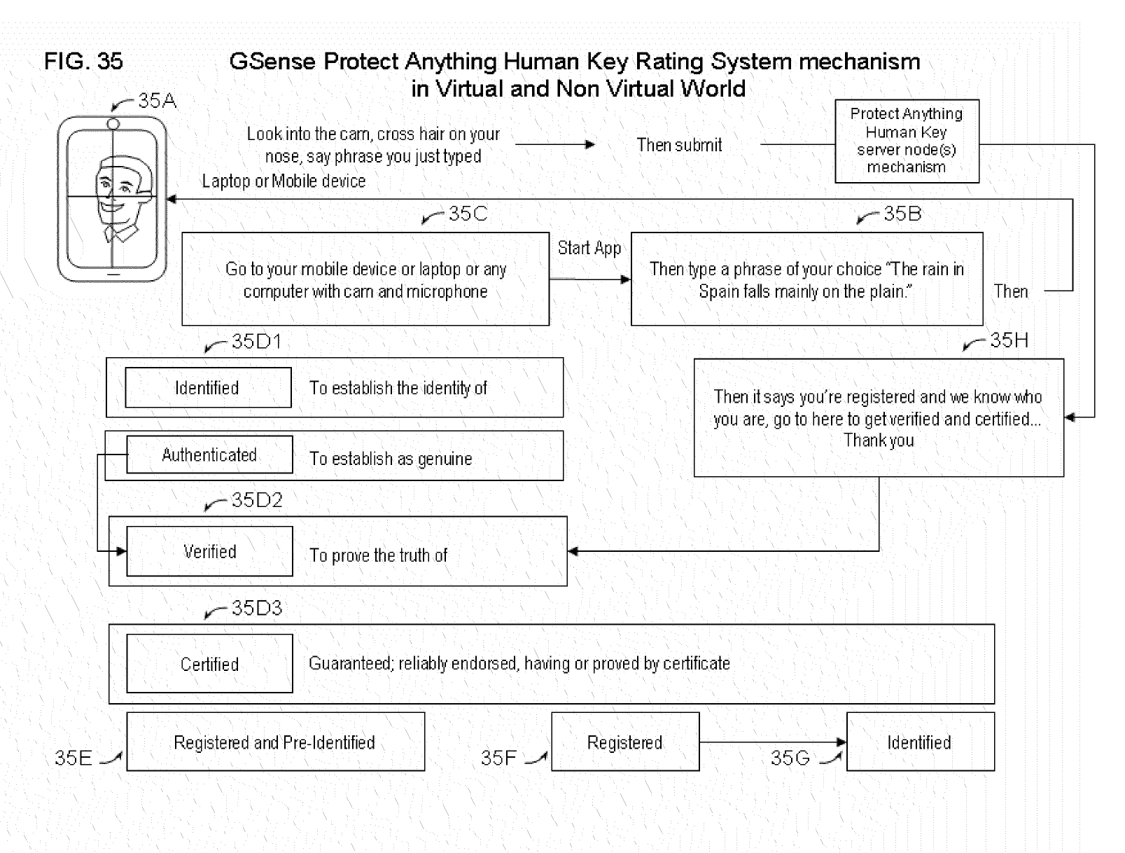

FIG. 35A describes How Data is processed into Protect Anything, Human Key and GSense rating system and shows how you look into the cam crosshair on your nose, say please you just typed and submitted with mobile device or laptop that has a cam and microphone.

FIG. 35B describes How Data is processed into Protect Anything Human Key and GSense rating system and shows how you start application and type a phrase of your choice like “the rain in Spain lies mainly on the plain” then go to your mobile device or laptop or any computer with cam and microphone and say the phrase as you look into cam.

FIG. 35C describes How Data is processed into Protect Anything Human Key and GSense rating system and shows you go to your mobile device or laptop or any computer with cam and microphone.

FIG. 35D1 describes How Data is processed into Protect Anything Human Key and GSense rating system and shows identified rating ‘to establish the identity of a person and authenticated to establish as genuine in the Protect Anything Human Key mechanism.

FIG. 35D2 describes How Data is processed into Protect Anything Human Key-and GSense rating system and shows verify to prove the truth of identity of a person in the Protect Anything Human Key mechanism.

FIG. 35D3 describes How Data is processed into Protect Anything Human Key and GSense rating system and shows certified guaranteed, reliably endorsed having or approved by a certificate of a person through the Protect Anything Human Key system.

FIG. 35E describes How Data is processed into Protect Anything Human Key and GSense rating system and shows registered and pretty identified in the Protect Anything Human Key mechanism.

FIG. 35F describes How Data is processed into Protect Anything Human Key and GSense rating system and shows registered in the Protect Anything Human Key mechanism.

FIG. 35G describes How Data is processed into Protect Anything Human Key and' GSense rating system and shows identified in the Protect Anything Human Key mechanism.

FIG. 35H describes How Data is processed int? Protect Anything Human Key and GSense rating system and shows that then it says “you're registered and we know who you are go here to give verified and certified, thank you”.

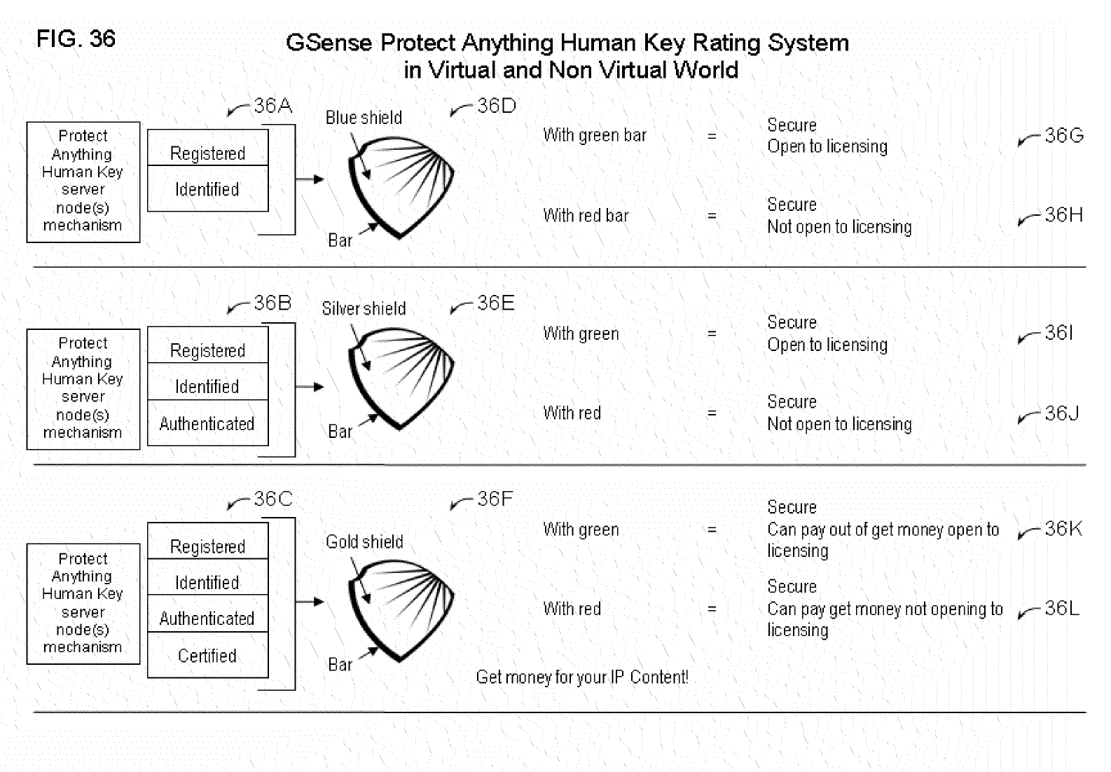

FIG. 36A describes how GSense rating system works with licensing color bands and shows a registered, identified user with Protect Anything Human Key server node(s) mechanism.

FIG. 36B describes How GSense rating system works with licensing color bands and shows a registered, identified, and authenticated user with Protect Anything Human Key server node(s) mechanism.

FIG. 36C describes How GSense rating system works with licensing color bands and shows a registered, identified, authenticated, and certified user with Protect Anything Human Key server node(s) mechanism.

FIG. 36D describes How GSense rating system works with licensing color bands and shows a registered, identified user with Blue Shield and licensing color bar.

FIG. 36E describes How GSense rating system works with licensing color bands and shows a registered, identified, authenticated user with Silver Shield and licensing, color bar.

FIG. 36F describes Ho˜GSense rating system works with licensing color bands and shows a registered, identified, authenticated, and certified user with gold shield and licensing color bar.

FIG. 36G describes How GSense rating system works with licensing color bands and shows a registered, identified user with green bar licensing for sharing, or collaboration or mash ups which equals that content is secure and open to licensing.

FIG. 36H describes How GSense rating system works with licensing color bands and shows a registered, identified user with red bar licensing for sharing, or collaboration or mash ups which equals that content is secure and closed to licensing.

FIG. 36I describes How GSense rating system works with licensing color bands and shows a registered, identified, and authenticated user with green bar licensing for sharing, or collaboration or mash ups which equals that content is secure and open to licensing.

FIG. 36J describes How GSense rating system works with licensing color bands and shows a registered, identified, and authenticated user with red bar licensing for sharing, or collaboration or mash ups which equals that content is secure and closed not open to licensing.

FIG. 36K describes How GSense rating system works with licensing color bands and shows a registered, identified, authenticated, and .certified user with green bar licensing for sharing, or collaboration or mash ups which equals that content is secure and open to licensing.

FIG. 36L describes How GSense rating system works with licensing color bands and shows a registered, identified, authenticated, and certified user with red bar licensing for sharing, or collaboration or mash ups which equals that content is secure and closed the younger to licensing.

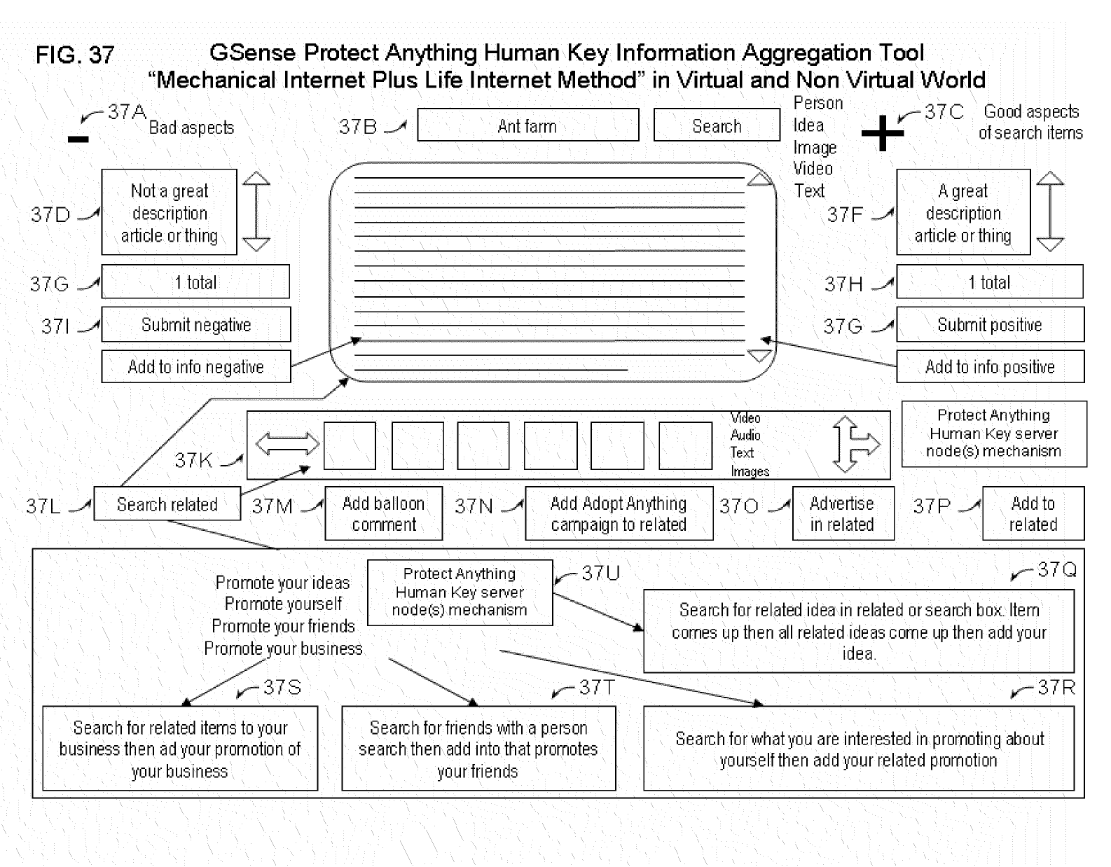

FIG. 37A describes GSense Information Aggregation Tool “mechanical internet plus the Life Internet” and shows negative aspects to searched subject.

FIG. 37B describes GSense Information Aggregation Tool “mechanical internet plus the Life Internet” and shows search for field with search button.

FIG. 37C describes GSense Information Aggregation Tool “mechanical internet plus the Life Internet” and shows good aspects of search item.

FIG. 37D describes GSense Information Aggregation Tool “mechanical internet plus the Life internet” and shows a more detailed description of the bad aspects and lists all total bad aspects of the search term.

FIG. 37E describes GSense Information Aggregation Tool “mechanical internet plus the Life internet” and shows the main search details of the item search for.

FIG. 37F describes GSense Information Aggregation Tool “mechanical internet-plus the Life Internet” and shows a more detailed description of the good aspects and list all total good aspects of the search term.

FIG. 37G describes GSense Information Aggregation Tool “mechanical internet plus the Life internet” and shows the total number of minus bad aspects of the search term.

FIG. 37H describes GSense Information Aggregation Tool “mechanical internet plus the Life internet” and shows the total number of plus good aspects of the search term.

FIG. 37I describes GSense Information Aggregation Tool “mechanical internet plus the Life internet” and shows submit negative impression or bad aspects button.

FIG. 37J describes GSense Information Aggregation Tool “mechanical internet plus the Life internet” and shows submit positive impression or good aspects button.

FIG. 37K describes GSense Information Aggregation Tool “mechanical internet plus the Life internet” and shows related video audio text images.

FIG. 37L describes GSense Information Aggregation Tool mechanical internet plus the Life internet and shows search related button to searched related items to the search item.

FIG. 37M describes GSense Information Aggregation Tool “mechanical internet plus the Life internet” and shows add balloon comment related button to searched related items to the search item.

FIG. 37N describes GSense Information Aggregation Tool “mechanical internet plus the Life internet” and shows add Adopt Anything campaign or any campaign related button to searched related items to the search item.

FIG. 37O describes G8ense Information Aggregation Tool “mechanical internet plus the Life internet” and shows advertise in related button where you can advertise in the related area.

FIG. 37P describes GSense Information Aggregation Tool “mechanical internet plus the Life internet” and shows add to related button where you can add things content media to the related area.

FIG. 37Q describes G8ense Information Aggregation Tool “mechanical internet plus the Life Internet” and shows where you search for related idea and related or main link to search box, item comes up then all related ideas come up then add your idea.

FIG. 37R describes GSense Information Aggregation Tool “mechanical internet plus the Life internet and shows where you can search for what you are interested in promoting about yourself then add your related promotion.

FIG. 37S describes GSense Information Aggregation Tool “mechanical internet plus the Life internet” and shows how to promote your ideas, promote yourself, promote your friends, promote your business, and search for related items to your business, then add your promotion of your business.

FIG. 37T describes GSense Information Aggregation Tool “mechanical internet plus the Life internet” and shows where you can search for friends with a person search then add information that promotes your friends.

FIG. 37T describes Protect Anything Human Key server node(s) mechanism.

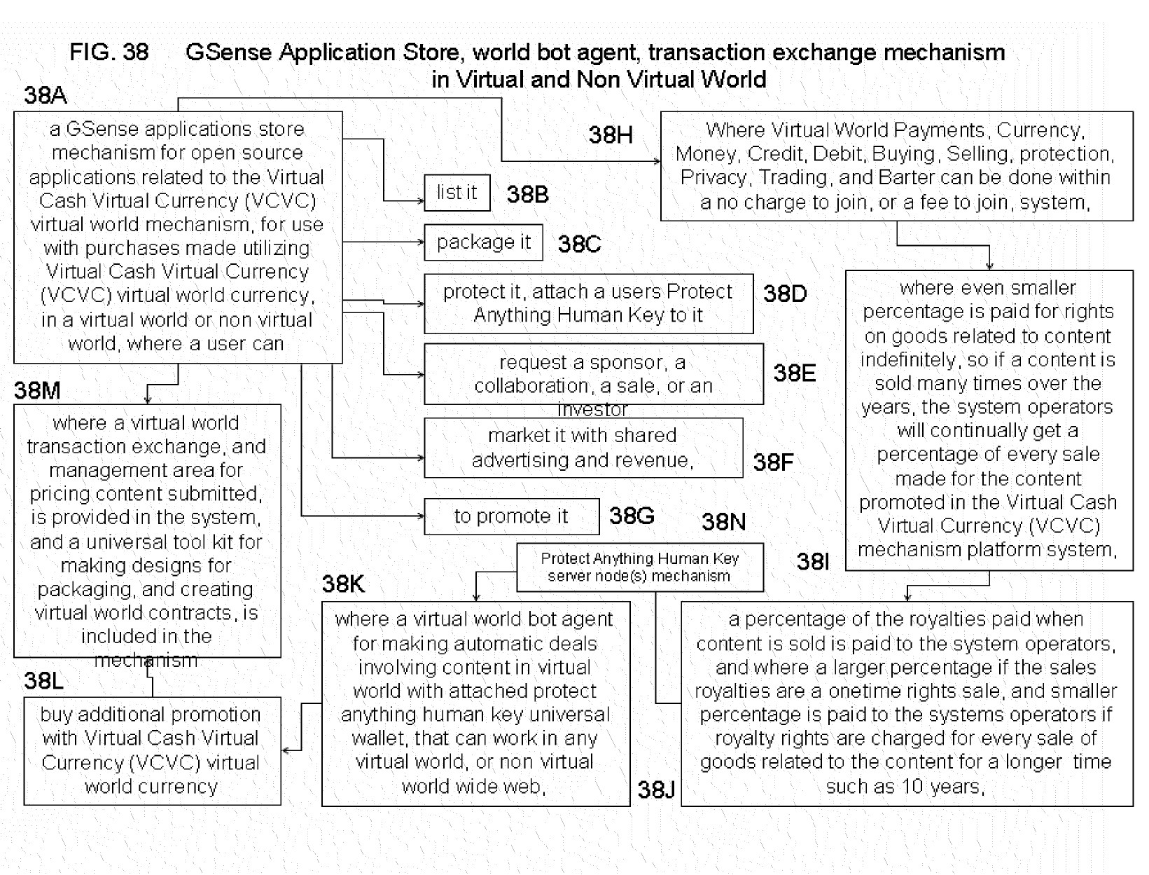

FIG. 38A illustrates the GSense Application Store, world bot agent, transaction exchange mechanism in Virtual and Non Virtual World and a GSense applications store mechanism for open source applications related to the Virtual Cash Virtual Currency (VCVC) virtual world mechanism, for use with purchases made utilizing Virtual Cash Virtual Currency (VCVC) virtual world currency, in a virtual world or non virtual world, where a user can.

FIG. 38B illustrates the GSense Application Store, world bot agent, transaction exchange mechanism in Virtual and Non Virtual World and can list it.

FIG. 38C illustrates the GSense Application Store, world bot agent, transaction exchange mechanism in Virtual and Non Virtual World and can package it.

FIG. 38D illustrates the GSense Application Store, world bot agent, transaction exchange mechanism in Virtual and Non Virtual World and can protect it, attach a users Protect Anything Human Key to it.

FIG. 38E illustrates the GSense Application Store, world bot agent, transaction exchange mechanism in Virtual and Non Virtual World and can request a sponsor, a collaboration, a sale, or an investor.

FIG. 38F illustrates the GSense Application Store, world bot agent, transaction exchange mechanism in Virtual and Non Virtual World and can market it with shared advertising and revenue.

FIG. 38G illustrates the GSense Application Store, world bot agent, transaction exchange mechanism in Virtual and Non Virtual World to promote it.

FIG. 38H illustrates the GSense Application Store, world bot agent, transaction exchange mechanism in Virtual and Non Virtual World where Virtual World Payments, Currency, Money, Credit, Debit, Buying, Selling, protection, Privacy, Trading, and Barter can be done within a no charge to join, or a fee to join, system.

FIG. 38I illustrates the GSense Application Store, world bot agent, transaction exchange mechanism in Virtual and Non Virtual World where even smaller percentage is paid for rights on goods related to content indefinitely, so if a content is sold many times over the years, the system operators will continually get a percentage of every sale made for the content promoted in the Virtual Cash Virtual Currency (VCVC) mechanism platform system.

FIG. 38J illustrates the GSense Application Store, world bot agent, transaction exchange mechanism in Virtual and Non Virtual World where a percentage of the royalties paid when content is sold is paid to the system operators, and where a larger percentage if the sales royalties are a onetime rights sale, and smaller percentage is paid to the systems operators if royalty rights are charged for every sale of goods related to the content for a longer time such as 10 years.

FIG. 38K illustrates the GSense Application Store, world bot agent, transaction exchange mechanism in Virtual and Non Virtual World where a virtual world bot agent for making automatic deals involving content in virtual world with attached protect anything human key universal wallet, that can work in any virtual world, or non virtual world wide web.

FIG. 38L illustrates the GSense Application Store, world bot agent, transaction exchange mechanism in Virtual and Non Virtual World where user can buy additional promotion with Virtual Cash Virtual Currency (VCVC) virtual world currency.

FIG. 38M illustrates the GSense Application Store, world bot agent, transaction exchange mechanism in Virtual and Non Virtual World where a virtual world transaction exchange, and management area for pricing content submitted, is provided in the system, and a universal tool kit for making designs for packaging, and creating virtual world contracts, is included in the mechanism.

FIG. 38N illustrates the GSense Application Store, world bot agent, transaction exchange mechanism in Virtual and Non Virtual World with the Protect Anything Human Key server node(s) mechanism.

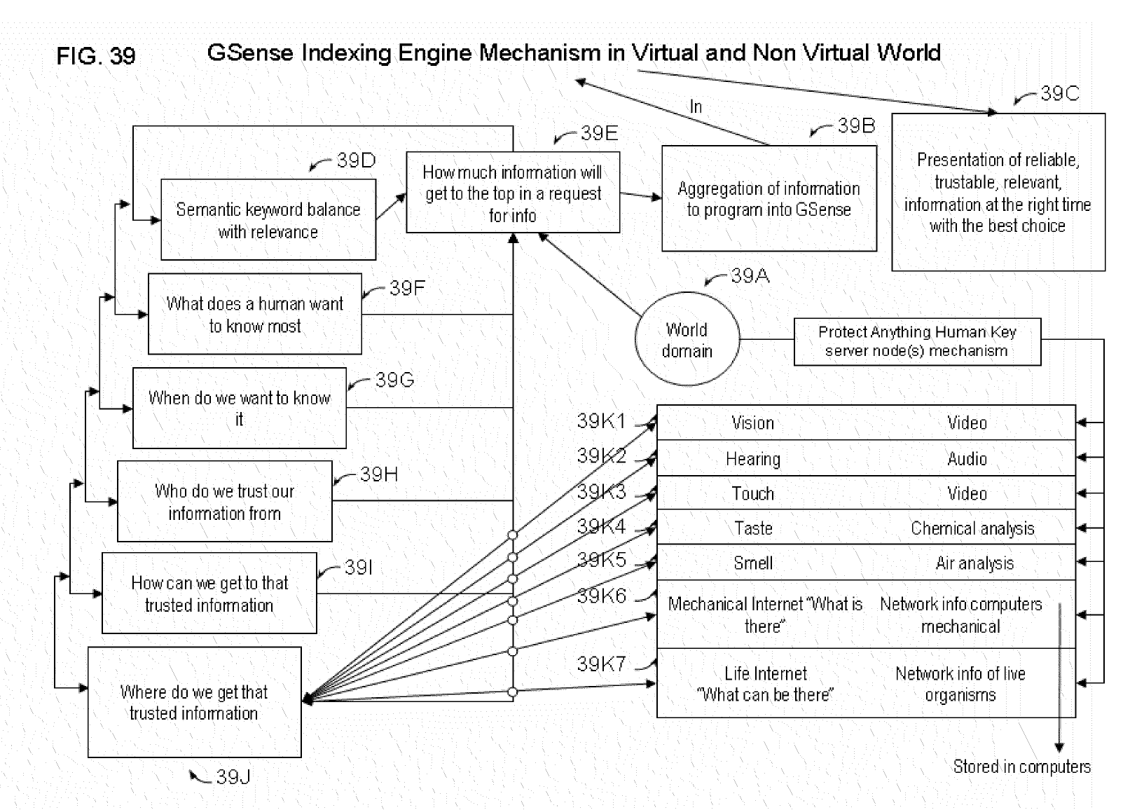

FIG. 39A describes GSense Engine and mechanism and shows how world domains connect with GSense engine.

FIG. 39B describes GSense Engine and mechanism and shows the aggregation of information to programmed into the GSense engine mechanism.

FIG. 39C describes GSense Engine and mechanism and shows how information flows out from the GSense engine mechanism for presentation of reliable, trustable, relevant information at the right time with the best choice for decision-making.

FIG. 39D describes GSense Engine and mechanism and shows how semantic keyword balances with relevance in the GSense engine.

FIG. 39E describes GSense Engine and mechanism and shows how much information will get to the top of the list in a request for information.

FIG. 39F describes GSense Engine and mechanism and shows questions are asked and fulfilled like what does a human one to know about most?

FIG. 39G describes GSense Engine and mechanism and shows questions are asked and fulfilled like when do we want to know it?

FIG. 39H describes GSense Engine and mechanism and shows questions are asked and fulfilled like who do we trust our information from?

FIG. 39I describes GSense Engine and mechanism and shows questions are asked and fulfilled like how can we get instantly automatically to that trust information?

FIG. 39J describes GSense Engine and mechanism and shows questions are asked and fulfilled like where do we get that trusted information automatically?

FIG. 39K1 describes GSense Engine and mechanism and shows vision information utilizing video aggregation, analysis, storage, and information distribution.

FIG. 39K2 describes GSense Engine and mechanism and shows hearing information utilizing audio aggregation, analysis, storage and information distribution.

FIG. 39K3 describes GSense Engine and mechanism and shows touch information utilizing sensors aggregation, analysis, storage and information distribution.

FIG. 39K4 describes GSense Engine and mechanism and shows taste information utilizing chemical analysis sensors aggregation, analysis, storage and information distribution.

FIG. 39K5 describes GSense Engine and mechanism and shows smell information utilizing chemical analysis of gases sensors aggregation, analysis, storage and information distribution.

FIG. 39K6 describes GSense Engine and mechanism and shows the mechanical internet “what is there” information utilizing network information from mechanical computers stored in computers aggregation, analysis, storage and information distribution.

FIG. 39K7 describes GSense Engine and mechanism and shows life internet what can be there and is there at this moment information utilizing network info of live organisms aggregation, analysis, storage and information distribution.

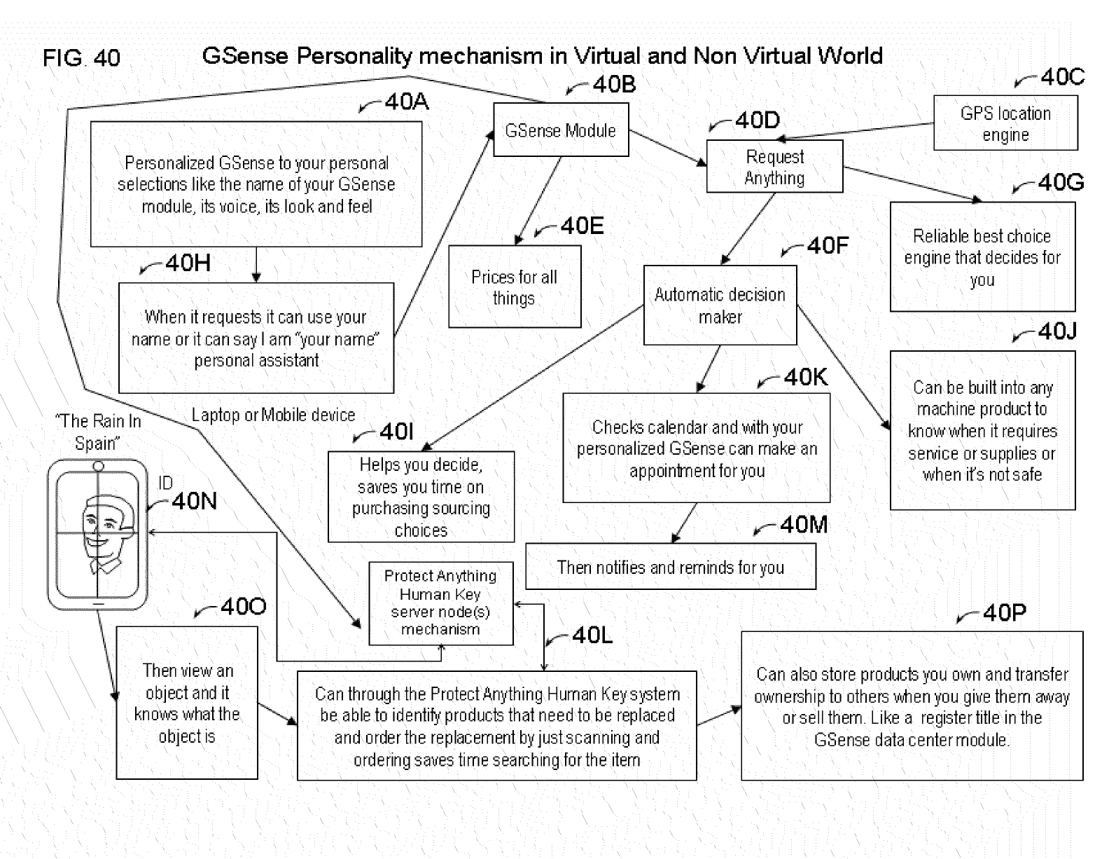

FIG. 40A describes how data is processed into intelligent data with Protect Anything Human Key Identification unit with, Request Anything, Remind Anything, and GSense mechanism and shows the personalized GSense to your personal selections like the name of your GSense module its voice, its look and feel.

FIG. 40B describes how data is processed into intelligent data with Protect Anything Human Key Identification unit with Request Anything, Remind Anything, and GSense mechanism and shows the GSense module.

FIG. 40C describes how data is processed into intelligent data with Protect Anything Human Key Identification unit with Request Anything, Remind Anything, and GSense mechanism and shows the GPS location agent engine.

FIG. 40D describes how data is processed into intelligent data with Protect Anything Human Key Identification unit with Request Anything, Remind Anything, and GSense mechanism and shows the Request Anything mechanism.

FIG. 40E describes how data is processed into intelligent data with Protect Anything Human Key Identification unit with Request Anything, Remind Anything, and GSense mechanism and shows the prices for all things engine and storage.

FIG. 40F describes how data is processed into intelligent data with Protect Anything Human Key Identification unit with Request Anything, Remind Anything, and GSense mechanism and shows the automatic decision maker agent.

FIG. 40G describes how data is processed into intelligent data with Protect. Anything Human Key Identification unit with Request Anything, Remind Anything, and GSense mechanism and shows the Request Anything reliable best choice engine that decides for you.

FIG. 40H describes how data is processed into intelligent data with Protect Anything Human Key Identification unit with Request Anything, Remind Anything, and GSense mechanism and shows when it requests you can use your name, or I can say I am “your name” your personal assistant.

FIG. 40I describes how data is processed into intelligent data with Protect Anything Human Key Identification unit with Request Anything, Remind Anything, and GSense mechanism and shows how she decide, saves you time purchasing sourcing and choices.

FIG. 40J describes how data is processed into intelligent data .with Protect Anything Human Key Identification unit with Request Anything, Remind Anything, and GSense mechanism and shows can be built into the machine or product to know when it requires service, or supplies or when it's not safe.

FIG. 40K describes how data is processed into intelligent data with Protect Anything Human Key Identification unit with Request Anything, Remind Anything, and GSense mechanism and shows checks calendar with your personalized GSense can make an appointment for you.

FIG. 40L describes how data is processed into intelligent data with Protect Anything Human Key Identification unit with Request Anything, Remind Anything, and GSense mechanism and shows where the mechanism can utilizing the protect identification system be able to identify products that need to be replaced and order the replacement by just scanning and ordering, saves time searching for the item.

FIG. 40M describes how data is processed into intelligent data with Protect Anything Human Key Identification unit with Request Anything, Remind Anything, and GSense mechanism and shows then notifies and reminds automatically for you.

FIG. 40N describes how data is processed into intelligent data with Protect Anything Human Key Identification unit with Request Anything, Remind Anything, and GSense mechanism and shows the mobile device with cam and microphone and crosshairs are protect identification.

FIG. 40O describes how data is processed into intelligent data with Protect Anything Human Key Identification unit with Request Anything, Remind Anything, and GSense mechanism and shows then when you view an object with cam your mobile device through the GSense protect system identifies and knows what the object is.

FIG. 40P describes how data is processed into intelligent data with Protect Anything Human Key Identification unit with Request Anything, Remind Anything, and GSense mechanism and shows the system can also store products your, and can transfer ownership to others when you give them away or sell them, like a registration title in the GSense data center module.

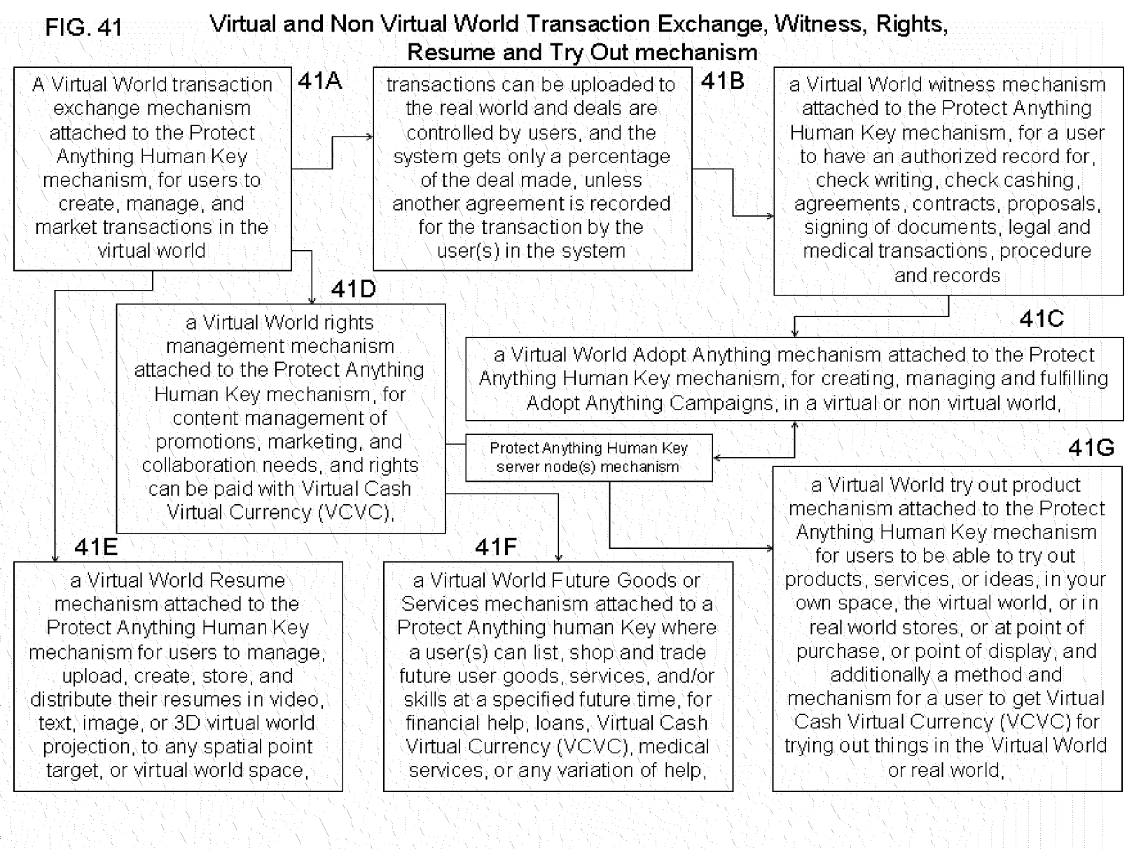

FIG. 41A illustrates the Virtual and Non Virtual World Transaction Exchange, Witness, Rights, Resume and Try Out mechanism with a A Virtual World transaction exchange mechanism attached to the Protect Anything Human Key mechanism, for users to create, manage, and market transactions in the virtual world.

FIG. 41B illustrates the Virtual and Non Virtual World Transaction Exchange, Witness, Rights, Resume and Try Out mechanism where transactions can be uploaded to the real world and deals are controlled by users, and the system gets only a percentage of the deal made, unless another agreement is recorded for the transaction by the user(s) in the system.

FIG. 41C illustrates the Virtual and Non Virtual World Transaction Exchange, Witness, Rights, Resume and Try Out mechanism where a Virtual World witness mechanism attached to the Protect Anything Human Key mechanism, for a user to have an authorized record for, check writing, check cashing, agreements, contracts, proposals, signing of documents, legal and medical transactions, procedure and records.

FIG. 41D illustrates the Virtual and Non Virtual World Transaction Exchange, Witness, Rights, Resume and Try Out mechanism and a Virtual World rights management mechanism attached to the Protect Anything Human Key mechanism, for content management of promotions, marketing, and collaboration needs, and rights can be paid with Virtual Cash Virtual Currency (VCVC).

FIG. 41E illustrates the Virtual and Non Virtual World Transaction Exchange, Witness, Rights, Resume and Try Out mechanism where a Virtual World Resume mechanism attached to the Protect Anything Human Key mechanism for users to manage, upload, create, store, and distribute their resumes in video, text, image, or 3D virtual world projection, to any spatial point target, or virtual world space.

FIG. 41F illustrates the Virtual and Non Virtual World Transaction Exchange, Witness, Rights, Resume and Try Out mechanism where a Virtual World Future Goods or Services mechanism attached to a Protect Anything human Key where a user(s) can list, shop and trade future user goods, services, and/or skills at a specified future time, for financial help, loans, Virtual Cash Virtual Currency (VCVC), medical services, or any variation of help.

FIG. 41G illustrates the Virtual and Non Virtual World Transaction Exchange, Witness, Rights, Resume and Try Out mechanism where a Virtual World try out product mechanism attached to the Protect Anything Human Key mechanism for users to be able to try out products, services, or ideas, in your own space, the virtual world, or in real world stores, or at point of purchase, or point of display, and additionally a method and mechanism for a user to get Virtual Cash Virtual Currency (VCVC) for trying out things in the Virtual World or real world.

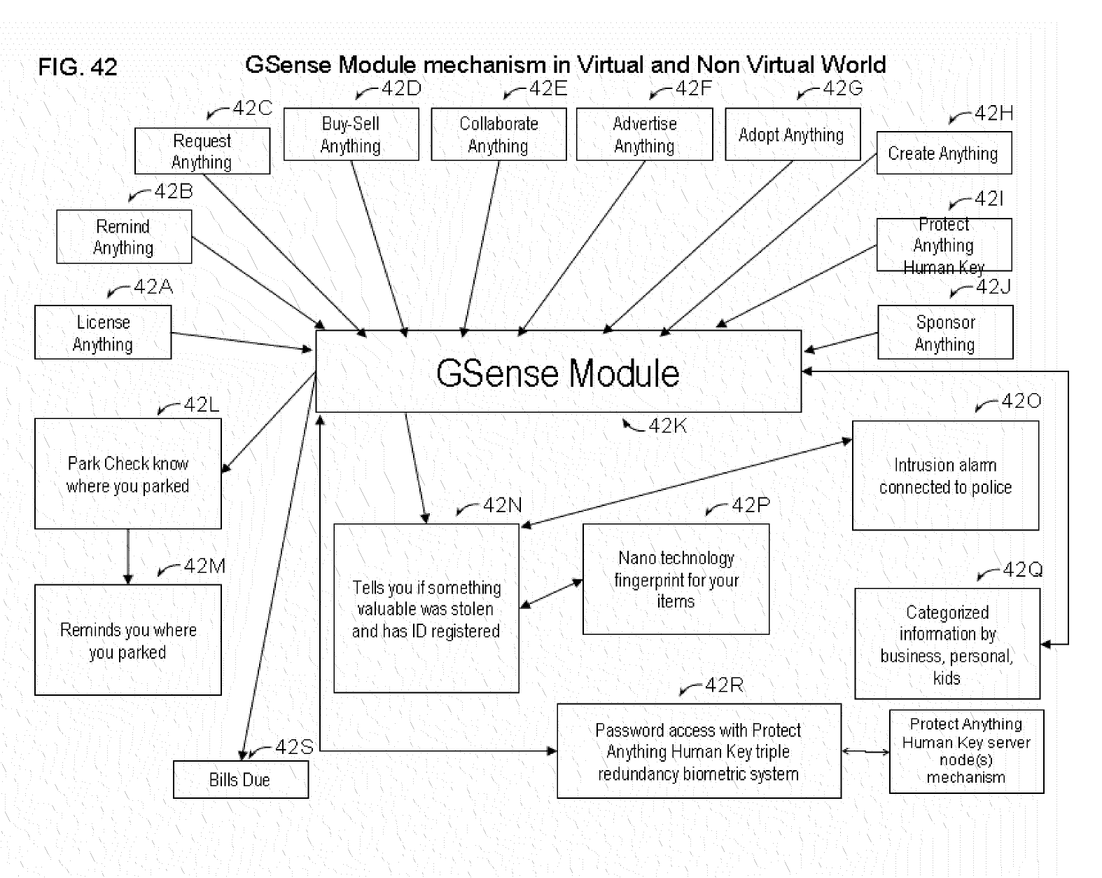

FIG. 42A describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows license anything connected to GSense module.

FIG. 42B describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key, aggregated into and used with GSense mechanism and shows Remind Anything connected to GSense module.

FIG. 42C describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Request Anything connected to GSense module.

FIG. 42D describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows buy sell anything connected to GSense module.

FIG. 42E describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, .teach, research, promote, collaborate, adopt, and Protect Anything Human Key aggregated into and used with GSense mechanism and shows collaborate anything connected to GSense module.

FIG. 42F describes how to create, design, record, file, document, publish, authenticate, plan, market, personalize, distribute, manufacture, license, franchise, sponsor, advertise, publicize, report, track, rate, rent, lease', price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows advertise anything connected to GSense module.

FIG. 42G describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Adopt Anything campaign or any campaign connected to GSense module.

FIG. 42H describes how to create, design, record, file, document; publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows create anything connected to GSense module.

FIG. 42I describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Protect Anything Human Key connected to GSense module.

FIG. 42J describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy,' sell, exchange, service, build, repair, install, learn, teach, research, promote, collaborate, adopt, and Protect Anything Human Key aggregated into and used with GSense mechanism and shows Sponsor Anything connected to GSense module.

FIG. 42K describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows the GSense module.

FIG. 42L describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows the GSense can park check know where you parked your car.

FIG. 42M describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows where the GSense module can remind you where you parked your car.

FIG. 42N describes how to create, design, record, file, document, publish, ‘authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense module can tell you something valuable stolen it has 10 registered with Protect Anything Human Key.

FIG. 42O describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows intrusion alarm connected to GSense and to police.

FIG. 42P describes how to create, design, record, file, document, publish, authenticate, plan, market, personalize, distribute: manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows the GSense Protect Anything Human Key nano technology fingerprint for your items.

FIG. 42Q describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense categorized information by business, personal and kids.

FIG. 42R describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense password access with Protect Anything Human Key triple redundancy biometric system.

FIG. 42S describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate˜adopt, and Protect Anything Human Key aggregated into and used with GSense mechanism and shows GSense can tell you when your bills are due.

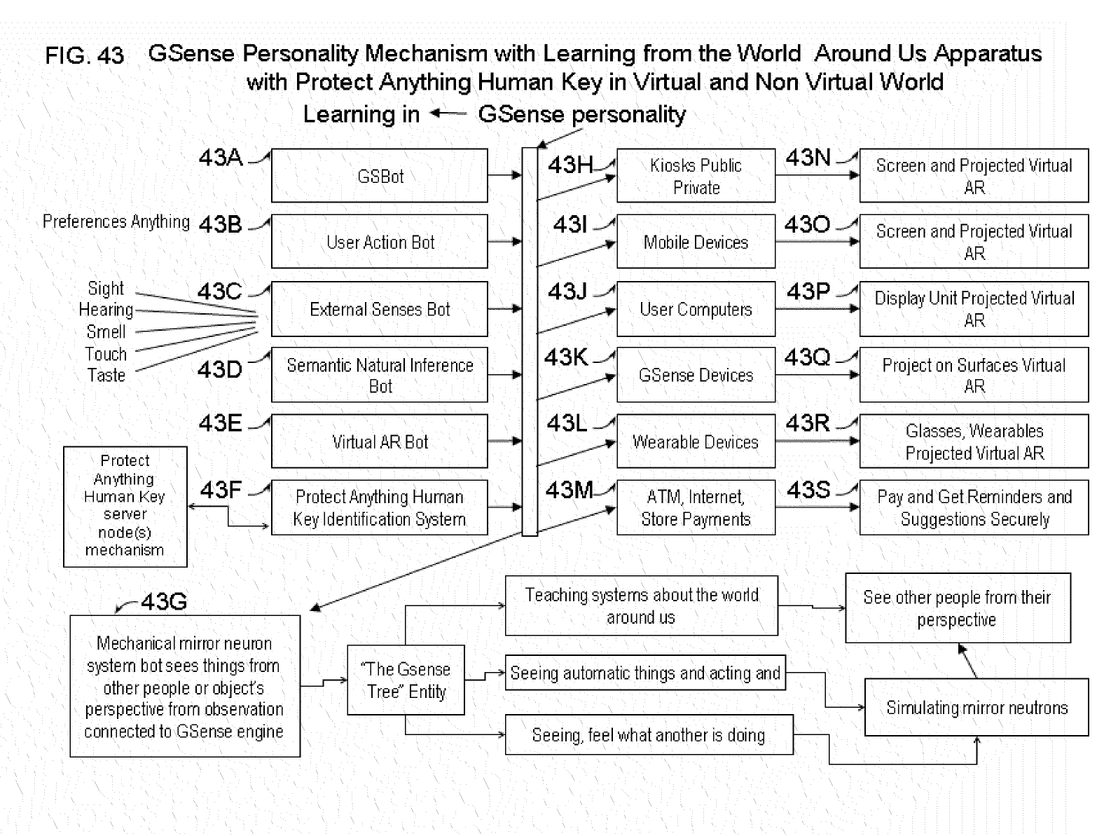

FIG. 43A describes the GSense Personality Mechanism with Learning from the World Around Us Apparatus and shows the GS bot learning into the GSense personality.

FIG. 43B describes the GSense Personality Mechanism with Learning from the World Around Us Apparatus and shows the user actions bot learning into the GSense personality. FIG. 43C describes the GSense Personality Mechanism with Learning from the World Around Us Apparatus and shows the external senses bot with sight, hearing, smell, touch, and taste learning into the GSense personality.

FIG. 43D describes the GSense Personality Mechanism with Learning from the World Around Us Apparatus and shows the semantic natural inference bot learning into the GSense personality.

FIG. 43E describes the GSense Personality Mechanism with Learning from the World Around Us Apparatus and shows the virtual augmented reality bot learning into the GSense personality.

FIG. 43F describes the GSense Personality Mechanism with Learning from the World Around Us Apparatus and shows the Protect Anything Human Key identification system managing learning into the GSense personality.

FIG. 43G describes the GSense Personality Mechanism with Learning from the World Around Us Apparatus and shows the mechanical mirror neuron system bot that sees things from other people or objects perspective from observation connected to the Life Internet and the GSense engine learning into the GSense personality.

FIG. 43H describes the GSense Personality Mechanism with Learning from the World Around Us Apparatus and shows kiosks public or private getting data from the GSense personality.

FIG. 43I describes the GSense Personality Mechanism with Learning from the World Around Us Apparatus and shows mobile devices getting data from the GSense personality.

FIG. 43J describes the GSense Personality Mechanism with Learning from the World Around Us Apparatus and shows user computers getting data from the GSense personality.

FIG. 43K describes the GSense Personality Mechanism with Learning from the World Around Us Apparatus and shows projection devices getting data from the GSense personality.

FIG. 43L describes the GSense Personality Mechanism with Learning from the World Around Us Apparatus and shows wearable devices getting data from the GSense personality.

FIG. 43M describes the GSense Personality Mechanism with Learning from the World Around Us Apparatus and shows bank AIMs Internet stores payments getting data from the GSense personality.

FIG. 43N describes the GSense Personality Mechanism with Learning from the World Around Us Apparatus and shows screen and projected virtual augmented reality data from kiosks public or private data from the GSense personality.

FIG. 43O describes the GSense Personality Mechanism with Learning from the World Around Us Apparatus and shows screen and projected virtual augmented reality data from mobile devices data from the GSense personality.

FIG. 43P describes the GSense Personality Mechanism with Learning from the World Around Us Apparatus and shows screen display unit and projected virtual augmented reality data from user computers with data from the GSense personality.

FIG. 43Q describes the GSense Personality Mechanism with Learning from the World Around Us Apparatus and shows screen and projected virtual augmented reality data on surfaces from projectors with data from the GSense personality.

FIG. 43R describes the GSense Personality Mechanism with Learning from the World Around Us Apparatus and shows glasses, wearable's and projected virtual augmented reality data from wearable devices with data from the GSense personality.

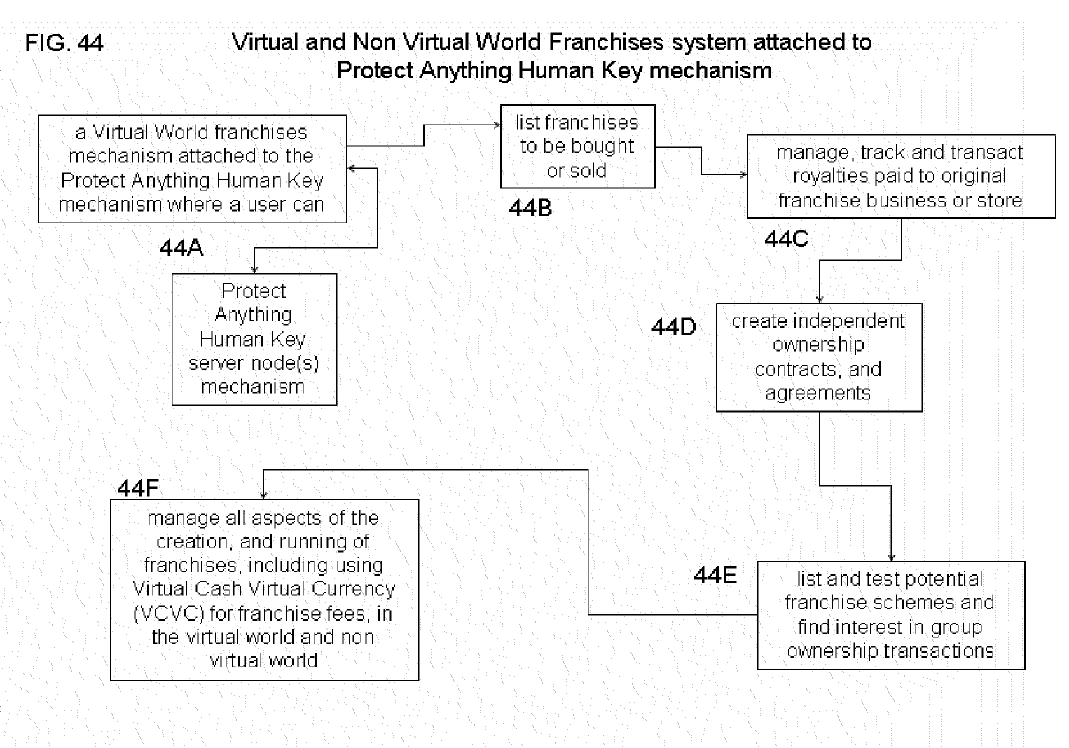

FIG. 44A illustrates the Virtual and Non Virtual World Franchises system attached to Protect Anything Human Key mechanism where a Virtual World franchises mechanism attached to the Protect Anything Human Key mechanism where a user can do many things.

FIG. 44B illustrates the Virtual and Non Virtual World Franchises system attached to Protect Anything Human Key mechanism where user can list franchises to be bought or sold.

FIG. 44C illustrates the Virtual and Non Virtual World Franchises system attached to Protect Anything Human Key mechanism where user can manage, track and transact royalties paid to original franchise business or store.

FIG. 44D illustrates the Virtual and Non Virtual World Franchises system attached to Protect Anything Human Key mechanism where user can create independent ownership contracts, and agreements.

FIG. 44E illustrates the Virtual and Non Virtual World Franchises system attached to Protect Anything Human Key mechanism where user can list and test potential franchise schemes and find interest in group ownership transactions

FIG. 44F illustrates the Virtual and Non Virtual World Franchises system attached to Protect Anything Human Key mechanism where user can manage all aspects of the creation, and running of franchises, including using Virtual Cash Virtual Currency (VCVC) for franchise fees, in the virtual world and non virtual world.

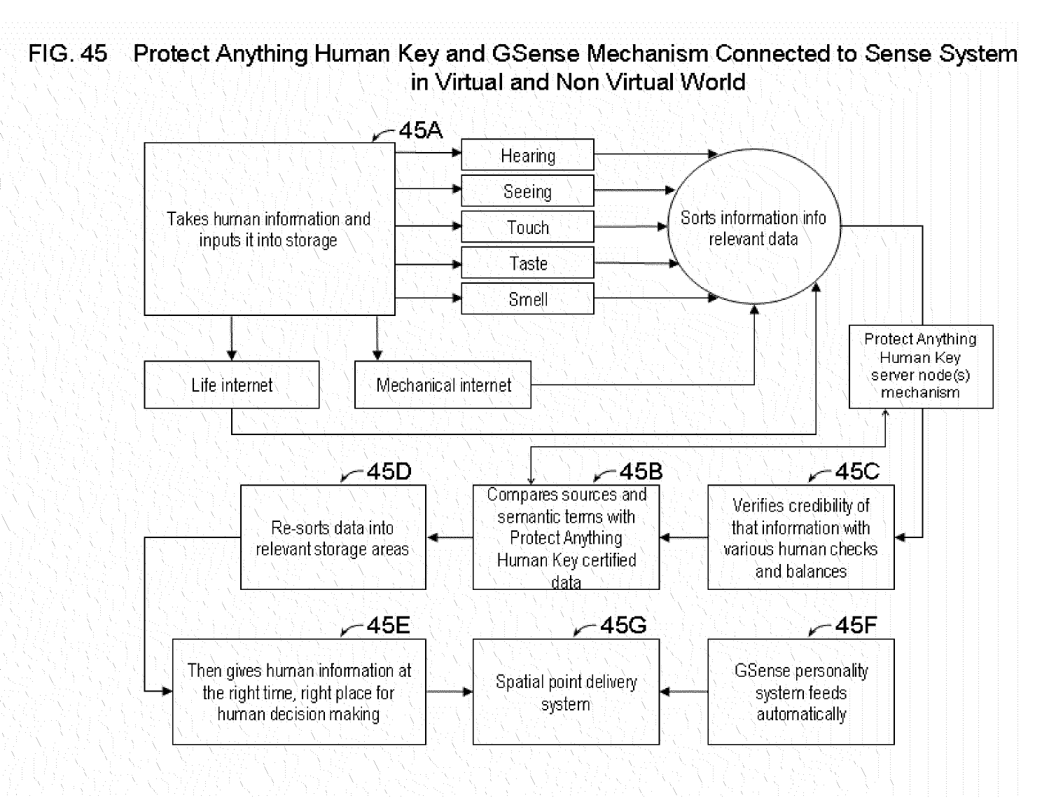

FIG. 45A describes how Protect Anything Human Key and GSense mechanism is connected to the sense system and shows how the system takes human information in implicit into storage the mechanism takes hearing, seeing, touching, taste, smell, life Internet, the mechanical Internet and sorts all information into relevant data areas.

FIG. 45B describes how Protect Anything Human Key and GSense mechanism is connected to the sense system and shows where the mechanism compares sources and semantic terms with Protect Anything Human Key certified data.

FIG. 45C describes how Protect Anything Human Key and GSense mechanism is connected to the sense system and shows where the mechanism verifies the credibility of that information with various human checks and balances built-in to be mechanism automatically.

FIG. 45D describes how Protect Anything Human Key and GSense mechanism is connected to the sense system and shows where the mechanism sorts again the data into relevant storage areas.

FIG. 45E describes how Protect Anything Human Key and GSense mechanism is connected to the sense system and shows the system then gives human information at the right time, right place for enhancing human decision making.

FIG. 45F describes how Protect Anything Human Key and GSense mechanism is connected to the sense system and shows that the GSense personality system feeds the relevant information automatically.

FIG. 45G describes how Protect Anything Human Key and GSense mechanism is connected to the sense system and shows that relevant information can be targeted with the spatial point delivery system mechanism.

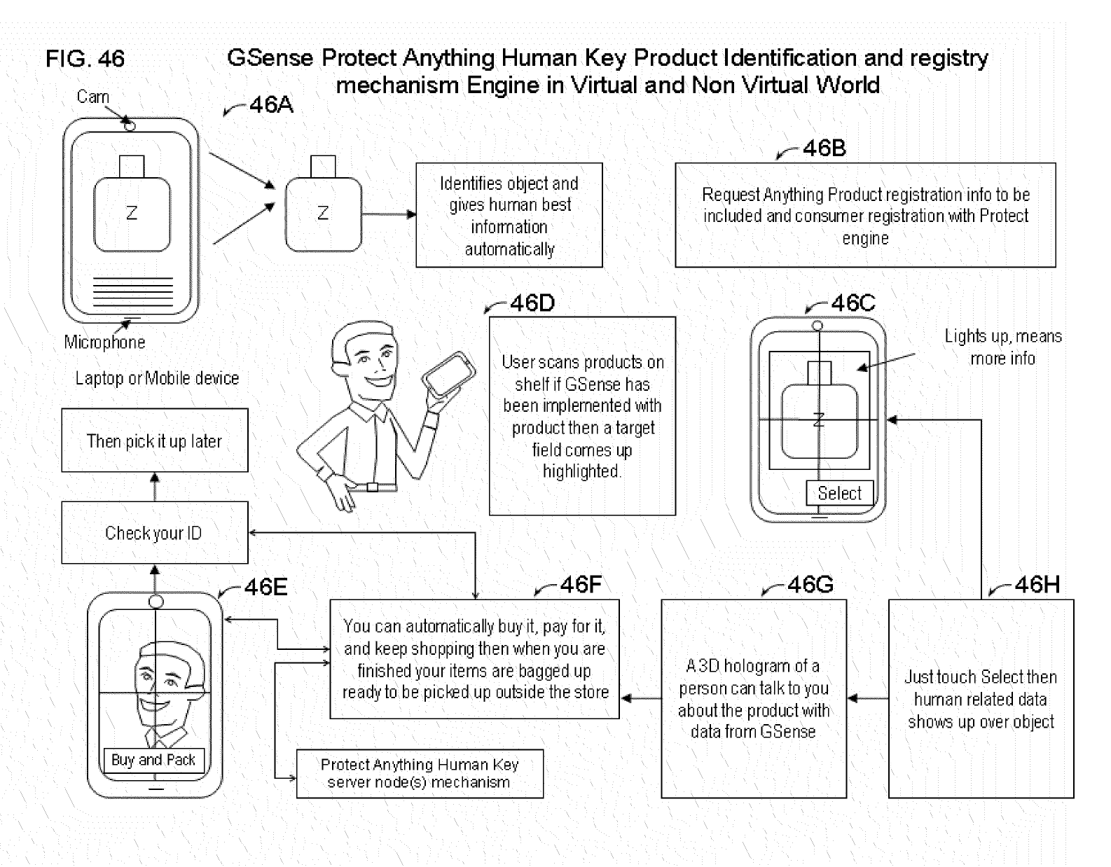

FIG. 46A describes GSense Product Identification and registry mechanism Engine and shows a mobile device with cam and microphone or laptop centering the product in the center of the screen the system identifies object and gives human best information automatically.

FIG. 46B describes GSense Product Identification and registry mechanism Engine and shows that are of the product registration entire to be included and consumer registration with protect engine for certification or identification.

FIG. 46C describes GSense Product Identification and registry mechanism Engine and shows that when product is centered in screen of mobile device or laptop object lights up which means there is more information about the product and if you would like more information just select the select button.

FIG. 46D describes GSense Product Identification and registry mechanism Engine and shows the user scans products on shelves if GSense has been implemented with product then they target field comes up highlighted.

FIG. 46E describes GSense Product Identification and registry mechanism Engine and shows where you can buy item then take it later outside the store or have it mailed or shipped to you from the Internet, it first checks your Protect Anything Human Key identification and verifies you, and can pay for it directly out of your bank or with credit card account.

FIG. 46F describes GSense Product Identification and registry mechanism Engine and shows where you can automatically buy it, pay for it, and keep shopping then when you are finished your items are bagged up or packed ready to be picked up outside the store.

FIG. 46G describes GSense Product Identification and registry mechanism Engine and shows a 3D hologram like view of a person can talk to you about the product with data from GSense like having a personal shopper or assistant.

FIG. 46H describes GSense Product Identification and registry mechanism Engine and shows you just touch select then human related data shares up over the object or product.

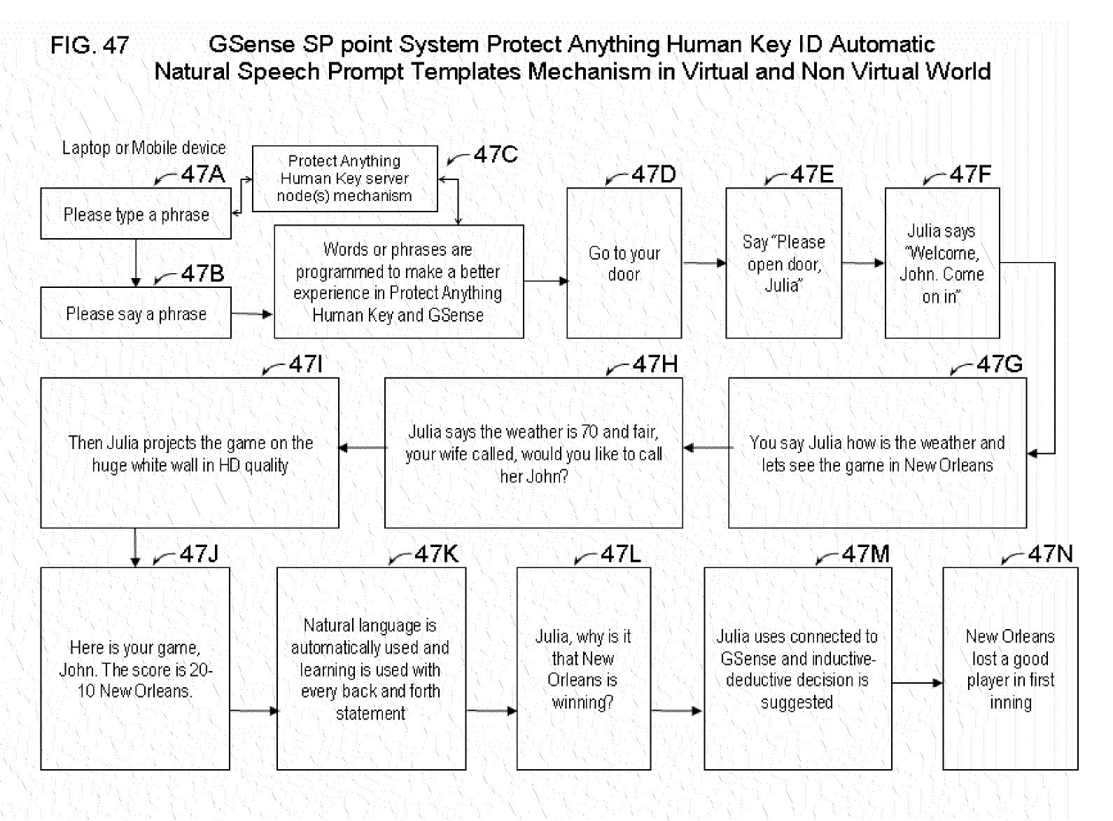

FIG. 47A describes GSense SP Targeted Point System with Protect Anything Human Key ID automatic natural speech prompt templates mechanism and shows where mechanism asks please type a phrase.

FIG. 47B describes GSense SP Targeted Point System with Protect Anything Human Key ID automatic natural speech prompt templates mechanism and shows where mechanism says please say a phrase.

FIG. 47C describes GSense SP Targeted Point System with Protect Anything Human Key ID automatic natural speech prompt templates mechanism and shows where words or phrases or program to make a better experience in the Protect Anything Human Key or GSense user interfaces, connected to Protect Anything Human Key server node(s) mechanism.

FIG. 47D describes GSense SP Targeted Point System with Protect Anything Human Key ID automatic natural speech prompt templates mechanism and shows where user does to your door.

FIG. 47E describes GSense SP Targeted Point System with Protect Anything Human Key ID automatic natural speech prompt templates mechanism and shows where user say “please open door Julia”.

FIG. 47F describes GSense SP Targeted Point System with Protect Anything Human Key ID automatic natural speech prompt templates mechanism and shows the GSense mechanism named Julia says “welcome John, come on in”.

FIG. 47G describes GSense SP Targeted Point System with Protect Anything Human Key ID automatic natural speech prompt templates mechanism and shows user says “Julia how is the weather and let's see the game in New Orleans”,

FIG. 47H describes GSense SP Targeted Point System with Protect Anything Human Key ID automatic natural speech prompt templates mechanism and shows where the GSense mechanism Julia says the weather is 70° F. and fair weather, your wife called would you like to call her back John?”,

FIG. 47I describes GSense SP Targeted Point System with Protect Anything Human Key ID automatic natural speech prompt templates mechanism and shows where then the GSense mechanism Julia projects again on the huge whitewall in high-definition quality,

FIG. 47J describes GSense SP Targeted Point System with Protect Anything Human Key ID automatic natural speech prompt templates mechanism and shows where GSense mechanism Julia says “here is your game John the scores are 20 to 10 New Orleans is winning”,

FIG. 47K describes GSense SP Targeted Point System with Protect Anything Human Key ID automatic natural speech prompt templates mechanism and shows where the GSense mechanism Julia is constantly programmed with natural language and visual, hearing, touch, smell, taste GSense engines also is continuously comparing life Internet and the mechanical Internet data to automatically learn continuously in learning is accomplished with every back and forth statement.

FIG. 47L describes GSense SP Targeted Point System with Protect Anything Human Key ID automatic natural speech prompt templates mechanism and shows where John asks the GSense mechanism Julia “why is it that New Orleans is winning game?”

FIG. 47M describes GSense SP Targeted Point System with Protect Anything Human Key ID automatic natural speech prompt templates mechanism and shows where the GSense mechanism Julia then uses his connector to the GSense human reasoning and decision engine and gives suggestion or proposal.

FIG. 47N describes GSense SP Targeted Point System with Protect Anything Human Key ID automatic natural speech prompt templates mechanism and shows where the GSense mechanism Julia then says “New Orleans lost a good player in the first inning and their game has been affected”, then the mechanism Julia says “the news announcers have commented on that loss of a player would you like more information, John?”

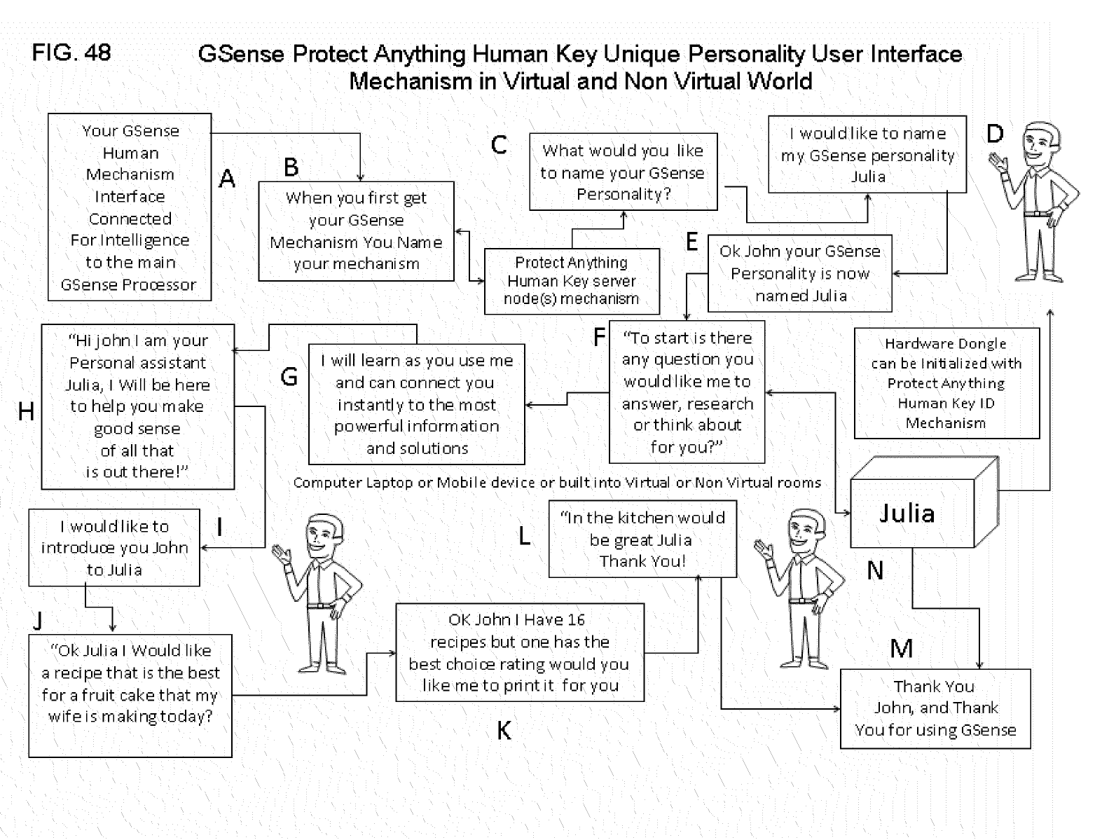

FIG. 48A describes GSense Unique Personality User Interface Mechanism and shows your GSense human mechanism interface connected for intelligence to the main GSense processor network.

FIG. 48B describes GSense Unique Personality User Interface Mechanism and shows when you first get your GSense mechanism and register your name for your mechanism.

FIG. 48C describes GSense Unique Personality User Interface Mechanism and shows that GSense says “what which you like to name your GSense personality?”.

FIG. 48D describes GSense Unique Personality User Interface Mechanism and shows user says the name like “I would like to name my GSense personality Julia”.

FIG. 48E describes GSense Unique Personality User Interface Mechanism and shows the GSense mechanism then says “okay John the GSense personality is now named Julia”.

FIG. 48F describes GSense Unique Personality User Interface. Mechanism and shows then the GSense mechanism says “I would like to introduce you John to Julia.”.

FIG. 48G describes GSense Unique Personality User Interface Mechanism and shows then the GSense personality responds with “hi John I'm your personal assistant Julia, I will be here to help you make sense of all that is out there”.

FIG. 48H describes GSense Unique Personality User Interface Mechanism, and shows then the personal assistant, GSense personality Julia says “I will learn as you use me and can connect you instantly care the most powerful information and solutions”.

FIG. 48I describes GSense Unique Personality User Interface Mechanism and shows where the GSense personality Julia says “to start, is any question you would like me to answer, research, think about the?”

FIG. 48J describes GSense Unique Personality User Interface Mechanism and shows where the user John then asks “okay Julia are like recipe is the best recipe for a fruitcake that my wife is cooking today?”

FIG. 48K describes GSense Unique Personality User Interface Mechanism and shows where the GSense unique personality Julia says “okay John I have 16 recipes but one has the best choice rating would you like me to print it for you at your family printing area? Or display it at your kitchen SP target point station?”

FIG. 48L describes GSense Unique Personality User Interface Mechanism and shows the user John says “in the kitchen would be great, thank you Julia”.

FIG. 48M describes GSense Unique Personality User Interface Mechanism and shows where the personal assistant GSense unique personality Julia replies “thank you John, and thank you for using GSense, allowing me to help you”.

FIG. 48N describes GSense Unique Personality User Interface Mechanism and shows the hardware device that is the GSense personal assistant personality hardware dongle that has to be initialized with Protect Anything Human Key identification log in system.

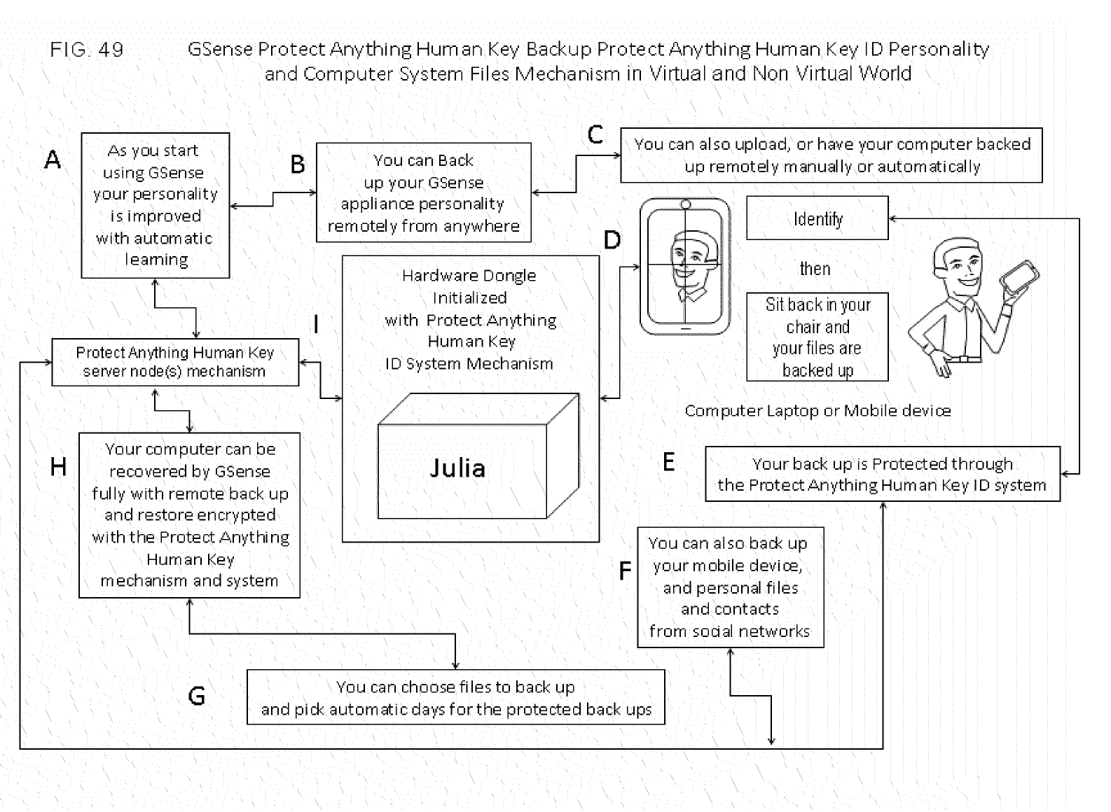

FIG. 49A describes GSense Personality Back Up and Recovery Mechanism with Protect Anything Human Key ID with Computer System and Files Remote Back Up Mechanism and shows as you start using GSense your GSense personality improves with continuous automatic learning's.

FIG. 49B describes GSense Personality Back Up and Recovery Mechanism with Protect Anything Human Key ID with Computer System and Files Remote Back Up Mechanism and shows where you can backup your GSense personality whatever name it is.

FIG. 49C describes GSense Personality Back Up and Recovery Mechanism with Protect Anything Human Key ID with Computer System and Files Remote Back Up Mechanism and shows you can also upload, or have your computer backed up remotely through the GSense mechanism.

FIG. 49D describes GSense Personality Back Up and Recovery Mechanism with Protect Anything Human Key ID with Computer System and Files Remote Back Up Mechanism and shows your backup is protected through the Protect Anything Human Key identification system and encryption protection.

FIG. 49E describes GSense Personality Back Up and Recovery Mechanism with Protect Anything Human Key ID with Computer System and Files Remote Back Up Mechanism and shows you can also backup your mobile device context or files remotely at any time to protect your sensitive files with Protect Anything Human Key identification security system.

FIG. 49F describes GSense Personality Back Up and Recovery Mechanism with Protect Anything Human Key ID with Computer System and Files Remote Back Up Mechanism and shows you can choose files to backup only a few are your whole system and then it can be recovered by only you with your Protect Anything Human Key identification security login.

FIG. 49G describes GSense Personality Back Up and Recovery Mechanism with. Protect Anything Human Key ID with Computer System and Files Remote Back Up Mechanism and shows the computer can be recovered fully remotely at any time, with the GSense system backup utility for storage and retrieval of important files by using remote backup and restore encrypted Protect Anything Human Key system, and you can choose files to back up and pick automatic days for the protected backups.

FIG. 49H describes GSense Personality Back Up and Recovery Mechanism with. Protect Anything Human Key ID with Computer System and Files Remote Back Up Mechanism and shows the computer can be recovered fully remotely at any time. with the GSense system backup utility for storage and retrieval of important files by using remote backup and restore encrypted Protect Anything Human Key system.

FIG. 49I describes GSense Personality Back Up and Recovery Mechanism with. Protect Anything Human Key ID with Computer System and Files Remote Back Up Mechanism and shows the computer can be recovered fully remotely at any time, with the GSense system backup utility for storage and retrieval of important files by using remote backup and restore encrypted Protect Anything Human Key system, and hardware dongle initialized with Protect anything Human Key ID system mechanism.

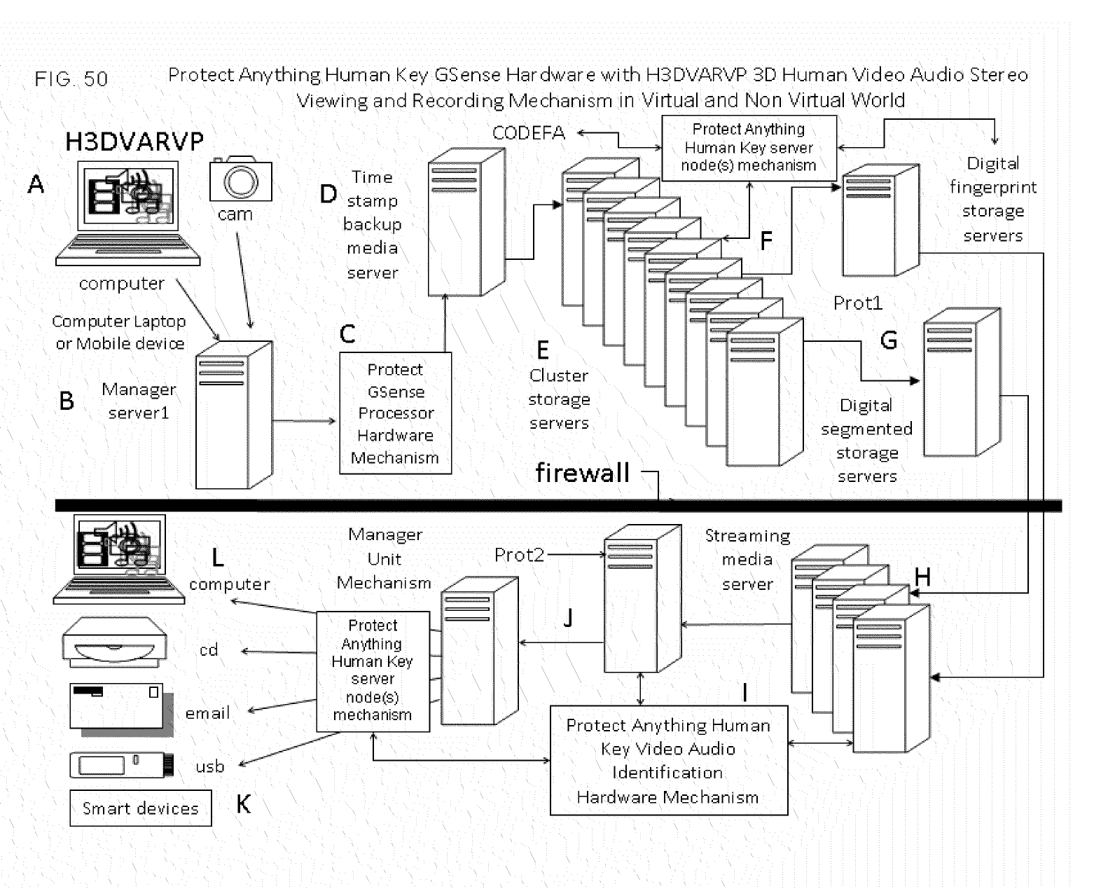

FIG. 50A describes the Protect Anything Human Key GSense Hardware server Mechanism with H3DVARV 3D Human Video Audio Stereo Viewing and Recording Mechanism where files, audio, video or any digital files can be uploaded and encrypted for security and protection to the Computer Object De-Encryption Encryption File Algorithm (CODEFA) mechanism server.

FIG. 50B describes a component of the Protect Anything Human Key GSense Hardware server Mechanism where. files, audio, video or any digital files can be uploaded arid encrypted for security and protection to the Computer Object DeEncryption Encryption File Algorithm (CODEFA) mechanism server, Manager server1 where initial files are processed into CODEFA.

FIG. 50C describes a component of the Protect Anything Human Key GSense Hardware server Mechanism where files, audio, video or any digital files can be uploaded and encrypted for security and protection to the Computer Object DeEncryption Encryption File Algorithm (CODEFA) mechanism server the Protect GSense processor Hardware mechanism that does a pre coding to the files as they enter the system.

FIG. 50D describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server adds the file to the Time Stamp backup media server to begin the documentation of the time and date that files were introduced into the system, and to create a backup of files for security.

FIG. 50E describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server the Cluster storage servers where all the files are stored for processing in Prot 1.

FIG. 50F describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server where Prot 1 then passes to Digital fingerprint storage servers for creation of digital fingerprinting for tracking a security.

FIG. 50G describes a component of the Protect Anything Human Key GSense Hardware server Mechanism where files, audio, video or any digital files ‘can be uploaded and encrypted for security and protection to the Computer Object De-Encryption Encryption File Algorithm (CODEFA) mechanism server where Prot1 then passes the file encrypted to the Digital segmented storage servers for storage until a request is made for the file.

FIG. 50H describes a component of the Protect Anything Human Key GSense Hardware server Mechanism where files, audio, video or any digital files can be uploaded and encrypted for security and protection to the Computer Object De Encryption Encryption File Algorithm (CODEFA) mechanism server when a request is passed from the Digital segmented storage servers for movement of a file to the streaming media server through the firewall after authentication of the proper user data.

FIG. 50I describes a component of the Protect Anything Human Key GSense Hardware server Mechanism where files, -audio, video or any digital files can be uploaded and encrypted for security and protection to the Computer Object De Encryption Encryption File Algorithm (CODEFA) mechanism server that links into the Protect Anything Human Key Video Audio Identification Hardware Mechanism with Prot2 connected to streaming media server.

FIG. 50J describes a component of the Protect Anything Human Key GSense Hardware server Mechanism where files, audio, video or any digital files can be uploaded and encrypted for security and protection to the Computer Object De Encryption Encryption File Algorithm (CODEFA) mechanism server and Prot2 connects after identification the streaming media server to the manager unit mechanism for delivery to appropriate devices.

FIG. 50K describes a component of the Protect Anything Human Key GSense Hardware server Mechanism where files, audio, video or any digital files can be uploaded and encrypted for security and protection to the Computer Object De Encryption Encryption File Algorithm (CODEFA) mechanism server delivery to smart devices that work with the protect anything human Key.

FIG. 50L describes Protect Anything Human Key GSense Hardware Mechanism where computers, laptops, mobile devices and cam files, audio, video or any digital files can be uploaded and encrypted for security and protection of intellectual property and delivered to computer, cd, email, and USB devices that work with the protect anything human Key.

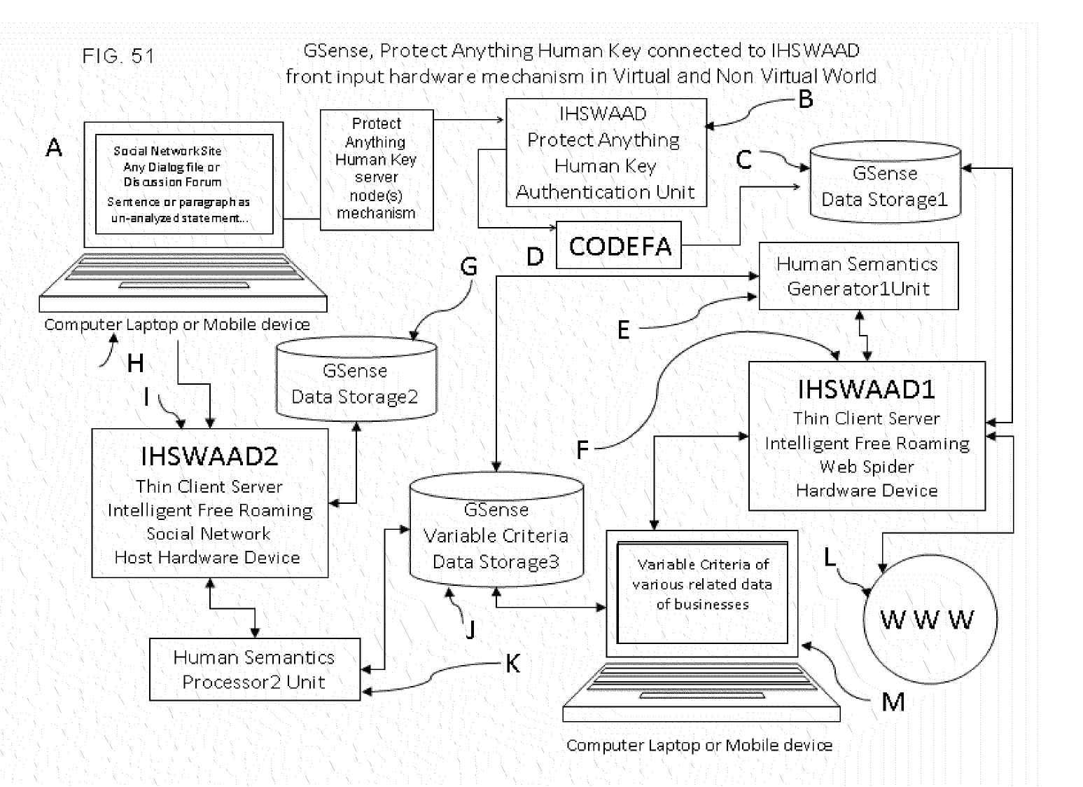

FIG. 51A describes GSense, Protect Anything Human Key connected to IHSWAAD hardware mechanism front input mechanism where data is input or aggregated from social networking site or any dialog file or discussion forum and a sentence or paragraph is entered as an un-analyzed statement from a computer, laptop, or mobile device for processing.

FIG. 51B describes GSense, Protect Anything Human Key connected to IHSWAAD hardware mechanism front input mechanism where data is input or aggregated through the IHSWAAD Protect Anything Human Key Authentication Unit and/or raw into the IHSWAAD2 Thin Client Server Intelligent Free Roaming Social Network Host Hardware Device from a computer, laptop, or mobile device for processing.

FIG. 51C describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing to the CODEFA encryption processing unit to the GSense Data Storage1.

FIG. 51D describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing through CODEFA Prot 1 security encryption processor.

FIG. 51E describes GSense, Protect Anything Human Key connected to IHSWAAD hardware mechanism front input mechanism where data is input into the Human Semantics Generator 1 Unit for keyword phrase analysis, intelligent pattern matching and processing.

FIG. 51F describes GSense, Protect Anything Human Key connected to IHSWAAD hardware mechanism front input mechanism where data is input and/or aggregated from WWW to the IHSWAAD1 Thin Client Server Intelligent Free Roaming Web Spider. Hardware Device and a sentence or paragraph is entered as an un-analyzed statement, from a computer, laptop, or mobile device for processing by the system.

FIG. 51G describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Data Storage2.

FIG. 51H describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing.

FIG. 51I describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing IHSWAAD2 Thin Client Server Intelligent Free Roaming Social Network Host Hardware Device.

FIG. 51J describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Variable Criteria Data Storage3.

FIG. 51K describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Human Semantics Processor2 Unit.

FIG. 51L describes GSense, Protect Anything Human Key connected to IHSW AAD hardware mechanism front input mechanism where data is input from social networking site or any dialog file or discussion forum and a sentence or paragraph is entered as an un-analyzed statement from a computer, laptop, or mobile device for processing from the WWW.

FIG. 51M describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Variable Criteria of various related data of businesses.

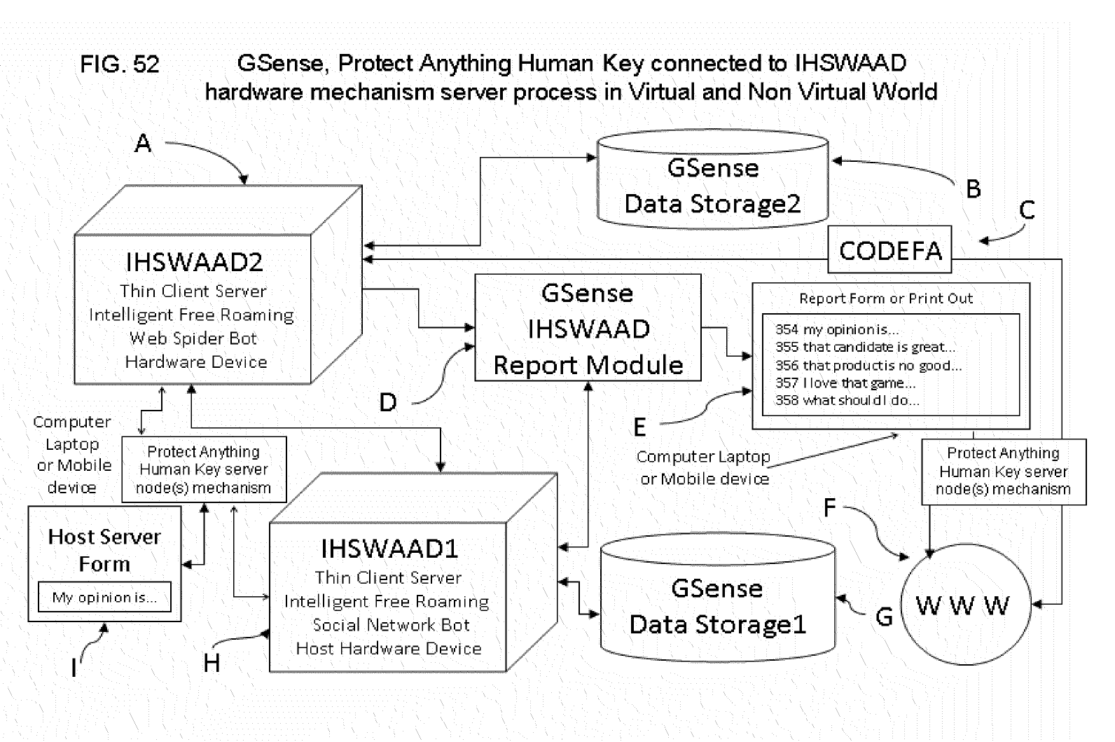

FIG. 52A describes GSense, Protect Anything Human Key connected to IHSWAAD hardware mechanism server process for processing and shows I HSWAAD2 Thin Client Server Intelligent Free Roaming Web Spider Bot Hardware Device for aggregating on the WWW.

FIG. 52B describes GSense, Protect Anything Human Key connected to IHSWAAD hardware mechanism server process for processing and shows G Sense data storage 2.

FIG. 52C describes GSense, Protect Anything Human Key connected to IHSWAAD hardware mechanism server process for processing and shows CODEFA.

FIG. 52D describes GSense, Protect Anything Human Key connected to IHSWAAD hardware mechanism server process for processing and shows GSense IHSWAAD Report Module.

FIG. 52E describes GSense, Protect Anything Human Key connected to IHSWAAD hardware mechanism server process for processing and shows Report Form or Print Out 354 my opinion is . . . 355 that candidate is great . . . 356 that product is no good . . . 357 I love that game . . . 358 what should I do . . . from Computer Laptop or Mobile device.

FIG. 52F describes GSense, Protect Anything Human Key connected to IHSWAAD hardware mechanism server process for processing and shows WWW.

FIG. 52G describes GSense, Protect Anything Human Key connected to IHSWAAD hardware mechanism server process for processing and shows GSense Data Storage 1.

FIG. 52H describes GSense, Protect Anything Human Key connected to IHSWAAD hardware mechanism server process for processing and shows IHSWAAD1 Thin Client Server Intelligent Free Roaming Social Network Bot Host Hardware Device.

FIG. 52I describes GSense, Protect Anything Human Key connected to IHSWAAD hardware mechanism server process for processing and shows Host Server Form My opinion is . . . from Computer Laptop or Mobile device.

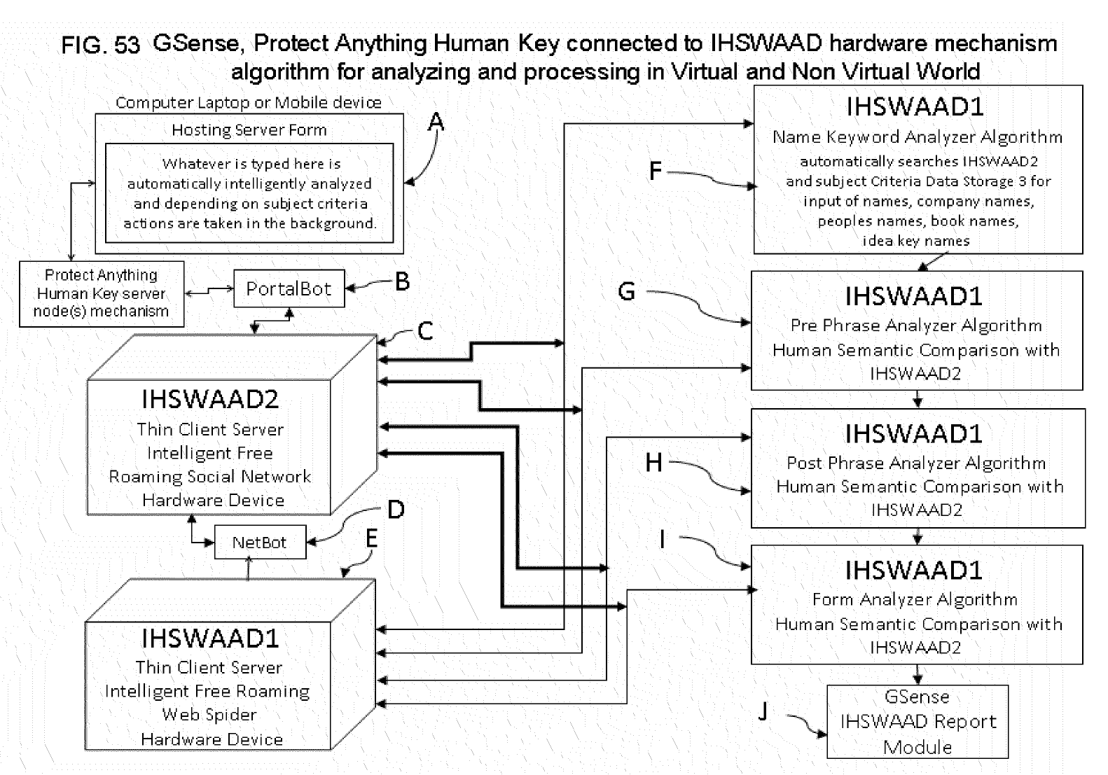

FIG. 53A describes GSense, Protect Anything Human Key connected to IHSWAAD hardware mechanism algorithm for analyzing and processing related information and shows Hosting Server Form input from Computer Laptop or Mobile device. Whatever is typed here is automatically intelligently analyzed and depending on subject criteria actions are taken in the background.

FIG. 53B describes GSense, Protect Anything Human Key connected to IHSWAAD hardware mechanism algorithm for analysis and processing related information and shows PortalBot.

FIG. 53C describes GSense, Protect Anything Human Key connected to IHSWAAD hardware mechanism algorithm for analyzing and processing related information and shows IHSWAAD2 Thin Client Server Intelligent Free Roaming Social Network Hardware Device.

FIG. 53D describes GSense, Protect Anything Human Key connected to IHSWAAD hardware mechanism algorithm for analyzing and processing related information and shows NetBot.

FIG. 53E describes GSense, Protect Anything Human Key connected to IHSWAAD hardware mechanism algorithm for analyzing and processing related information and shows IHSWAAD1 Thin Client Server Intelligent Free Roaming Web Spider Hardware Device.

FIG. 53F describes GSense, Protect Anything Human Key connected to IHSWAAD hardware mechanism algorithm for analyzing and processing related information and shows IHSWAAD1 Name Keyword Analyzer Algorithm automatically searches IHSWAAD2 and subject Criteria Data Storage 3 for input of names, company names, people's names, book names, idea key names.

FIG. 53G describes GSense, Protect Anything Human Key connected to IHSWAAD hardware mechanism algorithm for analyzing and processing related information and shows IHSWAAD1 Pre Phrase Analyzer Algorithm Human Semantic Comparison with IHSWAAD2.

FIG. 53H describes GSense, Protect Anything Human Key connected to IHSWAAD hardware mechanism algorithm for analyzing and processing related information and shows IHSWAAD1 Post Phrase Analyzer Algorithm Human Semantic Comparison with IHSWAAD2.

FIG. 53I describes GSense, Protect Anything Human Key connected to IHSWAAD hardware mechanism algorithm for analyzing and processing related information and shows IHSWAAD1 Form Analyzer Algorithm Human Semantic Comparison with IHSWAAD2.

FIG. 53J describes GSense, Protect Anything Human Key connected to IHSWAAD hardware mechanism algorithm for analyzing and processing related information and shows GSense IHSWAAD Report Module.

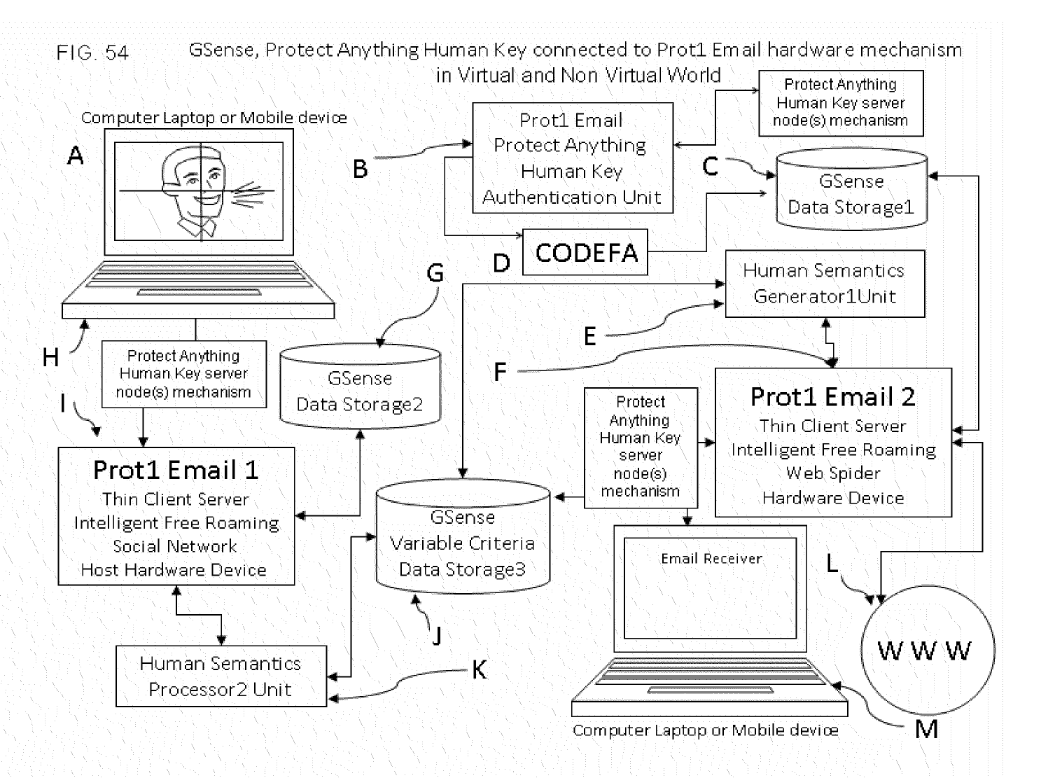

FIG. 54A describes GSense, Protect Anything Human Key connected to Prot1 Email hardware mechanism and shows the Computer Laptop or Mobile device.

FIG. 54B describes GSense, Protect Anything Human Key connected to Prot1 Email,1 hardware mechanism and shows the Prot1 Email Protect Anything Human Key Authentication Unit.

FIG. 54C describes GSense, Protect Anything Human Key connected to Prot1 Email hardware mechanism and shows the GSense Data Storage1.

FIG. 54D describes GSense, Protect Anything Human Key connected to Prot1 Email hardware mechanism and where the Protect Anything CODEFA mechanism provides storage, security; human key and tracking features are used.

FIG. 54E describes GSense, Protect Anything Human Key connected to Prot1 Email hardware mechanism and shows the Human Semantics Generator1 Unit.

FIG. 54F describes GSense, Protect Anything Human Key connected to Prot1 Email hardware mechanism and shows the Prot1 Email 2 Thin Client Server Intelligent Free Roaming Web Spider Hardware Device.

FIG. 54G describes GSense, Protect Anything Human Key connected to Prot1 Email hardware mechanism and shows the GSense Data Storage2.

FIG. 54H describes GSense, Protect Anything Human Key connected to Prot1 Email hardware mechanism and shows the Computer Laptop or Mobile device.

FIG. 54I describes GSense, Protect Anything Human Key connected to Prot1 Email hardware mechanism and shows the Prot1 Email 1 Thin Client Server Intelligent Free Roaming Social Network Host Hardware Device.

FIG. 54J describes GSense, Protect Anything Human Key connected to Prot1 Email hardware mechanism and shows the GSense Variable Criteria Data Storage3.

FIG. 54 K describes GSense, Protect Anything Human Key connected to Prot1 Email hardware mechanism and shows the Human Semantics Processor2 Unit.

FIG. 54 L describes GSense, Protect Anything Human Key connected to Prot1 Email hardware mechanism and shows where the WWW or World Wide Web is used for data aggregation and comparison analysis methods

FIG. 54M describes GSense, Protect Anything Human Key connected to Prot1 Email hardware mechanism and shows where the Email Receiver Computer Laptop or Mobile device.

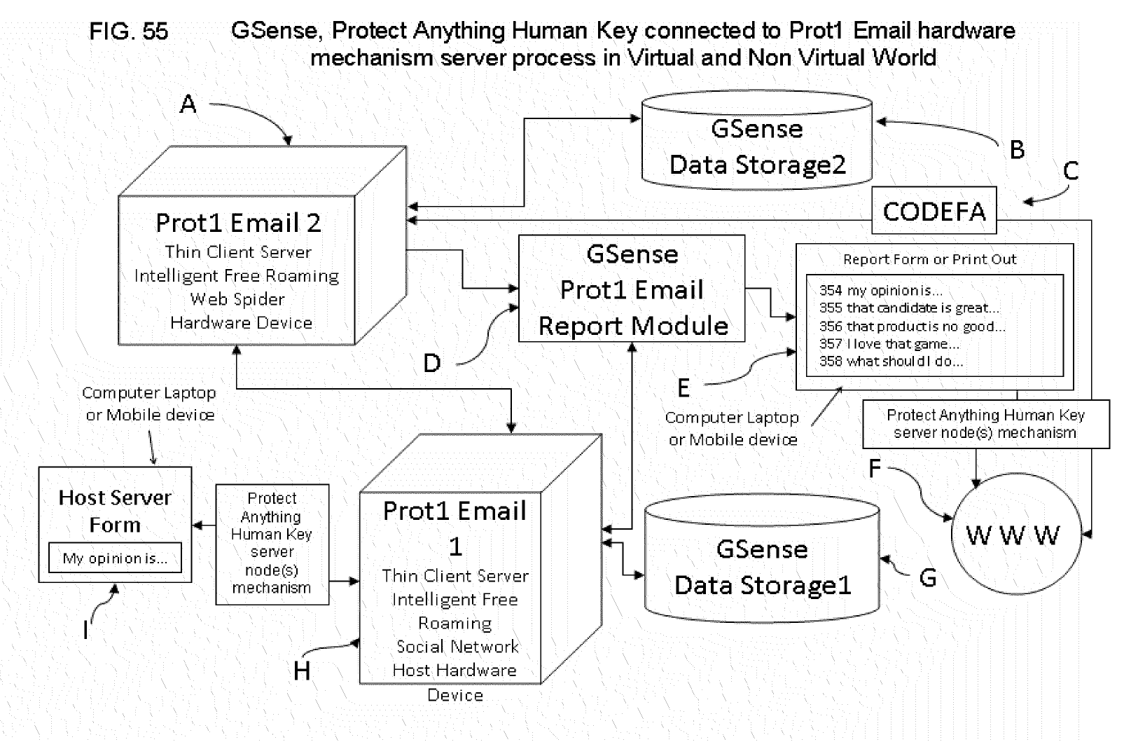

FIG. 55A describes GSense, Protect Anything Human Key connected to Prot1 Email hardware mechanism server process and shows the Prot1 Email 2Thin Client Server Intelligent Free Roaming Web Spider Hardware Device.

FIG. 55B describes GSense, Protect Anything Human Key connected to Prot1 Email hardware mechanism server process and shows the GSense Data Storage2.

FIG. 55C describes GSense, Protect Anything Human Key connected to Prot1 Email hardware mechanism server process and shows the Protect Anything CODEFA mechanism that provides storage, security, human key and tracking features.

FIG. 55D describes GSense, Protect Anything Human Key connected to Prot1 Email hardware mechanism server process and shows the GSense Prot1 Email Report Module.

FIG. 55E describes GSense, Protect Anything Human Key connected to Prot1 Email hardware mechanism server process and show˜ where the Report Form or Print Out examples of 354 my opinion is . . . 355 that candidate is great . . . 356 that product is no good . . . 357 I love that game . . . 358 what should I do . . . on a Computer Laptop or Mobile device.

FIG. 55F describes GSense, Protect Anything Human Key connected to Prot1 Email hardware mechanism server process and shows where the WWW or World Wide Web is used for data aggregation and comparison analysis methods.

FIG. 55G describes GSense, Protect Anything Human Key connected to Prot1 Email hardware mechanism server process and shows the GSense Data Storage1.

FIG. 55H describes GSense, Protect Anything Human Key connected to Prot1 Email hardware mechanism server process and •shows the Prot1 Email 1 Thin Client Server Intelligent Free Roaming Social Network Host Hardware Device.

FIG. 55I describes GSense, Protect Anything Human Key connected to Prot1 Email hardware mechanism server process and shows the Host Server Form in example; My opinion is . . . on a Computer Laptop or Mobile device.

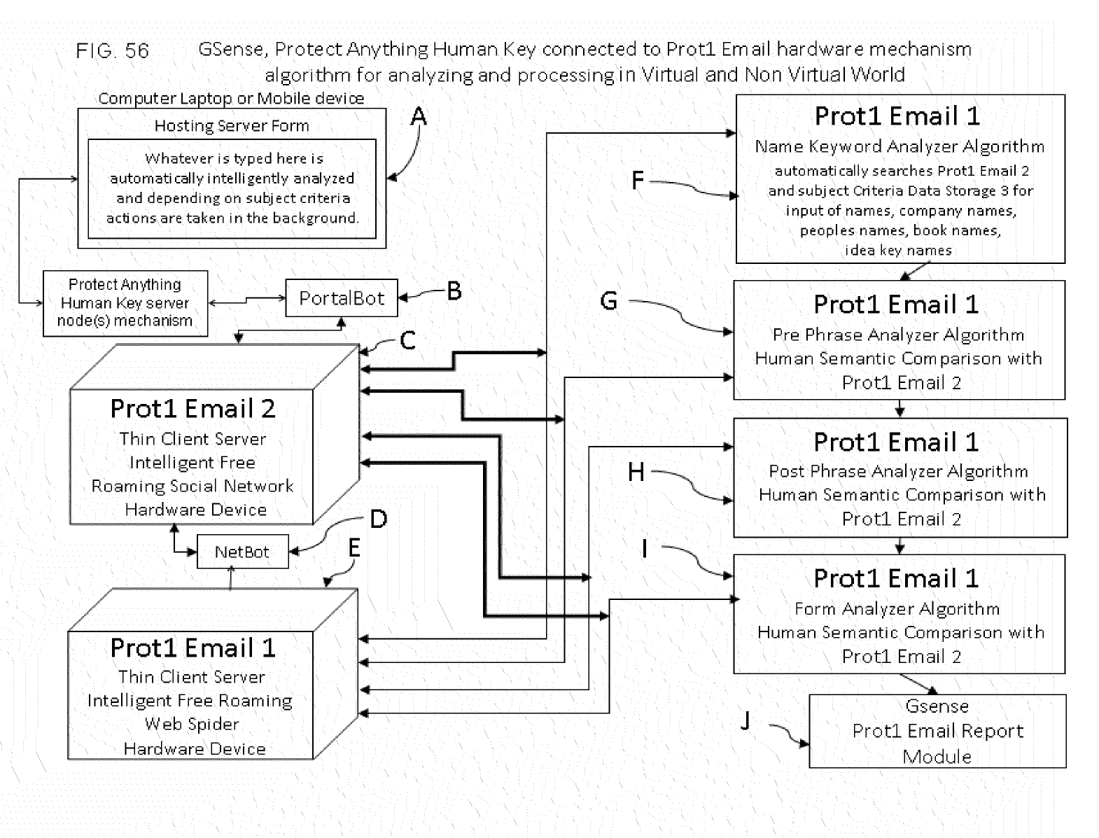

FIG. 56A describes GSense, Protect Anything Human Key connected to Prot1 Email hardware mechanism algorithm for analyzing and processing email data and shows the Computer Laptop or Mobile device Hosting Server Form Whatever is typed here is automatically intelligently analyzed and depending on subject criteria actions are taken in the background.

FIG. 56B describes GSense, Protect Anything Human Key connected to Prot1 Email hardware mechanism algorithm for analyzing and processing email data and shows the Portal Bot.

FIG. 56C describes GSense, Protect Anything Human Key connected to Prot1 Email hardware mechanism algorithm for analyzing and processing email data and shows the Prot1 Email 2 Thin Client Server Intelligent Free Roaming Social Network Hardware Device.

FIG. 56D describes GSense, Protect Anything Human Key connected to Prot1 Email hardware mechanism algorithm for analyzing and processing email data and shows the Net Bot.

FIG. 56E describes GSense, Protect Anything Human Key connected to Prot1 Email hardware mechanism algorithm for analyzing and processing email data and shows the Prot1 Email 1 Thin Client Server Intelligent Free Roaming Web Spider Hardware Device.

FIG. 56F describes GSense, Protect Anything Human Key connected to Prot1 Email hardware mechanism algorithm for analyzing and processing email data and shows the Prot1 Email 1 Name Keyword Analyzer Algorithm automatically searches Prot1 Email 2 and subject Criteria Data Storage 3 for input of names, company names, people's names, book names, idea ˜ey names.

FIG. 56G describes GSense, Protect Anything Human Key connected to Prot1 Email hardware mechanism algorithm for analyzing and processing email data and shows the Prot1 Email 1 Pre Phrase Analyzer Algorithm Human Semantic Comparison with Prot1 Email 2.

FIG. 56H describes GSense, Protect Anything Human Key connected to Prot1 Email hardware mechanism algorithm for analyzing and processing email data and shows the Prot1 Email 1 post Phrase Analyzer Algorithm Human Semantic Comparison •with Prot1 Email 2.

FIG. 56I describes GSense, Protect Anything Human Key connected to Prot1 Email hardware mechanism algorithm for analyzing and processing email data and shows the Prot1 Email 1 Form Analyzer Algorithm Human Semantic Comparison with Prot1 Email 2.

FIG. 56J describes GSense, Protect Anything Human Key connected to Prot1 Email hardware mechanism algorithm for analyzing and processing email data and shows the GSense Prot1 Email Report Module.

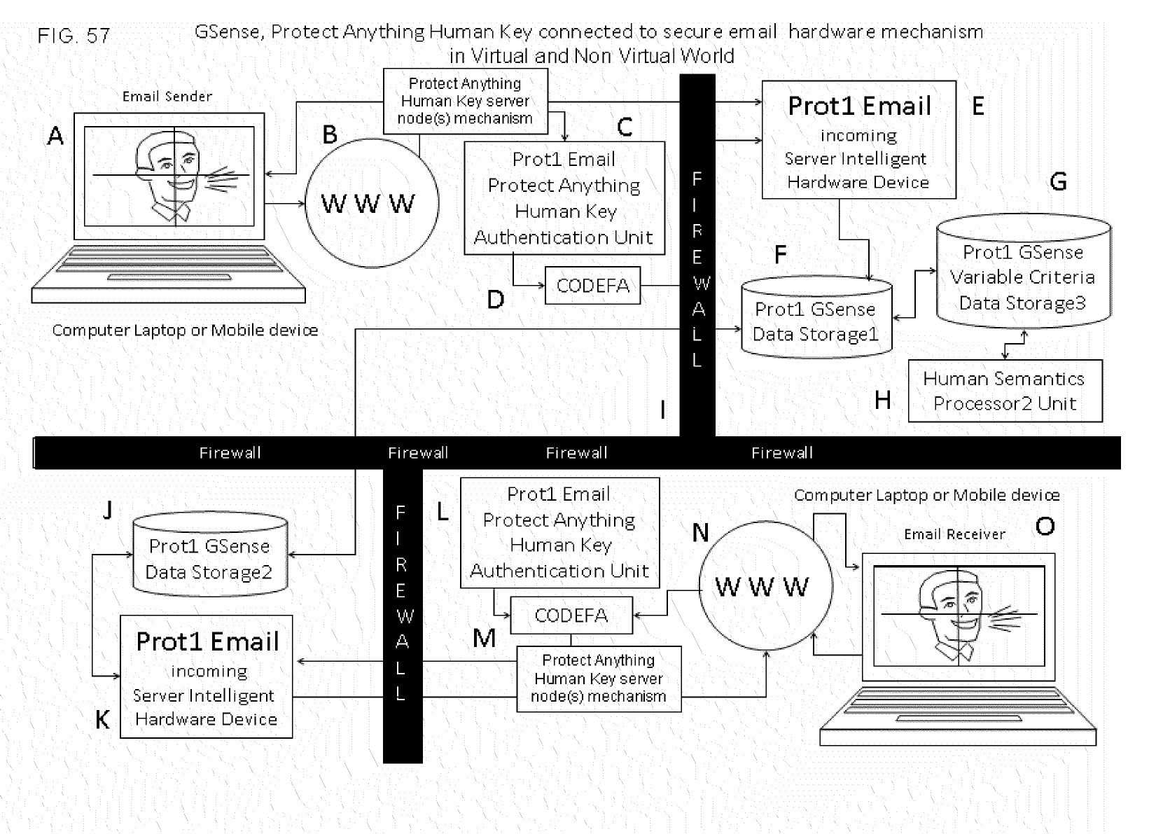

FIG. 57A describes GSense, Protect Anything Human Key connected to secure email hardware mechanism for analyzing and processing secure encrypted email data and shows the Email Sender Computer Laptop or Mobile device.

FIG. 57B describes GSense, Protect Anything Human Key connected to secure email hardware mechanism for analyzing and processing secure encrypted email data and shows the WWW or World Wide Web is used for data aggregation and comparison analysis methods.

FIG. 57C describes GSense, Protect Anything Human Key connected to secure email hardware mechanism for analyzing and processing secure encrypted email data and shows the Prot1 Email Protect Anything Human Key Authentication Unit.

FIG. 57D describes GSense, Protect Anything Human Key connected to secure email hardware mechanism for analyzing and processing secure encrypted email data and shows the Protect Anything COOEFA mechanism provides storage, security, human key and tracking features.

FIG. 57E describes GSense, Protect Anything Human Key connected to secure email hardware mechanism for analyzing and processing secure encrypted email data and shows the Prot1 Email incoming Server Intelligent Hardware Device.

FIG. 57F describes GSense, Protect Anything Human Key connected to secure email hardware mechanism for analyzing and processing secure encrypted email data and shows the Prot1 GSense Data Storage1.

FIG. 57G describes GSense, Protect Anything Human Key connected to secure email hardware mechanism for analyzing and processing secure encrypted email data and shows the Prot1 GSense Variable Criteria Data Storage3.

FIG. 57H describes GSense, Protect Anything Human Key connected to secure, email hardware mechanism for analyzing and processing secure encrypted email data and shows the Human Semantics Processor2 Unit.

FIG. 57I describes GSense, Protect Anything Human Key connected to secure email hardware mechanism for analyzing and processing secure encrypted email data and shows the firewall.

FIG. 57J describes GSense, Protect Anything Human Key connected to secure email hardware mechanism for analyzing and processing secure encrypted email data and shows the Prot1 GSense Data Storage2.

FIG. 57K describes GSense, Protect Anything Human Key connected to secure email hardware mechanism for analyzing and processing secure encrypted email data and shows the Prot1 Email incoming Server Intelligent Hardware Device.

FIG. 57L describes GSense, Protect Anything Human Key connected to secure email hardware mechanism for analyzing and processing secure encrypted email data′ and shows the Prot1 Email Protect Anything Human Key Authentication Unit.

FIG. 57M describes GSense, Protect Anything Human Key connected to secure email hardware mechanism for analyzing and processing secure encrypted email data and shows the Protect Anything CODEFA mechanism provides storage, security, human key and tracking features.

FIG. 57N describes GSense, Protect Anything Human Key connected to secure email hardware mechanism for analyzing and processing secure encrypted email data and shows the WWW or World Wide Web is used for data aggregation and comparison analysis methods.

FIG. 57O describes GSense, Protect Anything Human Key connected to secure” email hardware mechanism for analyzing and processing secure encrypted email data and shows the Computer Laptop or Mobile device Email Receiver.

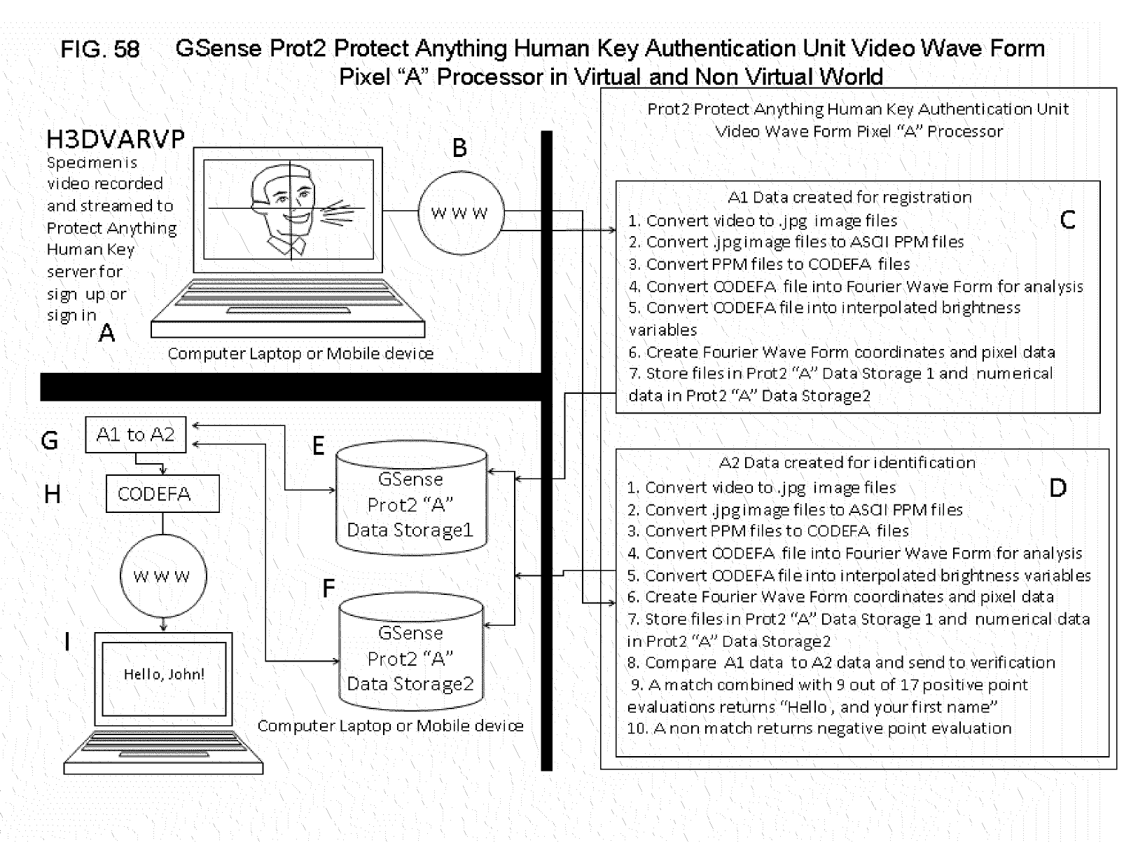

FIG. 58A describes GSense Prot2 Protect Anything Human Key Authentication Unit Video Fourier wave form Pixel “A” Processor with H3DVARV 3D Human Video Audio Stereo Viewing and Recording Mechanism and shows how the Specimen is video recorded and streamed to Protect Anything Human Key server for sign up or sign in Computer Laptop, or Mobile device.

FIG. 58B describes GSense Prot2 Protect Anything Human Key Authentication Unit Video Fourier wave form Pixel “A” Processor and shows how the WWW or World Wide Web is used for data aggregation and comparison analysis methods.

FIG. 58C describes GSense Prot2 Protect Anything Human Key Authentication Unit Video Fourier wave form Pixel “A” Processor and shows where the Prot2 Protect Anything Human Key Authentication Unit Video Fourier wave form Pixel “A” Processor A1 Data created for registration mechanism, 1. Converts video to .jpg image files, 2. Converts .jpg image files to ASCII PPM files, 3. Converts PPM files to Protect Anything CODEFA mechanism provides storage, security, human key and tracking features files, 4. Converts Protect Anything CODEFA mechanism provides storage, security, human key and tracking features file into Fourier wave form for analysis, 5. Converts Protect Anything CODEFA mechanism provides storage, security, human key and tracking features file into interpolated brightness variables, 6. Creates Fourier wave form coordinates and pixel data, 7. Stores files in Prot2 “A” Data Storage 1 and numerical data in Prot2 “A” Data Storage2.

FIG. 58D describes GSense Prot2 Protect Anything Human Key Authentication Unit Video Fourier wave form Pixel “A” Processor and shows where the Prot2 Protect Anything Human Key Authentication Unit Video Fourier wave form Pixel “A” Processor A2 Data created for identification mechanism, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “A” Data Storage 1 and numerical data in Prot2 “A” Data Storage 2, 8. Compares A 1 data to A2 data and send to verification, 9. Where A match combined with 9 out of 16 positive point evaluations returns “Hello, and your first name”, 10. Where a non match returns negative point evaluation.

FIG. 58E describes GSense Prot2 Protect Anything Human Key Authentication Unit Video Fourier wave form Pixel “A” Processor and shows the GSense Prot2 “A” Data Storage1.

FIG. 58-F describes GSense Prot2 Protect Anything Human Key Authentication Unit Video Fourier wave form Pixel “A” Processor and shows the GSense Prot2 “A” Data Storage2.

FIG. 58G describes GSense Prot2 Protect Anything Human Key Authentication Unit Video Fourier wave form Pixel “A” Processor and shows the A1 to A2 Pattern matching and Comparison Processor Mechanism that analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 58H describes GSense Prot2 Protect Anything Human Key Authentication Unit Video Fourier wave form Pixel “A” Processor and shows the Protect Anything CODEFA mechanism that provides storage, security, human key and tracking features.

FIG. 58I describes GSense Prot2 Protect Anything Human Key Authentication Unit Video Fourier wave form Pixel “A” Processor and shows where the WWW or World Wide Web is used for data aggregation and comparison analysis methods “Hello, John” in Computer Laptop or Mobile device.

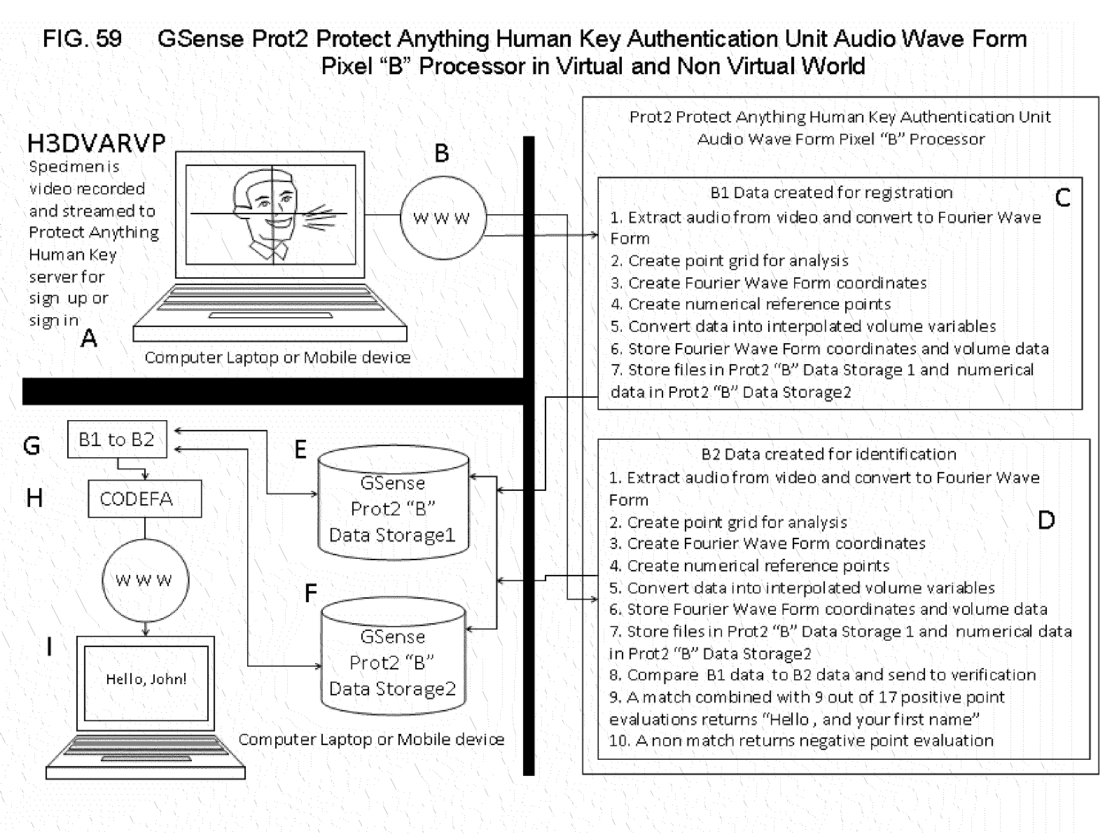

FIG. 59A describes GSense Prot2 Protect Anything Human Key Authentication Unit Audio Fourier wave form Pixel “B” Processor with H3DVARV 3D Human Video Audio Stereo Viewing and Recording Mechanism and shows where the Specimen is video recorded and streamed to Protect Anything Human Key server for sign up or sign in Computer Laptop or Mobile device.

FIG. 59B describes GSense Prot2 Protect Anything Human Key Authentication Unit Audio Fourier wave form Pixel “B” Processor and shows where the WWW or World Wide Web is used for data aggregation and comparison analysis methods.

FIG. 59C describes GSense Prot2 Protect Anything Human Key Authentication Unit Audio Fourier wave form Pixel “B” Processor and shows where the Prot2 Protect Anything Human Key Authentication Unit Audio Fourier wave form Pixel “B” Processor B1 Data created for registration mechanism, 1. Extracts audio from video and convert to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data, 7. Stores files in Prot2 “B” Data Storage 1 and numerical data in Prot2 “B” Data Storage2.

FIG. 59D describes GSense Prot2 Protect Anything Human Key Authentication Unit Audio Fourier wave form Pixel “B” Processor and shows where the Prot2 Protect Anything Human Key Authentication Unit Audio Fourier wave form Pixel “B” Processor B2 Data created for identification mechanism, 1. Extracts audio from video and convert to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data, 7. Stores files in Prot2 “B” Data Storage 1 and numerical data in Prot2 “B” Data Storage2, 8. Compares B1 data to B2 data and send to verification, 9. Where a match combined with 9 out of 16 positive point evaluations returns “Hello, and your first name”, 10. And where a non match returns negative point evaluation.

FIG. 59E describes GSense Prot2 Protect Anything Human Key Authentication Unit Audio WaveForm Pixel “B” Processor and shows the GSense Prot2 “B” Data Storage1.

FIG. 59F describes GSense Prot2 Protect Anything Human Key Authentication Unit Audio Fourier wave form Pixel “B” Processor and shows the GSense Prot2 “B” Data Storage2.

FIG. 59G describes GSense Prot2 Protect Anything Human Key Authentication Unit Audio Fourier wave form Pixel “B” Processor and shows where the B1 to B2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 59H describes GSense Prot2 Protect Anything Human Key Authentication Unit Audio Fourier wave form Pixel “B” Processor and shows the Protect Anything CODEFA mechanism that provides storage, security, human key and tracking features.

FIG. 59I describes GSense Prot2 Protect Anything Human Key Authentication Unit Audio Fourier wave form Pixel “B” Processor and shows where the WWW or world wide web is used for data aggregation and comparison analysis methods Hello, John! In Computer Laptop or Mobile device.

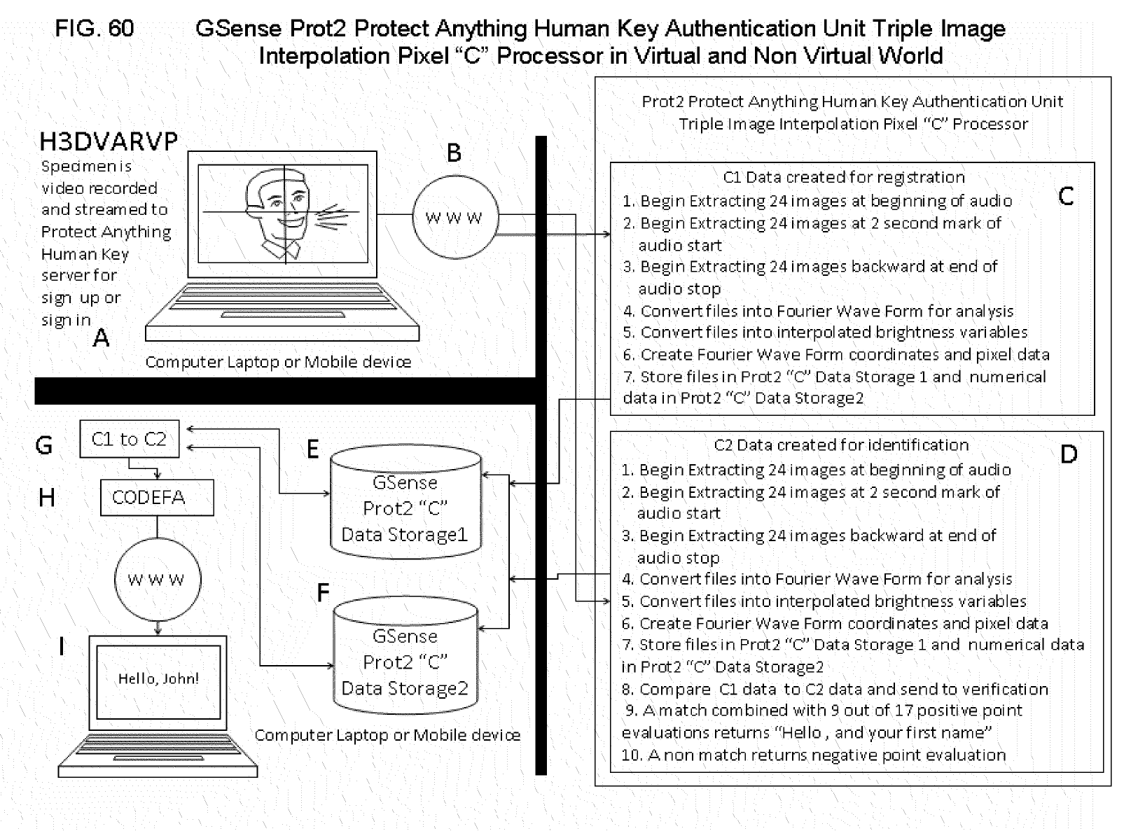

FIG. 60A describes GSense Prot2.Protect Anything Human Key, Authentication Unit Triple Image Interpolation Pixel “C” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 60B describes GSense Prot2 Protect Anything Human Key Authentication Unit Triple Image Interpolation Pixel “C” Processor and shows where the WWW or World Wide Web is used for data aggregation and comparison analysis methods.

FIG. 60C describes GSense Prot2 Protect Anything Human Key Authentication Unit Triple Image Interpolation Pixel “C” Processor and shows where the Prot2 Protect Anything Human Key Authentication Unit Triple Image Interpolation Pixel “C” Processor C1 Data created for registration, 1. Begins Extracting 24 images at beginning of audio, 2. Begins Extracting 24 images at 2 second mark of audio start, 3. Begins Extracting 24 images backward at end of audio stop, 4. Converts files into Fourier wave form for analysis, 5. Converts files into interpolated brightness variables, 6. Creates Fourier wave form coordinates and pixel data, 7. Stores files in Prot2 “C” Data Storage 1 and numerical data in Prot2 “C” Data Storage 2.

FIG. 60D describes GSense Prot2 Protect Anything Human Key Authentication Unit Triple Image Interpolation Pixel “C” Processor and shows where the Prot2 Protect Anything Human Key Authentication Unit Triple Image Interpolation Pixel “C” Processor C2 Data created for identification, 1. Begins Extracting 24 images at beginning of audio, 2. Begins Extracting 24 images at 2 second mark of audio start, 3. begins Extracting 24 images, backward at end of audio stop, 4. converts files into Fourier wave form for analysis, 5. converts files into interpolated brightness variables, 6. creates Fourier wave form coordinates and pixel data, 7. stores files in Prot2 “G” Data Storage 1 and numerical data in Prot2 “C” Data Storage2, 8. Compares G1 data to G2 data arid send to verification, 9. where a match combined with 9 out of 16 positive point evaluations returns “Hello, and your first name”, 10. where a non match ‘returns negative point evaluation.

FIG. 60E describes GSense Prot2 Protect Anything Human Key Authentication Unit Triple Image Interpolation Pixel “C” Processor and shows the GSense Prot2 “G” Data Storage1.

FIG. 60F describes GSense Prot2 Protect Anything Human Key Authentication Unit Triple Image Interpolation Pixel “C” Processor and shows the GSense Prot2 “C” Data Storage2.

FIG. 60G describes GSense Prot2 Protect Anything Human Key Authentication Unit Triple Image Interpolation Pixel “C” Processor and shows where the C1 to C2 pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 60H describes GSense Prot2 Protect Anything Human Key Authentication Unit Triple Image Interpolation Pixel “C” Processor and shows where the Protect Anything CODEFA mechanism that provides storage, security, human key and tracking features.

FIG. 60I describes GSense Prot2 Protect Anything Human Key Authentication Unit Triple Image Interpolation Pixel “C” Processor and shows where the WWW or World Wide Web is used for data aggregation and comparison analysis methods Hello, John! in computer Laptop or Mobile device.

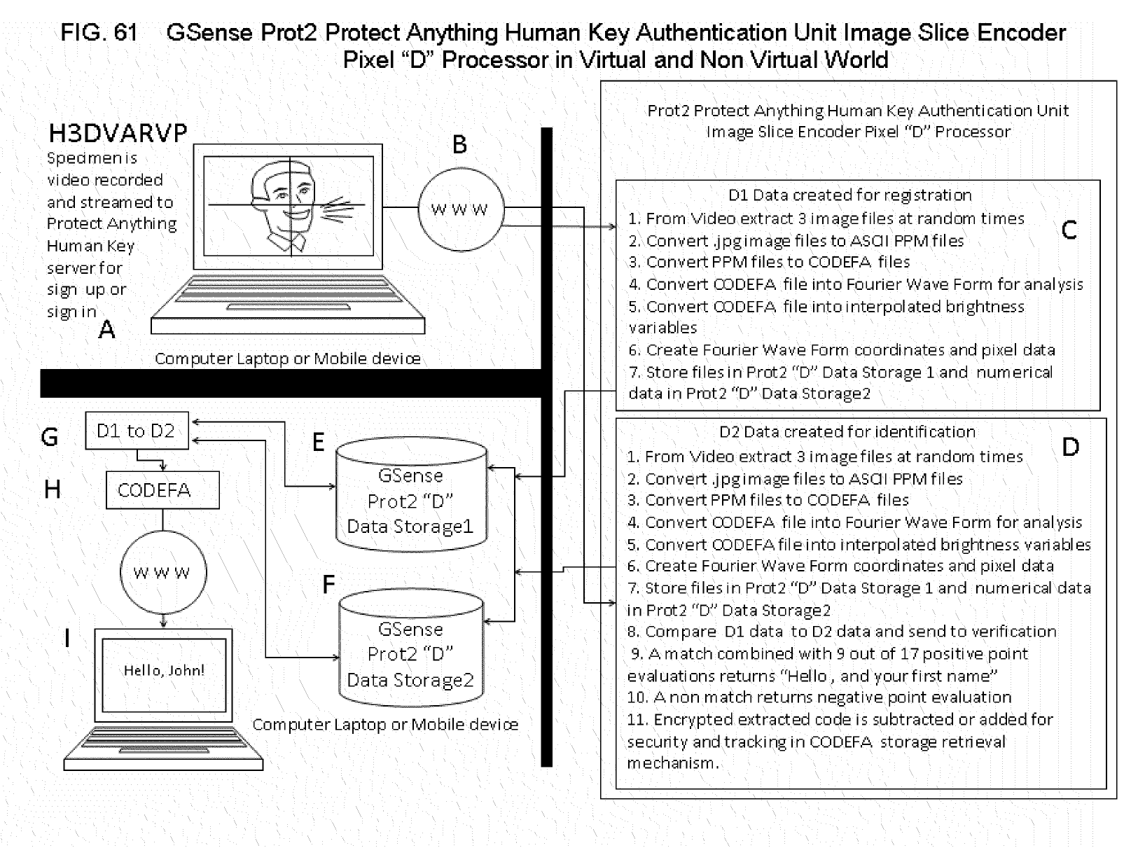

FIG. 61A describes GSense Prot2 Protect Anything Human Key, Authentication Unit Image Slice Encoder Pixel “D” Processor, with H3DVARV 3D Human Video Audio Stereo Viewing, and Recording Mechanism, and shows where the Specimen video is recorded, and streamed to Protect Anything Human Key server for sign up or sign in Computer Laptop or Mobile device.

FIG. 61B describes GSense Prot2 Protect Anything Human Key Authentication Unit Image Slice Encoder Pixel “D” Processor and shows where the WWW or World Wide Web is used for data aggregation and comparison analysis methods.

FIG. 61C describes GSense Prot2 Protect Anything Human Key Authentication Unit Image Slice Encoder Pixel “D” Processor and shows where the Prot2 Protect Anything Human Key Authentication Unit Image Slice Encoder Pixel “D” Processor D1 Data created for registration, 1. from Video extracts 3 image files at random times, 2. converts .jpg image files to ASCII PPM files, 3. converts PPM files to Protect Anything CODEFA mechanism that provides storage, security, human key and tracking features files, 4. converts Protect Anything CODEFA mechanism that provides storage, security, human key′ and tracking features file into Fourier wave form for analysis, 5. converts Protect Anything COOEFA mechanism that provides storage, security, human key and tracking features file into interpolated brightness variables, 6. creates Fourier wave form coordinates and pixel data, 7. stores files in Prot2 “D” Data Storage 1. and numerical data in Prot2 “D” Data Storage2.

FIG. 61D describes GSense Prot2 Protect Anything Human Key Authentication Unit Image Slice Encoder Pixel “D” Processor and shows where the Prot2 Protect Anything Human Key Authentication Unit Image Slice Encoder Pixel “D” Processor. D2 Data created for identification, 1. From Video extracts 3 image files at random times, 2. Converts .jpg image files to ASCII PPM files, 3. Converts PPM files to Protect Anything COOEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “D” Data Storage 1 and numerical data in Prot2 “D” Data Storage 2, 8. Compares D1 data to D2 data and send to verification, 9. Where a match combined with 9 out of 16 positive point evaluations returns “Hello, and your first name”, 10. Where a non match returns negative point evaluation, 11. Where encrypted extracted code is subtracted or added for security and tracking in the Protect Anything CODEFA mechanism that provides storage, security, human key and tracking features storage retrieval mechanism.

FIG. 61E describes GSense Prot2 Protect Anything Human Key Authentication Unit Image Slice Encoder Pixel “D” Processor and shows the GSense Prot2 “D” Data Storage1.

FIG. 61F describes GSense Prot2 Protect Anything Human Key Authentication Unit. Image Slice Encoder Pixel “D” Processor and shows the GSense Prot2 “D” Data Storage2.

FIG. 61G describes GSense Prot2 Protect Anything Human Key Authentication Unit Image Slice Encoder Pixel “D” Processor and shows where the D1 to D2 Pattern matching and Comparison Processor Mechanism analyzes the data utilizing one or all of these analysis mechanisms including maximum distance analysis, mean distance analysis, mathematical error/data fit analysis; average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 61H describes GSense Prot2 Protect Anything Human Key Authentication Unit Image Slice Encoder Pixel “D” Processor and shows the Protect Anything CODEFA mechanism that provides storage, security, human key and tracking features.

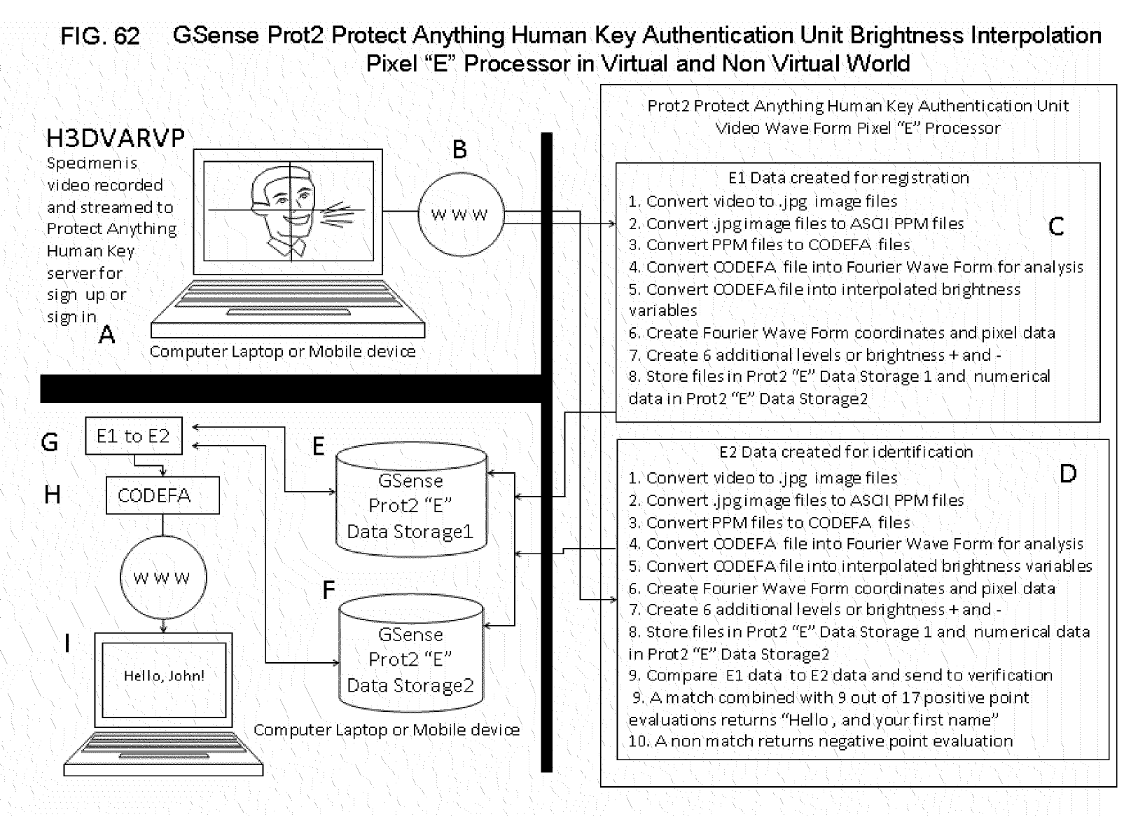

FIG. 62I describes GSense Prot2 Protect Anything Human Key Authentication Unit Image Slice Encoder Pixel “D” Processor and shows where the WWW or World Wide Web is used for data aggregation and comparison analysis methods Hello, John! in Computer Laptop, or Mobile device.

FIG. 62A describes GSense Prot2 Protect Anything Human Key Authentication Unit Brightness Interpolation Pixel “E” Processor with H30VARV 30 Human Video Audio Stereo Viewing and Recording Mechanism and shows where the Specimen video is recorded and streamed to Protect Anything Human Key server for sign up or sign in Computer Laptop or Mobile device.

FIG. 62B describes GSense Prot2 Protect Anything Human Key Authentication Unit Brightness Interpolation Pixel “E” Processor and shows where the WWW or World Wide Web is used for data aggregation and comparison analysis methods.

FIG. 62C describes GSense Prot2 Protect Anything Human Key Authentication Unit Brightness Interpolation Pixel “E” Processor and shows where the Prot2 Protect Anything Human Key Authentication Unit Video Fourier wave form Pixel “E” ProcessorE1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Creates 6 additional levels or brightness + and −, 8. Stores files in Prot2 “E” Data Storage 1 and numerical data in Prot2 “E” Data Storage2.

FIG. 62D describes GSense Prot2 Protect Anything Human Key Authentication Unit Brightness Interpolation Pixel “E” Processor and shows where the Prot2 Protect Anything Human Key Authentication Unit Video Fourier wave form Pixel “E” Processor E2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7: Creates 6 additional levels or brightness + and −, 8. Stores files in Prot2 “E” ‘Data Storage 1 and numerical data in Prot2 “E” Data Storage 2, 9. Compares E1 data to E2 data and send to verification, 9. Where a match combined with 9 out of 16 positive point evaluations returns “Hello, and your first name”, 10. Where a non match returns negative point evaluation.

FIG. 62E describes GSense Prot2 Protect Anything Human Key Authentication Unit Brightness Interpolation Pixel “E” Processor and shows the GSense Prot2 “E” Data Storage1.

FIG. 62F describes GSense Prot2 Protect Anything Human, Key Authentication Unit Brightness Interpolation Pixel “E” Processor and shows the GSense Prot2 “E” Data Storage2.

FIG. 158-G describes GSense Prot2 Protect Anything Human Key Authentication Unit Brightness Interpolation Pixel “E” Processor and shows where the E1 to E2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 62H describes GSense Prot2 Protect Anything Human Key Authentication Unit Brightness Interpolation Pixel “E” Processor and shows the Protect Anything CODEFA mechanism that provides storage, security, human key and tracking features.

FIG. 62I describes GSense Prot2 Protect Anything Human Key Authentication Unit Brightness Interpolation Pixel “E” Processor and shows where the WWW or World Wide Web is used for data aggregation and comparison analysis methods Hello, John! Computer Laptop, or Mobile device.

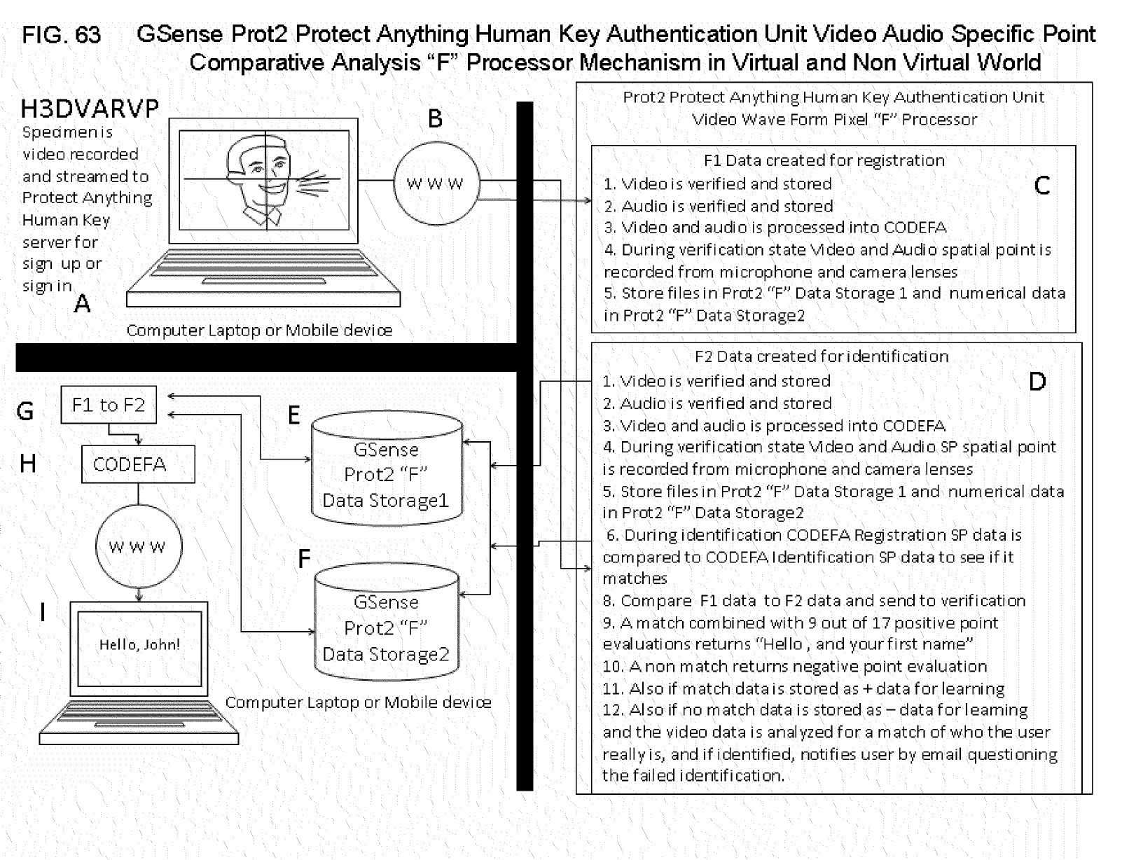

FIG. 63A describes GSense Prot2 Protect Anything Human Key Authentication Unit Video Audio Specific Point Comparative Analysis “F” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 63B describes GSense Prot2 Protect Anything Human Key Authentication Unit Video Audio Specific Point Comparative Analysis “F” Processor Mechanism and shows where the WWW or World Wide Web is used for data aggregation and comparison analysis methods.

FIG. 63C describes GSense Prot2 Protect Anything Human Key Authentication Unit Video Audio Specific Point Comparative Analysis “F” Processor Mechanism and shows where the Prot2 Protect Anything Human Key Authentication Unit Video Fourier wave form Pixel “F” Processor F1 Data created for registration, 1. Video is verified and stored, 2. Audio is verified and stored, 3. Video and audio is processed into CODEFA, 4. During verification state Video and Audio spatial point is recorded from microphone and camera lenses, 5. Stores files in Prot2 “F” Data Storage 1 and numerical data in Prot2. “F” Data Storage2.

FIG. 63D describes GSense Prot2 Protect Anything Human Key Authentication Unit Video Audio Specific Point Comparative Analysis “F” Processor Mechanism and shows where the Prot2 Protect Anything Human Key Authentication Unit Video Fourier wave form Pixel “F” Processor F2 Data created for identification, 1. Video is verified and stored, 2. Audio is verified and stored, 3. Video and audio is processed into CODEFA, 4. During verification state Video and Audio SP spatial point is recorded from microphone and camera lenses, 5. Store files in Prot2 “F” Data Storage 1 and numerical data in Prot2 “F” Data Storage2, 6. During identification CODEFA Registration SP data is compared to CODEFA Identification SP data to see if it matches, 8. Compare F1 data to F2 data and send to verification, 9. Where a match combined with 9 out of 16 positive point evaluations returns “Hello, and your first name”, 10. Where a non match returns negative point evaluation, 11. Also if match data is stored as +data for learning 12. Also if no match data is stored as −data for learning and the video data is analyzed for a match of who the user really is, and if identified, notifies user by email questioning the failed identification.

FIG. 63E describes GSense Prot2 Protect Anything Human Key Authentication Unit .Video Audio Specific Point Comparative Analysis “F” Processor Mechanism and shows the GSense Prot2 “F” Data Storage1.

FIG. 63F describes GSense Prot2 Protect Anything Human Key Authentication Unit Video Audio Specific Point Comparative Analysis “F” Processor Mechanism and shows the GSense Prot2 “F” Data Storage2.

FIG. 63G describes GSense Prot2 Protect Anything Human Key Authentication Unit Video Audio Specific Point Comparative Analysis “F” Processor Mechanism and shows where the F1 to F2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 63H describes GSense Prot2 Protect Anything Human Key Authentication Unit Video Audio Specific Point Comparative Analysis “F” Processor Mechanism and shows the Protect Anything CODEFA mechanism that provides storage, security, human key and tracking features.

FIG. 63I describes GSense Prot2 Protect Anything Human Key Authentication Unit Video Audio Specific Point Comparative Analysis “F” Processor Mechanism and shows where the WWW or World Wide Web is used for data aggregation and comparison analysis methods Hello, John! Computer Laptop, or Mobile device.

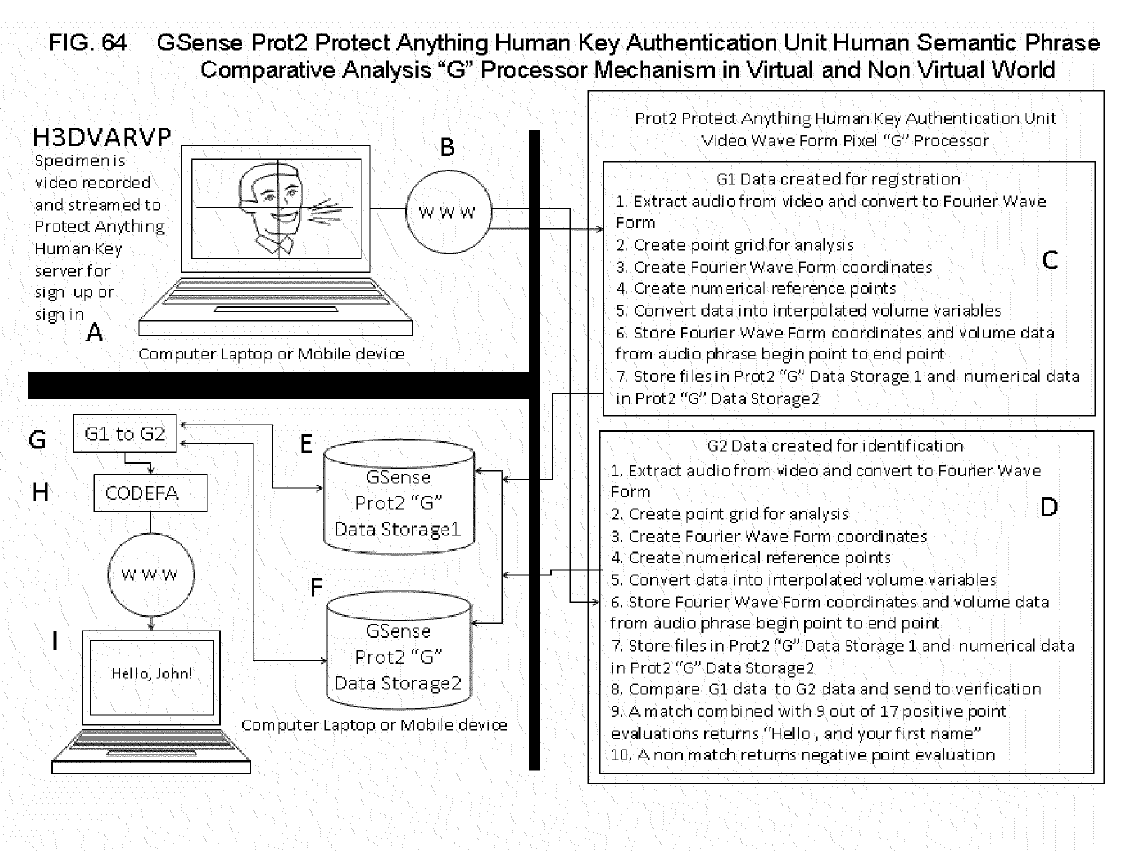

FIG. 64A describes GSense Prot2 Protect Anything Human Key Authentication Unit Human Semantic Phrase Comparative Analysis “G” Processor Mechanism with. H3DVARV 3D Human Video Audio Stereo Viewing and Recording Mechanism and shows where the Specimen video is recorded and streamed to Protect Anything Human Key server for sign up or sign in Computer Laptop or Mobile device

FIG. 64B describes GSense Prot2 Protect Anything Human Key Authentication Unit Human Semantic Phrase Comparative Analysis “G” Processor Mechanism and shows where the WWW or World. Wide Web is used for data aggregation and comparison analysis methods.

FIG. 64C describes GSense Prot2 Protect Anything Human Key Authentication Unit Human Semantic Phrase Comparative Analysis “G” Processor Mechanism and where the Prot2 Protect Anything Human Key Authentication Unit Video Fourier wave form Pixel “G” Processor G1 Data created for registration, 1. Extracts audio from video and converts to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data from audio phrase begin point to end point, 7. Stores files in Prot2 “G” Data Storage 1 and numerical data in Prot2 “G” Data Storage 2.

FIG. 64D describes GSense Prot2 Protect Anything Human Key Authentication Unit Human Semantic Phrase Comparative Analysis “G” Processor Mechanism and shows where the Prot2 Protect Anything Human Key Authentication Unit Video Fourier wave form Pixel “G” Processor G2 Data created for identification, 1. Extracts audio from video and converts to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data from audio phrase begin point to end point, 7. Stores files in Prot2 “G” Data Storage 1 and numerical data in Prot2 “G” Data Storage 2, 8. Compares G1 data to G2 data and send to verification, 9. Where a match combined with 9 out of 16 positive point evaluations returns “Hello, and your first name”, 1 O. Where a non match returns negative point evaluation.

FIG. 64E describes GSense Prot2 Protect Anything Human Key Authentication Unit Human Semantic Phrase Comparative Analysis “G” Processor Mechanism and shows the GSense Prot2 “G” Data Storage 1.

FIG. 64F describes GSense Prot2 Protect Anything Human Key Authentication Unit Human Semantic Phrase Comparative Analysis “G” Processor Mechanism and shows the GSense Prot2 “G” Data Storage2.

FIG. 64G describes GSense Prot2 Protect Anything Human Key Authentication Unit Human Semantic Phrase Comparative Analysis “G” Processor Mechanism and shows where the G1 to G2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 64H describes GSense Prot2 Protect Anything Human Key Authentication Unit Human Semantic Phrase Comparative Analysis “G” Processor Mechanism and shows the Protect Anything CODEFA mechanism that provides storage, security, human key and tracking features.

FIG. 64I describes GSense Prot2 Protect Anything Human Key Authentication Unit Human Semantic Phrase Comparative Analysis “G” Processor Mechanism and shows where the WWW or World Wide Web is used for data aggregation and comparison analysis methods Hello, John! Computer Laptop, or Mobile device.

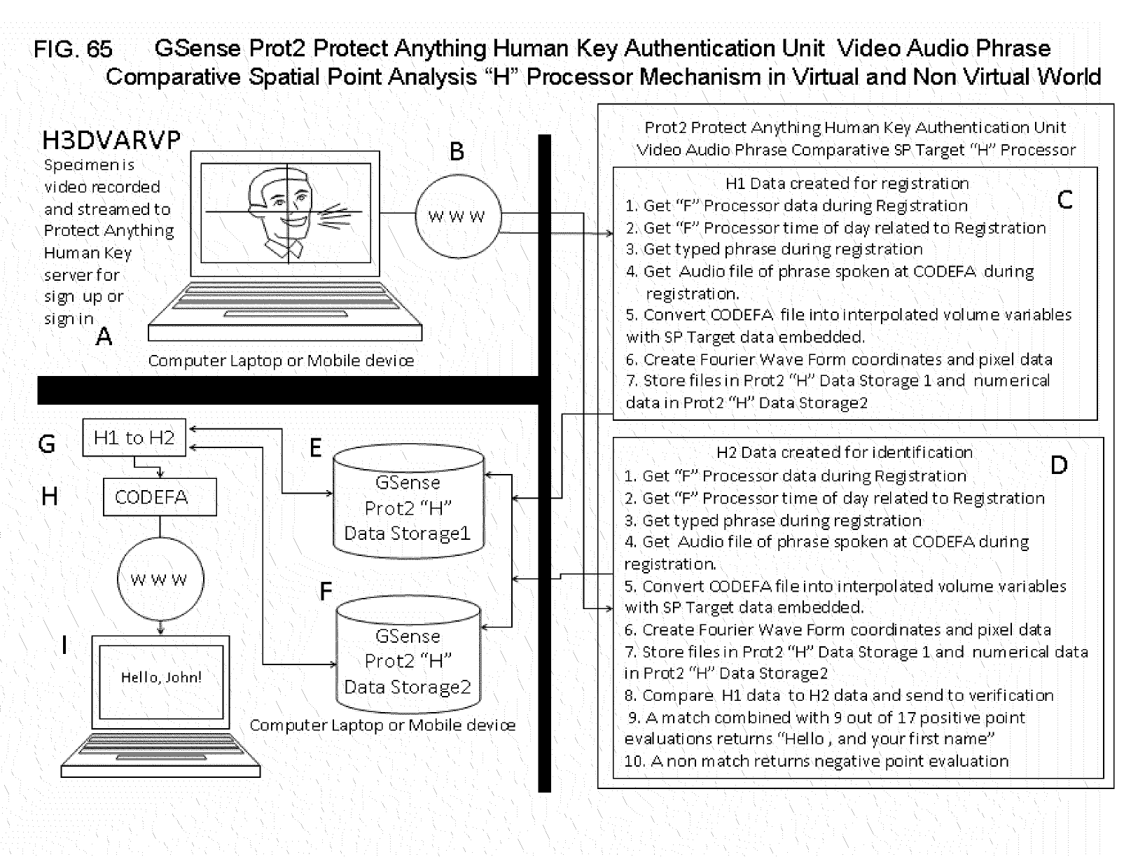

FIG. 65A describes GSense Prot2 Protect Anything Human Key Authentication Unit Video Audio Text Comparative Spatial Point Analysis “H” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 65B describes GSense Prot2 Protect Anything Human Key Authentication Unit Video Audio Text Comparative Spatial Point Analysis “H” Processor Mechanism and shows where the WWW or World Wide Web is used for data aggregation and comparison analysi˜ methods.

FIG. 65C describes GSense Prot2 Protect Anything Human Key Authentication Unit Video Audio Text Comparative Spatial Point Analysis “H” Processor Mechanism and shows where the Prot2 Protect Anything Human Key Authentication Unit Video Audio Text Comparative SP Target “H” Processor H1 Data created for registration, 1. Gets “F” Processor data, during Registration, 2. Gets “F” Processor time of day related to Registration, 3. Gets typed phrase during registration, 4. Gets Audio file of phrase spoken at Protect Anything CODEFA mechanism that provides storage, security, human key and tracking features during registration, 5. Converts Protect Anything CODEFA mechanism that provides storage, security, human key and tracking features file into interpolated volume variables with SP Target data embedded, 6. Creates Fourier wave form coordinates and pixel data, 7. Stores files in Prot2 “H” Data Storage 1 and numerical data in Prot2 “H” Data Storage2.

FIG. 65D describes GSense Prot2 Protect Anything Human Key Authentication Unit Video Audio Text Comparative Spatial P18 int Analysis “H” Processor Mechanism and shows where the Prot2 Protect Anything Human Key Authentication Unit Video Audio Text Comparative SP Target “H” Processor H2 Data created for identification, 1. Gets “F” Processor data during Registration, Gets “F” Processor time of day related to Registration, 3. Gets typed phrase during registration, 4. Gets Audio file of phrase spoken at Protect Anything CODEFA mechanism that provides storage, security, human key and tracking features during registration, 5. Converts Protect Anything CODEFA mechanism that provides storage, security, human key and tracking features file into interpolated volume variables with SP Target data embedded, 6. Creates Fourier wave form coordinates and pixel data, 7. Stores files in Prot2 “H” Data Storage 1 and numerical data in Prot2 “H” Data Storage2, 8. Compares H1 data to H2 data and send to verification, 9. Where a match combined with 9 out of 16 positive point evaluations returns “Hello, and your first name”, 10. Where a non match returns negative point evaluation.

FIG. 65E describes GSense Prot2 Protect Anything Human Key Authentication Unit Video Audio Text Comparative Spatial Point Analysis “H” Processor Mechanism and shows the GSense Prot2 “H” Data Storage 1.

FIG. 65F describes GSense Prot2 Protect Anything Human Key Authentication Unit Video Audio Text Comparative Spatial Point Analysis “H” Processor Mechanism and shows the GSense Prot2 “H” Data Storage 2.

FIG. 65G describes GSense Prot2 Protect Anything Human Key Authentication Unit Video Audio Text Comparative Spatial Point Analysis “H” Processor Mechanism and shows where the H1 to H2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 65H describes GSense Prot2 Protect Anything Human Key Authentication Unit Video Audio Text Comparative Spatial Point Analysis “H” Processor Mechanism and shows the Protect Anything CODEFA mechanism that provides storage, security, human key and tracking features.

FIG. 65I describes GSense Prot2 Protect Anything Human Key Authentication Unit Video Audio Text Comparative Spatial Point Analysis “H” Processor Mechanism and shows where the WWW or World Wide Web is used for data aggregation and comparison analysis methods Hello, John! Computer Laptop, or Mobile device.

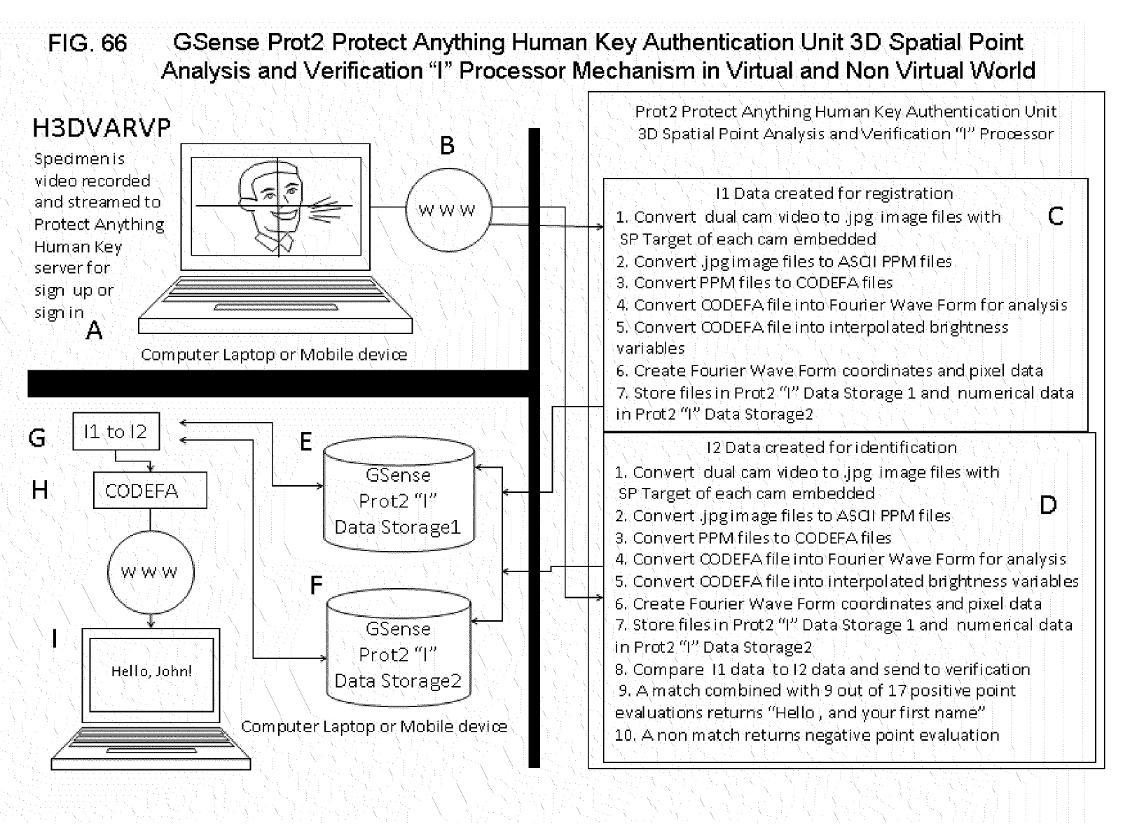

FIG. 66A describes GSense Prot2 Protect Anything Human Key Authentication Unit 3D Spatial Point Analysis and Verification “I” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 66B describes GSense Prot2 Protect Anything Human Key Authentication Unit 3D Spatial Point Analysis and Verification “I” Processor Mechanism and shows where the WWW or World Wide Web is used for data aggregation and comparison analysis methods.

FIG. 66C describes GSense Prot2 Protect Anything Human Key Authentication Unit 3D Spatial Point Analysis and Verification “I” Processor Mechanism and shows where the Prot2 Protect Anything Human Key Authentication Unit 3D Spatial Point Analysis and Verification “I” Processor 11 Data created for registration, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “I” Data Storage 1 and numerical data in Prot2 “I” Data Storage2.

FIG. 66D describes GSense Prot2 Protect Anything Human Key Authentication Unit 3D'Spatial Point Analysis and Verification “I” Processor Mechanism and shows where the Prot2 Protect Anything Human Key Authentication Unit 3D Spatial Point Analysis and Verification “I” Processor 12 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form Fourier analysis, 5. Converts Protect Anything CODEFA mechanism that provides storage, security, human key and tracking features file into interpolated brightness variables, 6. Creates Fourier wave form coordinates and pixel data, 7. Stores files in Prot2, “I” Data Storage 1 and numerical data in Prot2 “I” Data Storage2, 8. Compares 11 data to 12 data and send to verification, 9. Where a match combined with 9 out of 16 positive point evaluations returns “Hello, and your first name”, 1 O. Where a non match returns negative point evaluation.

FIG. 66E describes GSense Prot2 Protect Anything Human Key Authentication Unit 3D Spatial Point Analysis and Verification “I” Processor Mechanism and shows the GSense Prot2 “I” Data Storage1.

FIG. 66F describes GSense Prot2 Protect Anything Human Key Authentication Unit 3D Spatial Point Analysis and Verification “I” Processor Mechanism and shows the GSense Prot2 “I” Data Storage2.

FIG. 66G describes GSense Prot2 Protect Anything Human Key Authentication Unit 3D Spatial Point Analysis and Verification “I” Processor Mechanism and shows where the 11 to 12 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 66H describes GSense Prot2 Protect Anything Human Key Authentication Unit 3D Spatial Point Analysis and Verification “I” Processor Mechanism and shows the Protect Anything CODEFA mechanism that provides storage, security, human key and tracking features:

FIG. 66I describes GSense Prot2 Protect Anything Human Key Authentication Unit 3D Spatial Point Analysis and Verification “I” Processor Mechanism and shows where the WWW or World Wide Web is used for data aggregation and comparison analysis methods Hello, John! Computer Laptop or Mobile device.

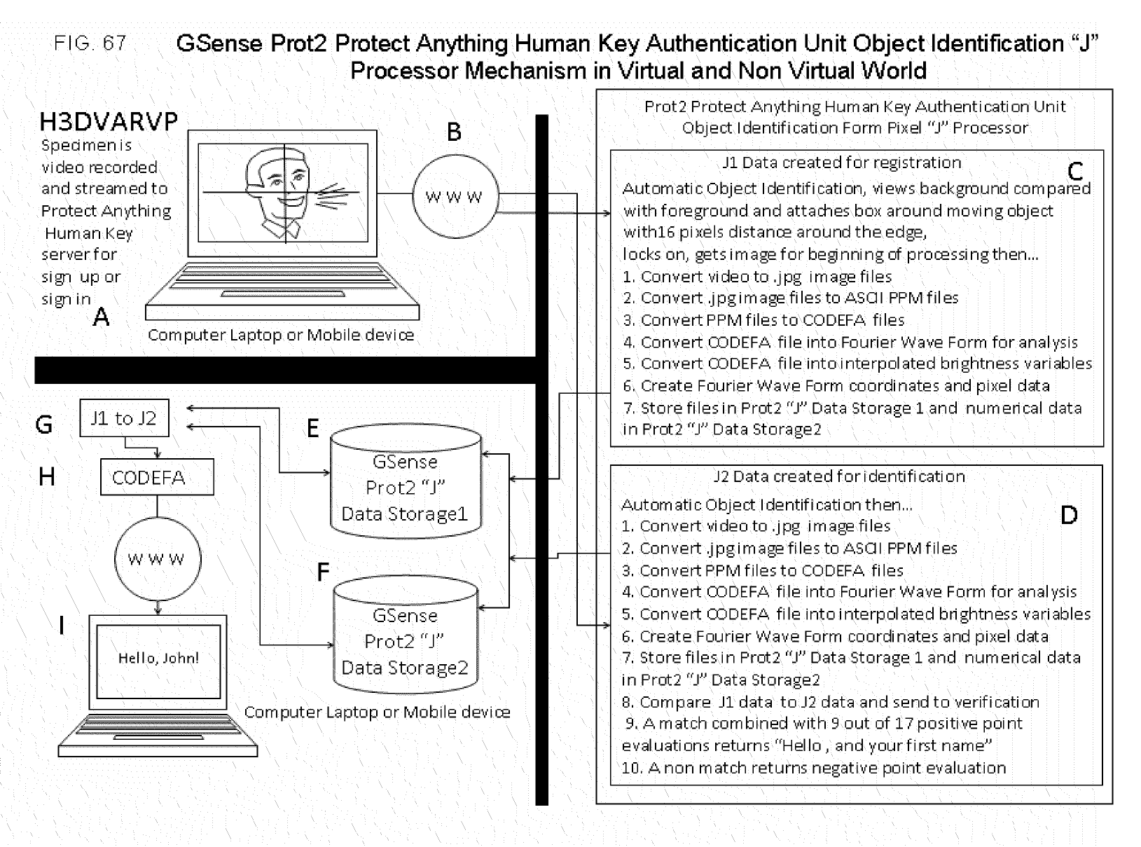

FIG. 67A describes GSense Prot2 Protect Anything Human Key Authentication Unit Object Identification “J” Processor Mechanism with H3DVARV 3D Human Video .Audio Stereo Viewing and Recording Mechanism and shows where the Specimen video is recorded and streamed to Protect Anything Human Key server for sign up or sign in Computer Laptop or Mobile device.

FIG. 67B describes GSense Prot2 Protect Anything Human Key Authentication Unit Object Identification “J” Processor Mechanism and shows where the WWW or World Wide Web is used for data aggregation and comparison analysis methods.

FIG. 67C describes GSense Prot2 Protect Anything Human Key Authentication Unit Object Identification “J” Processor Mechanism and shows where the Prot2 Protect Anything Human Key Authentication Unit Object Identification Form Pixel “J” Processor J1 Data created for registration Automatic Object Identification, views background compared with foreground and attaches box around moving object with 16 pixels distance around the edge, locks on, gets image for beginning of processing then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “J” Data Storage 1 and numerical data in Prot2 “J” Data Storage2.

FIG. 67D describes GSense Prot2 Protect Anything Human Key Authentication Unit Object Identification “J” Processor Mechanism and shows where the Prot2 Protect Anything Human Key Authentication Unit Object Identification Form Pixel “J” Processor J2 Data created for identification Automatic Object Identification then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “J” Data Storage 1 and numerical data in Prot2 “J” Data Storage2, 8. Compares, J1 data to J2 data and send to verification, 9. Where a match combined with 9 out of 16 positive point evaluations returns “Hello, and your first name”, 10. Where a non match returns negative point evaluation.

FIG. 67E describes GSense Prot2 Protect Anything Human Key Authentication Unit Object Identification “J” Processor Mechanism and shows the GSense Prot2 “J” Data Storage1.

FIG. 67F describes GSense Prot2 Protect Anything Human Key Authentication Unit Object Identification “J” Processor Mechanism and shows the GSense Prot2 “J” Data Storage2.

FIG. 67G describes GSense Prot2 Protect Anything Human Key Authentication Unit Object Identification “J” Processor Mechanism and shows where the J1 to J2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 67H describes GSense Prot2 Protect Anything Human Key Authentication Unit Object Identification “J” Processor Mechanism and shows the Protect Anything CODEFA mechanism that provides storage, security, human key and tracking features.

FIG. 67I describes GSense Prot2 Protect Anything Human Key Authentication Unit Object Identification “J” Processor Mechanism and shows where the WWW or World Wide Web is used for data aggregation and comparison analysis methods Hello, John! Computer Laptop, or Mobile device.

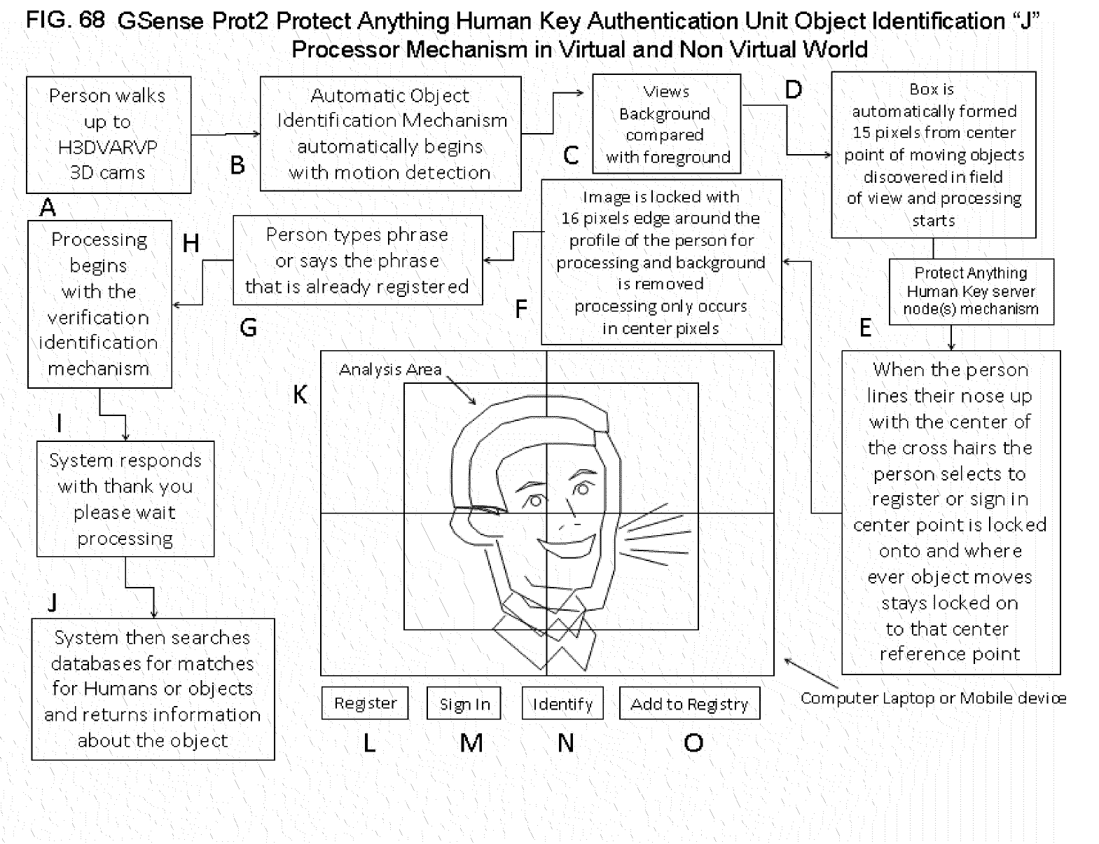

FIG. 68A describes GSense Prot2 Protect Anything Human Key Authentication Unit Object Identification “J” Processor with H3DVARV 3D Human Video Audio Stereo Viewing and Recording Mechanism Analysis Area Mechanism and shows where the Person walks up to H3DVARV 3D Human Video Audio Stereo Viewing and Recording Mechanism 3D cams.

FIG. 68B describes GSense Prot2 Protect Anything Human Key Authentication Unit Object Identification “J” Processor Analysis Area Mechanism and shows where automatic Object Identification Mechanism automatically begins with motion detection.

FIG. 68C describes GSense Prot2 Protect Anything Human Key Authentication Unit Object Identification “J” Processor Analysis Area Mechanism and shows where the Views Background is compared with foreground.

FIG. 68D describes GSense Prot2 Protect Anything Human Key Authentication Unit Object Identification “J” Processor Analysis Area Mechanism and shows where the Box is automatically formed 200 pixels from center point of moving objects discovered in field of view and processing starts.

FIG. 68E describes GSense Prot2 Protect Anything Human Key Authentication Unit Object Identification “J” Processor Analysis Area Mechanism and shows where when the person lines their nose up with the center of the cross hairs the person selects to register or sign in center point is locked onto and where ever object moves stays locked onto that center reference point, and data is stored in the Protect Anything Human Key server node(s) mechanism for processing.

FIG. 68F describes GSense Prot2 Protect Anything Human Key Authentication Unit Object Identification “J’, ‘Processor Analysis Area Mechanism and shows where the, Image is locked with 16 pixels edge around the profile of the person for processing and the background is removed processing only occurs in center pixels.

FIG. 68G describes GSense Prot2 Protect Anything Human Key Authentication Unit Object Identification “J” Processor Analysis Area Mechanism and shows where the Person types phrase or says the phrase that is already registered.

FIG. 68H describes GSense Prot2 Protect Anything Human Key Authentication Unit Object Identification “J” Processor Analysis Area Mechanism and shows where the Processing begins with the verification identification mechanism.

FIG. 68I describes GSense Prot2 Protect Anything Human Key Authentication Unit Object Identification “J” Processor Analysis Area Mechanism and shows where the System responds with thank you please wait processing.

FIG. 68J describes GSense Prot2 Protect Anything Human Key Authentication Unit Object Identification “J” Processor Analysis Area Mechanism and shows where the System then searches databases for matches for Humans or objects and returns information about the object.

FIG. 68K describes GSense Prot2 Protect Anything Human Key Authentication Unit Object Identification “J” Processor Analysis Area Mechanism and shows where analysis Area is used with any Computer, Laptop, or Mobile device.

FIG. 68L describes GSense Prot2 Protect Anything Human Key Authentication Unit Object Identification “J” Processor Analysis Area Mechanism and shows where the Register button is located.

FIG. 68M describes GSense Prot2 Protect Anything Human Key Authentication Unit Object Identification “J” Processor Analysis Area Mechanism and shows where the Sign In button is located.

FIG. 68N describes GSense Prot2 Protect Anything Human Key Authentication Unit Object Identification “J” Processor Analysis Area Mechanism and shows where the Identify button is located.

FIG. 68O describes GSense Prot2 Protect Anything Human Key Authentication Uriit Object Identification “J” Processor Analysis Area Mechanism and shows where add to Registry button is located.

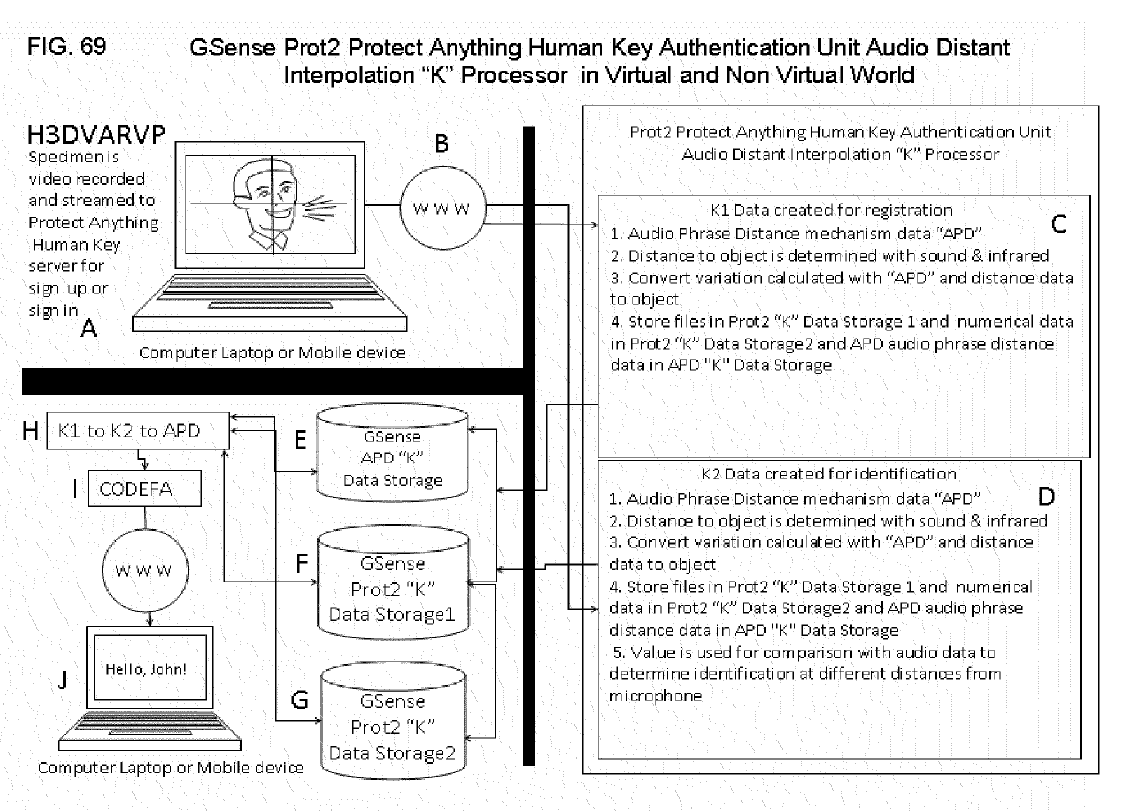

FIG. 69A describes GSense Prot2 Protect Anything Human Key Authentication Unit Audio Distant Interpolation “K” Processor with H3DVARV 3D Human Video Audio Stereo Viewing and Recording Mechanism and shows where the Specimen video is Recorded, and streamed to Protect Anything Human Key serv.er for sign up or sign in Computer Laptop or Mobile device.

FIG. 69B describes GSense Prot2 Protect Anything Human Key Authentication Unit Audio Distant Interpolation “K” Processor and shows where the WWW or World Wide Web is used for data aggregation and comparison analysis methods.

FIG. 69C describes GSense Prot2 Protect Anything Human Key Authentication Unit Audio Distant Interpolation “K” Processor and shows where the Prot2 Protect Anything Human Key Authentication Unit Audio Distant Interpolation “K” Processor K1 Data created for registration, 1. Audio Phrase Distance mechanism data “APD”, 2. Distance to object is determined with sound & infrared, 3. Converts variation calculated with “APD” and distance data to object, 4. Stores files in Prot2 “K” Data Storage 1 and numerical data in Prot2 “K” Data Storage2 and APD audio phrase distance data in APD “K” Data Storage.

FIG. 69D describes GSense Prot2 Protect Anything Human Key Authentication Unit Audio Distant Interpolation “K” Processor and shows• where the Prot2 Protect Anything Human Key Authentication Unit Audio Distant Interpolation “K” Processor K2 Data created for identification, 1. Audio Phrase Distance mechanism data “APD”, 2. Distance to object is determined with sound & infrared, 3. Converts variation calculated with “APD” and distance data to object, 4. Stores files in Prot2 “K” Data Storage 1 and numerical data in Prot2 “K” Data Storage2 and APD audio phrase distance data in APD “K” Data Storage, 5. Where value is used for comparison with audio data to determine identification at different distances from microphone.

FIG. 69E describes GSense Prot2 Protect Anything Human Key Authentication Unit Audio Distant Interpolation “K” Processor and shows the GSense APD “K” Data Storage.

FIG. 69F describes GSense Prot2 Protect Anything Human Key Authentication Unit Audio Distant Interpolation “K” Processor and shows the GSense Prot2 “K” Data Storage1.

FIG. 69G describes GSense Prot2 Protect Anything Human Key Authentication Unit Audio Distant Interpolation uK” Processor and shows the GSense Prot2 “K” Data Storage2.

FIG. 69H describes GSense Prot2 Protect Anything Human Key Authent.ication Unit Audio Distant Interpolation “K” Processor and shows where the APD to K1 to K2 to APD Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 69I describes GSense Prot2 Protect Anything Human Key Authentication Unit Audio Distant Interpolation “K” Processor and shows the Protect Anything CODEFA Mechanism, that provides storage, security, human key and tracking features.

FIG. 69J describes GSense Prot2 Protect Anything Human Key Authentication Unit Audio Distant Interpolation “K” Processor and shows where the W W′W or World Wide Web is used for data aggregation and comparison analysis methods Hello, John! Computer Laptop or Mobile device.

FIG. 70A describes GSense Prot2 Protect Anything Human Key Authentication Unit 3D Video Audio “L” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 70B describes GSense Prot2 Protect Anything Human Key Authentication Unit 3D Video Audio “L” Processor and shows where the W WW or World Wide Web is used for data aggregation and comparison analysis methods.

FIG. 70C describes GSense Prot2 Protect Anything Human Key Authentication Unit 3D Video Audio “L” Processor “and shows where the Prot2 Protect Anything Human Key Authentication Unit 3D Video Audio “L” Processor L1 Data created for registration, 1. Converts 3D multiple cam video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “L” Data Storage 1 and numerical data in Prot2 “L” Data Storage2.

FIG. 70D describes GSense Prot2 Protect Anything Human Key Authentication Unit 3D Video Audio “L” Processor and shows where the Prot2 Protect Anything Human Key Authentication Unit3D Video Audio “L” Processor L2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “L” Data Storage 1 and numerical data in Prot2 “L” Data Storage2, 8. Compares 3D differences and store in 3D data storage, 9. Compares L1 data to L2 data and send to verification, 10. Where a match combined with 9 out of 16 positive point evaluations returns “Hello, and your first name” 11. Where a non match returns negative point evaluation.

FIG. 70E describes GSense Prot2 Protect Anything Human Key Authentication Unit 3D Video Audio “L” Processor and shows the GSense 3D “L” Data Storage.

FIG. 70F describes GSense Prot2 Protect Anything Human Key Authentication Unit 3D Video Audio “L” Processor and shows the GSense Prot2 “L” Data Storage1.

FIG. 70G describes GSense Prot2 Protect Anything Human Key Aut˜entication Unit 3D Video Audio “L” Processor and shows the GSense Prot2 “L” Data Storage2.

FIG. 70H describes GSense Prot2 Protect Anything Human Key Authentication Unit 3D Video Audio “L” Processor and shows where the L1 to L2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis audio Fourier wave form pattern analysis, and audio converted to image comparative analysis.

FIG. 70I describes GSense Prot2 Protect Anything Human Key Authentication Unit 3D Video Audio “L” Processor and shows the Protect Anything CODEFA mechanism that provides storage, security, human key and tracking features.

FIG. 70J describes GSense Prot2 Protect Anything Human Key Authentication Unit 3D Video Audio “L” Processor and shows where the WWW or World Wide Web is used for data aggregation and comparison analysis methods Hello, John! Computer Laptop, or Mobile device.

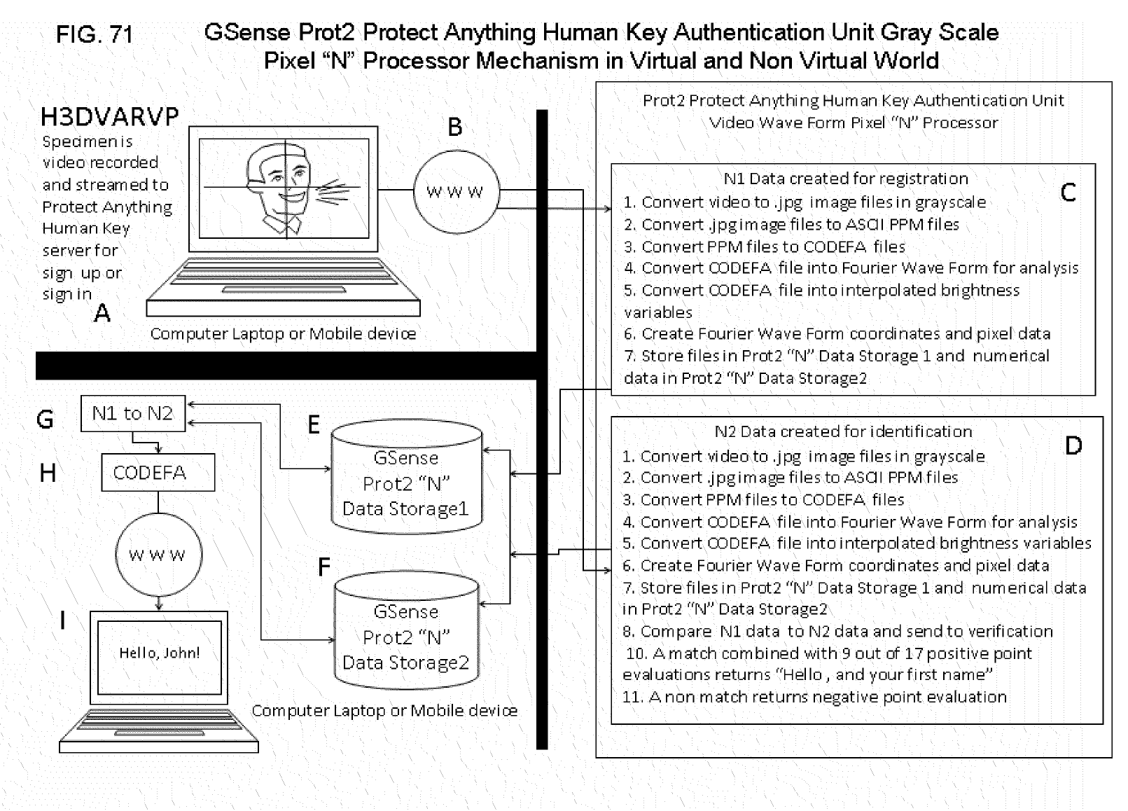

FIG. 71A describes GSense Prot2 Protect Anything Human Key Authentication Unit Gray Scale Pixel “N” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 71B describes GSense Prot2 Protect Anything Human Key Authentication Unit Gray Scale Pixel “N” Processor Mechanism and shows where the WWW or World Wide Web is used for data aggregation and comparison analysis methods.

FIG. 71C describes GSense Prot2 Protect Anything Human Key Authentication Unit Gray Scale Pixel “N” Processor Mechanism and shows where the Prot2 Protect Anything Human Key Authentication Unit Video Fourier wave form. Pixel “N” Processor N1 Data created for registration, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage; security, human key and tracking features file into interpolated brightness variables, 6. Creates Fourier wave form coordinates and pixel data, 7. Stores files in Prot2 “N” Data Storage 1 and numerical data in Prot2 “N” Data Storage2.

FIG. 71D describes GSense Prot2 Protect Anything Human Key Authentication Unit Gray Scale Pixel “N” Processor Mechanism and shows where the Prot2 Protect Anything Human Key Authentication Unit Video Fourier wave form Pixel “N” Processor N2 Data created for identification, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “N” Data Storage 1 and numerical data in Prot2 “N” Data Storage2, 8. Compares N1 data to N2 data and send to verification, 10. Where a match combined with 9 out of 16 positive point evaluations returns “Hello, and your first name” 11. Where a non match returns negative point evaluation.

FIG. 71E describes GSense Prot2 Protect Anything Human Key Authentication Unit Gray Scale Pixel “N” Processor Mechanism and shows the GSense Prot2 “N” Data Storage1.

FIG. 71F describes GSense Prot2 Protect Anything Human Key Authentication Unit Gray Scale Pixel “N” Processor Mechanism and shows the GSense Prot2 “N” Data Storage2.

FIG. 71G describes GSense Prot2 Protect Anything Human Key Authentication Unit Gray Scale Pixel “N” Processor Mechanism and shows where the N1 to N2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector o″,erlay pattern analysis, audio Fourier wave form pattern analysis, and audio converted to image comparative analysis.

FIG. 71H describes GSense Prot2 Protect Anything Human Key Authentication Unit Gray Scale Pixel “N” Processor Mechanism and shows the Protect Anything CODEFA mechanism that provides stor˜ge, security, human key and tracking features.

FIG. 71I describes GSense Prot2 Protect Anything Human Key Authentication Unit Gray Scale Pixel “N” Processor Mechanism and shows where the WWW or World Wide Web is used for data aggregation and comparison analysis methods Hello, John! Computer Laptop or Mobile device.

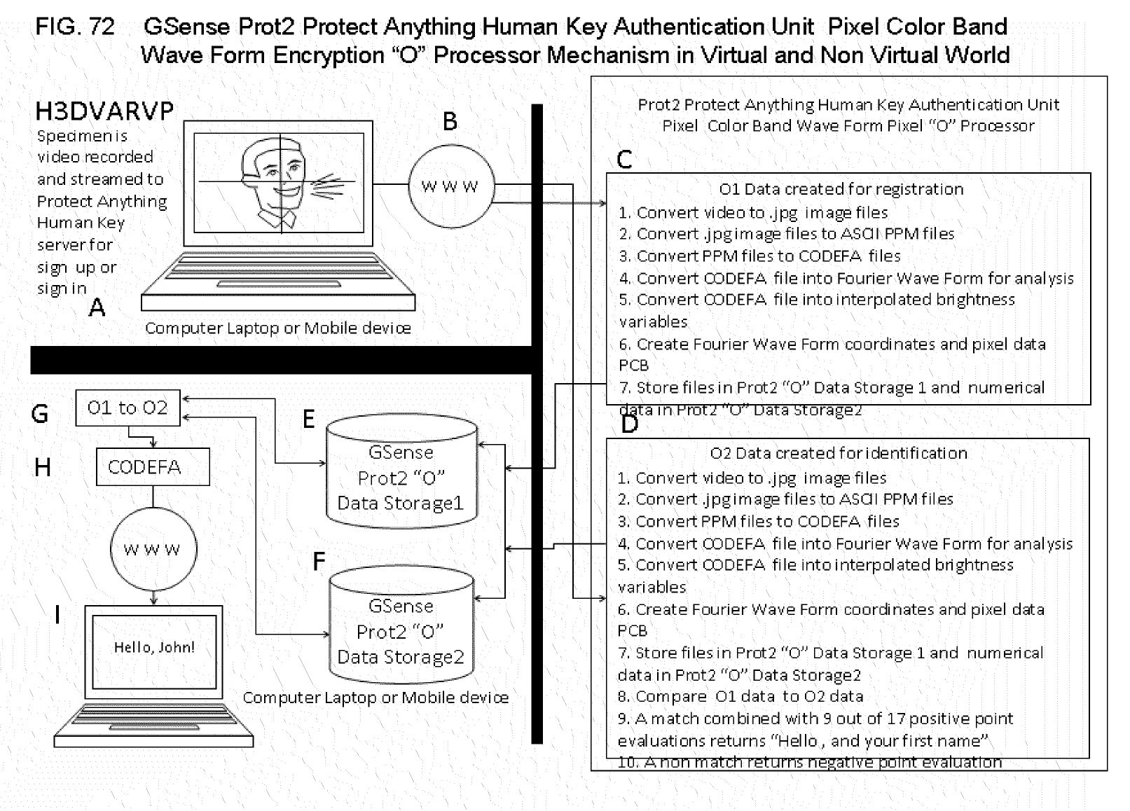

FIG. 72A describes GSense Prot2 Protect Anything Human Key Authentication Unit Pixel Color Band Fourier wave form Encryption “Q” Area Processor Method and Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 72B describes GSense Prot2 Protect Anything Human Key Authentication Unit Pixel Color Band Fourier wave form Encryption “Q” Area Processor Method and Mechanism and shows where the WWW or World Wide Web is used for data aggregation and comparison analysis methods.

FIG. 72C describes GSense Prot2 Protect Anything Human Key Authentication Unit Pixel Color Band Fourier wave form Encryption “Q” Area Processor Method and Mechanism and shows where the Prot2 Protect Anything Human Key Authentication Unit Pixel Color Band Fourier wave form Pixel “Q” Processor Q1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data PCB, 7. Stores files in Prot2 “Q” Data Storage 1 and numerical data in Prot2 “Q” Data Storage2.

FIG. 72D describes GSense Prot2 Protect Anything Human Key Authentication Unit Pixel Color Band Fourier wave form Encryption “Q” Area Processor Method and Mechanism• and shows where the Prot2 Protect Anything Human Key Authentication Unit Pixel Color Band Fourier wave form Pixel “Q” Processor Q2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data PCB, 7. Stores files in Prot2 “Q” Data Storage 1 and numerical data in Prot2 “Q” Data Storage2, 8. Compares Q1 data to Q2 data, 9: Where a match combined with 9 out of 16 positive point evaluations returns “Hello, and your first name”, 10. Where a non match returns negative point evaluation.

FIG. 72E describes GSense Prot2 Protect Anything Human Key Authentication Unit Pixel Color Band Fourier wave form Encryption “Q” Area Processor Method and Mechanism and shows the GSense Prot2 “Q” Data Storage1.

FIG. 72F describes GSense Prot2 Protect Anything Human Key Authentication Unit Pixel Color Band Fourier wave form Encryption “Q” Area Processor Method and Mechanism and shows the GSense Prot2 “Q” Data Storage2.

FIG. 72G describes GSense Prot2 Protect Anything Human Key Authentication Unit Pixel Color Band Fourier wave form Encryption “Q” Area Processor Method and Mechanism and shows where the Q1 to Q2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 72H describes GSense Prot2 Protect Anything Human Key Authentication Unit Pixel Color Band Fourier wave form Encryption “Q” Area Processor Method and Mechanism and shows the Protect Anything CODEFA mechanism that provides storage, security, human key and tracking features.

FIG. 72I describes GSense Prot2 Protect Anything Human Key Authentication Unit ‘Pixel Color Band Fourier wave form Encryption “Q” Area Processor Method and Mechanism and shows where the WWW or World Wide Web is used for data aggregation and comparison analysis methods Hello, John! Computer Laptop or Mobile device.

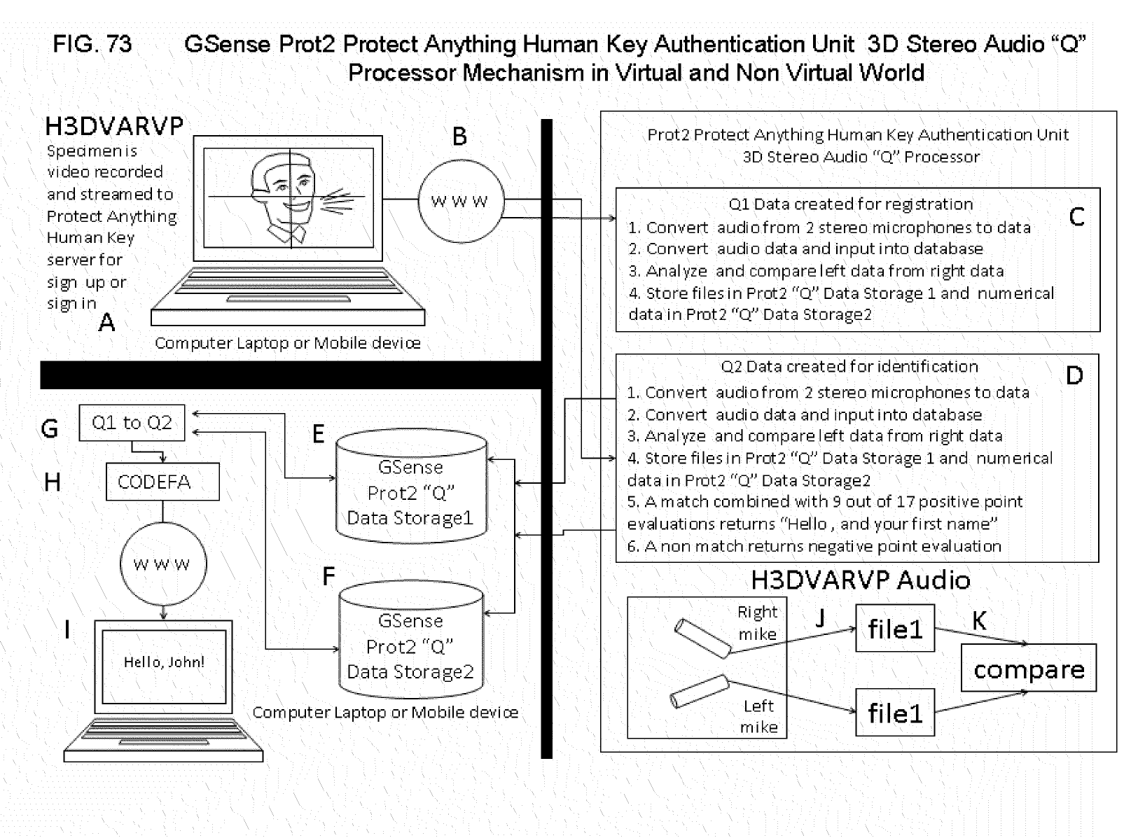

FIG. 73A describes GSense Prot2 Protect Anything Human Key Authentication Unit 3D Stereo Audio “Q” Processor Mechanism with H3DVARV 3D Human Video Audio Stereo Viewing and Recording Mechanism and shows where the Specimen Video is recorded and streamed to Protect Anything Human Key server for sign up or sign in Computer Laptop or Mobile device.

FIG. 73B describes GSense Prot2 Protect Anything Human Key Authentication Unit 3D Stereo Audio “Q” Processor Mechanism and shows where the WWW or World Wide Web is used for data aggregation and comparison analysis methods.

FIG. 73C describes GSense Prot2 Protect Anything Human Key Authentication Unit 3D Stereo Audio “Q” Processor’ Mechanism and shows where the Prot2 Protect Anything Human Key Authentication Unit 3D Stereo Audio “Q” Processor Q1 Data created for registration, 1. Converts audio from 2 stereo microphones to data, 2. Converts audio data and input into database, 3. Analyzes and compares left data from right data, 4. Stores files in Prot2 “Q” Data Storage 1 and numerical data in Prot2 “Q” Data Storage2.’

FIG. 73D describes GSense Prot2 Protect Anything Human Key Authentication Unit 3D Stereo Audio “Q” Processor Mechanism and shows where the Prot2 Protect Anything Human Key Authentication Unit 3D Stereo Audio “Q” Processor Q2 Data created for identification, 1. Converts audio from 2 stereo microphones to data, 2. Converts audio data and input into database, 3. Analyzes and compares left data from right data, 4. Stores files in Prot2 “Q” Data Storage 1 and numerical data in Prot2 “Q” Data Storage2, 5. Where a match combined with 9 out of 16 positive point evaluation's returns “Hello, and your first name”, 6. Where a non match returns negative point evaluation.

FIG. 73E describes GSense Prot2 Protect Anything Human Key Authentication Unit 3D Stereo Audio “Q” Processor Mechanism and shows the GSense Prot2 “Q” Data Storage1.

FIG. 73F describes GSense Prot2 Protect Anything Human Key Authentication Unit 3D Stereo Audio “Q” Processor Mechanism and shows the GSense Prot2 “Q” Data Storage2.

FIG. 73G describes GSense Prot2 Protect Anything Human Key Authentication Unit 3D Stereo Audio “Q” Processor Mechanism and shows where the Q1 to Q2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 73H describes GSense Prot2 Protect Anything Human Key Authentication Unit 3D Stereo Audio “Q” Processor Mechanism and shows the Protect Anything CODEFA mechanism that provides storage, security, human key and tracking features.

FIG. 73I describes GSense Prot2 Protect Anything Human Key Authentication Unit 3D Stereo Audio “Q” Processor Mechanism and shows where the WWW or World Wide Web is used for data aggregation and comparison analysis methods Hello, Johnl Computer Laptop, or Mobile device.

FIG. 73J describes GSense Prot2 Protect Anything Human Key Authentication Unit 3D Stereo Audio “Q” Processor Mechanism and shows where, the right microphone and left microphone creates and aggregates into separate files file 1 and file 2

FIG. 73K describes GSense Prot2 Protect Anything Human Key Authentication Unit Vector Line Overlay to Grid Form Pixel Analysis “M” Processor Mechanism with H3DVARV 3D Human Video Audio Stereo Viewing and Recording Mechanism and shows where the 2 3D Stereo audio files, file 1 and file 2 are overlaid and converted to pixel data and compared.

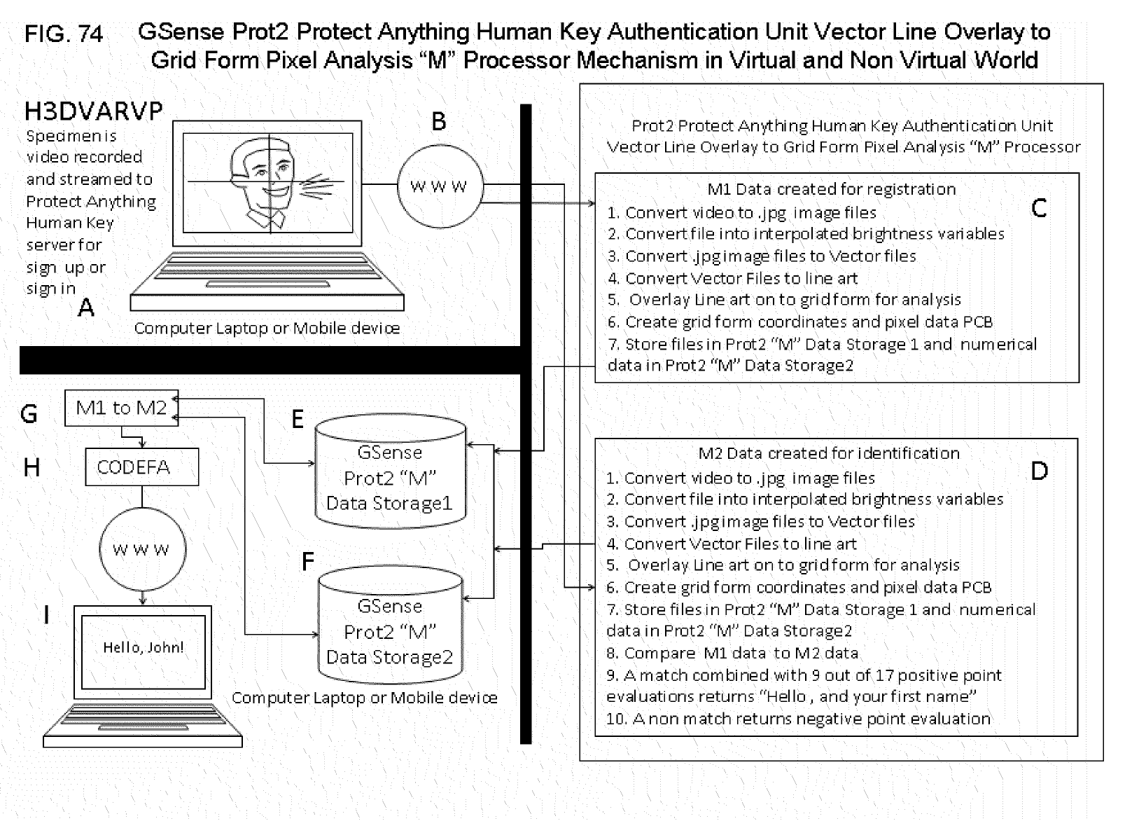

FIG. 74A describes GSense Prot2 Protect Anything Human Key Authentication Unit Vector Line Overlay to Grid Form Pixel Analysis “M” Processor Mechanism with H3DVARV 3D Human Video Audio Stereo Viewing and Recording Mechanism' and shows where the Specimen video is recorded and streamed to Protect Anything Human Key server for sign up or sign in Computer Laptop or Mobile device.

FIG. 74B describes GSense Prot2 Protect Anything Human Key Authentication Unit Vector Line Overlay to Grid Form Pixel Analysis “M” Processor Mechanism' and shows where the WWW or World Wide Web is used for data aggregation and comparison analysis methods.

FIG. 74C describes GSense Prot2 Protect Anything Human Key Authentication Unit Vector Line Overlay to Grid Form Pixel Analysis “M” Processor Mechanism and shows where the Prot2 Protect Anything Human Key Authentication Unit Vector Line Overlay to Grid Form Pixel Analysis “M” Processor M1 Data created for registration, 1. Converts video to .jpg image files, 2. Converts file into interpolated brightness variables, 3. Converts .jpg image files to Vector files, 4. Converts Vector Files to line art, S. Overlays Line art on to grid form for analysis, 6. Creates grid form coordinates and pixel data PCB, 7. Stores files in Prot2 “M” Data Storage 1 and numerical data in Prot2 “M” Data Storage2.

FIG. 74D describes GSense Prot2 Protect Anything Human Key Authentication Unit Vector Line Overlay to Grid Form Pixel Analysis “M” Processor Mechanism and shows where the Prot2 Protect Anything Human Key Authentication Unit Vector Line Overlay to Grid Form Pixel Analysis “M” Processor M2 Data created for identification, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “M” Data Storage 1 and numerical data in Prot2 “M” Data Storage2, 8. Compares M1 data to M2 data, 9. Where a match combined with 9′ out of 16 positive point evaluations returns “Hello, and your first name”, 10. Where a non match returns negative point evaluation.

FIG. 74E describes GSense Prot2 Protect Anything Human Key Authentication Unit Vector Line Overlay to Grid Form Pixel Analysis “Mil Processor Mechanism and shows the GSense Prot2 “M” Data Storage1.

FIG. 74F describes GSense Prot2 Protect Anything Human Key Authentication Unit Vector Line Overlay to Grid Form Pixel Analysis “M” Processor Mechanism and shows the GSense Prot2 “M” Data Storage2.

FIG. 74G describes GSense Prot2 Protect Anything Human Key Authentication Unit Vector Line Overlay to Grid Form Pixel Analysis “M” Processor Mechanism and shows where the M1 to M2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 74H describes GSense Prot2 Protect Anything Human Key Authentication Unit Vector Line Overlay to Grid Form Pixel Analysis “M” Processor Mechanism and shows the Protect Anything CODEFA mechanism that provides storage, security, human key and tracking features.

FIG. 74I describes GSense Prot2 Protect Anything Human Key Authentication Unit Vector Line Overlay to Grid Form Pixel Analysis “M” Processor Mechanism and shows where the WWW or World Wide Web is used for data aggregation and comparison analysis methods Hello, John! Computer Laptop, or Mobile device.

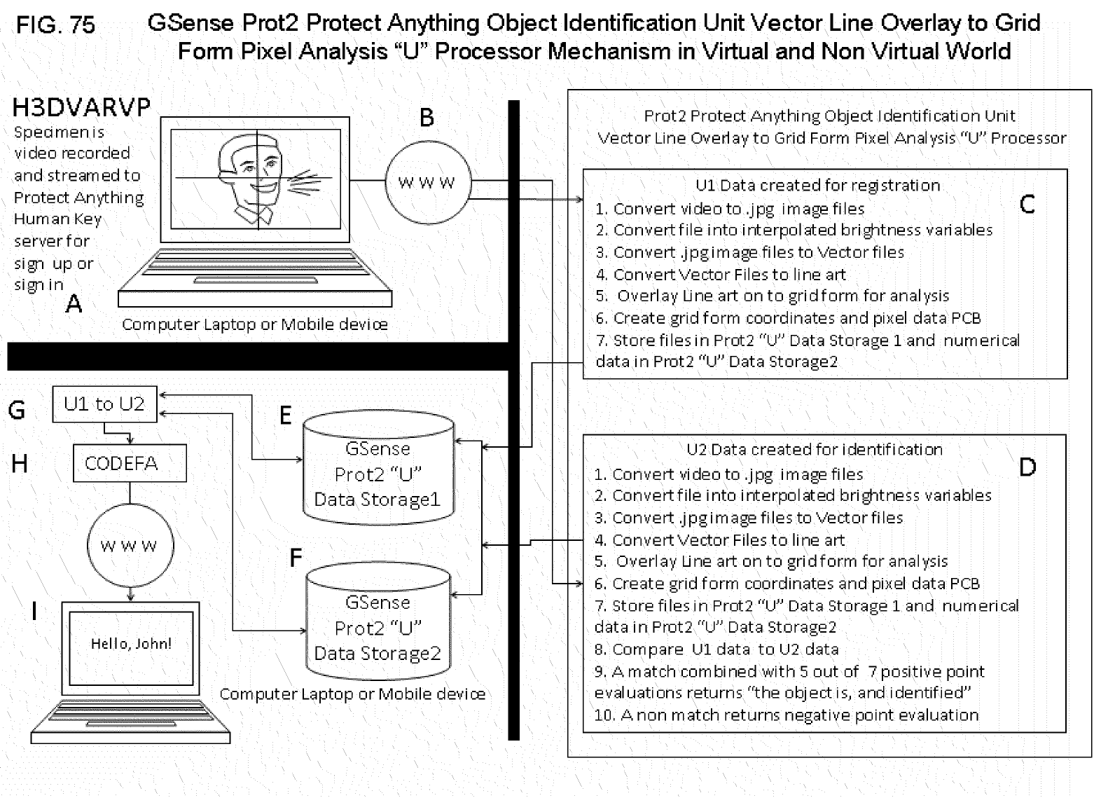

FIG. 75A describes GSense Prot2 Protect Anything Object Identification Unit Vector Line Overlay to Grid Form Pixel Analysis “U” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 75B describes GSense Prot2 Protect Anything Object Identification Unit Vector Line Overlay to Grid Form Pixel Analysis “U” Processor Mechanism and shows where. the WWW or World Wide Web is used for data aggregation and comparison analysis methods.

FIG. 75C describes GSense Prot2 Protect Anything Object Identification Unit Vector Line Overlay to Grid Form Pixel Analysis “U” Processor Mechanism and shows where the Prot2 Protect Anything Object Identification Unit Vector Line Overlay to Grid Form Pixel Analysis “U” Processor U1 Data created for registration, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “U” Data Storage 1 and numerical data in Prot2 “U” Data Storage2.

FIG. 75D describes GSense Prot2 Protect Anything Object Identification Unit. Vector Line Overlay to Grid Form Pixel Analysis “U” Processor Mechanism and shows where the Prot2 Protect Anything Object Identification Unit Vector Line Overlay to Grid Form Pixel Analysis “U” Processor U2 Data created for identification, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “U” Data Storage 1 and numerical data in Prot2 “U” Data Storage2, 8. Compares U1 data to U2 data, 9. Where a match combined with 5 out of 7 positive point evaluations returns “the object is, and identified”, 10. Where a non match returns negative point evaluation.

FIG. 75E describes GSense Prot2 Protect Anything Object Identification Unit Vector Line Overlay to Grid Form Pixel Analysis “U” Processor Mechanism and shows the GSense Prot2 “U” Data Storage 1.

FIG. 75F describes GSense prot2 Protect Anything Object Identification Unit Vector Line Overlay to Grid Form Pixel Analysis “U” Processor Mechanism and shows the GSense Prot2 “U” Data Storage2.

FIG. 75G describes GSense Prot2 Protect Anything Object Identification Unit Vector Line Overlay to Grid Form Pixel Analysis “U”, Processor Mechanism and shows where the U1 to U2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 75H describes GSense Prot2 Protect Anything Object Identification Unit Vector Line Overlay to Grid Form Pixel Analysis “U” Processor Mechanism and shows the Protect Anything CODEFA mechanism that provides storage, security, human key and tracking features.

FIG. 75I describes GSense Prot2 Protect Anything Object Identification Unit Vector Line Overlay to Grid Form Pixel Analysis “U” Processor Mechanism and shows where the WWW or World Wide Web is used for data aggregation and comparison analysis methods Hello, John! Computer Laptop, or Mobile device.

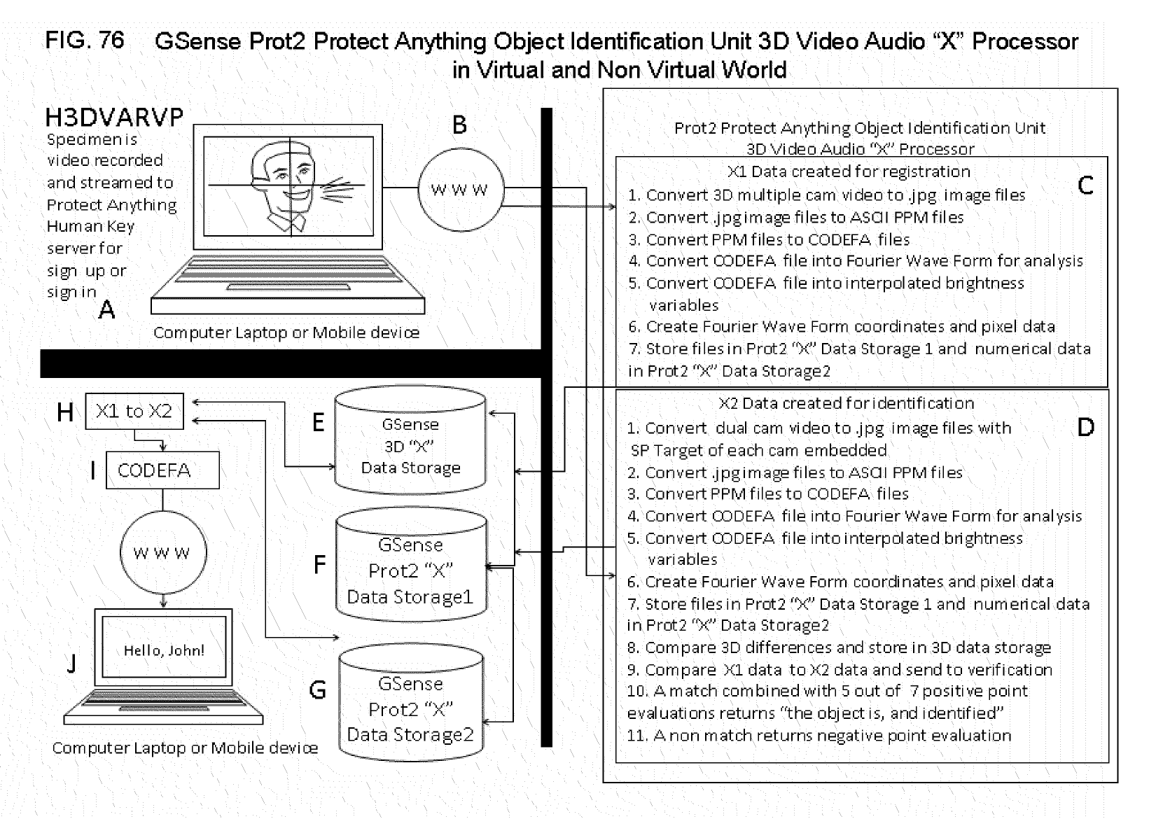

FIG. 76A describes GSense Prot2 Protect Anything Object Identification Unit 3D Video Audio “X” Processor, with H30VARV 3D Human Video Audio Stereo Viewing and Recording Mechanism, and shows where the Specimen video is recorded and streamed to Protect Anything Human Key server, for sign up, or sign in Computer Laptop or Mobile device.

FIG. 76B describes GSense Prot2 Protect Anything Object Identification Unit 3D Video Audio “X” Processor and shows where the WWW or World Wide Web is used for data aggregation. and comparison analysis methods.

FIG. 76C describes GSense Prot2 Protect Anything Object Identification Unit 3D Video Audio “X” Processor and shows where the Prot2 Protect Anything Object Identification Unit 30 Video Audio “X” Processor X1 Data created for registration, 1. Converts 3D multiple cam video to .jpg image files, 2. Converts .jpg image files to ASCII PPM files, 3. Converts PPM files to Protect Anything COOEFA mechanism that provides storage, security, human key and tracking features files, 4. Converts Protect Anything COOEFA mechanism that provides storage, security, human key and tracking features file into Fourier wave form for analysis, 5. Converts Protect Anything COOEFA mechanism that provides storage, security, human key and tracking features file into interpolated brightness variables, 6. Creates Fourier wave form coordinates and pixel data, 7. Stores files in Prot2 “X” Data Storage 1 and numerical data in Prot2 “X” Data Storage2.

FIG. 76D describes GSense Prot2 Protect Anything Object Identification Unit 3D Video Audio “X” Processor and shows where the Prot2 Protect Anything Object Identification Unit3D Video Audio “X” Processor X2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “X” Data Storage 1 and numerical data in Prot2 “X” Data Storage2, 8. Compares 3D differences and store in 3D data storage, 9. Compares X1 data to X2 data and send to verification, 10. Where a match combined with 5 out of 7 positive point evaluations returns “the object is, and identified”•11. Where a non match returns negative point evaluation.

FIG. 76E describes GSense Prot2 Protect Anything Object Identification Unit 3D Video Audio “X” Processor and shows the GSense 3D “X” Data Storage.

FIG. 76F describes GSense ‘Prot2 Protect Anything Object Identification Unit 3D Video Audio “X” Processor and shows the GSense Prot2 “X” Data Storage 1.

FIG. 76G describes GSense Prot2 Protect Anything Object Identification Unit 3D Video Audio “X” Processor and shows the GSense Prot2 “X” Data Storage2.

FIG. 76H describes GSense Prot2 Protect Anything Object Identification Unit 3D Video Audio “X” Processor and shows where the X1, to X2 Pattern matching and Comparison Processor-Mechanism analyzes the data utilizing one or all of these analysis mechanisms including maximum distance analysis, mean distance analysis, ‘mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 76I describes GSense Prot2 Protect Anything Object Identification Unit 3D Video Audio “X” Processor and shows the Protect Anything CODEFA mechanism that provides storage, security, human key and tracking features.

FIG. 76J describes GSense Prot2 Protect Anything Object Identification Unit 3D Video Audio “X” Processor and shows where the WWW or World Wide Web is used for data aggregation and comparison analysis methods Hello, John! Computer Laptop, or Mobile device.

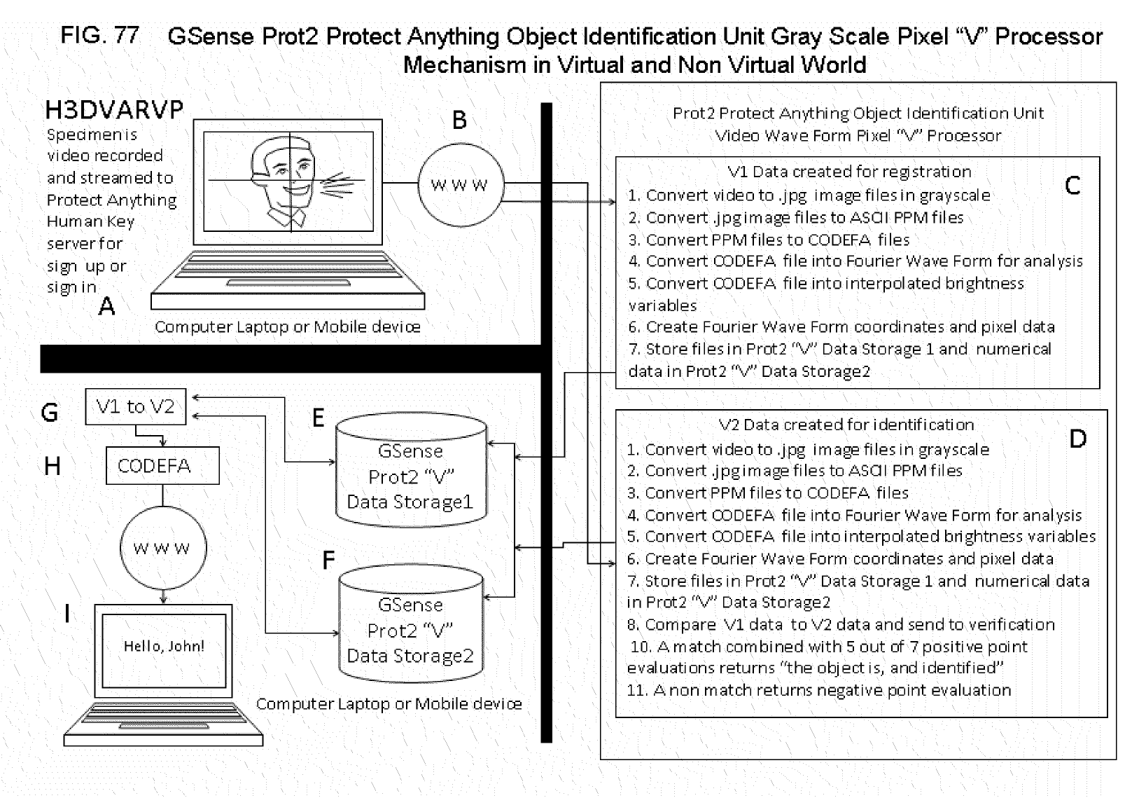

FIG. 77A describes GSense Prot2 Protect Anything Object Identification Unit Gray Scale Pixel “V” Processor Mechanism with H3DVARV 3D Human Video Audio Stereo Viewing and Recording Mechanism and shows where the Specimen video is recorded and streamed to Protect Anything Human Key server for sign up or sign in Computer, Laptop or Mobile device.

FIG. 77B describes GSense Prot2 Protect Anything Object Identification Unit Gray Scale Pixel “V” Processor Mechanism and shows where the WWW or World Wide Web is used for data aggregation and comparison analysis methods.

FIG. 77C describes GSense Prot2 Protect Anything Object Identification Unit Gray Scale Pixel “V” Processor Mechanism and shows where the Prot2 Protect Anything Object Identification Unit Video Fourier wave form Pixel “V” Processor V1 Data created for registration, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “V” Data Storage 1 and numerical data in Prot2 “V” Data Storage2.

FIG. 77D describes GSense Prot2 Protect Anything Object Identification Unit Gray Scale Pixel “V” Processor Mechanism and shows where the Prot2 Protect Anything Object Identification Unit Video Fourier wave form Pixel “V” Processor V2 Data created for identification, 1. Converts video to .jpg image files'in grayscale, 2. Converts .jpg image files to ASCII PPM flies, 3. Converts PPM files to Protect, Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files, in Prot2 “V” Data Storage 1 and numerical data in Prot2 “V” Data Storage2, 8. Compares V1 data to V2 data and send to verification, 10. Where a match combined with 5 out of, 7 positive point evaluations returns “the object is, and identified” 11. Where a non match returns negative point evaluation.

FIG. 77E describes GSense Prot2 Protect Anything Object Identification Unit Gray Scale Pixel “V” Processor Mechanism and shows the GSense Prot2 “V” Data Storage 1.

FIG. 77F describes GSense Prot2 Protect Anything Object Identification Unit Gray Scale Pixel “V” Processor Mechanism and shows the GSense Prot2 “V” Data Storage2.

FIG. 77G describes GSense Prot2 Protect Anything Object Identification Unit Gray Scale Pixel “V” Processor Mechanism and shows where the V1 to V2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 77H describes GSense Prot2 Protect Anything Object Identification Unit Gray Scale Pixel “V” Processor Mechanism and shows the Protect Anything CODEFA mechanism that provides storage, security, human key and tracking features.

FIG. 77I describes GSense Prot2 Protect Anything Object Identification Unit Gray Scale Pixel “V” Processor Mechanism and shows' where the WWW or World Wide Web is used for data aggregation and comparison analysis methods Hello, John! Computer Laptop, or Mobile ‘device.

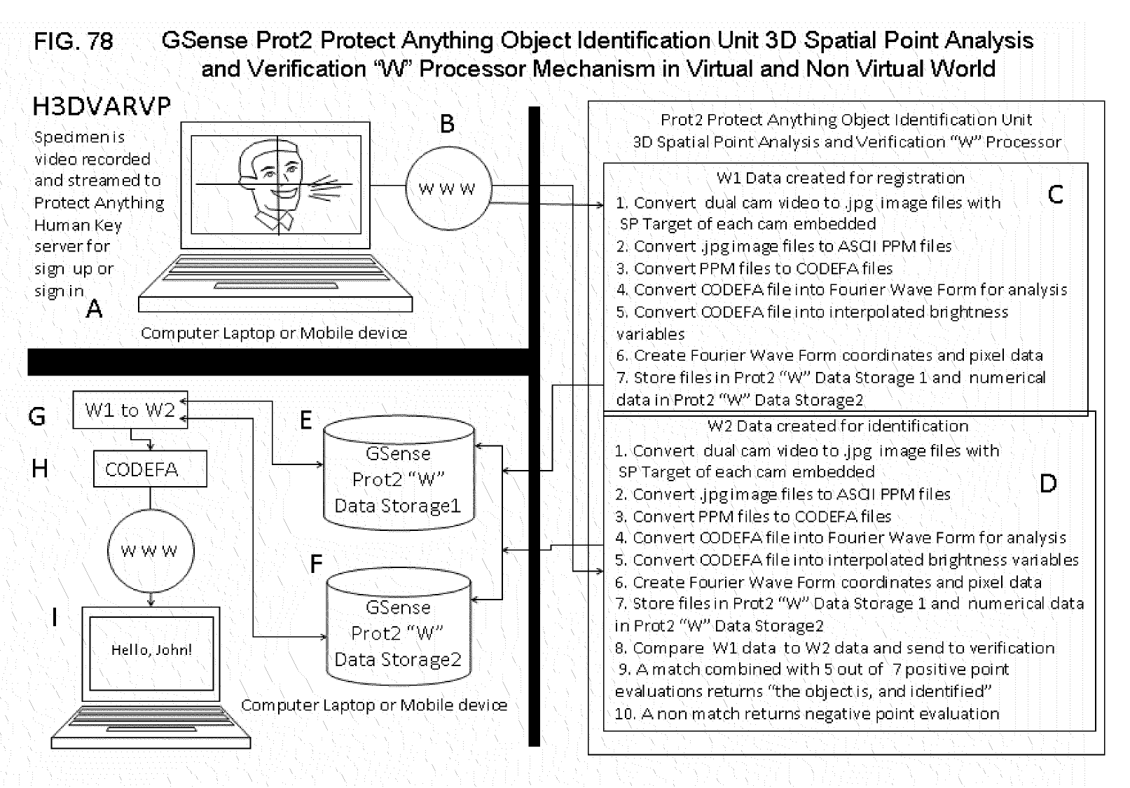

FIG. 78A describes GSense Prot2 Protect Anything Object Identification Unit 3D Spatial Point Analysis and Verification “W” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 78B describes GSense Prot2 Protect Anything Object Identification Unit 3D Spatial Point Analysis and Verification “W” Processor Mechanism and shows where the WWW or World Wide Web is used for data aggregation and comparison analysis methods.

FIG. 78C describes GSense Prot2 Protect Anything Object Identification Unit 3D Spatial Point Analysis and Verification “W” Processor Mechanism and shows where the Prot2 Protect Anything Object Identification Unit3D Spatial Point Analysis and Verification “W” Processor W1 Data created for registration, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “W” Data Storage 1 and numerical data in Prot2 “W” Data Storage2.

FIG. 78D describes GSense Prot2 Protect Anything Object Identification Unit 3D Spatial Point Analysis and Verification “W” Processor Mechanism and shows where the Prot2 Protect Anything Object Identification Unit3D Spatial Point Analysis and Verification “W” Processor W2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “W” Data Storage 1 and numerical data in Prot2 “W” Data Storage2, 8. Compares W1 data to W2 data and send to verification, 9. Where a match combined with 5 out of 7 positive point evaluations returns “the object is, and identified”, 10. Where a non match returns negative point evaluation.

FIG. 78E describes GSense Prot2 Protect Anything Object Identification Unit 3D Spatial Point Analysis and Verification “W” Processor Mechanism and shows the GSense Prot2 “W” Data Storage 1.

FIG. 78F describes GSense Prot2 Protect Anything Object Identification Unit 3D Spatial Point Analysis and Verification “W” Processor Mechanism and shows the GSense Prot2 “W” Data Storage2.

FIG. 78G describes GSense Prot2 Protect Anything Object Identification Unit 3D Spatial Point Analysis and Verification “W” Processor Mechanism and shows where the W1 to W2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 78H describes GSense Prot2 Protect Anything Object ‘Identification Unit 30 Spatial Point Analysis and Verification ‘W” Processor Mechanism and shows the Protect Anything CODEFA mechanism that provides storage, security, human key and tracking features.

FIG. 78I describes GSense Prot2 Protect Anything Object Identification Unit 3D Spatial Point Analysis and Verification “W” Processor Mechanism and shows where the WWW or World Wide Web is used for data aggregation and comparison analysis methods Hello, John! Computer Laptop, or Mobile device.

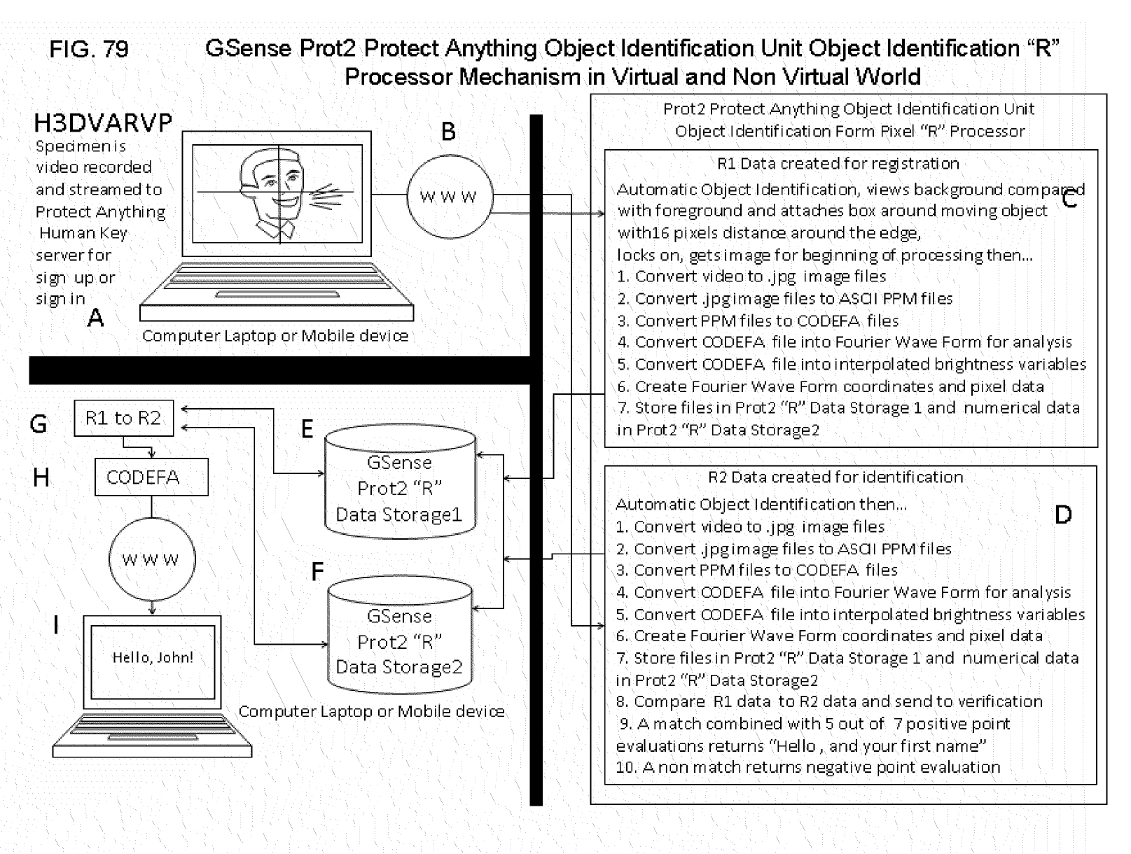

FIG. 79A describes GSense Prot2 Protect Anything Object Identification Unit Object Identification “‘R” Processor Mechanism with H30VARV 3D Human Video Au.dio Stereo Viewing and Recording Mechanism and shows where the Specimen video is recorded and streamed to Protect Anything Human Key server for sign up or sign in Computer Laptop or Mobile device.

FIG. 79B describes GSense Prot2 Protect Anything Object Identification Unit Object Identification “R” Processor Mechanism and shows where the WWW or World Wide Web is used for data aggregation and comparison analysis methods.

FIG. 79C describes GSense Prot2 Protect Anything Object Identification Unit Object Identification “R” Processor Mechanism and shows where the Prot2 Protect Anything Object Identification Unit Object Identification Form Pixel “R” Processor R1 Data created for registration Automatic Object Identification, views background compared with foreground and attaches box around moving object with 16 pixels distance around the edge, locks on, gets image’ for beginning of processing then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “R” Data Storage 1 and numerical data in Prot2 “R” Data Storage2.

FIG. 79D describes GSense Prot2 Protect Anything Object Identification Unit Object Identification “R” Processor Mechanism and shows where the Prot2 Protect Anything Object Identification Unit Object Identification Form Pixel “R” Processor R2 Data created for identification Automatic Object Identification then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “R” Data Storage 1 and numerical data in Prot2 “R” Data Storage2, 8. Compares R1 data to R2 data and send to verification, 9. Where a match combined with 5 out of 7 positive point evaluations returns “the object is, and identified”, 10. Where a non match returns negative point evaluation.

FIG. 79E describes GSense Prot2 Protect Anything Object Identification Unit Object Identification “R” Processor Mechanism and shows the GSense Prot2 “R” Data Storage1.

FIG. 79F describes GSense Prot2 Protect Anything Object Identification Unit Object Identification “R” Processor Mechanism and shows the GSense Prot2 “R” Data Storage2.

FIG. 79G describes GSense Prot2 Protect Anything Object Identification Unit Object Identification “R” Processor Mechanism and shows where the R1 to R2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 79H describes GSense Prot2 Protect Anything Object Identification Unit Object Identification “R” Processor Mechanism and shows the Protect Anything CODEFA mechanism that provides storage, security, human key and tracking features.

FIG. 79I describes GSense Prot2 Protect Anything Object Identification Unit Object Identification “R” Processor Mechanism and shows where the WWW or World Wide Web is used for data aggregation and comparison analysis methods Hello, John! Computer Laptop, or Mobile device.

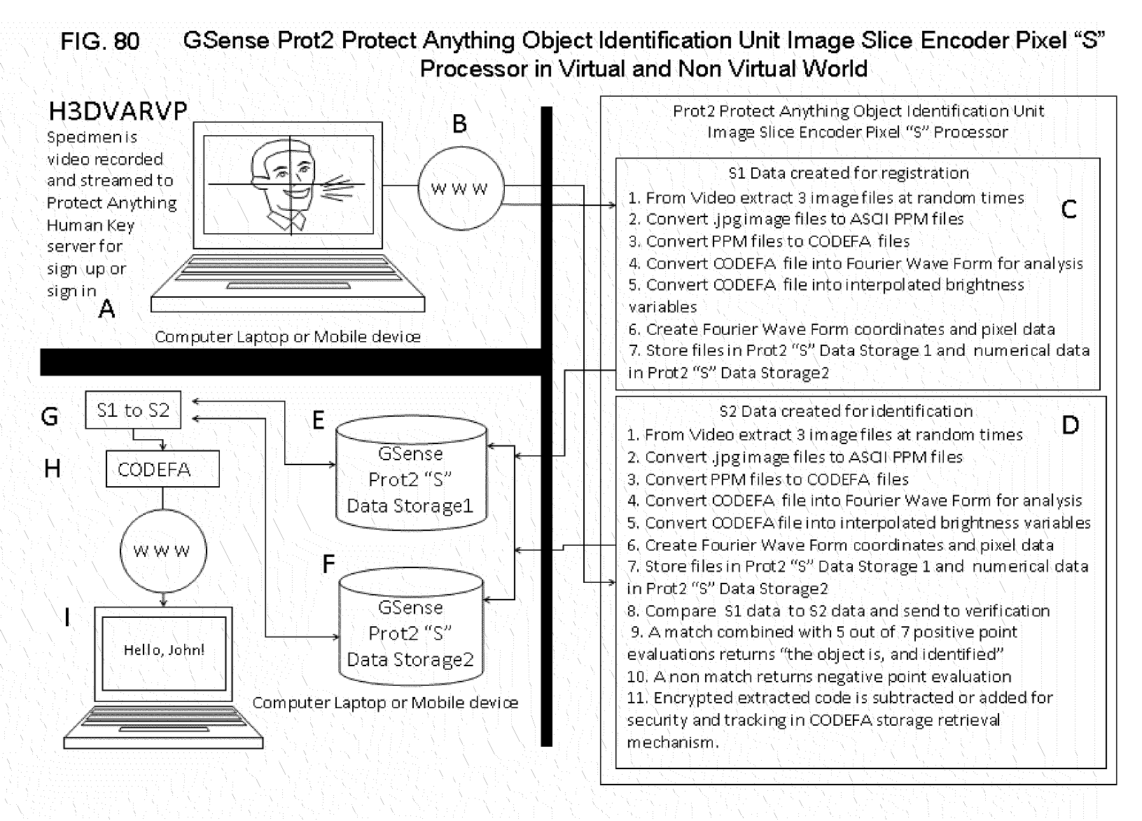

FIG. 80A describes GSense Prot2 Protect Anything Object Identification Unit Image Slice Encoder Pixel “S” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 80B describes GSense Prot2 Protect Anything Object Identification Unit Image Slice Encoder Pixel “S” Processor and shows where the WWW or World Wide Web is used for data aggregation and comparison analysis methods.

FIG. 80C describes GSense Prot2 Protect Anything Object Identification Unit Image Slice Encoder Pixel “S” Processor and shows where the Prot2 Protect Anything Object Identification Unit Image Slice Encoder Pixel “S” Processor 81 Data created for registration, 1. From Video extracts 3 image files at random times, 2. Converts .jpg image files, to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “S” Data Storage 1 and numerical data in Prot2 “S” Data Storage2.

FIG. 80D describes GSense Prot2 Protect Anything Object Identification Unit Image Slice Encoder. Pixel “S” Processor and shows where the Prot2 Protect Anything Object Identification Unit Image Slice Encoder Pixel “S” Processor S2 Data created for identification, 1. From Video extracts 3 image files at random times, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “s” Data Storage 1 and numerical data in Prot2 “S” Data Storage 2, 8. Compares s1 data-to S2 data and send to verification, 9. Where a match combined with 5 out of 7 positive point evaluations returns “the object is, and identified”, 10. Where a non match returns negative point evaluation, 11. Where encrypted extracted code is subtracted or added for security and tracking in the Protect Anything CODEFA mechanism that provides storage, security, human key and tracking features storage retrieval mechanism.

FIG. 80E describes GSense Prot2 Protect Anything Object identification Unit Image Slice Encoder Pixel “S” Processor and shows the GSense Prot2 “S” Data Storage1.

FIG. 80F describes GSense Prot2 Protect Anything Object Identification Unit Image Slice Encoder Pixel “S” Processor and shows the GSense Prot2 “S” Data Storage2.

FIG. 80G describes GSense Prot2 Protect Anything Object Identification Unit Image Slice Encoder Pixel “S” Processor and shows where the S1 to S2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 80H describes GSense Prot2 Protect Anything Object Identification Unit Image Slice Encoder Pixel “S” Processor and shows the Protect Anything CODEFA mechanism that provides storage, security, human key and tracking features.

FIG. 80I describes GSense Prot2 Protect Anything Object Identification Unit Image Slice Encoder Pixel “S” Processor and shows where the WWW or World Wide Web is used for data aggregation and comparison analysis methods Hello, John! Computer Laptop or Mobile device.

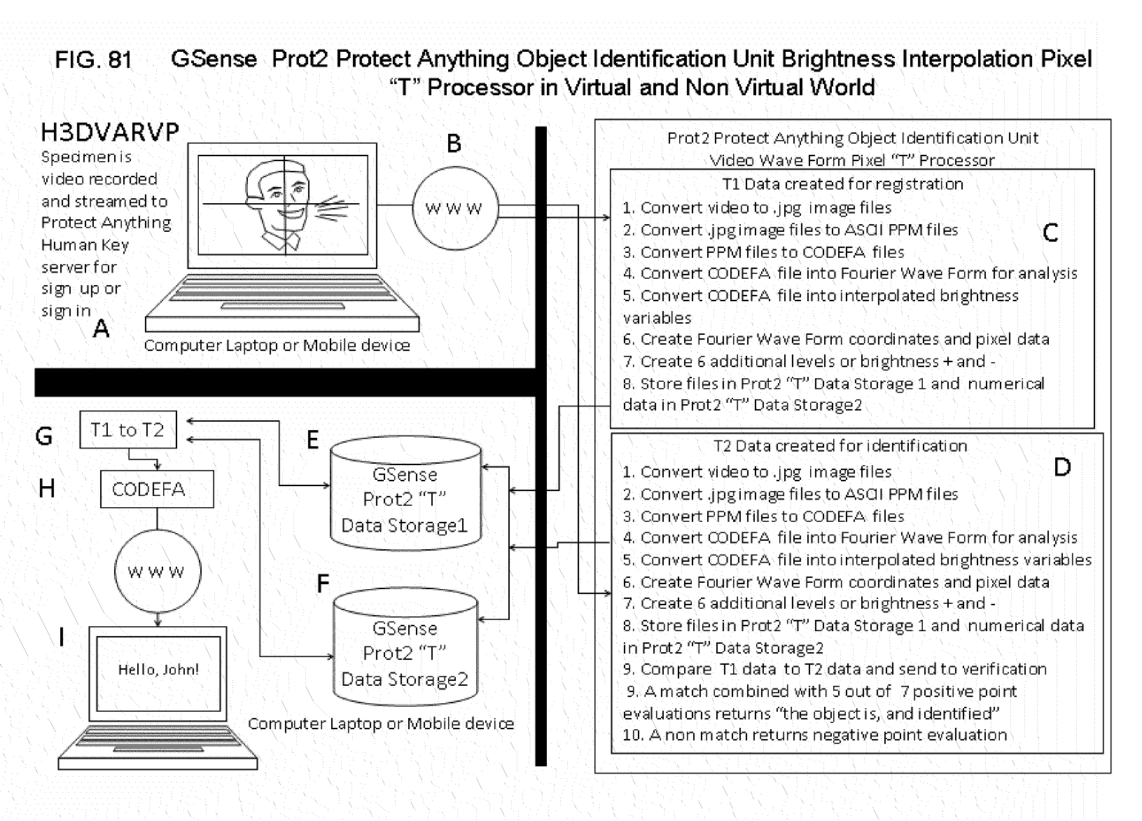

FIG. 81A describes GSense Prot2 Protect Anything Object Identification Unit Brightness Interpolation Pixel “T” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 81B describes GSense Prot2 Protect Anything Object Identification Unit Brightness Interpolation Pixel “T” Processor and shows where the WWW or World Wide Web is used for data aggregation and comparison analysis methods.

FIG. 81C describes GSense Prot2 Protect Anything Object Identification Unit Brightness Interpolation Pixel “T” Processor and shows where the Prot2 Protect Anything Object Identification Unit Video Fourier wave form Pixel “T” Processor T1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Creates 6 additional levels or brightness + and −, 8. Stores files in Prot2 “T” Data Storage 1 and numerical data in Prot2 “T” Data Storage2.

FIG. 81D describes GSense Prot2 Protect Anything Object Identification Unit Brightness Interpolation Pixel “T” Processor and shows where the Prot2 Protect Anything Object Identification Unit Video Fourier wave form Pixel “T” Processor T2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Creates 6 additional levels or brightness + and −, 8. Stores files in Prot2 “T” Data Storage 1 and numerical data in Prot2 “T” Data Storage 2, 9. Compares T1 data to T2 data and send to verification, 9. Where a match combined with 5 out of 7 positive point evaluations returns “the object is, and identified”, 10. Where a non match returns negative point evaluation.

FIG. 81E describes GSense Prot2 Protect Anything Object Identification Unit Brightness Interpolation Pixel “T” Processor and shows the GSense Prot2 “T’ Data Storage1.

FIG. 81F describes GSense Prot2 Protect Anything Object Identification Unit Brightness Interpolation Pixel “T” Processor and shows the GSense Prot2 “‘T” Data Storage2.

FIG. 81G describes GSense Prot2 Protect Anything Object Identification Unit Brightness Interpolation Pixel “T’ Processor and shows where the T1 to T2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.

FIG. 81H describes. GSense Prot2 Protect Anything Object Identification Unit Brightness Interpolation Pixel “T” Processor and shows the Protect Anything CODEFA mechanism that provides storage, security, human key and tracking features.

FIG. 81I describes GSense Prot2 Protect Anything Object Identification Unit Brightness Interpolation Pixel “T” Processor and shows where the WWW or World Wide Web is used for data aggregation and comparison analysis methods “Hello, John” with a Computer Laptop, or Mobile device.

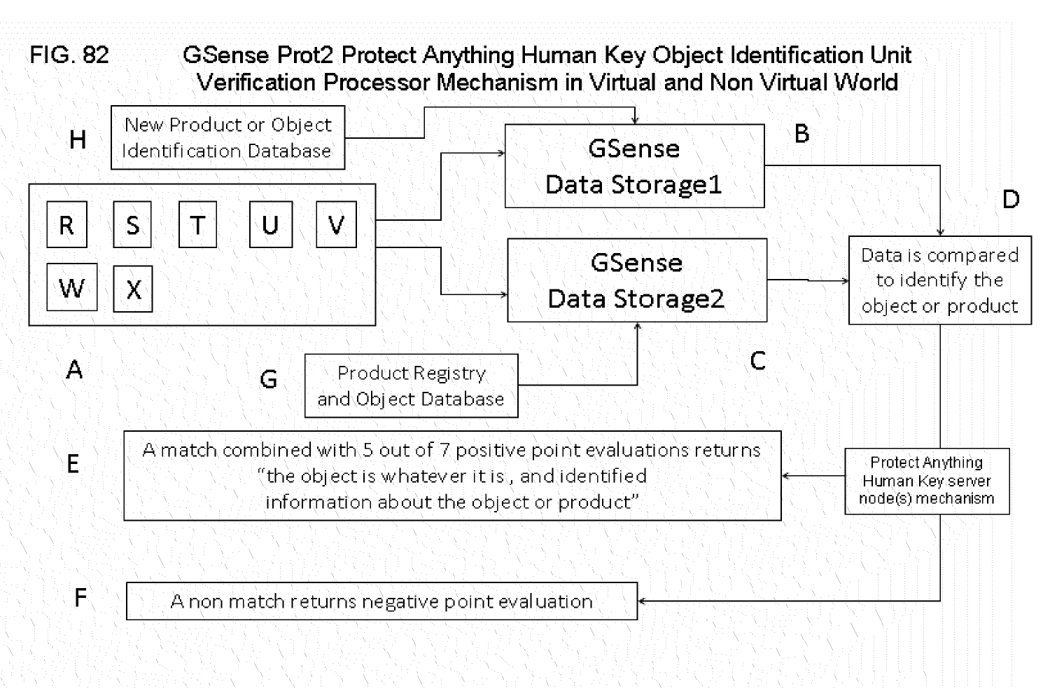

FIG. 82A describes GSense Prot2 Protect Anything Object Identification Unit Verification Processor Mechanism where the R,S,T,U,V,W,X object identification processors are used to compare the product registry and objects database data with the new product or object identification database for possible matches.

FIG. 82B describes GSense Prot2 Protect Anything Object Identification Unit Verification Processor Mechanism GSense Data Storage 1 area with new product or object identification database.

FIG. 82C describes GSense Prot2 Protect Anything Object Identification Unit Verification Processor Mechanism GSense Data Storage 2 area with pre entered product registry and object database data.

FIG. 82D describes GSense Prot2 Protect Anything Object Identification Unit Verification Processor Mechanism is where data is compared to identify the object or the product.

FIG. 82E describes GSense Prot2 Protect Anything Object Identification Unit Verification Processor Mechanism where a match combined with 5 out of 7 positive point evaluations returns “the object is whatever it is, and identified information about the object or product”.

FIG. 82F describes GSense Prot2 Protect Anything Object Identification Unit Verification Processor Mechanism where a non match returns negative point evaluation.

FIG. 82G describes GSense Prot2 Protect Anything Object Identification Unit Verification Processor Mechanism Product Registry and Object Database.

FIG. 82H describes GSense Prot2 Protect Anything Object Identification Unit Verification Processor Mechanism the New Product or Object identification Database.

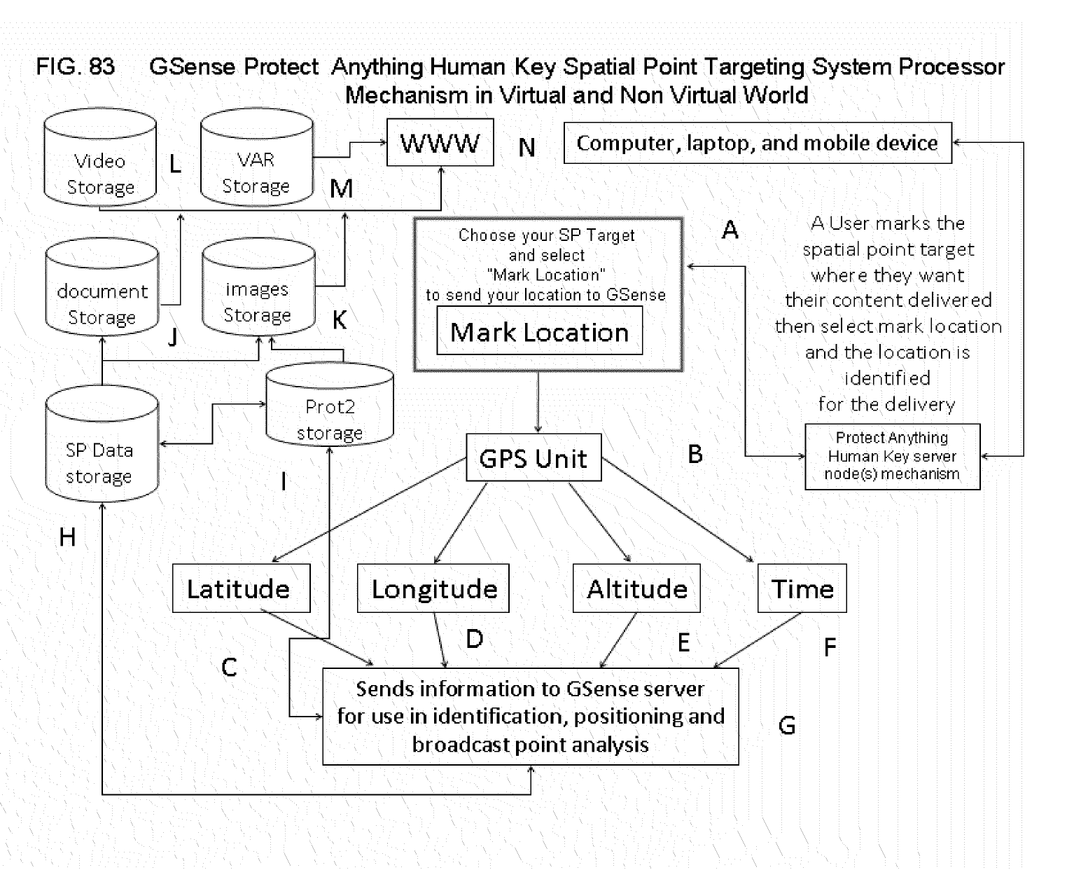

FIG. 83A describes GSense Protect Anything Spatial Point Targeting System Processor Mechanism and shows where A user marks the spatial point target, or targets where they want their content delivered to then selects “Mark Location” and the location is identified for the delivery where you Choose your SP Target and select “Mark Location” to send your location to GSense on a Computer, laptop, and mobile device and that location is locked into the mechanism for broadcast delivery by Latitude, Longitude, Altitude, and Time coordinates.

FIG. 83B describes GSense Protect Anything Spatial Point Targeting System Processor Mechanism and shows where the GPS Unit in Computer, laptop, and mobile device is used to get spatial point coordinates of the actual position of the device for locking into a delivery point for content by Latitude, Longitude, Altitude, and Time coordinates with Degrees, Minutes, and Seconds coordinates.

FIG. 83C describes GSense Protect Anything Spatial Point Targeting System Processor Mechanism and shows the Latitude coordinate.

FIG. 83D describes GSense Protect Anything Spatial Point Targeting System Processor Mechanism and shows the Longitude coordinate.

FIG. 83E describes GSense Protect Anything Spatial Point Targeting System Processor Mechanism and shows the Altitude coordinate.

FIG. 83F describes GSense Protect Anything Spatial Point Targeting System Processor Mechanism and shows the Time coordinate.

FIG. 83G describes GSense Protect Anything Spatial Point Targeting System Processor Mechanism and shows where the GPS delivery spatial point target is set for content by Latitude, Longitude, Altitude, and Time coordinates with Degrees, Minutes, and Seconds coordinates sends information to GSense server for use in identification, positioning and broadcast point analysis.

FIG. 83H describes GSense Protect Anything Spatial Point Targeting System Processor Mechanism and shows the GSense Protect Anything Spatial Point data storage mechanism.

FIG. 83I describes GSense Protect Anything Spatial Point Targeting System Processor Mechanism and shows the GSense Protect Anything Prot2 Spatial Point data storage mechanism.

FIG. 83J describes GSense Protect Anything Spatial Point Targeting System Processor Mechanism and shows the GSense Protect Anything document storage mechanism.

FIG. 83K describes GSense Protect Anything Spatial Point Targeting System Processor Mechanism and shows the GSense Protect Anything images storage mechanism.

FIG. 83L describes GSense Protect Anything Spatial Point Targeting System Processor Mechanism and shows the GSense Protect Anything video storage mechanism.

FIG. 83M describes GSense Protect Anything Spatial Point Targeting System Processor Mechanism and shows the GSense Protect Anything virtual augmented reality storage mechanism.

FIG. 83N describes GSense Protect Anything Spatial Point Targeting System Processor Mechanism and shows the WWW or World Wide Web.

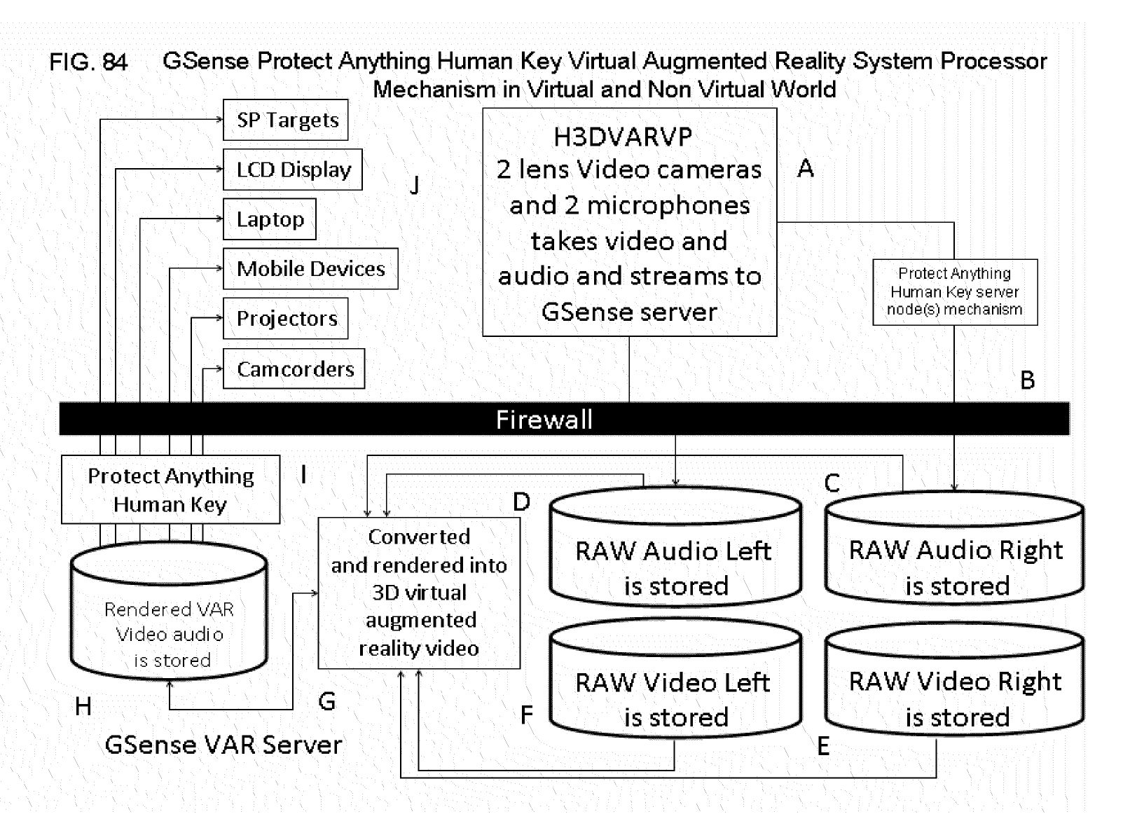

FIG. 84A describes GSense Protect Anything H3DVARV 3D Human Video Audio Stereo Viewing and Recording Virtual Augmented Reality System Processor Mechanism and shows the H3DVARV or Human 3 Dimensional Video Audio Recorder Viewer 2 lens and 2 APS cameras takes video and streams to GSense server for processing of the 4 data streams 2 video and 2 audio streams.

FIG. 84B describes GSense Protect Anything H3DVARV 3D Human Video Audio Stereo Viewing and Recording Virtual Augmented Reality System Processor Mechanism and shows the Firewall.

FIG. 84C describes GSense Protect Anything H3DVARV 3D Human Video Audio Stereo Viewing and Recording Virtual Augmented Reality System Processor Mechanism and shows the RAW Audio Right is stored for later processing.

FIG. 84D describes GSense Protect Anything H3DVARV 3D Human Video Audio Stereo Viewing and Recording Virtual Augmented Reality System Processor Mechanism and shows the RAW Audio Left is stored for later processing.

FIG. 84E describes GSense Protect Anything H3DVARV 3D Human Video Audio Stereo Viewing and Recording Virtual Augmented Reality System Processor Mechanism and shows the RAW Video Right is stored for later processing.

FIG. 84F describes GSense Protect Anything H3DVARV 3D Human Video Audio Stereo Viewing and Recording Virtual Augmented Reality System Processor Mechanism and shows the RAW Video Left is stored for later processing.

FIG. 84G describes GSense Protect Anything H3DVARV 3D Human Video Audio Stereo Viewing and Recording Virtual. Augmented Reality System Processor Mechanism and shows GSense VAR Server where the 2 video and 2 audio files are converted and rendered into 3D virtual augmented reality video.

FIG. 84H describes GSense Protect Anything H3DVARV 3D Human Video Audio Stereo Viewing and Recording Virtual Augmented Reality System Processor Mechanism and shows GSense VAR Server where the VAR video audio that is rendered is stored.

FIG. 84I describes GSense Protect Anything H3DVARV 3D Human Video Audio Stereo Viewing and Recording Virtual Augmented Reality System Processor Mechanism and shows and then shows where the broadcast or delivery is run through the Protect Anything Human Key before the delivery takes place.

FIG. 84J describes GSense Protect Anything H3DVARV 3D Human Video Audio Stereo' Viewing and Recording Virtual Augmented Reality System Processor Mechanism and shows the broadcast or delivery to SP Targets, LCD Display, Laptop, Mobile Devices, Projectors, and Camcorders through the firewall.

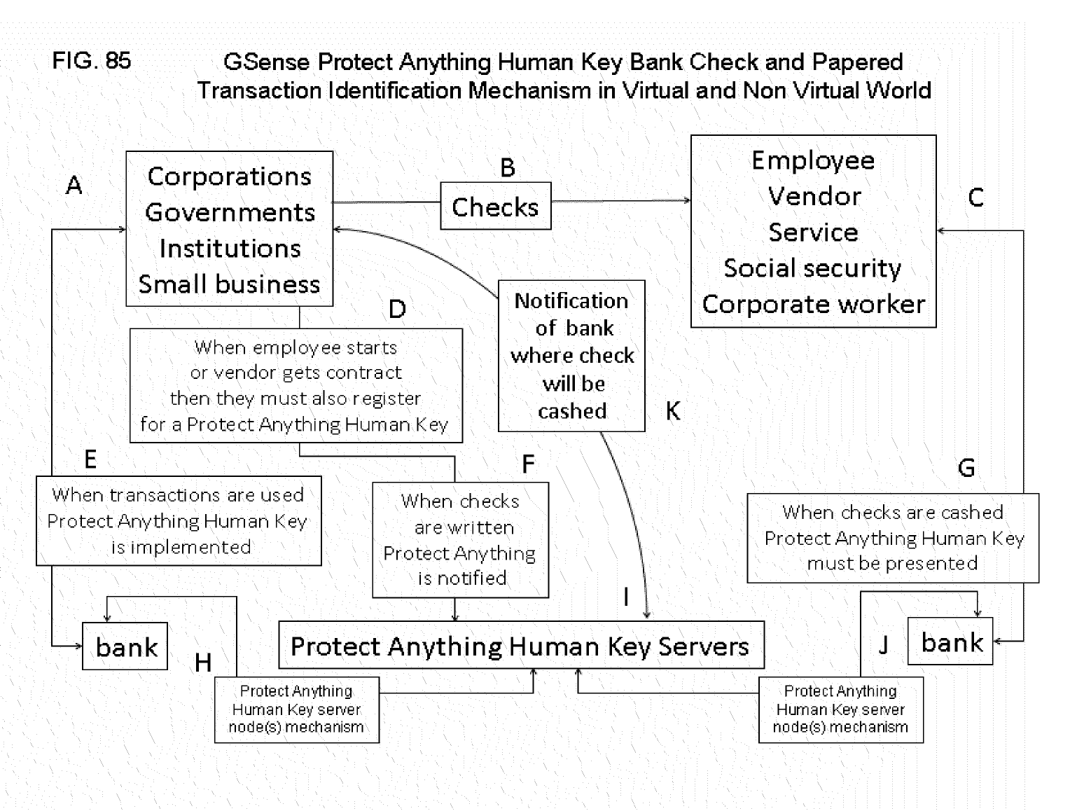

FIG. 85A describes Protect Anything Human Key Bank Check and Papered Transaction Identification Mechanism and shows where Corporations, Governments, Institutions, Small business can protect their checks written from forgery utilizing the Protect Anything Human Key system.

FIG. 85B describes Protect Anything Human Key Bank Check and Papered Transaction Identification Mechanism and shows where Corporations, Governments, Institutions, Small business can protect their checks written from forgery utilizing the Protect Anything Human Key system when utilizing a check.

FIG. 85C describes Protect Anything Human Key Bank Check and Papered Transaction Identification Mechanism and shows where Corporations, Governments, Institutions, Small business can protect their checks written from forgery utilizing the Protect Anything Human Key system Employee, Vendor, Service, Social security, corporate worker.

FIG. 85D describes Protect Anything Human Key Bank Check and Papered Transaction Identification Mechanism and shows when employee starts or vendor gets contract then they must also register for a Protect Anything Human Key for cashing checks from the business or institution.

FIG. 85E describes Protect Anything Human Key Bank Check and Papered Transaction Identification Mechanism and shows when transactions are used Protect Anything Human Key has to be implemented.

FIG. 85F describes Protect Anything Human Key Bank Check and Papered Transaction Identification Mechanism and shows when checks are written Protect Anything is notified by the business or institution.

FIG. 85G describes Protect Anything Human Key Bank Check and Papered Transaction Identification Mechanism and shows when checks are cashed Protect Anything Human Key must be presented for the person to be identified before money is paid.

FIG. 85H describes Protect Anything Human Key Bank Check and Papered Transaction Identification Mechanism and shows the Corporations, Governments, Institutions, Small business, bank account connection.

FIG. 85I describes Protect Anything Human Key Bank Check and Papered Transaction Identification Mechanism and shows the Protect Anything Human Key secure servers for processing identification data through 16 different identification tests.

FIG. 85J describes Protect Anything Human Key Bank Check and Papered Transaction Identification Mechanism and shows the Employee, Vendor, Service, Social security, corporate worker, bank account connection.

FIG. 85K describes Protect Anything Human Key Bank Check and Papered Transaction Identification Mechanism and shows as an additional verification, the business or institution can ask the person who will be getting the checks for the name of their bank and the Protect Anything Human Key can only cash checks that are cashed at that bank that is registered in the Protect Anything system.

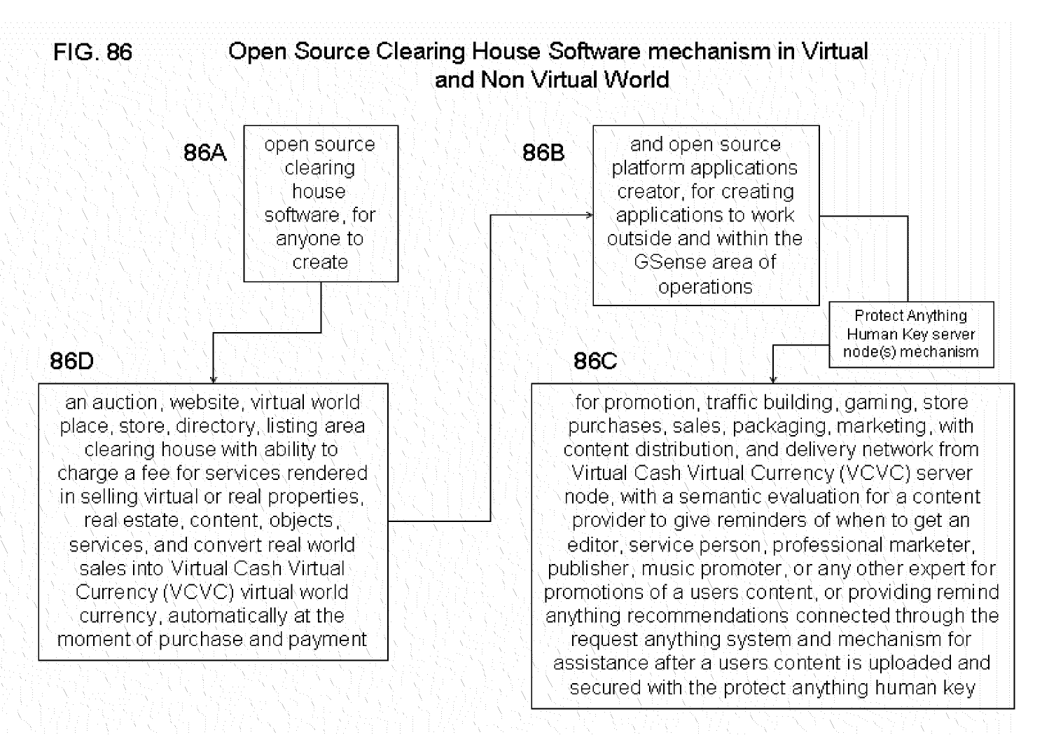

FIG. 86A illustrates the Open Source Clearing House Software mechanism in Virtual and Non Virtual World, open source clearing house software, for anyone to create.

FIG. 86B illustrates and open source platform applications creator, for creating applications to work outside and within the GSense area of operations linked to the Protect Anything Human Key server node(s) mechanism.

FIG. 86C illustrates for promotion, traffic building, gaming, store purchases, sales, packaging, marketing, with content distribution, and delivery network from Virtual Cash Virtual Currency (VCVC) server node, with a semantic evaluation for a content provider to give reminders of when to get an editor, service person, professional marketer, publisher, music promoter, or any other expert for promotions of a users content, or providing remind anything recommendations connected through the request anything system and mechanism for assistance after a users content is uploaded and secured with the protect anything human key.

FIG. 86D illustrates an auction, website, virtual world place, store, directory, listing area clearing house with ability to charge a fee for services rendered in selling virtual or real properties, real estate, content, objects, services, and convert real world sales into Virtual Cash Virtual Currency (VCVC) virtual world currency, automatically at the moment of purchase and payment.

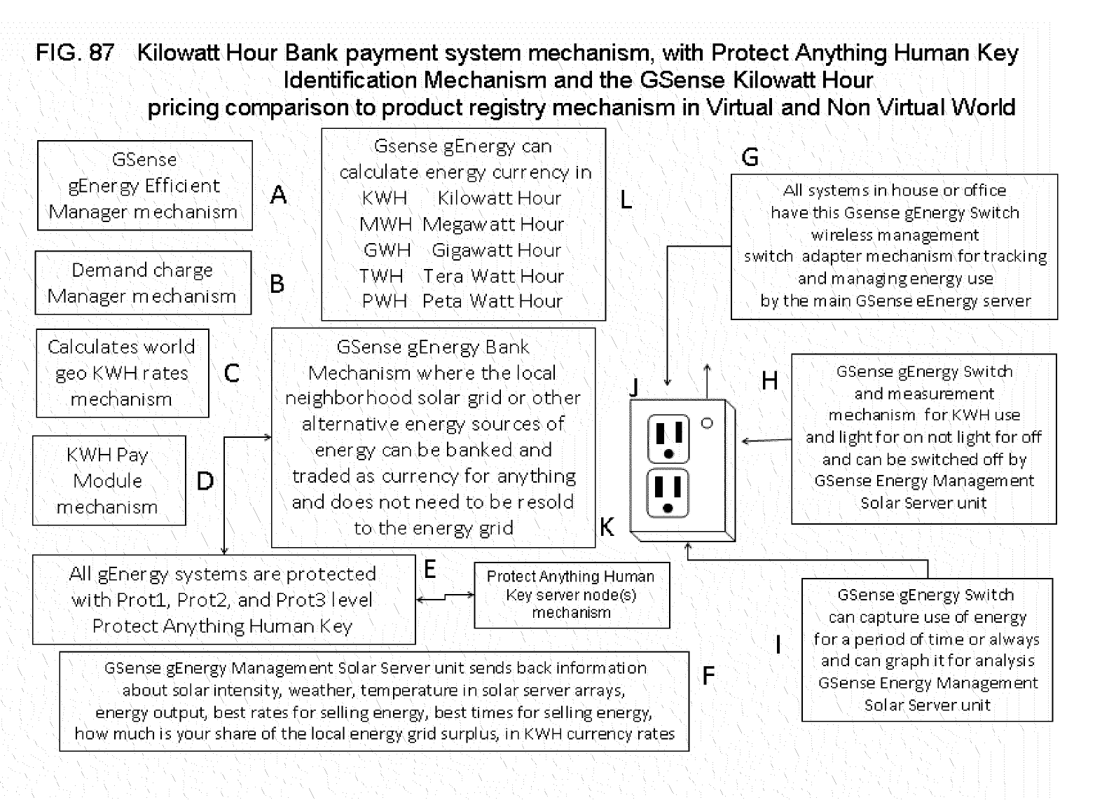

FIG. 87A describes Kilowatt Hour Bank payment system mechanism, with Protect. Anything Human Key Identification Mechanism and the GSense Kilowatt Hour pricing comparison to product registry mechanism and shows the GSense eEnergy Efficient Manager mechanism.

FIG. 87B describes Kilowatt Hour Bank payment system mechanism, with Protect Anything Human Key Identification Mechanism and the GSense Kilowatt Hour pricing comparison to product registry mechanism and shows the Demand charge Manager mechanism.

FIG. 87C describes Kilowatt Hour Bank payment system mechanism, with Protect Anything Human Key Identification Mechanism and the GSense Kilowatt Hour pricing comparison to product registry mechanism and shows the Calculates world geo KWH rates mechanism.

FIG. 87D describes Kilowatt Hour Bank payment system mechanism, with Protect Anything Human Key Identification Mechanism and the GSense Kilowatt Hour pricing comparison to product registry mechanism and shows the KWH Pay Module mechanism.

FIG. 87E describes Kilowatt Hour Bank payment system mechanism, with Protect Anything Human Key Identification Mechanism and the GSense Kilowatt Hour pricing comparison to product registry mechanism and shows that all eEnergy systems are protected with Prot1, Prot2, and Prot3 level Protect Anything Human Key.

FIG. 87F describes Kilowatt Hour Bank payment system mechanism, with Protect Anything Human Key Identification Mechanism and the GSense Kilowatt Hour pricing comparison to product registry mechanism and shows the GSense eEnergy Management Solar Server unit sends back information about solar intensity, weather, temperature in solar server arrays, energy output, best rates for selling energy, best times for selling energy, how much is your share of the local energy grid surplus, in KWH currency rates.

FIG. 87G describes Kilowatt Hour Bank payment system mechanism, with Protect Anything Human Key Identification Mechanism and the GSense Kilowatt Hour pricing comparison to product registry mechanism and shows that All systems in house or office have the GSense wireless management switch adapter mechanism for tracking .and managing energy use by the main GSense eEnergy server.

FIG. 87H describes Kilowatt Hour Bank payment system mechanism, with Protect Anything Human Key Identification Mechanism and the GSense Kilowatt Hour pricing comparison to product registry mechanism and shows the GSense eEnergy Switch adapter and measurement mechanism for KWH use and light for on not light for off and can be switched off by GSense Energy Management Solar Server unit.

FIG. 87I describes Kilowatt Hour Bank payment system mechanism, with Protect Anything Human Key Identification Mechanism and the GSense Kilowatt Hour pricing comparison to product registry mechanism and shows the GSense eEnergy Switch adapter can capture use of energy for a period of time or always and can graph it for, analysis GSense Energy Management Solar Server unit.

FIG. 87J describes Kilowatt Hour Bank payment system mechanism, with Protect Anything Human Key Identification Mechanism and the GSense Kilowatt Hour pricing comparison to product registry mechanism and shows the GSense eEnergy Switch adapter.

FIG. 87K describes Kilowatt Hour Bank payment system mechanism, with Protect Anything Human Key Identification Mechanism and the GSense Kilowatt Hour pricing comparison to product registry mechanism and shows the GSense eEnergy Bank Mechanism where the local neighborhood solar grid energy or other alternative energy sources of energy can be banked and traded as currency for anything and does not need to be resold to the energy grid.

FIG. 87L describes Kilowatt Hour Bank payment system mechanism, with Protect Anything Human Key Identification Mechanism and the GSense Kilowatt Hour pricing comparison to product registry mechanism and shows where energy in the GSense eEnergy system can calculate energy currency in KWH Kilowatt Hour, or larger amounts for industry like MWH Megawatt Hour, GWH Gigawatt Hour, TWH Tera Watt Hour, PWH Peta Watt Hour.

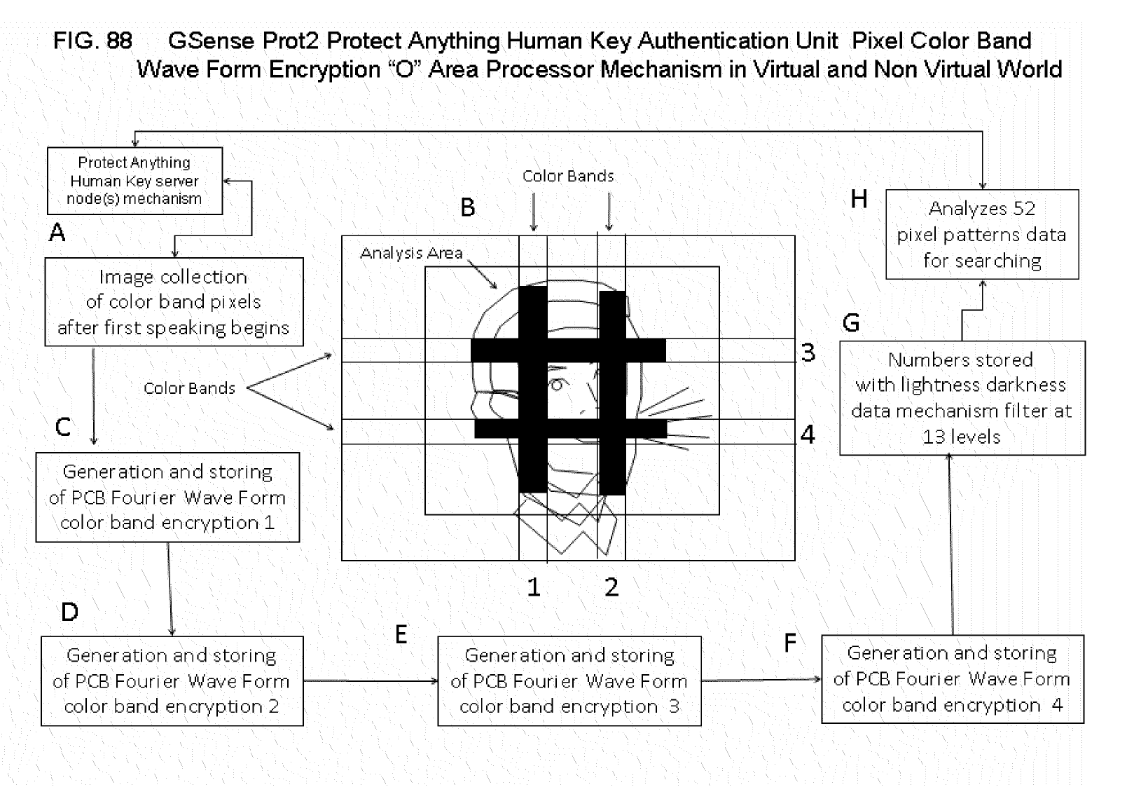

FIG. 88A describes GSense Prot2 Protect Anything Human Key Authentication Unit Pixel Color Band Fourier wave form Encryption “O” Area Processor Mechanism and shows where the Image collection of color band pixels begins after first audio speaking phrase begins.

FIG. 88B describes GSense Prot2 Protect Anything Human Key Authentication Unit Pixel Color Band Fourier wave form Encryption “O” Area Processor Mechanism and shows where analysis Area Color Bands begins.

FIG. 88C describes GSense Prot2 Protect Anything Human Key Authentication Unit Pixel Color Band Fourier wave form Encryption “O” Area Processor Mechanism and shows the Generation and storing of PCB Fourier wave form color band encryption 1.

FIG. 88D describes GSense Prot2 Protect Anything Human Key Authentication Unit Pixel Color Band Fourier wave form Encryption “O” Area Processor Mechanism and shows the Generation and storing of PCB Fourier wave form color band encryption 2.

FIG. 88E describes GSense Prot2 Protect Anything Human Key Authentication Unit Pixel Color Band Fourier wave form Encryption “O” Area Processor Mechanism and shows the Generation and storing of PCB Fourier wave form color band encryption 3.

FIG. 88F describes GSense Prot2 Protect Anything Human Key Authentication Unit Pixel Color Band Fourier wave form Encryption “O” Area Processor Mechanism and shows the Generation and storing of PCB Fourier wave form color band encryption 4.

FIG. 88G describes GSense Prot2 Protect Anything Human Key Authentication Unit Pixel Color Band Fourier wave form Encryption “O” Area Processor Mechanism and shows where the data numbers are stored with lightness darkness data mechanism filter are aggregated at 13 levels.

FIG. 88H describes GSense Prot2 Protect Anything Human Key Authentication Unit Pixel Color Band Fourier wave form Encryption “O” Area Processor Mechanism and shows where mechanism analyzes 52 pixel patterns image data for searching.

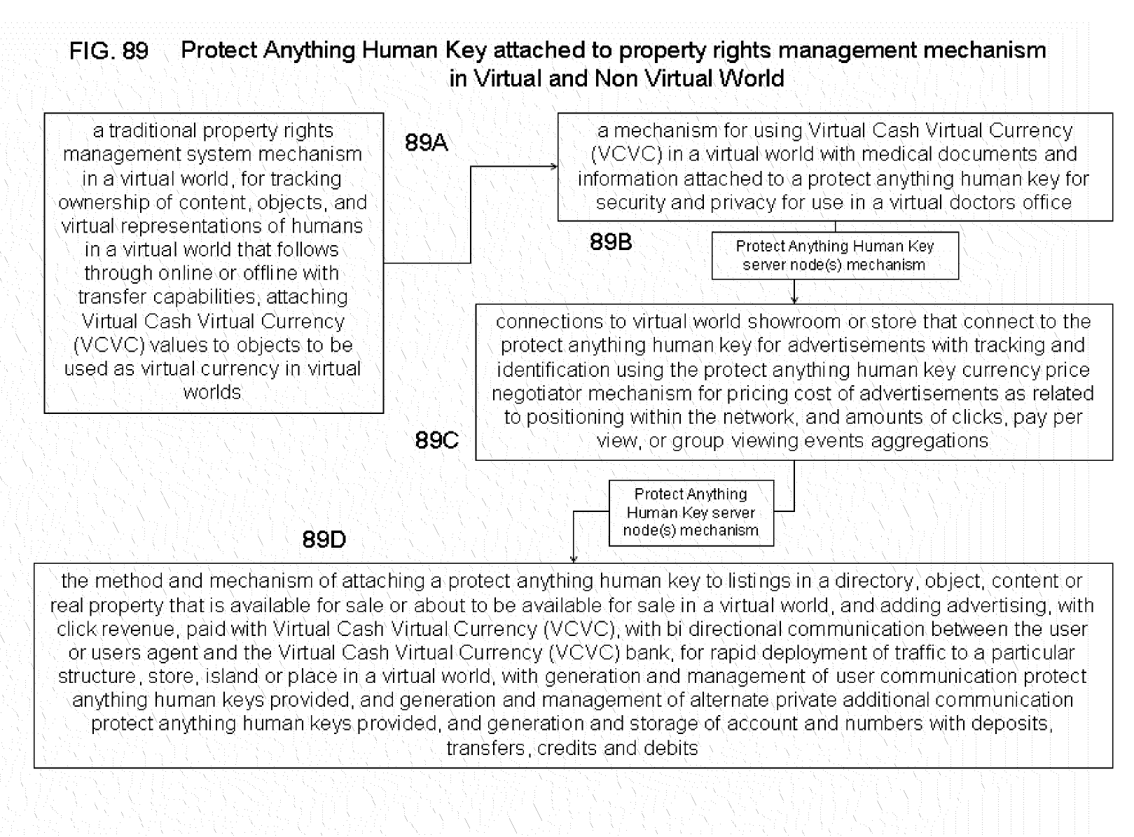

FIG. 89A illustrates Protect Anything Human Key attached to property rights management mechanism in Virtual and Non Virtual World and a traditional property rights management system mechanism in a virtual world, for tracking ownership of content, objects, and virtual representations of humans in a virtual world that follows through online or offline with transfer capabilities, attaching Virtual Cash Virtual Currency (VCVC) values to objects to be used as virtual currency in virtual worlds.

FIG. 89B illustrates a mechanism for using Virtual Cash Virtual Currency (VCVC) in a virtual world with medical documents and information attached to a protect anything human key for security and privacy for use in a virtual doctors office linked to the Protect Anything Human Key.

FIG. 89C illustrates connections to virtual world showroom or store that connect to the protect anything human key for advertisements with tracking and identification using the protect anything human key currency price negotiator mechanism for pricing cost of advertisements as related to positioning within the network, and amounts of clicks, pay per view, or group viewing events aggregations linked to the Protect Anything Human Key.

FIG. 89D illustrates the method and mechanism of attaching a protect anything human key to listings in a directory, object, content or real property that is available for sale or about to be available for sale in a virtual world, and adding advertising, with click revenue, paid with Virtual Cash Virtual Currency (VCVC), with bi directional communication between the user or users agent and the Virtual Cash Virtual Currency (VCVC) bank, for rapid deployment of traffic to a particular structure, store, island or place in a virtual world, with generation and management of user communication protect anything human keys provided, and generation and management of alternate private additional communication protect anything human keys provided, and generation and storage of account and numbers with deposits, transfers, credits and debits.

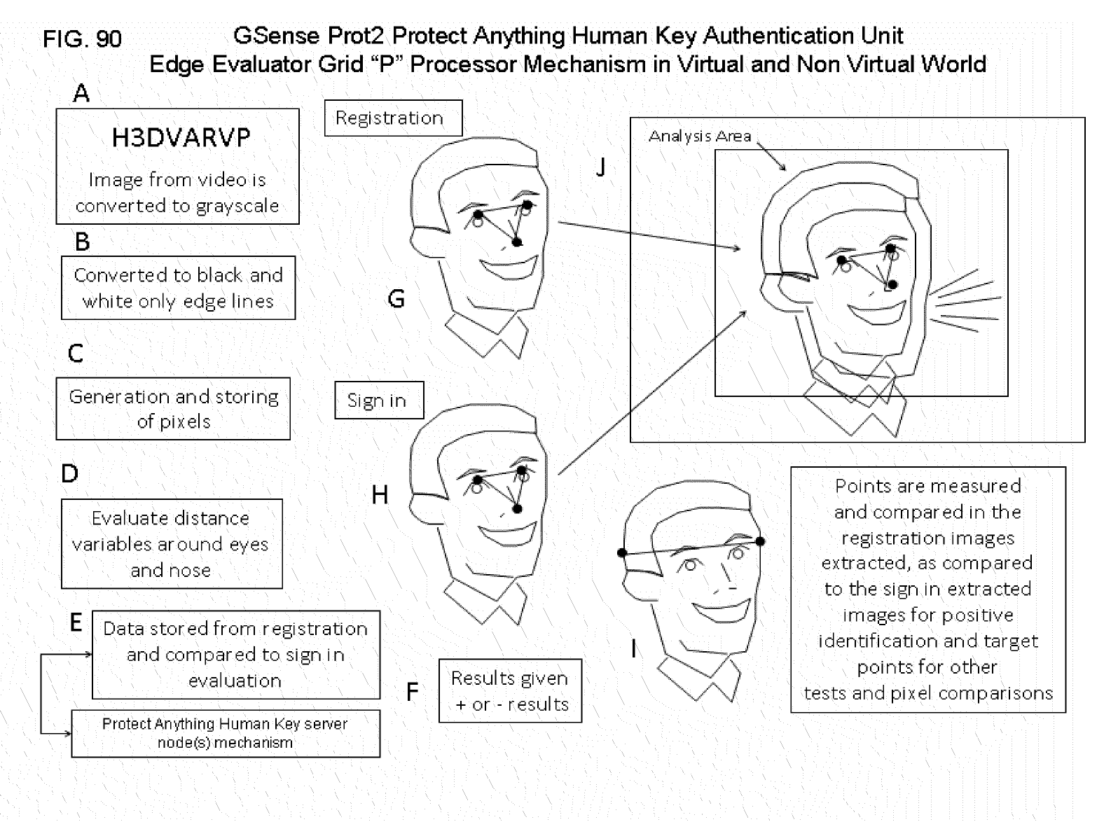

FIG. 90A describes GSense Prot2 Protect Anything Human Key Authentication Unit Edge Evaluator Grid “P” Processor Mechanism with H3DVARV 3D Human Video Audio Stereo Viewing and Recording Mechanism and shows where the Image from video is converted to grayscale.

FIG. 90B describes GSense Prot2 Protect Anything Human Key Authentication Unit Edge Evaluator Grid “P” Processor Mechanism and shows where the extracted image is converted to black and white only edge lines.

FIG. 90C describes GSense Prot2 Protect Anything Human Key Authentication Unit Edge Evaluator Grid “P” Processor Mechanism and shows where the data is generated and the storing of pixels data.

FIG. 90D describes GSense Prot2 Protect Anything Human Key Authentication Unit Edge Evaluator Grid “P” Processor Mechanism and shows where the evaluate distance data variables are aggregated from around subjects eyes and nose.

FIG. 90E describes GSense Prot2 Protect Anything Human Key Authentication Unit Edge Evaluator Grid “P” Processor Mechanism and shows where the Data is stored from registration and compared with sign in data for evaluation.

FIG. 90F describes GSense Prot2 Protect Anything Human Key Authentication Unit Edge Evaluator Grid “P” Processor Mechanism and shows where the Results are given with + or −results. + is a positive match and − is a negative match.

FIG. 90G describes GSense Prot2 Protect Anything Human Key Authentication Unit Edge Evaluator Grid “P” Processor Mechanism and shows where the Registration triangulation is made between the eyes and the nose for calculations and pattern matching identification.

FIG. 90H describes GSense Prot2 Protect Anything Human Key Authentication Unit Edge Evaluator Grid “P” Processor Mechanism and shows where the Sign In triangulation is made between the eyes and the nose for calculations and pattern matching identification.

FIG. 90I describes GSense Prot2 Protect Anything Human Key Authentication Unit Edge Evaluator Grid “P” Processor Mechanism and shows where the Points are measured and compared in the registration images extracted, as compared to the sign in extracted images for positive identification and target points for other tests and pixel comparisons.

FIG. 90J describes GSense Prot2 Protect Anything Human Key Authentication Unit Edge Evaluator Grid “P” Processor Mechanism and shows the analysis Area with the triangulation data and edge analysis overlay area.

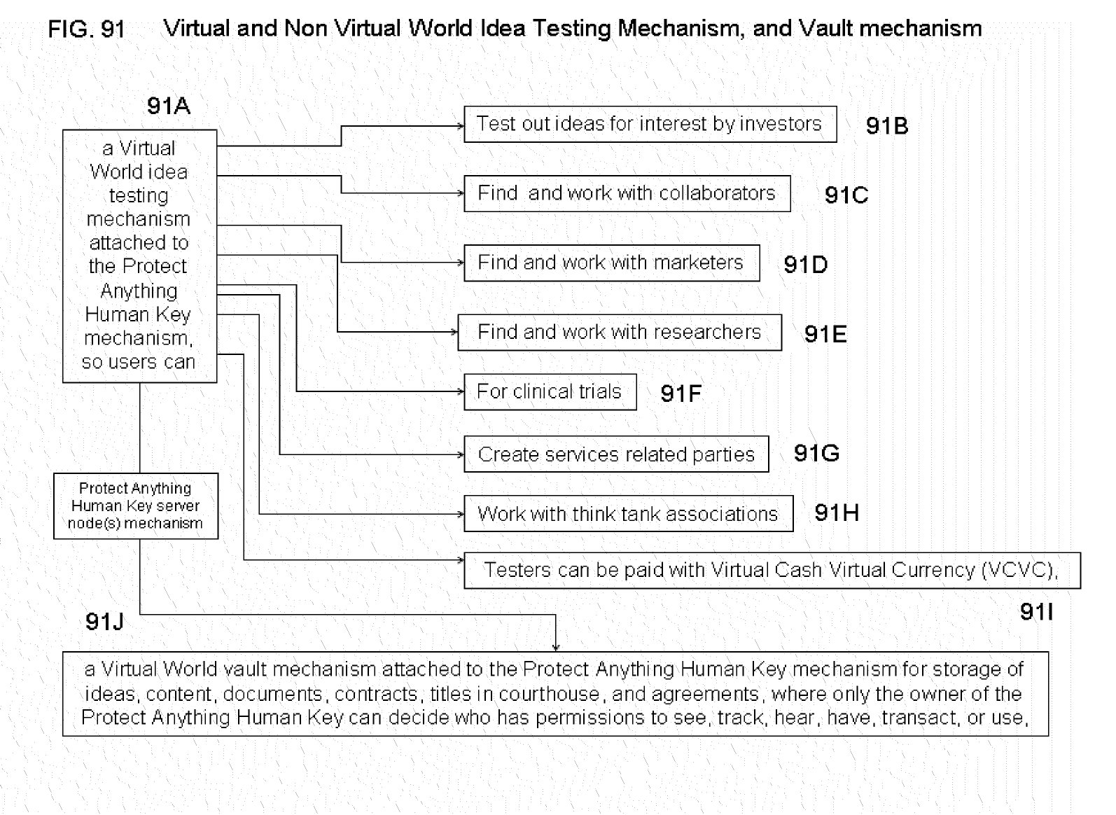

FIG. 91A illustrates Virtual and Non Virtual World Idea Testing Mechanism, and Vault mechanism, and a Virtual World idea testing mechanism attached to the Protect Anything Human Key mechanism, so users can do various uses.

FIG. 91B illustrates users can Test out ideas for interest by investors.

FIG. 91C illustrates users can Find and work with collaborators.

FIG. 91D illustrates users can Find and work with marketers.

FIG. 91E illustrates users can Find and work with researchers.

FIG. 91F illustrates users can test For clinical trials.

FIG. 91G illustrates users can Create services related parties.

FIG. 91H illustrates users can Work with think tank associations.

FIG. 91I illustrates user Testers can be paid with Virtual Cash Virtual Currency (VCVC).

FIG. 91J illustrates a Virtual World vault mechanism attached to the Protect Anything Human Key mechanism for storage of ideas, content, documents, contracts, titles in courthouse, and agreements, where only the owner of the Protect Anything Human Key can decide who has permissions to see, track, hear, have, transact, or use.

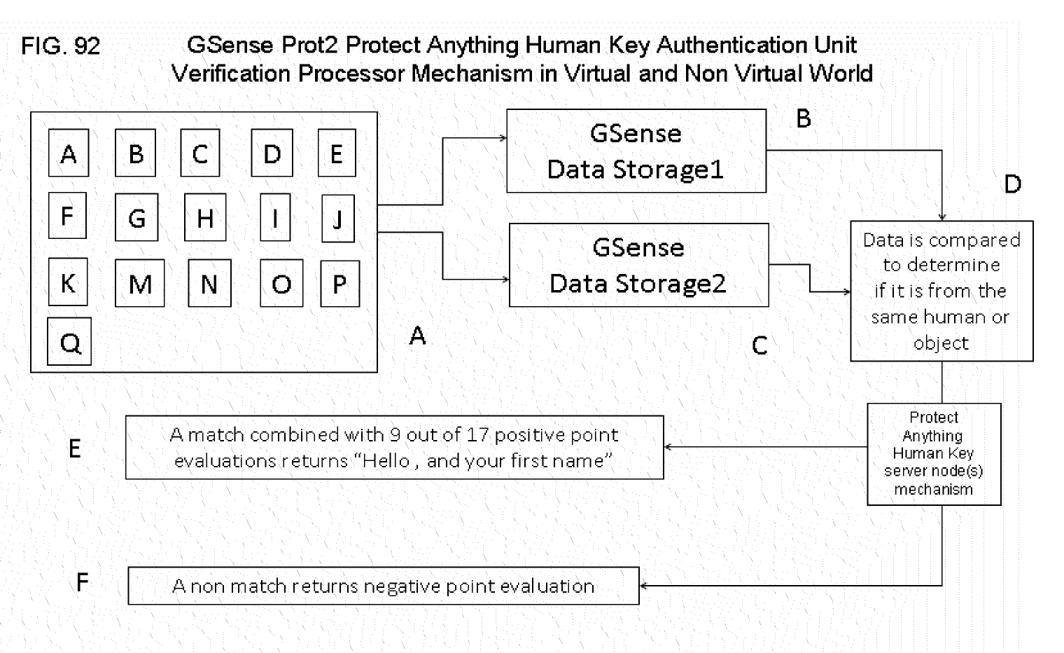

FIG. 92A describes GSense Prot2 Protect Anything Human Key Authentication Unit Verification Processor Mechanism and shows where all the processors are evaluated.

FIG. 92B describes GSense Prot2 Protect Anything Human Key Authentication Unit Verification Processor Mechanism and shows the GSense Data Storage1.

FIG. 92C describes GSense Prot2 Protect Anything Human Key Authentication Unit Verification Processor Mechanism and shows the GSense Data Storage2.

FIG. 92D describes GSense Prot2 Protect Anything Human Key Authentication Unit Verification Processor Mechanism and shows where the Data is compared to determine if it is from the same human or object.

FIG. 92E describes GSense Prot2 Protect Anything Human Key Authentication Unit Verification Processor Mechanism and shows where a match combined with 9 out of 16 positive point evaluations returns “Hello, and your first name”.

FIG. 92F describes GSense Prot2 Protect Anything Human Key Authentication Unit Verification Processor Mechanism and shows where a non match returns negative point evaluation.

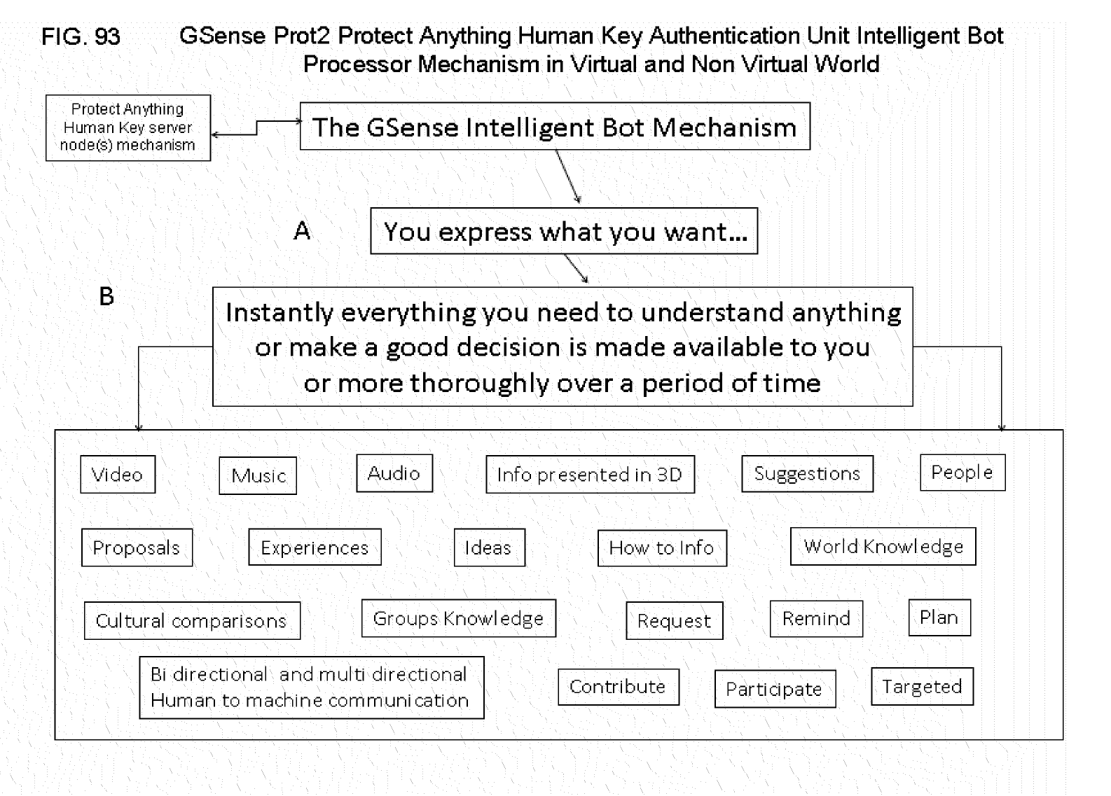

FIG. 93A illustrates GSense Prot2 Protect Anything Human Key Authentication Unit Intelligent Bot Processor Mechanism in Virtual and Non Virtual World.

FIG. 93B illustrates instantly everything you need to understand anything or make a good decision is made available to you or more thoroughly over a period of time and all the mechanisms.

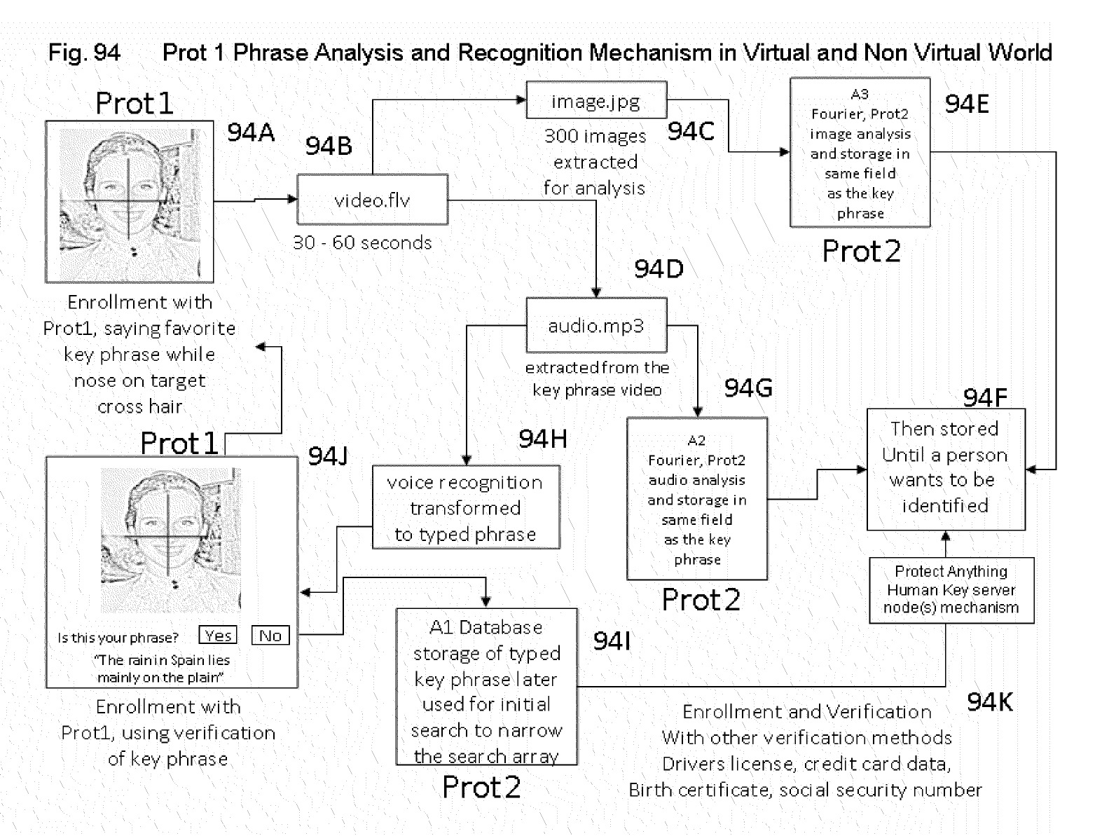

FIG. 94 is a block diagram illustrating a method and mechanism and mechanism for phrase analysis and human recognition as part of an embodiment of the present invention.

FIG. 94A is a block diagram illustrating an enrollment method and mechanism with ProtI, saying favorite key phrase while nose is on target cross hair of screen from cam.

FIG. 94B is a block diagram illustrating an extraction of a video.flv that is the length of 30 to 60 seconds.

FIG. 94C is a block diagram illustrating an extraction of 300 images for analysis from the key phrase video.

FIG. 94D is a block diagram illustrating an extraction of audio from the key phrase video.

FIG. 94E is a block diagram illustrating a Fourier, Prot2, transformation from image.jpg file for analysis and storage in the same field as the key phrase for further processing.

FIG. 94F is a block diagram illustrating that the data is then stored in a database until a person wants to be identified.

FIG. 94G is a block diagram illustrating a Fourier, Prot2, transformation from audio.mp3 file for analysis and storage in the same field as the key phrase for further processing.

FIG. 94H is a block diagram illustrating a voice recognition mechanism that takes voice and converts it to typed phrase.

FIG. 94I is a block diagram illustrating a database storage mechanism of typed key phrase that is later used for the initial search, to narrow the search array.

FIG. 94J is a block diagram illustrating the Prot1 mechanism where a user is asked to say a phrase then verify that the typed phrase is the one that was said by the user yes or no and enrollment begins when the user presses yes and all of the audio, video, image, transformations of data, and the text data is stored for future comparison and identification.

FIG. 94K is a block diagram illustrating the enrollment and verification with other verification method and mechanisms that can be added to the enrollment mechanism like driver's license, credit card data, birth certificate, and social security number.

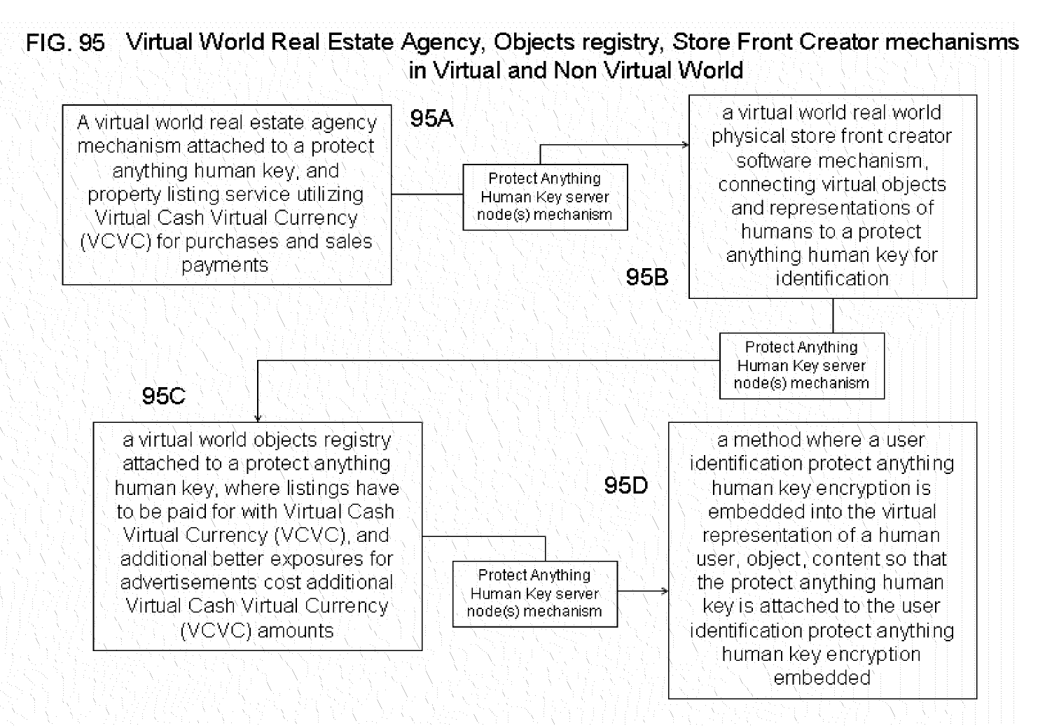

FIG. 95A illustrates Virtual World Real Estate Agency, Objects registry, Store Front Creator mechanisms in Virtual and Non Virtual World and a virtual world real estate agency mechanism attached to a protect anything human key, and property listing service utilizing Virtual Cash Virtual Currency (VCVC) for purchases and sales payments linked to the Protect Anything Human Key.

FIG. 95B illustrates a virtual world real world physical store front creator software mechanism, connecting virtual objects and representations of humans to a protect anything human key for identification.

FIG. 95C illustrates a virtual world objects registry attached to a protect anything human key, where listings have to be paid for with Virtual Cash Virtual Currency (VCVC), and additional better exposures for advertisements cost additional Virtual Cash Virtual Currency (VCVC) amounts.

FIG. 95D illustrates a method where a user identification protect anything human key encryption is embedded into the virtual representation of a human user, object, content so that the protect anything human key is attached to the user identification protect anything human key encryption embedded.

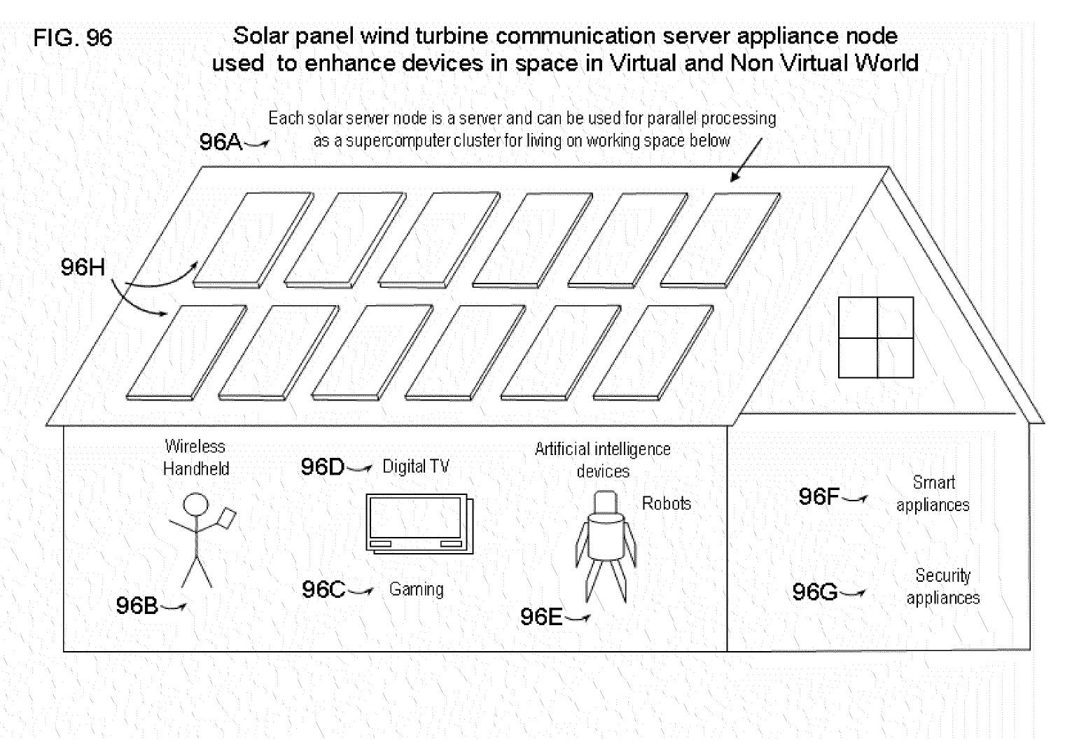

FIG. 96 is a conceptual diagram illustrating a method and mechanism for terrestrial based solar panel wind turbine communication server appliance node wireless or wired remote transfer of information to smart devices, robots, artificial intelligent agents mechanism in another embodiment of the present invention.

FIG. 96A is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information use in another embodiment of the present invention.

FIG. 96B is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information with wireless handheld devices in another embodiment of the present invention.

FIG. 96C is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information gaming in another embodiment of the present invention.

FIG. 96D is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information digital TV 3D or high definition TV in another embodiment of the present invention.

FIG. 96E is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information artificial intelligence, robots in another embodiment of the present invention.

FIG. 96F is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information smart appliances in another embodiment of the present invention.

FIG. 96G is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information security appliances in another embodiment of the present invention.

FIG. 96H is a conceptual diagram illustrating a method and mechanism for each solar panel wind turbine communication server appliance node is a server and can be used for parallel processing as a supercomputer cluster in the living and working space below plus remotely wirelessly or wired for use in entertainment or information utilizing the supercomputer aspects of the solar panel wind turbine communication server appliance node cluster for research remotely in another embodiment of the present invention.

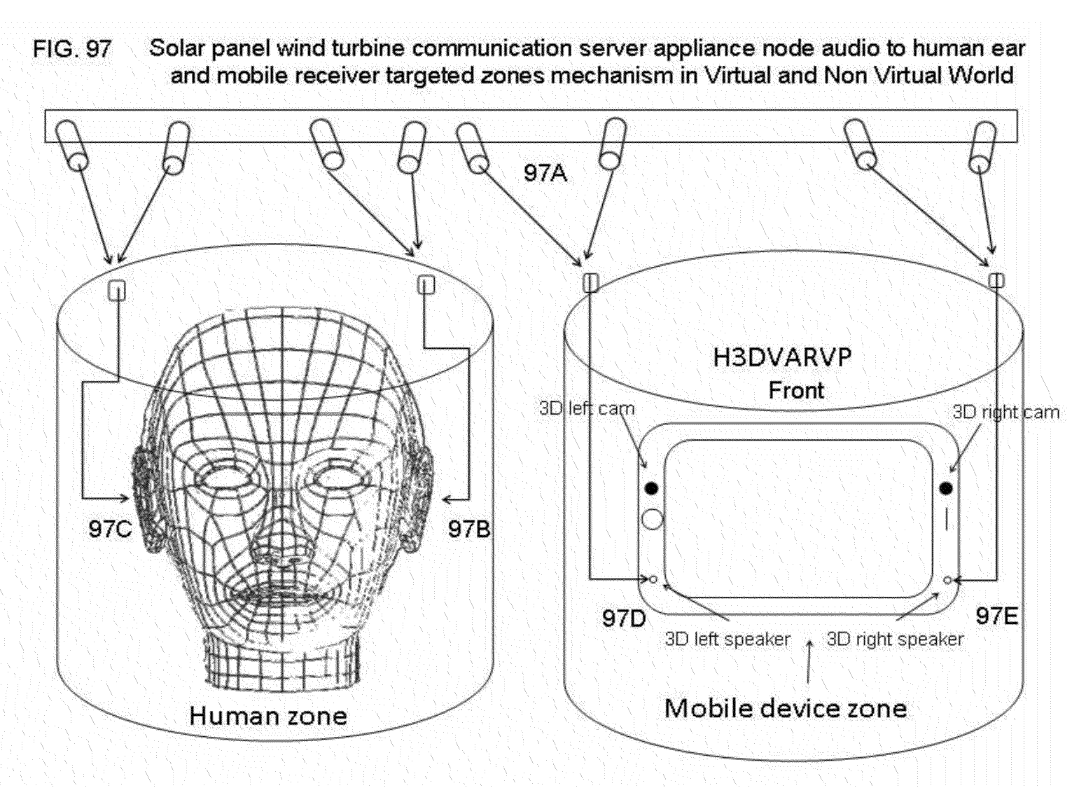

FIG. 97 is a conceptual diagram illustrating a method and mechanism that shows Solar panel wind turbine communication server appliance node audio to human ear and mobile receiver targeted zones mechanism.

FIG. 97A is a conceptual diagram illustrating a method and mechanism that shows the solar panel wind turbine communication server appliance node lasers for audio transmission to spatial point.

FIG. 97B is a conceptual diagram illustrating a method and mechanism that shows audio transmission to spatial point zone near left ear.

FIG. 97C is a conceptual diagram illustrating a method and mechanism that shows audio transmission spatial point zone near right ear.

FIG. 97D is a conceptual diagram illustrating a method and mechanism that shows audio transmission to spatial point zone near 3D left speaker of mobile phone.

FIG. 97E is a conceptual diagram illustrating a method and mechanism that shows audio transmission to spatial point zone near 3D right speaker of mobile phone.

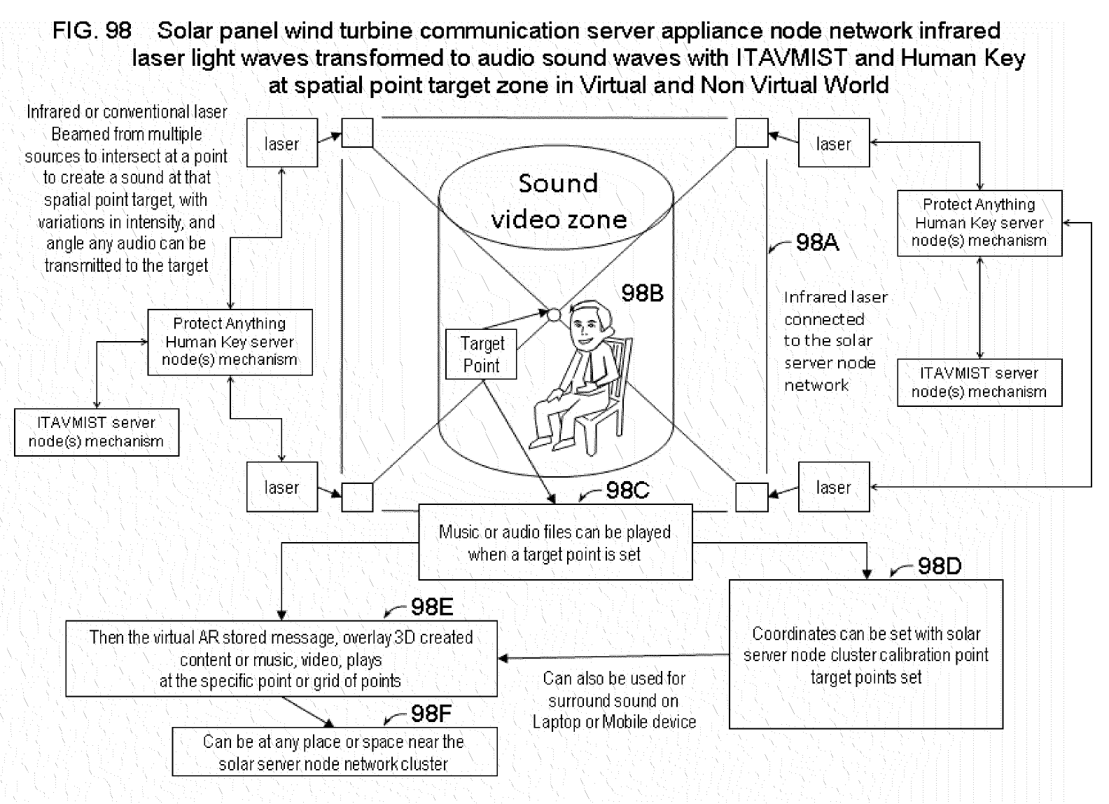

FIG. 98 is a conceptual diagram illustrating a method and mechanism that shows Solar panel wind turbine communication server appliance node network infrared laser light waves transformed to audio sound waves at spatial point target zone

FIG. 98A is a conceptual diagram illustrating a method and mechanism that shows Infrared laser connected to the solar panel wind turbine communication server appliance node network.

FIG. 98B is a conceptual diagram illustrating a method and mechanism that shows sound video zone point target with person hearing and viewing video.

FIG. 98C is a conceptual diagram illustrating a method and mechanism that shows where music or audio files can be played when a target point is set.

FIG. 98D is a conceptual diagram illustrating a method and mechanism that shows where coordinates can be set with solar panel wind turbine communication server appliance node cluster calibration point target points set.

FIG. 98E is a conceptual diagram illustrating a method and mechanism that shows where Then the virtual AR stored message, overlay 3D created content or music, video, plays at the specific point or grid of points.

FIG. 98F is a conceptual diagram illustrating a method and mechanism that shows where can be at any place or space near the solar panel wind turbine communication server appliance node network cluster.

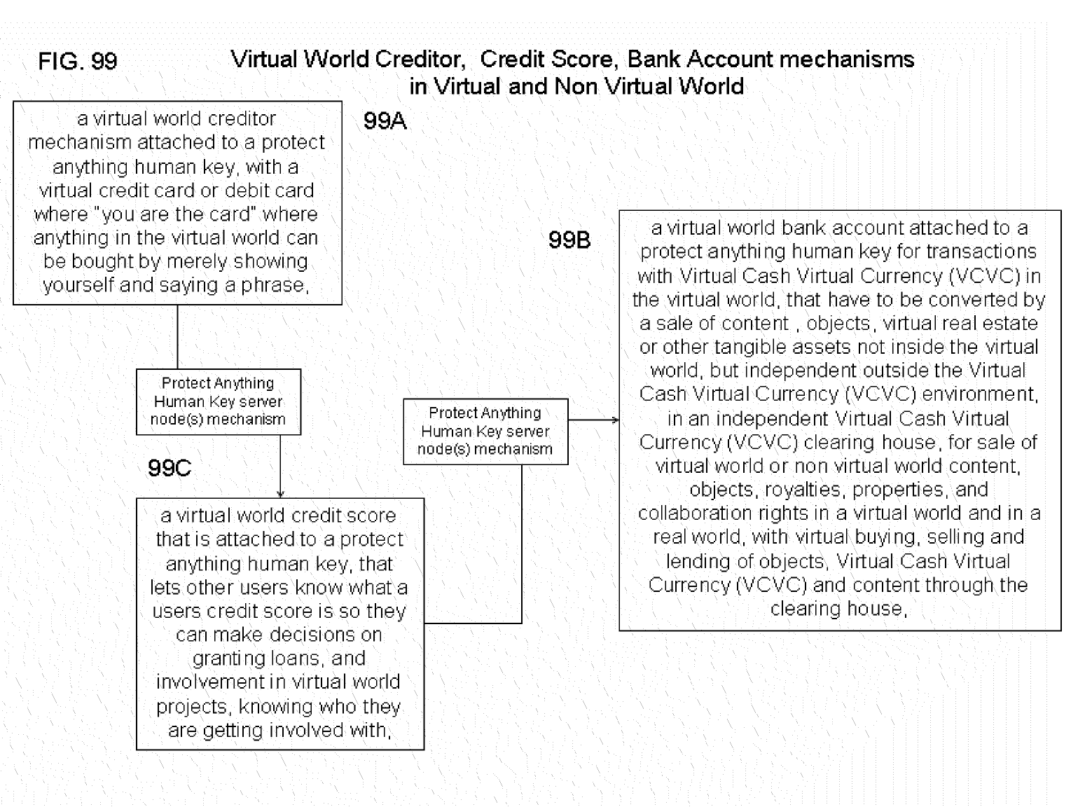

FIG. 99A illustrates Virtual World Creditor, Credit Score, Bank Account mechanisms in Virtual and Non Virtual World and a virtual world creditor mechanism attached to a protect anything human key, with a virtual credit card or debit card where “you are the card” where anything in the virtual world can be bought by merely showing yourself and saying a phrase.

FIG. 99B illustrates a virtual world bank account attached to a protect anything human key for transactions with Virtual Cash Virtual Currency (VCVC) in the virtual world, that have to be converted by a sale of content, objects, virtual real estate or other tangible assets not inside the virtual world, but independent outside the Virtual Cash Virtual Currency (VCVC) environment, in an independent Virtual Cash Virtual Currency (VCVC) clearing house, for sale of virtual world or non virtual world content, objects, royalties, properties, and collaboration rights in a virtual world and in a real world, with virtual buying, selling and lending of objects, Virtual Cash Virtual Currency (VCVC) and content through the clearing house linked to the Protect Anything Human Key.

FIG. 99C illustrates a virtual world credit score that is attached to a protect anything human key, that lets other users know what a users credit score is so they can make decisions on granting loans, and involvement in virtual world projects, knowing who they are getting involved with linked to the Protect Anything Human Key.

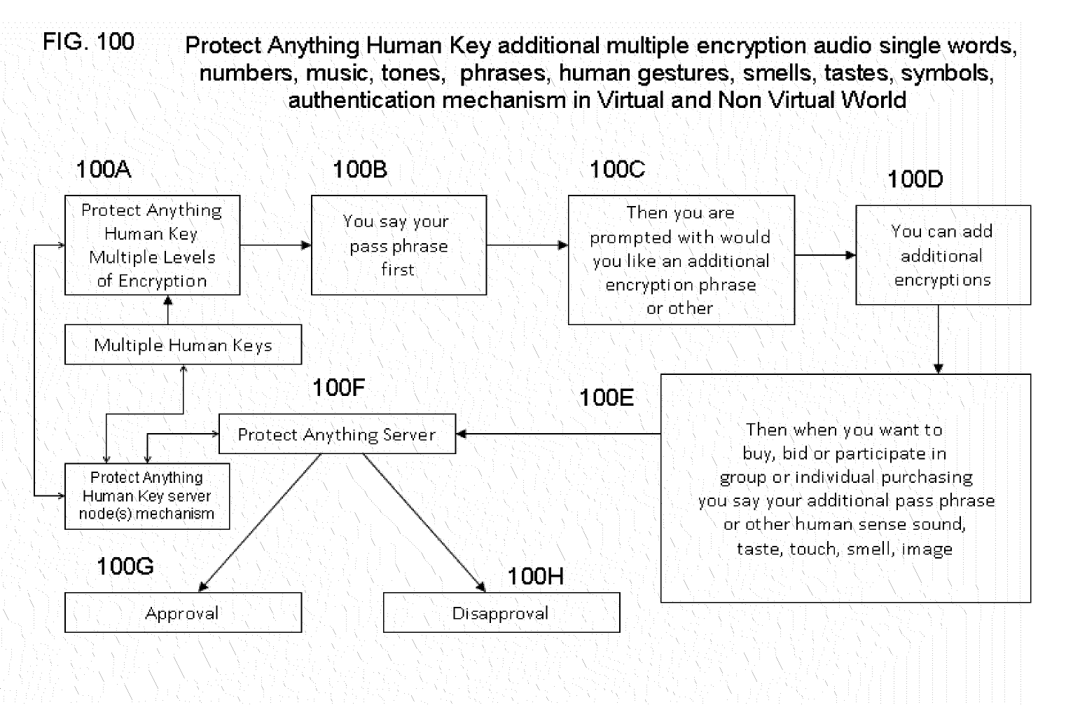

FIG. 100 is an illustration representative showing the Protect Anything Human Key additional multiple encryption audio single words, numbers, music, tones, phrases, human gestures, smells, tastes, symbols, authentication mechanism.

FIG. 100A is an illustration representative showing the Protect Anything Human Key Multiple Levels of Encryption.

FIG. 100B is an illustration representative showing you say your pass phrase first.

FIG. 100C is an illustration representative showing then you are prompted with would you like an additional encryption phrase or other.

FIG. 100D is an illustration representative showing you can add additional encryptions.

FIG. 100E is an illustration representative showing Then when you want to buy, bid or participate in group or individual purchasing you say your additional pass phrase or other human sense sound, taste, touch, smell, image.

FIG. 100F is an illustration representative showing the protect Anything Human Key server.

FIG. 100G is an illustration representative showing the Approval.

FIG. 100H is an illustration representative showing the disapproval.

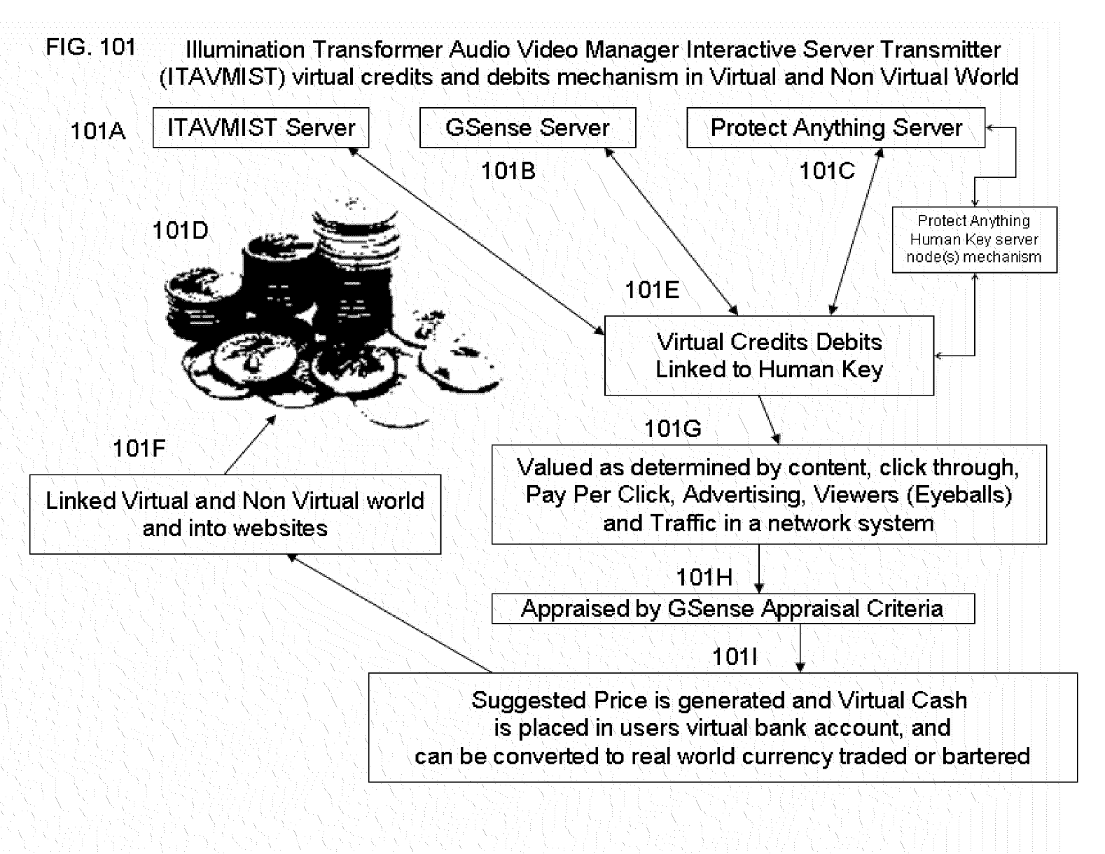

FIG. 101A is an illustration representative showing the ITAVMIST server.

FIG. 101B is an illustration representative showing the GSense server.

FIG. 101C is an illustration representative showing the Protect Anything Human Key server.

FIG. 101D is an illustration representative showing the virtual coins for use in virtual world.

FIG. 101E is an illustration representative showing the Virtual Credits Debits Linked to Human Key.

FIG. 101F is an illustration representative showing the Linked Virtual and Non Virtual world and into websites.

FIG. 101G is an illustration representative showing the Valued as determined by content, click through, Pay Per Click, Advertising, Viewers (Eyeballs) and Traffic in a network system.

FIG. 101H is an illustration representative showing the appraised by GSense Appraisal Criteria.

FIG. 101I is an illustration representative showing the Suggested Price is generated and Virtual Cash is placed in users virtual bank account, and can be converted to real world currency traded or bartered.

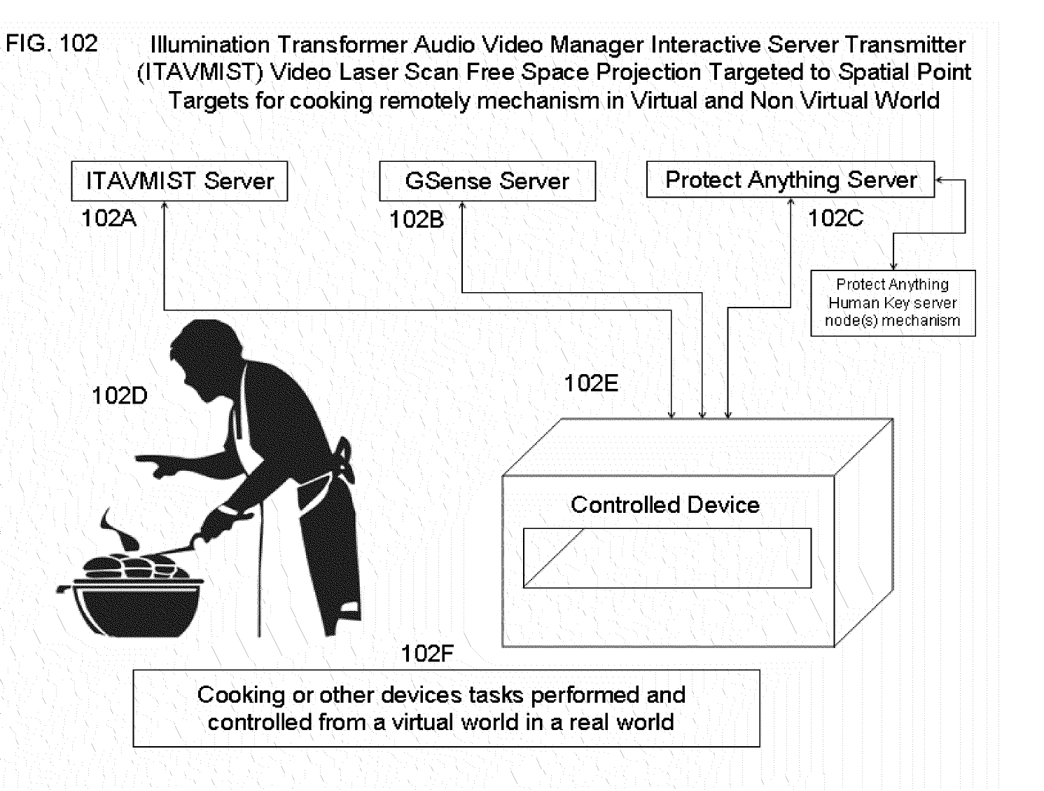

FIG. 102 is an illustration representative showing the Illumination Transformer Audio Video Manager Interactive Server Transmitter (ITAVMIST) Video Laser Scan Free Space Projection Targeted to Spatial Point Targets for cooking remotely mechanism.

FIG. 102A is an illustration representative showing the ITAVMIST server.

FIG. 102B is an illustration representative showing the GSense server.

FIG. 102C is an illustration representative showing the Protect Anything Human Key server.

FIG. 102D is an illustration representative showing the regular way of cooking.

FIG. 102E is an illustration representative showing the remote device for cooking controlled from a virtual world.

FIG. 102F is an illustration representative showing the cooking or other tasks performed and controlled from a virtual world in a real world.

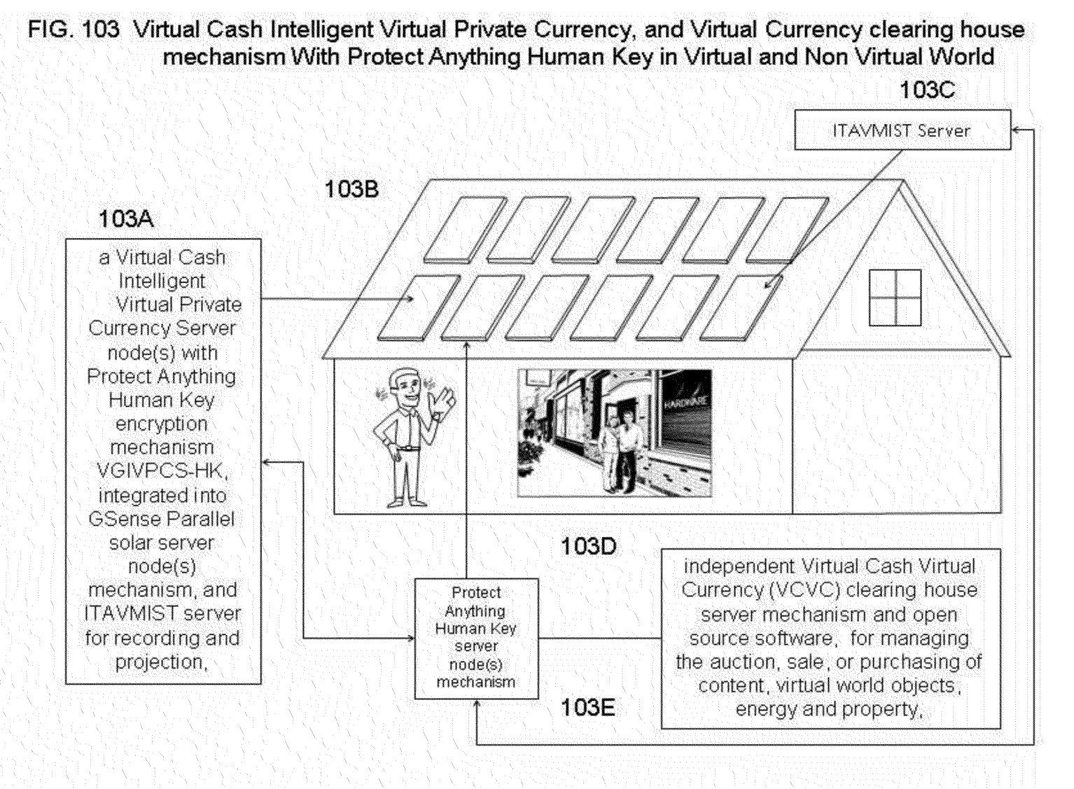

FIG. 103A illustrates Virtual Cash Intelligent Virtual Private Currency, and Virtual Currency clearing house mechanism With Protect Anything Human Key in Virtual and Non Virtual World and a Virtual Cash Intelligent Virtual Private Currency Server node(s) with Protect Anything Human Key encryption mechanism VGIVPCS-HK, integrated into GSense Parallel solar server node(s) mechanism, and ITAVMIST server for recording and projection.

FIG. 103B illustrates a home with the GSense Solar Servers and the ITAVMIST controller mechanism.

FIG. 103C illustrates the ITAVMIST Server location on the roof.

FIG. 103D illustrates Independent Virtual Cash Virtual Currency (VCVC) clearing house server mechanism and open source software, for managing the auction, sale, or purchasing of content, virtual world objects, energy and property.

FIG. 103E illustrates Protect Anything Human Key server node(s) mechanism.

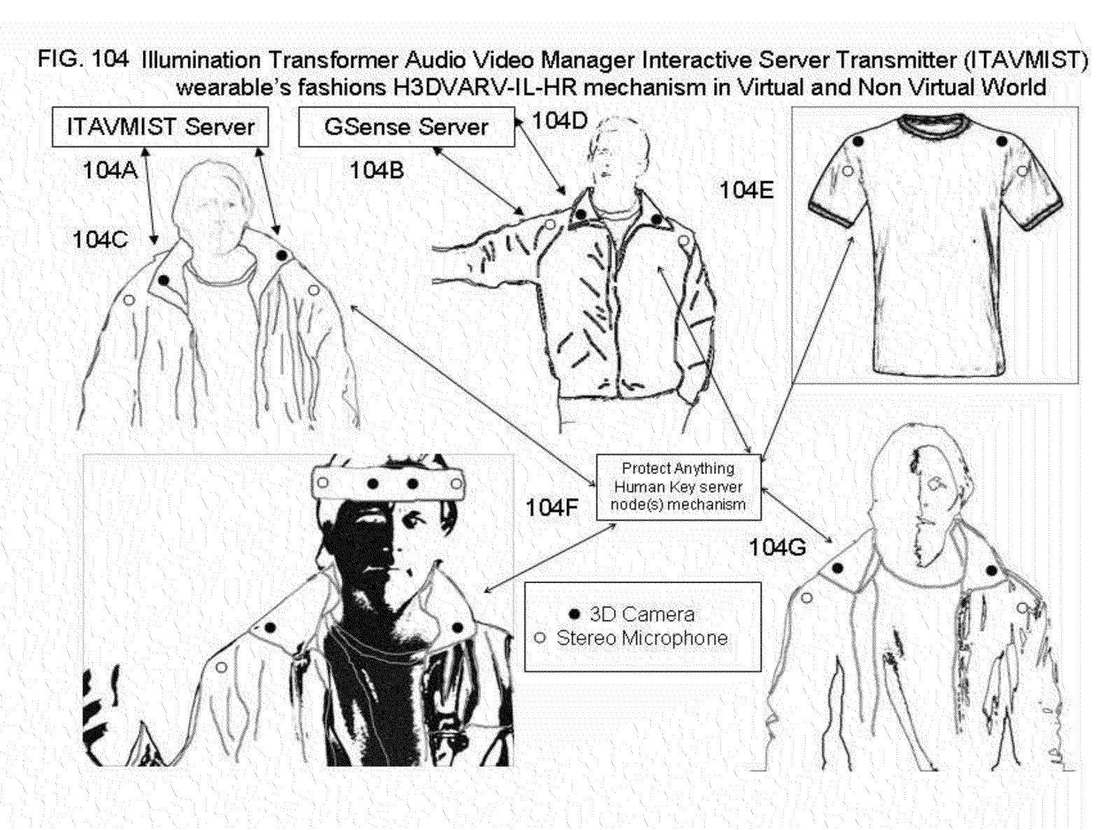

FIG. 104 is an illustration representative showing the Illumination Transformer Audio Video Manager Interactive Server Transmitter (ITAVMIST) wearable's fashions H30VARV-IL-HR mechanism.

FIG. 104A is an illustration representative showing the ITAVMIST server.

FIG. 104B is an illustration representative showing the GSense server.

FIG. 104C is an illustration representative showing the wearable's fashion mechanism with 3D cams, and stereo microphones.

FIG. 104D is an illustration representative showing the wearable's fashion mechanism with 3D cams, and stereo microphones.

FIG. 104E is an illustration representative showing the wearable's fashion mechanism with 3D cams, and stereo microphones.

FIG. 104F is an illustration representative showing the wearable's fashion mechanism with 3D cams, and stereo microphones in headband, and jacket.

FIG. 104G is an illustration representative showing the wearable's fashion mechanism with 3D cams, and stereo microphones.

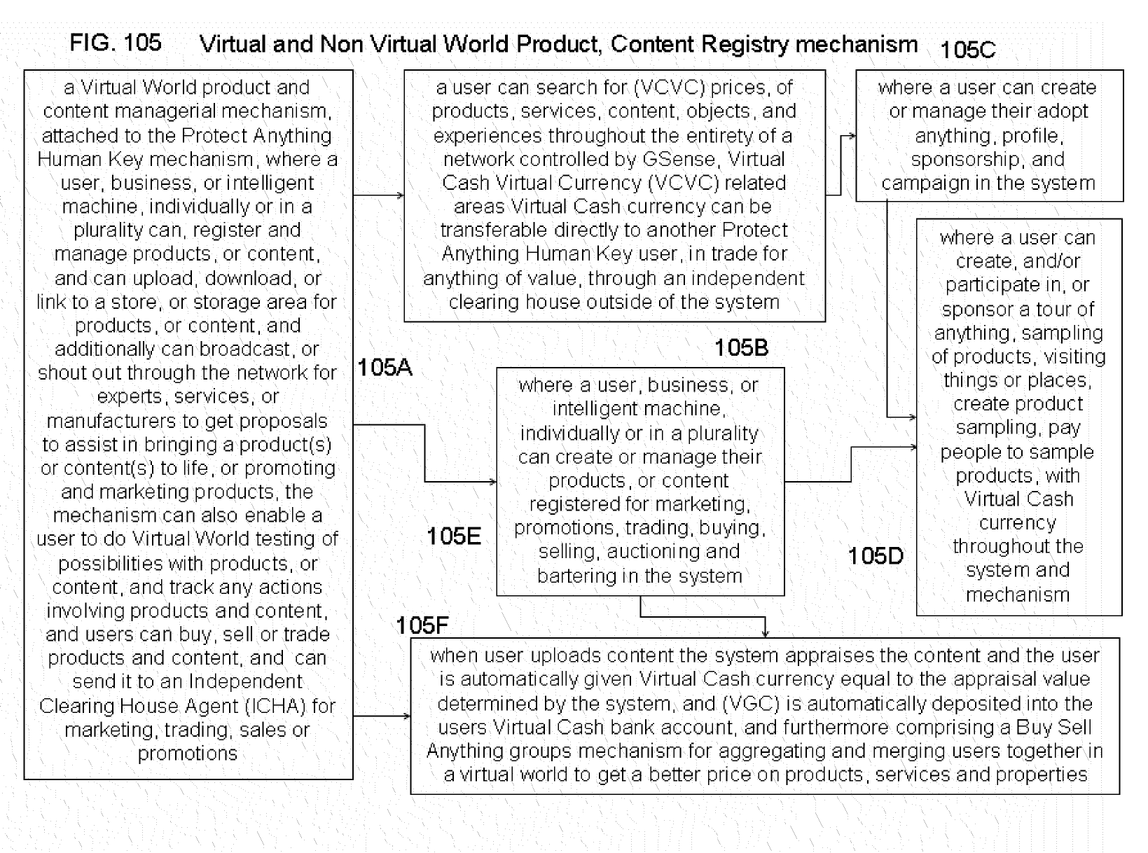

FIG. 105A illustrates the Virtual and Non Virtual World Product, Content Registry mechanism, and a Virtual World product and content managerial mechanism, attached to the Protect Anything Human Key mechanism, where a user, business, or intelligent machine, individually or in a plurality can, register and manage products, or content, and can upload, download, or link to a store, or storage area for products, or content, and additionally can broadcast, or shout out through the network for experts, services, or manufacturers to get proposals to assist in bringing a product(s) or content(s) to life, or promoting and marketing products, the mechanism can also enable a user to do Virtual World testing of possibilities with products, or content, and track any actions involving products and content, and users can buy, sell or trade products and content, and can send it to an Independent Clearing House Agent (ICHA) for marketing, trading, sales or promotions.

FIG. 105B illustrates where a user can search for (VCVC) prices, of products, services, content, objects, and experiences throughout the entirety of a network controlled by GSense, Virtual Cash Virtual Currency (VCVC) related areas Virtual Cash currency can be transferable directly to another Protect Anything Human Key user, in trade for anything of value, through an independent clearing house outside of the system.

FIG. 105C illustrates where a user can create or manage their adopt anything, profile, sponsorship, and campaign in the system.

FIG. 105D illustrates where a user can create, and/or participate in, or sponsor a tour of anything, sampling of products, visiting things or places, create product sampling, pay people to sample products, with Virtual Cash currency throughout the system and mechanism.

FIG. 105E illustrates where a user, business, or intelligent machine, individually or in a plurality can create or manage their products, or content registered for marketing, promotions, trading, buying, selling, auctioning and bartering in the system.

FIG. 105F illustrates when user uploads content the system appraises the content and the user is automatically given Virtual Cash currency equal to the appraisal value determined by the system, and (VGC) is automatically deposited into the users Virtual Cash bank account, and furthermore comprising a Buy Sell Anything groups mechanism for aggregating and merging users together in a virtual world to get a better price on products, services and properties.

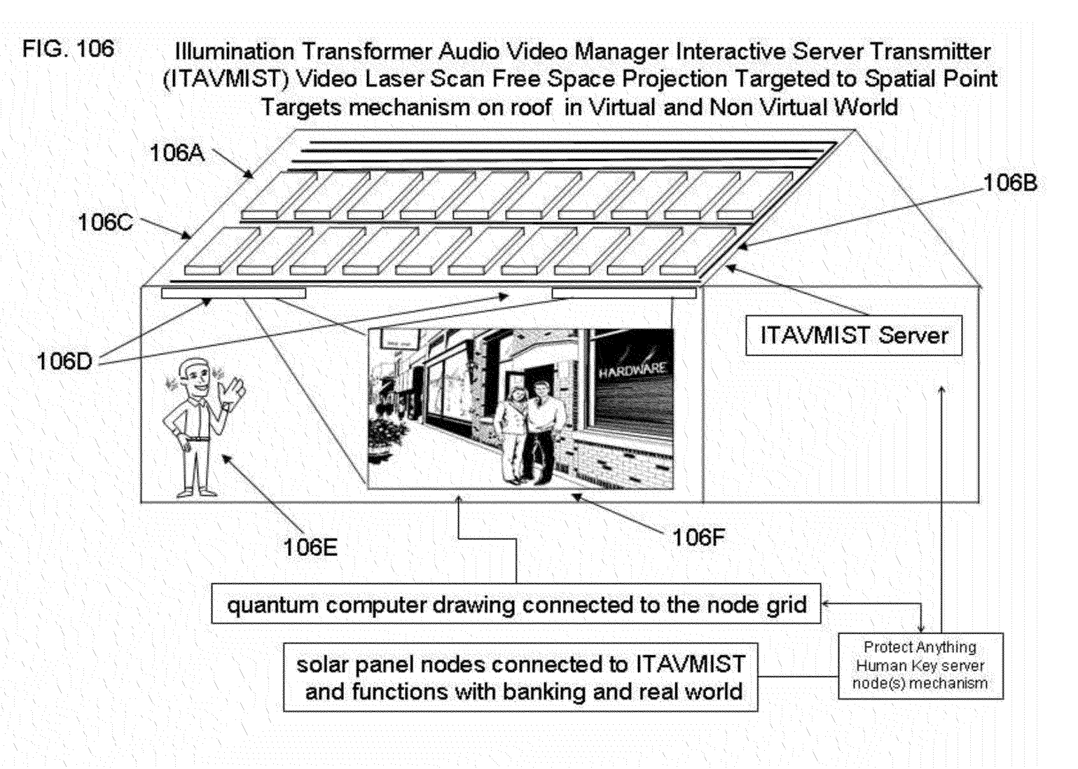

FIG. 106 is an illustration representative showing the Illumination Transformer Audio Video Manager Interactive Server Transmitter (ITAVMIST) Video Laser Scan Free Space Projection Targeted to Spatial Point Targets mechanism on roof and solar panel nodes connected to ITAVMIST and functions with banking and real world.

FIG. 106A is an illustration representative showing the GSense solar server nodes.

FIG. 106B is an illustration representative showing the ITAVMIST server.

FIG. 106C is an illustration representative showing the GSense VoIP server.

FIG. 106D is an illustration representative showing the ITAVMIST laser projection units.

FIG. 106E is an illustration representative showing a user viewing projection and sound.

FIG. 106F is an illustration representative showing a projection of a movie.

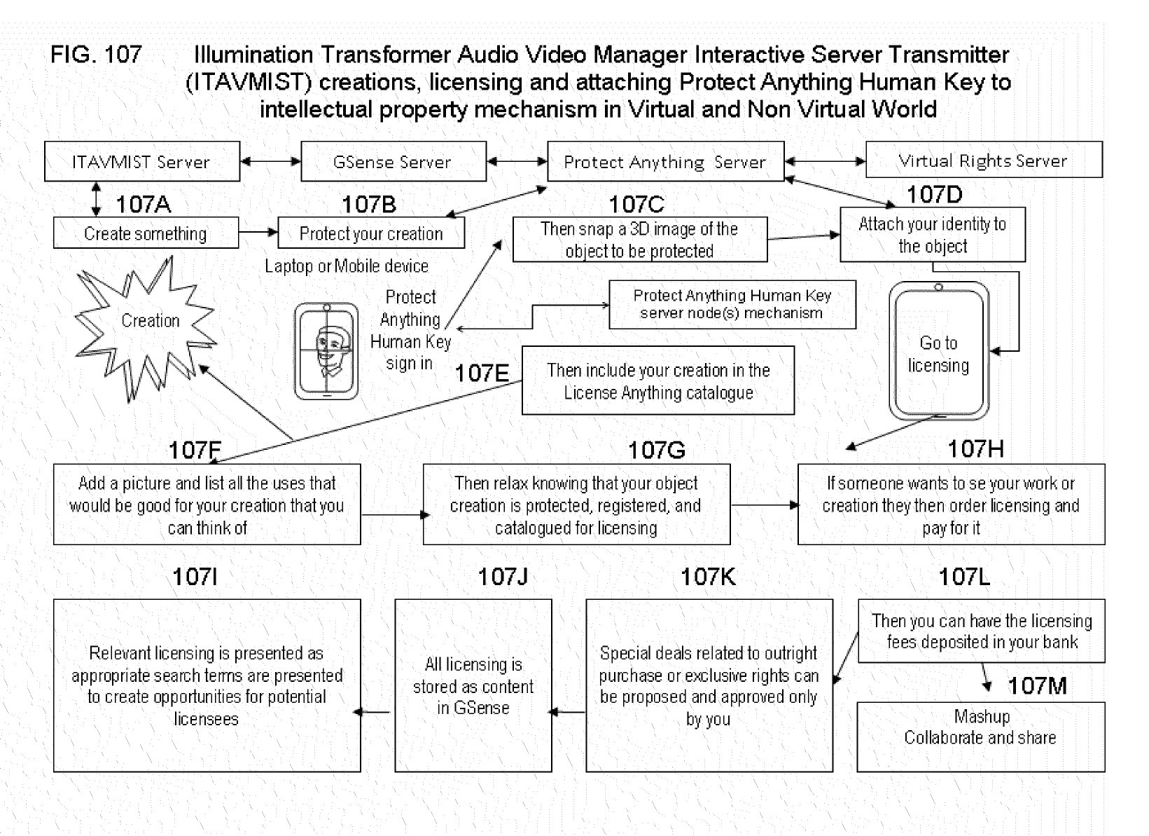

FIG. 107 is an illustration representative showing the Illumination Transformer Audio Video Manager Interactive Server Transmitter (ITAVMIST) creations, licensing and attaching Protect Anything Human Key to intellectual property mechanism.

FIG. 107A is an illustration representative showing the create something aspect.

FIG. 107B is an illustration representative, showing protect your creation aspect.

FIG. 107C is an illustration representative showing where a user then snaps a 3D image of the object to be protected.

FIG. 107D is an illustration representative showing where user can attach identity to the object.

FIG. 107E is an illustration representative, showing the system include your creation in the License Anything catalogue.

FIG. 107F is an illustration representative showing Add a picture and list all the uses that would be good for your creation that you can think of.

FIG. 107G is an illustration representative showing then relax knowing that your object creation is protected, registered, and catalogued for licensing.

FIG. 107H is an illustration representative showing If someone wants to see your work or creation they then order licensing and pay for it.

FIG. 1071 is an illustration representative showing Relevant licensing is presented as appropriate search terms are presented to create opportunities for potential licensees.

FIG. 107J is an illustration representative showing all licensing is stored as content in GSense.

FIG. 107K is an illustration representative showing special deals related to outright purchase or exclusive rights can be proposed and approved only by you.

FIG. 107L is an illustration representative showing then you can have the licensing fees deposited in your bank.

FIG. 107M is an illustration representative showing the mashup and collaboration mechanism.

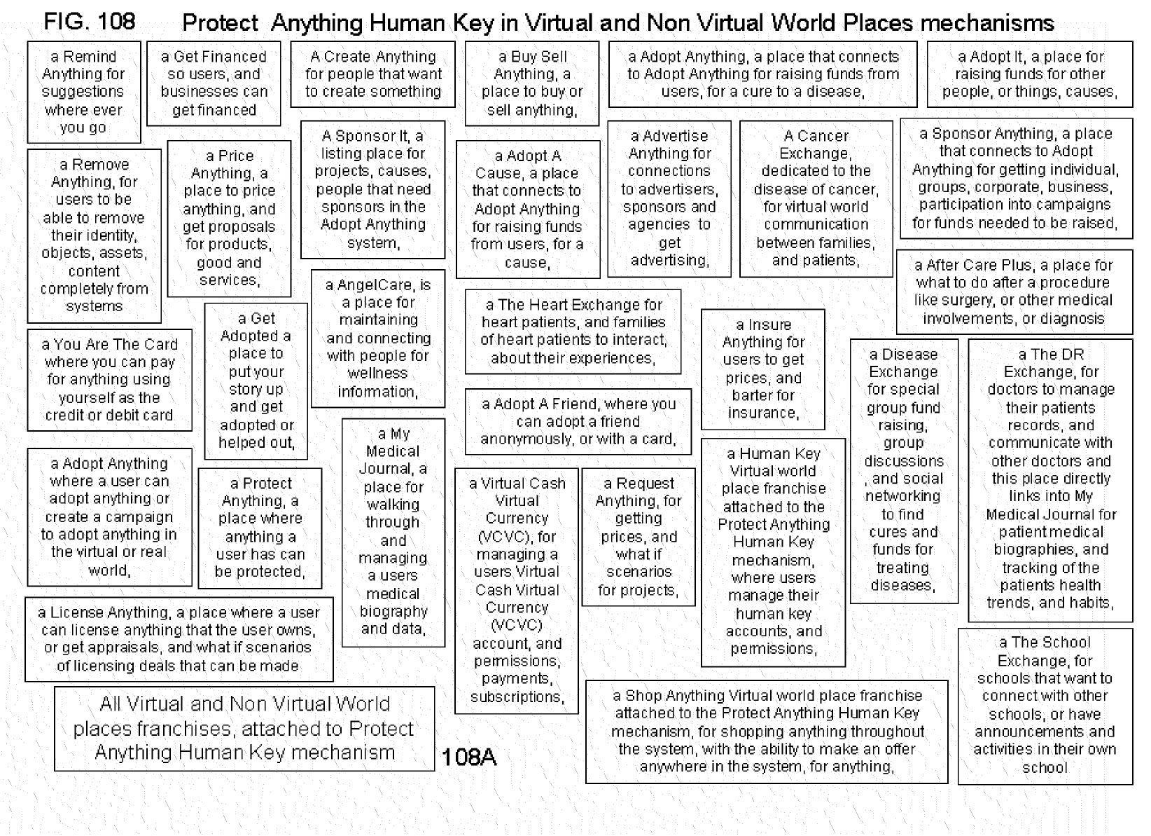

FIG. 108A illustrates Protect Anything Human Key in Virtual and Non Virtual World Places mechanisms.

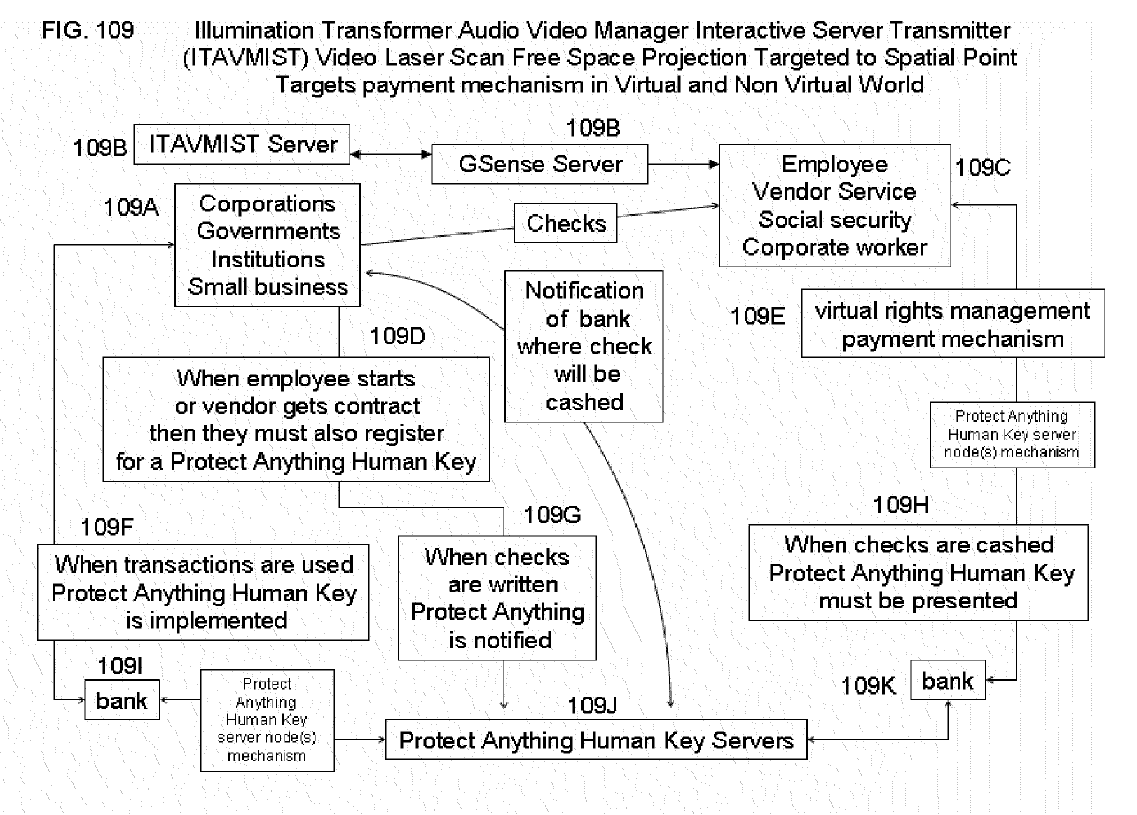

FIG. 109 is an illustration representative showing the Illumination Transformer Audio Video Manager Interactive Server Transmitter (ITAVMIST) Video Laser Scan Free Space Projection Targeted to Spatial Point Targets payment mechanism.

FIG. 109A is an illustration representative showing the corporations, governments, institutions, small business, and users in the mechanism.

FIG. 109B is an illustration representative showing the ITAVMIST server sending data to the GSense server for processing payments.

FIG. 109C is an illustration representative showing the Employee Vendor Service Social security corporate worker abilities for payments and cashing checks system.

FIG. 109D is an illustration representative showing the When employee starts or vendor gets contract then they must also register for a Protect Anything Human Key.

FIG. 109E is an illustration representative showing the Notification of bank where check will be cashed part of the mechanism.

FIG. 109F is an illustration representative showing where when transactions are used Protect Anything Human Key is implemented.

FIG. 109G is an illustration representative showing where when checks are written Protect Anything is notified.

FIG. 109H is an illustration representative showing where when checks are cashed Protect Anything Human Key must be presented.

FIG. 109I is an illustration representative showing the bank.

FIG. 109J is an illustration representative showing the Protect Anything Human Key.

FIG. 109K is an illustration representative showing the bank.

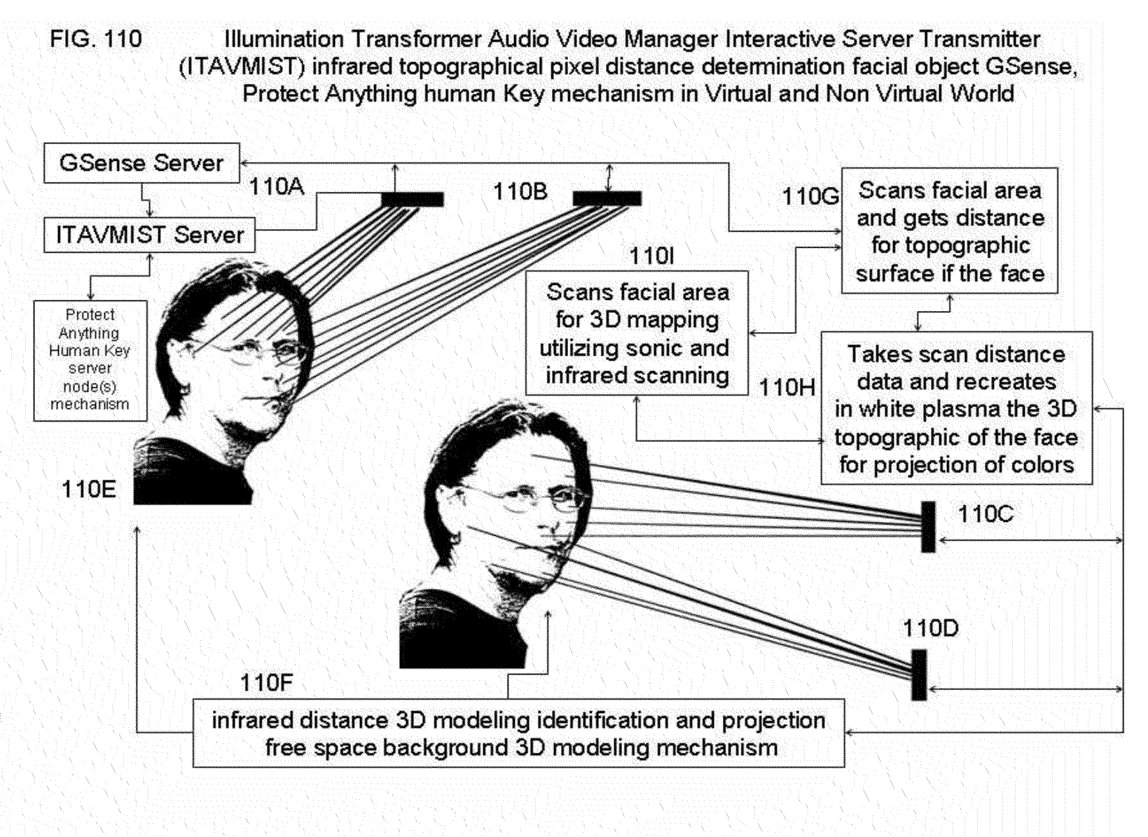

FIG. 110 is an illustration representative showing the Illumination Transformer Audio Video Manager Interactive Server Transmitter (ITAVMIST) infrared topographical pixel distance determination facial object GSense, Protect Anything human Key mechanism.

FIG. 110A is an illustration representative showing the infrared pixel distance detector of the facial area from the ITAVMIST server node.

FIG. 110B is an illustration representative showing the second infrared pixel distance detector of the facial area from the ITAVMIST server node.

FIG. 110C is an illustration representative showing the infrared pixel distance detector of the facial front projection area for human key distance aggregation.

FIG. 110D is an illustration representative showing the second infrared pixel distance detector of the facial front projection area for human key distance aggregation.

FIG. 110E is an illustration representative showing the subjects face being identified in a space.

FIG. 110F is an illustration representative showing the subjects face being enrolled, registered and identified in a space.

FIG. 110G is an illustration representative showing where the mechanism scans facial area and gets distance for topographic surface of the face.

FIG. 110H is an illustration representative showing where the mechanism takes scan distance data and recreates in white plasma the 3D topographic of the face for projection of colors.

FIG. 110I is an illustration representative showing where the mechanism scans facial area for 3D mapping utilizing sonic and infrared scanning.

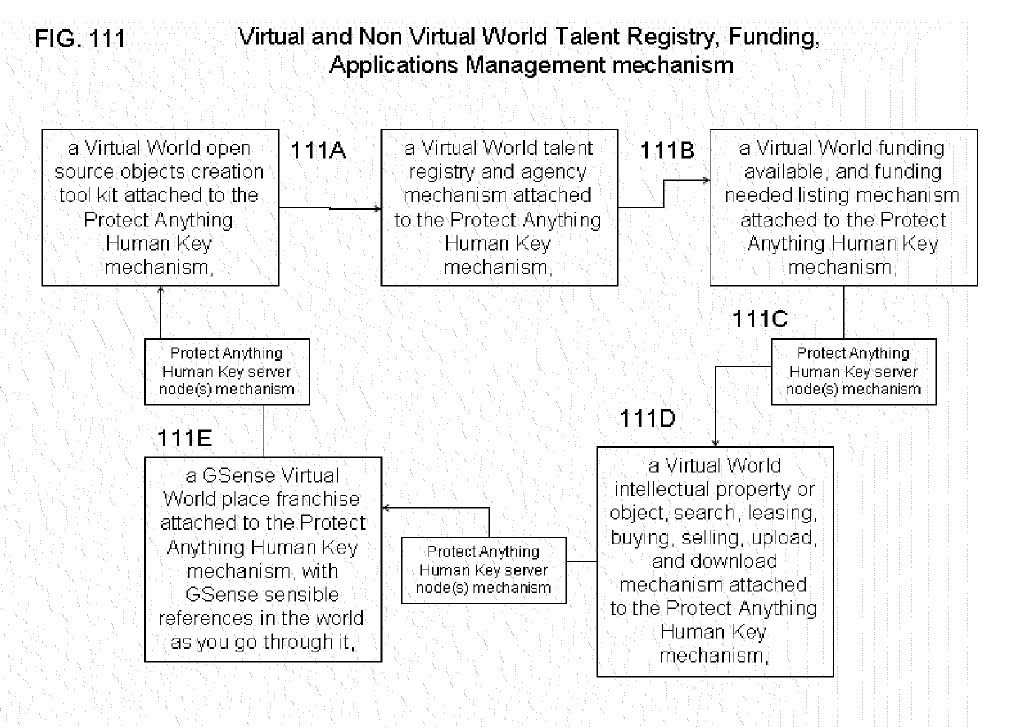

FIG. 111A illustrates Virtual and Non Virtual World Talent Registry, Funding, Applications Management mechanism and a Virtual World open source objects creation tool kit attached to the Protect Anything Human Key mechanism.

FIG. 111B illustrates a Virtual World talent registry and agency mechanism attached to the Protect Anything Human Key mechanism.

FIG. 111C illustrates a Virtual World funding available, and funding needed listing mechanism attached to the Protect Anything Human Key mechanism.

FIG. 111D illustrates a Virtual World intellectual property or object, search, leasing, buying, selling, upload, and download mechanism attached to the Protect Anything Human Key mechanism.

FIG. 111E illustrates a GSense Virtual World place franchise attached to the Protect Anything Human Key mechanism, with GSense sensible references in the world as you go through it.

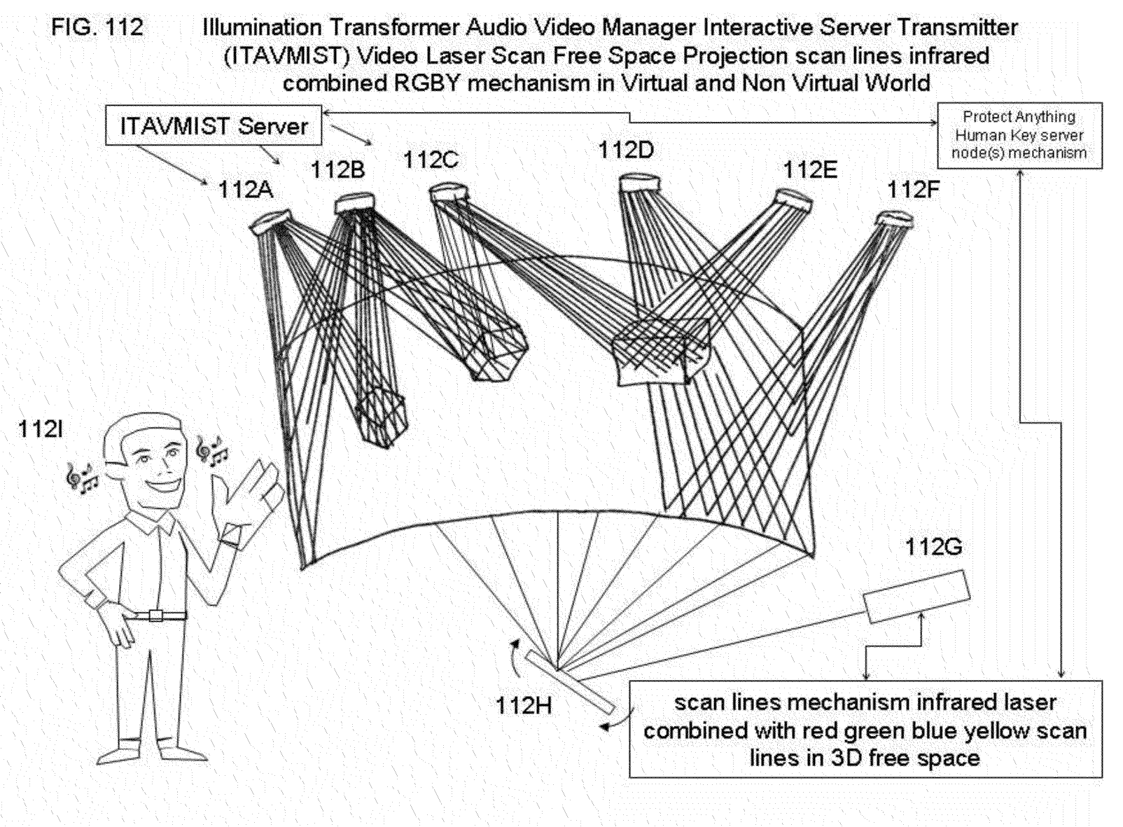

FIG. 112 is an illustration representative showing the Illumination Transformer Audio Video Manager Interactive Server Transmitter (ITAVMIST) Video Laser Scan Free Space Projection scan lines infrared combined RGBY mechanism.

FIG. 112A is an illustration representative showing the ITAVMIST server infrared laser background generator.

FIG. 112B is an illustration representative showing the ITAVMIST server laser color pixel generator.

FIG. 112C is an illustration representative showing the ITAVMIST server infrared laser background generator.

FIG. 112D is an illustration representative showing the ITAVMIST server infrared laser background generator.

FIG. 112E is an illustration representative showing the ITAVMIST server laser color pixel generator.

FIG. 112F is an illustration representative showing the ITAVMIST server infrared laser background generator.

FIG. 112G is an illustration representative showing the ITAVMIST server laser color pixel and infrared generator targeted to rotating mirror for scan lines.

FIG. 112H is an illustration representative showing the ITAVMIST rotating mirror for laser distribution of colors and background.

FIG. 112I is an illustration representative showing the user viewing and listening to content.

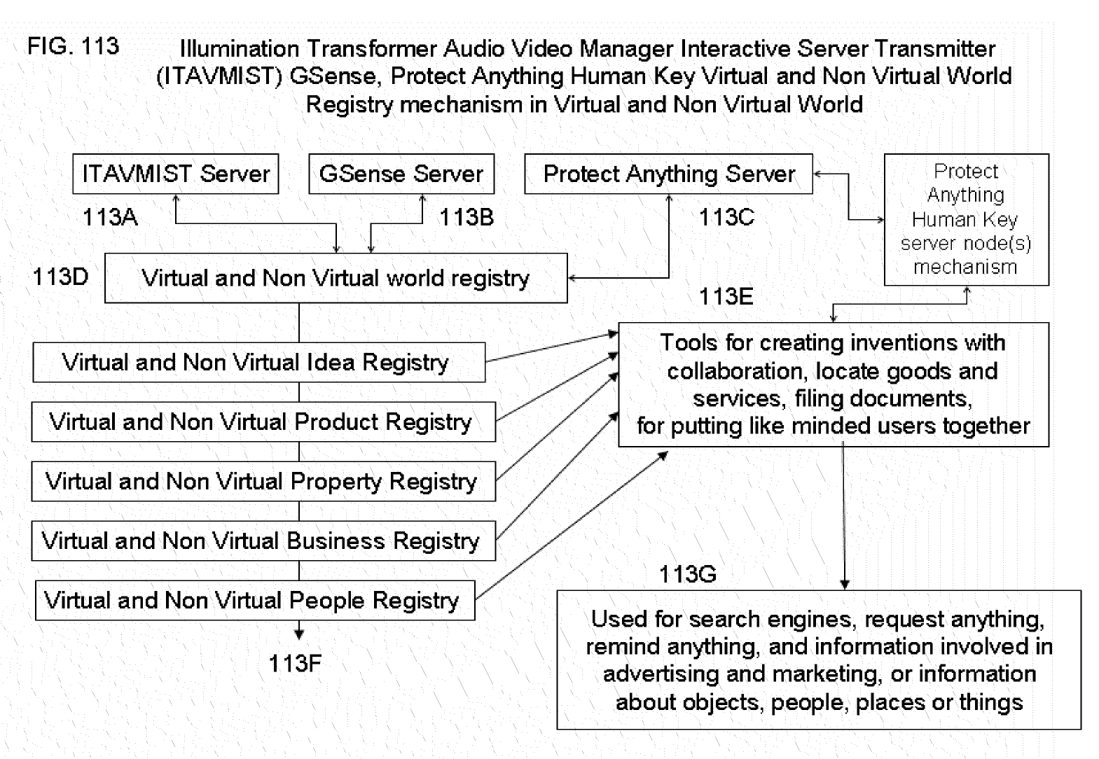

FIG. 113 is an illustration representative showing the Illumination Transformer Audio Video Manager Interactive Server Transmitter (ITAVMIST) GSense, Protect Anything Human Key Virtual and Non Virtual World Registry mechanism.

FIG. 113A is an illustration representative showing the ITAVMIST server.

FIG. 113B is an illustration representative showing the GSense server.

FIG. 113C is an illustration representative showing the Protect Anything server.

FIG. 113D is an illustration representative showing the Virtual World and Non Virtual World Registry.

FIG. 113E is an illustration representative showing the Virtual and Non Virtual Idea, product, property, business, people Registry.

FIG. 113F is an illustration representative showing the Tools for creating inventions with collaboration, locate goods and services, filing documents, for putting like minded users together.

FIG. 113G is an illustration representative showing the Used for search engines, request anything, remind anything, and information involved in advertising and marketing, or information about objects, people, places or things.

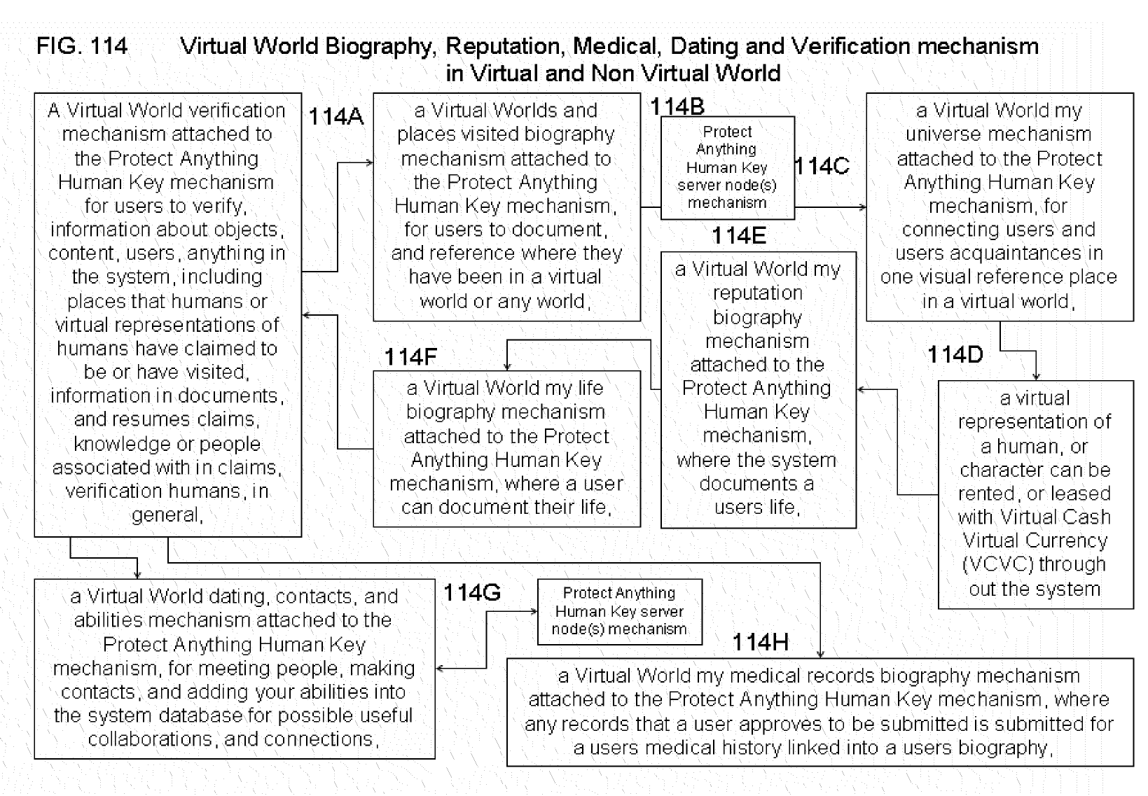

FIG. 114A illustrates Virtual World Biography, Reputation, Medical, Dating and Verification mechanism in Virtual and Non Virtual World and a Virtual World verification mechanism attached to the Protect Anything Human Key mechanism for users to verify, information about objects, content, users, anything in the system, including places that humans or virtual representations of humans have claimed to be or have visited, information in documents, and resumes claims, knowledge or people associated with in claims, verification humans, in general.

FIG. 114B illustrates a Virtual Worlds and places visited biography mechanism attached to the Protect Anything Human Key mechanism, for users to document, and reference where they have been in a virtual world or any world.

FIG. 114C illustrates a Virtual World my universe mechanism attached to the Protect Anything Human Key mechanism, for connecting users and users acquaintances in one visual reference place in a virtual world.

FIG. 114D illustrates a virtual representation of a human, or character can be rented, or leased with Virtual Cash Virtual Currency (VCVC) throughout the system.

FIG. 114E illustrates a Virtual World my reputation biography mechanism attached to the Protect Anything Human Key mechanism, where the system documents a users life.

FIG. 114F illustrates a Virtual World my life biography mechanism attached to the Protect Anything Human Key mechanism, where a user can document their life.

FIG. 114G illustrates a Virtual World dating, contacts, and abilities mechanism attached to the Protect Anything Human Key mechanism, for meeting people, making contacts, and adding your abilities into the system database for possible useful collaborations, and connections.

FIG. 114H illustrates a Virtual World my medical records biography mechanism attached to the Protect Anything Human Key mechanism, where any records that a user approves to be submitted is submitted for a users medical history linked into a users biography.

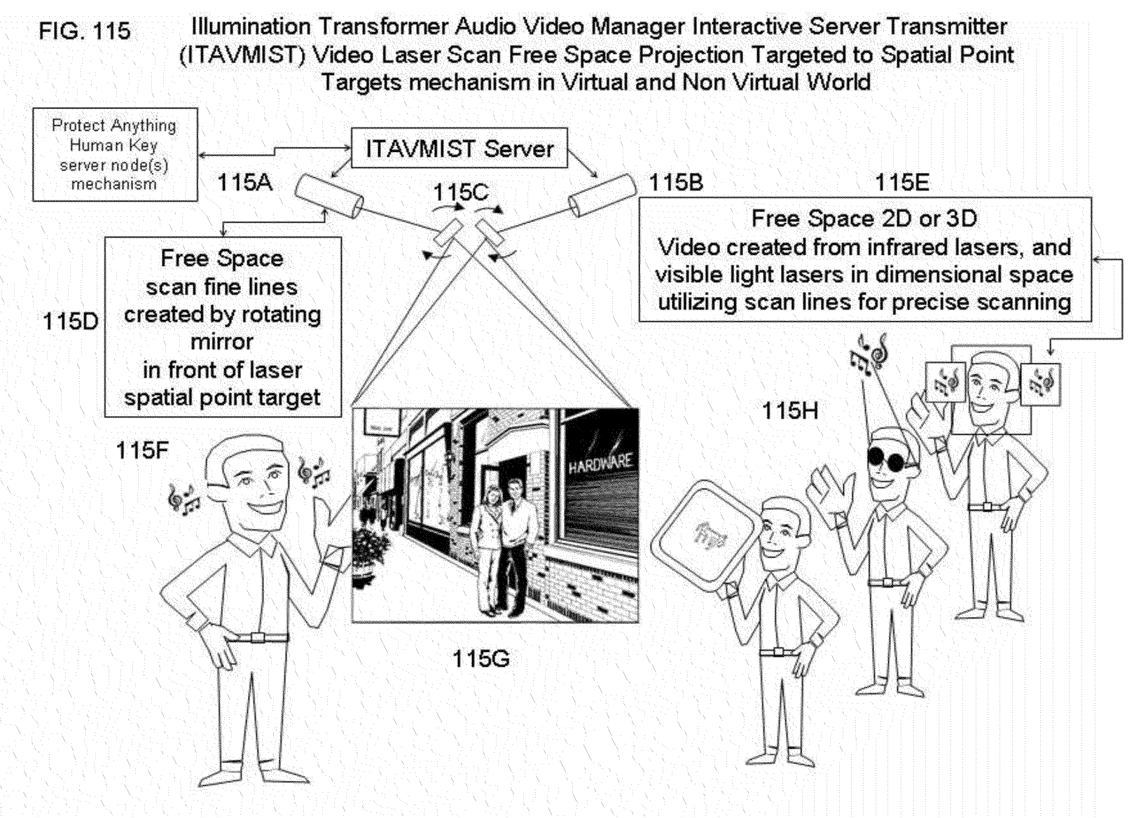

FIG. 115 is an illustration representative showing the Illumination Transformer Audio Video Manager Interactive Server Transmitter (ITAVMIST) Video Laser Scan Free Space Projection Targeted to Spatial Point Targets mechanism and further comprising a method and mechanism for new granular color spectrum of multiple colors for more vivid colors, in the recording of digital data for video and images, utilizing infrared laser with rotating mirror for creating a scan line in synchronization with another infrared laser to an intersecting point and scan lines created together to form a white background for free space projected pixels to create a video, image 3D, 20 at a specific spatial point target zone for viewing in ultra high definition or regular conventional definition.

FIG. 115A is an illustration representative showing the mechanism for new granular color spectrum of multiple colors for more vivid colors, in the recording of digital data for video and images, utilizing infrared laser

FIG. 115B is an illustration representative showing the mechanism for new granular color spectrum of multiple colors for more vivid colors, in the recording of digital data for video and images, utilizing infrared laser

FIG. 115C is an illustration representative showing the rotating mirror for creating a scan line in synchronization with another infrared laser to an intersecting point and scan lines created together to form a white background

FIG. 115D is an illustration representative showing the Free Space scan fine lines created by rotating mirror in front of laser spatial point target.

FIG. 115E is an illustration representative showing the Free Space 20 or 3D Video created from infrared lasers, and visible light lasers in dimensional space utilizing scan lines for precise scanning.

FIG. 115F is an illustration representative showing the user viewing content in free space.

FIG. 115G is an illustration representative showing the free space projected content.

FIG. 115H is an illustration representative showing the other variations of viewing with devices, wearable devices and free space viewing.

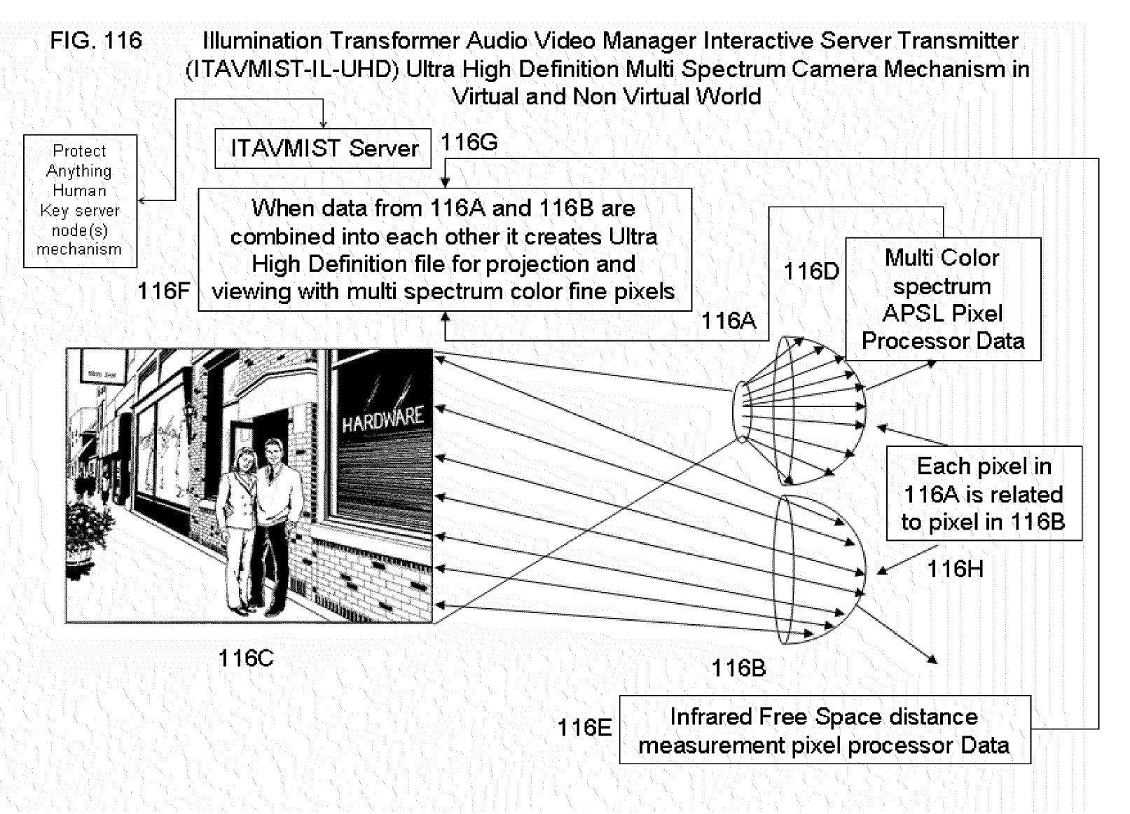

FIG. 116 is an illustration representative showing the Illumination Transformer Audio Video Manager Interactive Server Transmitter (ITAVMIST-IL-UHD) Ultra High Definition Multi Spectrum Camera Mechanism and further comprising a method and mechanism which is an active-pixel sensor (APS) device that includes a plurality of curved bowl shape sensors with active-pixel image sensors that have sensitivity to wide spectral gamut of colors at nano scale each combined with position related active pixel sensor imager (APSI) infrared distance measurement recording mechanism, for recording of distance to the nano pixel object, for processing in determining ultra high resolution vision, and further comprising where distance to object viewed at upper edge of bowl active-pixel image sensor is always the same as the distance to object viewed center lower edge of active-pixel image sensor bowl, for creating and recording ultra high definition images and video.

FIG. 116A is an illustration representative showing the mechanism which is an active pixel sensor (APS) device that includes a plurality of curved bowl shape sensors with active-pixel image sensors that have sensitivity to wide spectral gamut of colors at nano scale

FIG. 116B is an illustration representative showing the mechanism that is the position related active pixel sensor imager (APSI) infrared distance measurement recording mechanism, for recording of distance to the nano pixel object,

FIG. 116C is an illustration representative showing the object that is being recorded

FIG. 116D is an illustration representative showing the data from the APS color pixel unit and the infrared distance unit being stored as a file in 24F database and file storage

FIG. 116E is an illustration representative showing the Infrared free space distance measurement pixel processor data storage unit.

FIG. 116F is an illustration representative showing the process where when data from 116A and 116B are combined into 116F each other it creates Ultra High Definition file for projection and viewing with multi spectrum color fine pixels.

FIG. 116G is an illustration representative showing the Multi Color 116D spectrum APS Pixel Processor Data storage unit.

FIG. 116H is an illustration representative showing where each pixel in 116A is related to pixel in 116B.

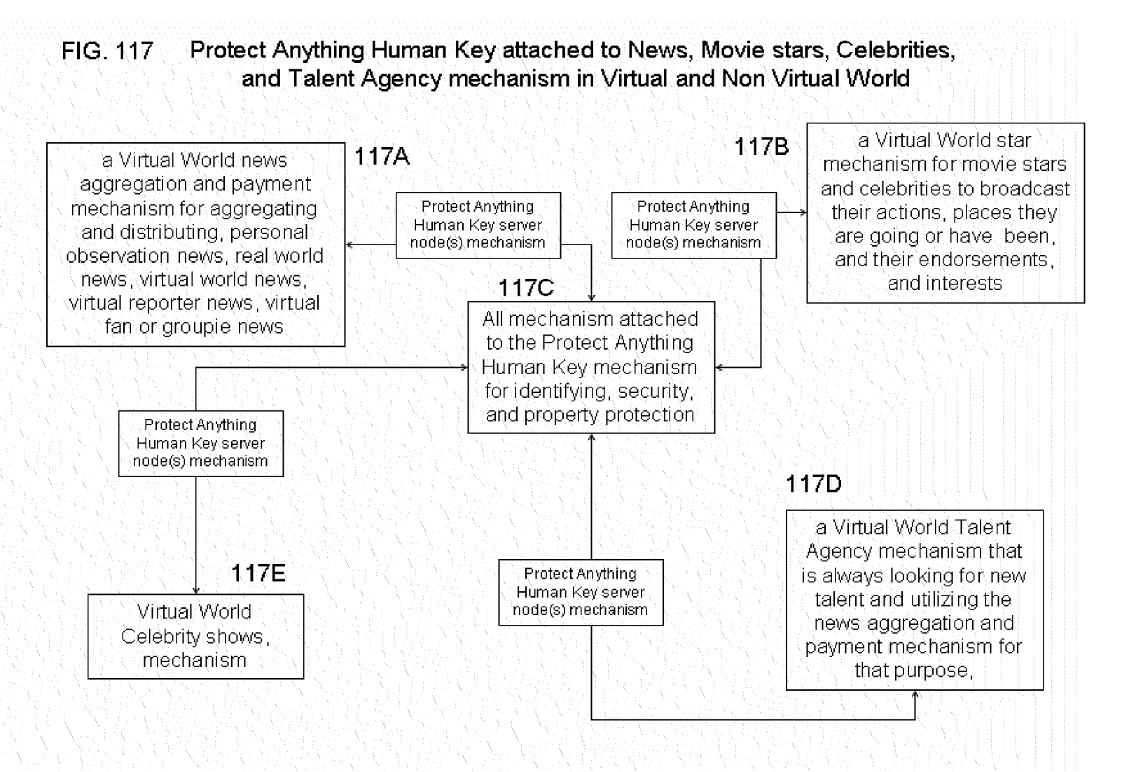

FIG. 117A illustrates Protect Anything Human Key attached to News, Movie stars, Celebrities, and Talent Agency mechanism in Virtual and Non Virtual World and a Virtual World news aggregation and payment mechanism for aggregating and distributing, personal observation news, real world news, virtual world news, virtual reporter news, virtual fan or groupie news.

FIG. 117B illustrates a Virtual World star mechanism for movie stars and celebrities to broadcast their actions, places they are going or have been, and their endorsements, and interests

FIG. 117C illustrates where all mechanisms are attached to the Protect Anything Human Key mechanism for identifying, security, and property protection.

FIG. 117D illustrates a Virtual World Talent Agency mechanism that is always looking for new talent and utilizing the news aggregation and payment mechanism for that purpose.

FIG. 117E illustrates Virtual World Celebrity shows, mechanism.

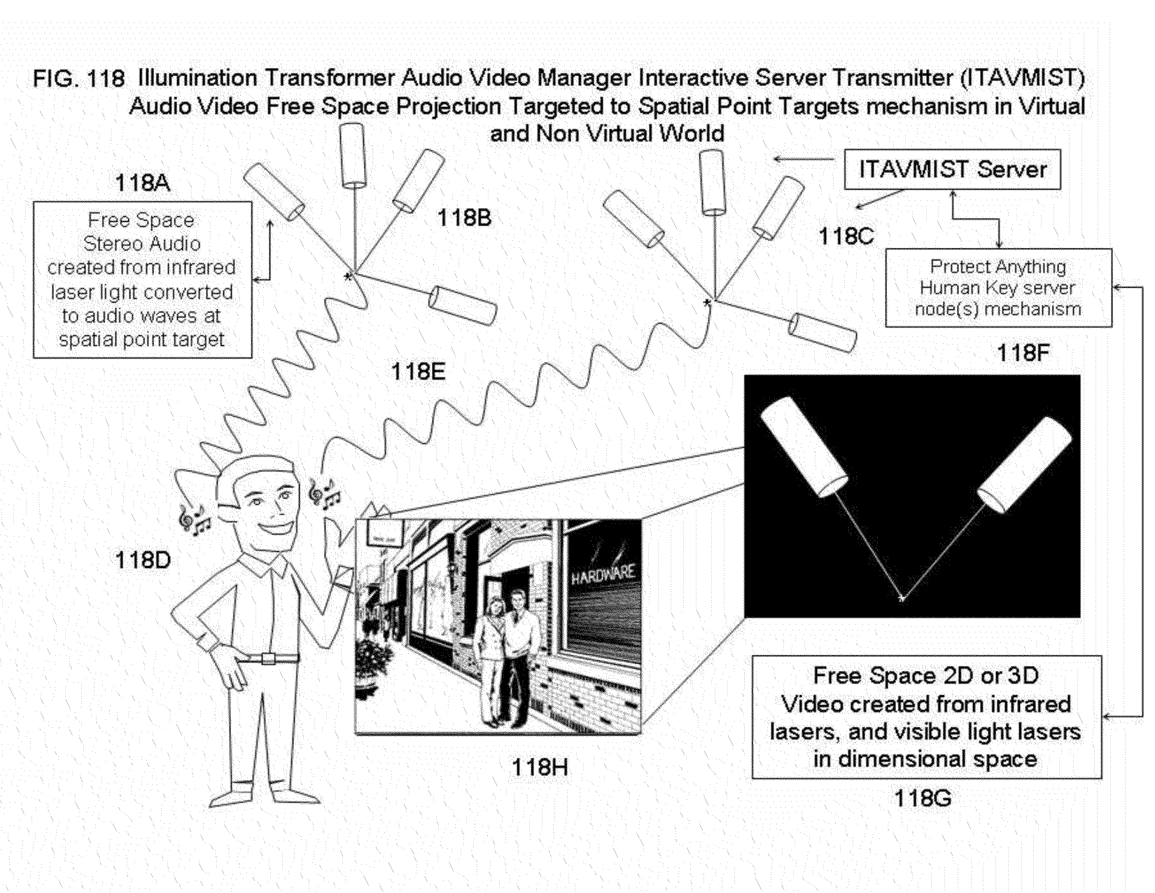

FIG. 118 is a conceptual diagram representative of Illumination Transformer Audio Video Manager Interactive Server Transmitter (ITAVMIST) Audio Video Free Space Projection Targeted to Spatial Point Targets mechanism.

FIG. 118A is an illustration representative showing the Free Space Stereo Audio created from infrared laser light converted to audio waves at spatial point target part of the mechanism.

FIG. 118B is an illustration representative showing the right infrared light laser beams intersecting in a way to create sound waves at a particular spatial point part of the mechanism.

FIG. 118C is an illustration representative showing the left infrared light laser beams intersecting in a way to create sound waves at a particular spatial point part of the mechanism.

FIG. 118D is an illustration representative showing person listening at the right ear spatial point to the projected sound and video part of the mechanism.

FIG. 118E is an illustration representative showing person listening at the left ear spatial point to the projected sound and video part of the mechanism.

FIG. 118F is an illustration representative showing the infrared light laser beams projected to create plasma visible light that can be colored for viewing pixels in free space part of the mechanism.

FIG. 118G is an illustration representative showing the Free Space 20 or 3D Video created from infrared lasers, and visible light lasers in dimensional space part of the mechanism.

FIG. 118H is an illustration representative showing the infrared and visible light laser beam projected content part of the mechanism.

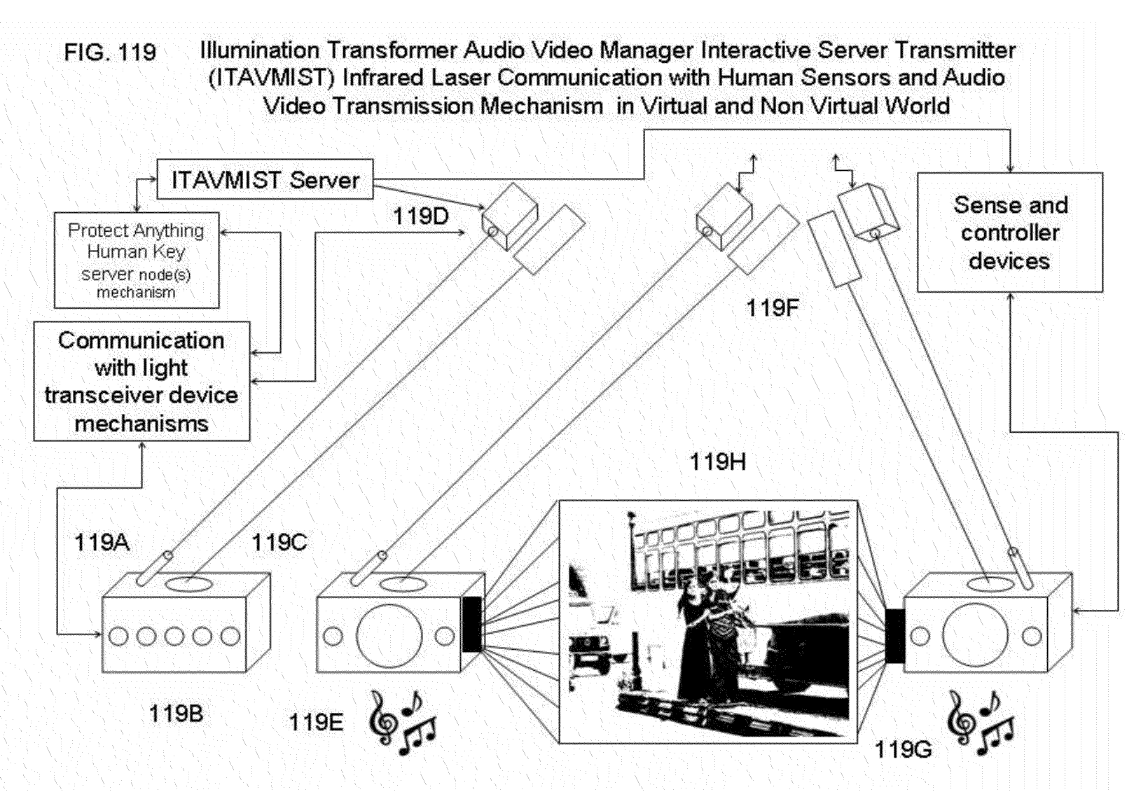

FIG. 119 is a conceptual diagram representative of Illumination Transformer Audio Video Manager Interactive Server Transmitter (ITAVMIST) Infrared Laser Communication with Human Sensors and Audio Video Transmission Mechanism.

FIG. 119A is an illustration representative showing where information is transmitted by laser to the Illumination Transformer Audio Video Manager Interactive Server Transmitter (ITAVMIST) apparatus as part of the mechanism.

FIG. 119B is an illustration representative showing where information from all five senses taste, touch, smell, vision and hearing can be transmitted or received and projected as part of the mechanism.

FIG. 119C is an illustration representative showing where information is received by laser from the Illumination Transformer Audio Video Manager Interactive Server Transmitter (ITAVMIST) apparatus as part of the mechanism.

FIG. 119D is an illustration representative showing where information is transmitted by laser from the Illumination Transformer Audio Video Manager Interactive Server Transmitter (ITAVMIST) apparatus as part of the mechanism.

FIG. 119E is an illustration representative showing the infrared light laser right speaker part of the mechanism.

FIG. 119F is an illustration representative showing where information is transmitted by laser from the Illumination Transformer Audio Video Manager Interactive Server Transmitter (ITAVMIST) apparatus to entertainment unit as part of the mechanism.

FIG. 119G is an illustration representative showing the infrared light laser left speaker part of the mechanism.

FIG. 119H is an illustration representative showing the projected free space content part of the mechanism.

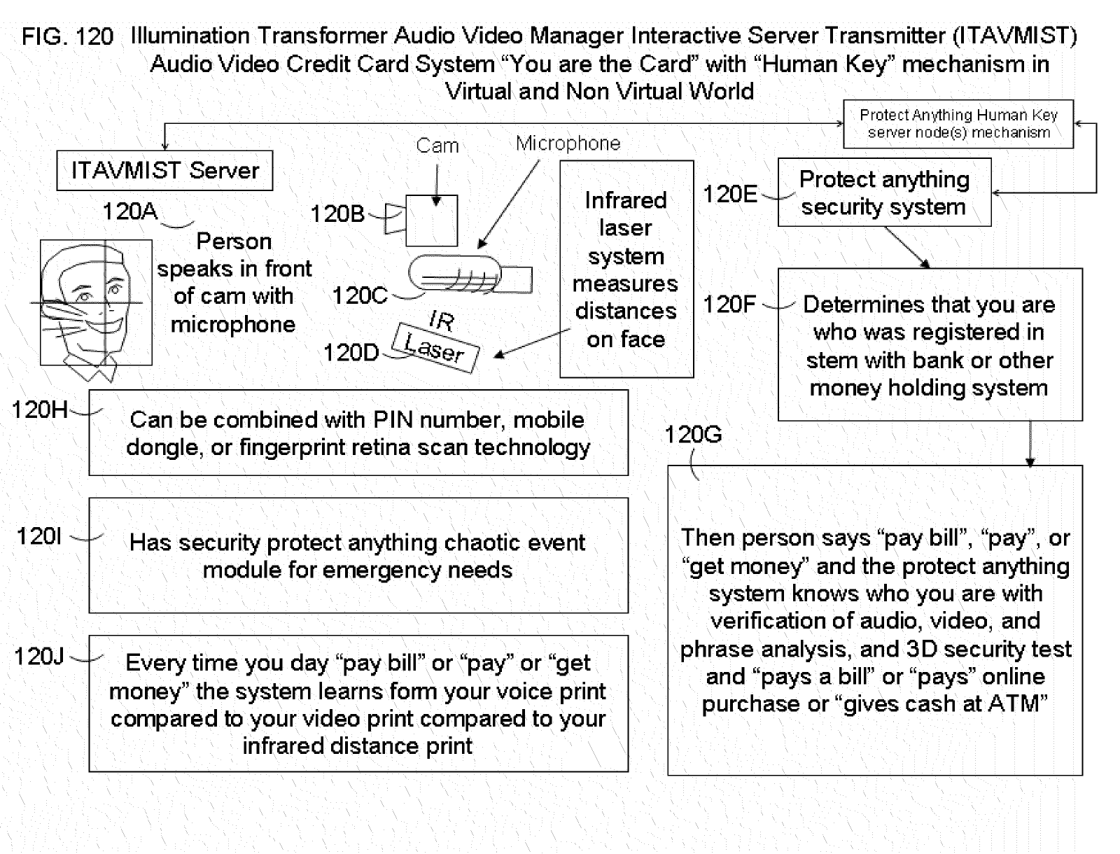

FIG. 120 is a conceptual diagram representative of Illumination Transformer Audio Video Manager Interactive Server Transmitter (ITAVMIST) Audio Video Credit Card System “You are the Card” with “Human Key” mechanism.

FIG. 120A is an illustration representative showing the Person speaks in front of cam with microphone part of the mechanism.

FIG. 120B is an illustration representative showing the identification cam or cams part of the mechanism.

FIG. 120C is an illustration representative showing the identification microphone or microphones part of the mechanism.

FIG. 120D is an illustration representative showing the identification infrared laser system which measures distances on face part of the mechanism.

FIG. 120E is an illustration representative showing the Protect anything security system part of the mechanism.

FIG. 120F is an illustration representative showing the system that Determines that you are who was registered in stem with bank or other money holding system part of the mechanism.

FIG. 120G is an illustration representative showing where Then a person says “pay bill”, “pay”, or “get money” and the protect anything system knows who you are with verification of audio, video, and phrase analysis, and 3D security test and “pays a bill” or “pays” online purchase or “gives cash at ATM” part of the mechanism.

FIG. 120H is an illustration representative showing the mechanism method Can be combined with PIN number, mobile dongle, or fingerprint retina scan technology part of the mechanism.

FIG. 120I is an illustration representative showing the system has security protect anything chaotic event module for emergency needs as part of the mechanism.

FIG. 120J is an illustration representative showing where Every time you say “pay bill” or “pay” or “get money” the system learns form your voice print compared to your video print compared to your infrared distance print part of the mechanism.

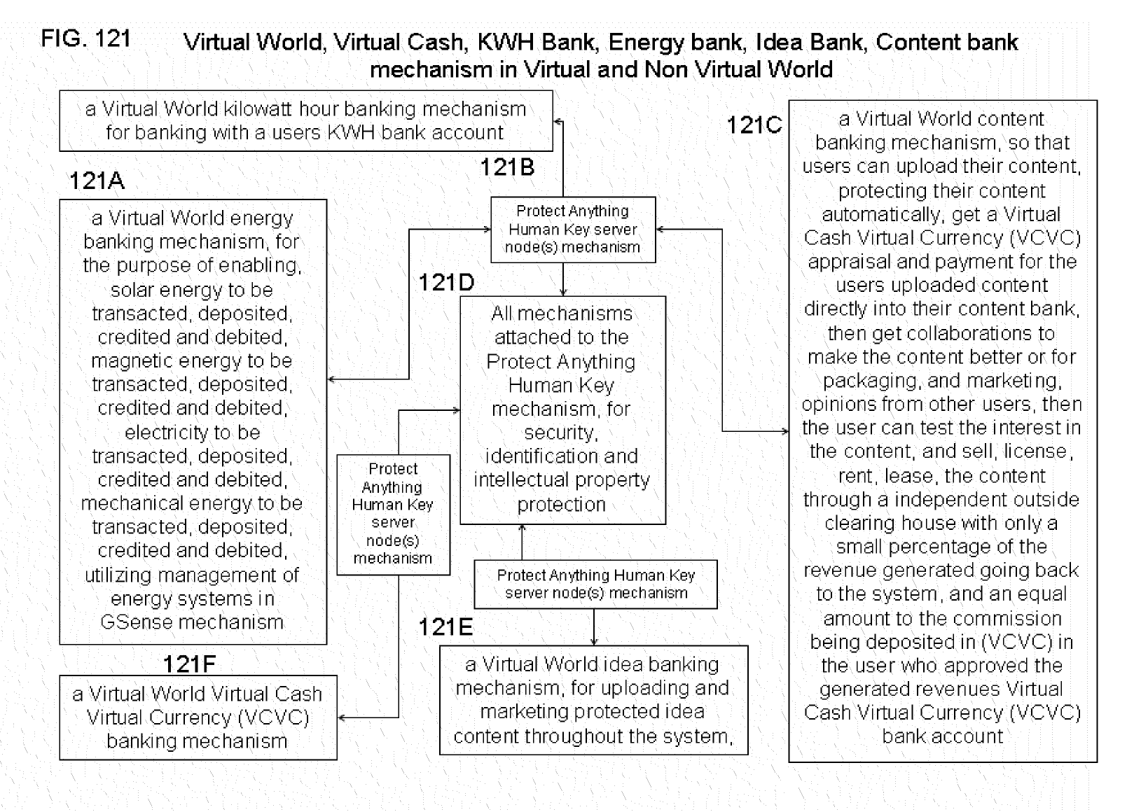

FIG. 121A illustrates Virtual World, Virtual Cash, KWH Bank, Energy bank, Idea Bank, Content bank mechanism in Virtual and Non Virtual World, and a Virtual World energy banking mechanism, for the purpose of enabling, solar energy to be transacted, deposited, credited and debited, magnetic energy to be transacted, deposited, credited and debited, electricity to be transacted, deposited, credited and debited, mechanical energy to be transacted, deposited, credited and debited, utilizing management of energy systems in GSense mechanism.

FIG. 121B illustrates a Virtual World kilowatt hour banking mechanism for banking with a users KWH bank account.

FIG. 121C illustrates a Virtual World content banking mechanism, so that users can upload their content, protecting their content automatically, get a Virtual Cash Virtual Currency (VCVC) appraisal and payment for the users uploaded content directly into their content bank, then get collaborations to make the content better or for packaging, and marketing, opinions from other users, then the user can test the interest in the content, and sell, license, rent, lease, the content through a independent outside clearing house with only a small percentage of the revenue generated going back to the system, and an equal amount to the commission being deposited in (VCVC) in the user who approved the generated revenues Virtual Cash Virtual Currency (VCVC) bank account.

FIG. 121D illustrates where all mechanisms are attached to the Protect Anything Human Key mechanism, for security, identification and intellectual property protection.

FIG. 121E illustrates a Virtual World idea banking mechanism, for uploading and marketing protected idea content throughout the system.

FIG. 121F illustrates a Virtual World Virtual Cash Virtual Currency (VCVC) banking mechanism.

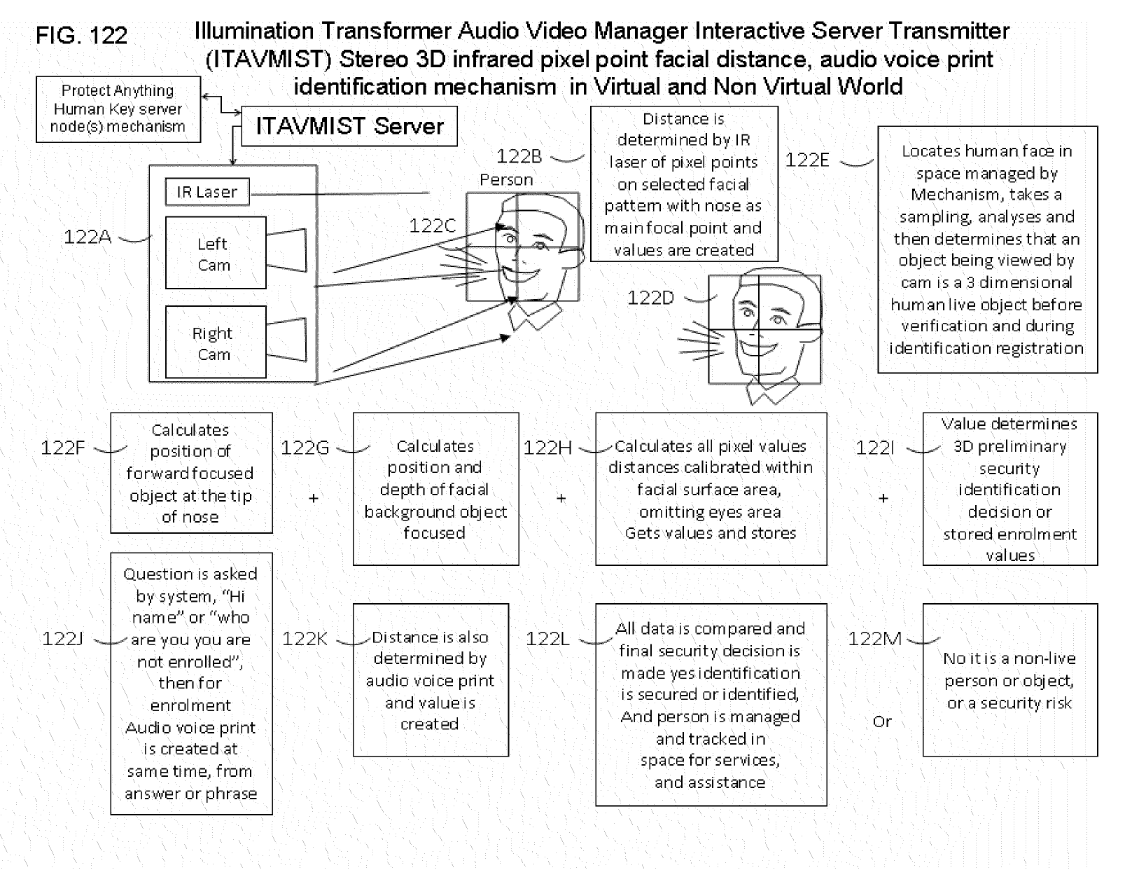

FIG. 122 is a conceptual diagram representative of Illumination Transformer Audio Video Manager Interactive Server Transmitter (ITAVMIST) Stereo 3D infrared pixel point facial distance, audio voice print identification mechanism.

FIG. 122A is an illustration representative showing the infrared light laser left cam and right cam part of the mechanism.

FIG. 122B is an illustration representative showing a person being identified as part of the mechanism.

FIG. 122C is an illustration representative showing the person speaking a phrase as part of the mechanism.

FIG. 122D is an illustration representative showing where the Distance is instantly determined by IR laser of pixel points on selected facial pattern with nose as main focal point and values are created part of the mechanism.

FIG. 122E is an illustration representative showing where the system locates human face in space managed by mechanism, takes a sampling, analyzes and then determines that an object being viewed by cam is a 3 dimensional human live object before verification and during identification registration part of the mechanism.

FIG. 122F is an illustration representative showing where system Calculates position of forward focused object at the tip of nose part of the mechanism.

FIG. 122G is an illustration representative showing system that Calculates position and depth of facial background object focused part of the mechanism.

FIG. 122H is an illustration representative showing where the system calculates all pixel values distances calibrated with in facial surface area, omitting eyes area gets values and stores part of the mechanism.

FIG. 122I is an illustration representative showing where the created Value determines 3D preliminary security identification decision or stored enrollment values part of the mechanism.

FIG. 122J is an illustration representative showing a Question is asked by system, “Hi name” or “who are you are not enrolled”, then for enrollment Audio voice print is created at same time, from answer or phrase part of the mechanism.

FIG. 122K is an illustration representative showing where the Distance is also determined by audio voice print and value is created by the system part of the mechanism.

FIG. 122L is an illustration representative showing that in the system all data is compared and final security decision is made yes identification is secured or identified, and person is managed and tracked in space for services, and assistance part of the mechanism.

FIG. 122M is an illustration representative showing the or No it is a non-live person or object, or a security risk system response part of the mechanism.

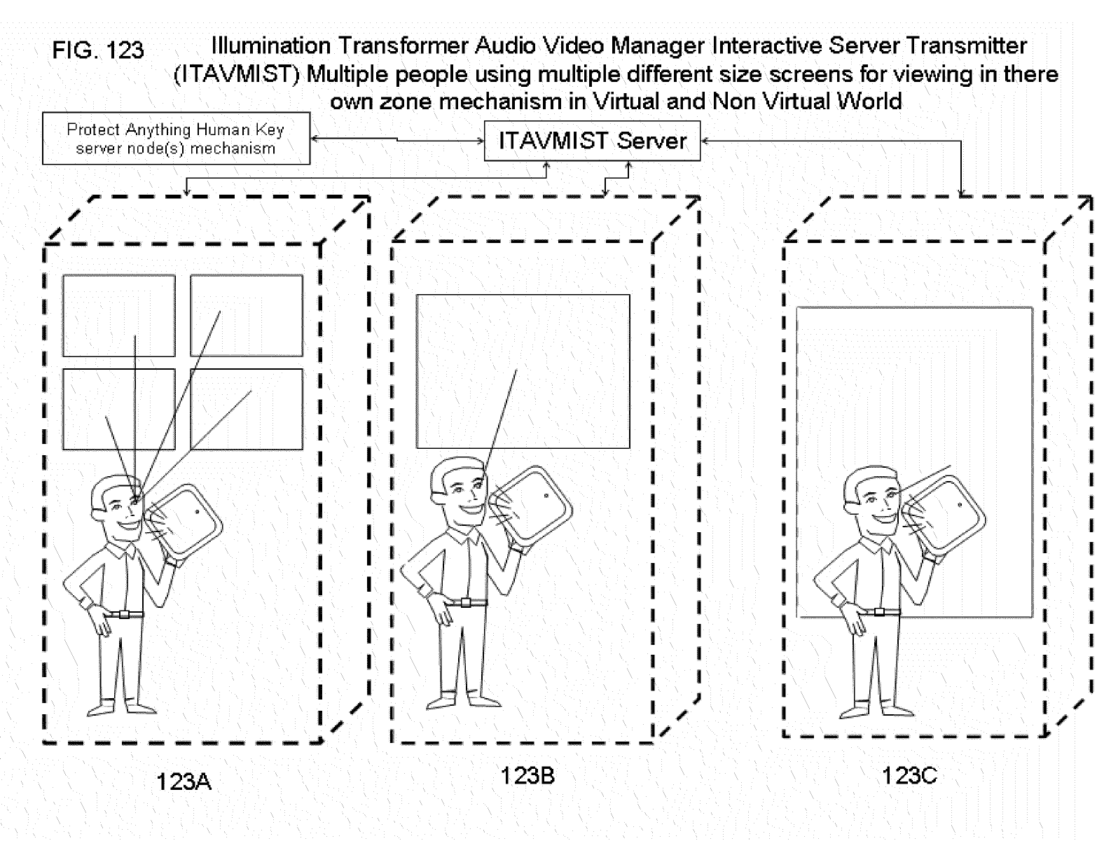

FIG. 123 is a conceptual diagram representative of Illumination Transformer Audio Video Manager Interactive Server Transmitter (ITAVMIST) multiple people using multiple different size screens for viewing in their own zone mechanism.

FIG. 123A is an illustration representative showing a person viewing 4 projected screens in a private space zone next 2 other people part of the mechanism.

FIG. 123B is an illustration representative showing a person viewing a frontal single screen next to other people in a zone part of the mechanism.

FIG. 123C is an illustration representative showing a person who has re sized his screen in his zone next to other people viewing in their zones part of the mechanism.

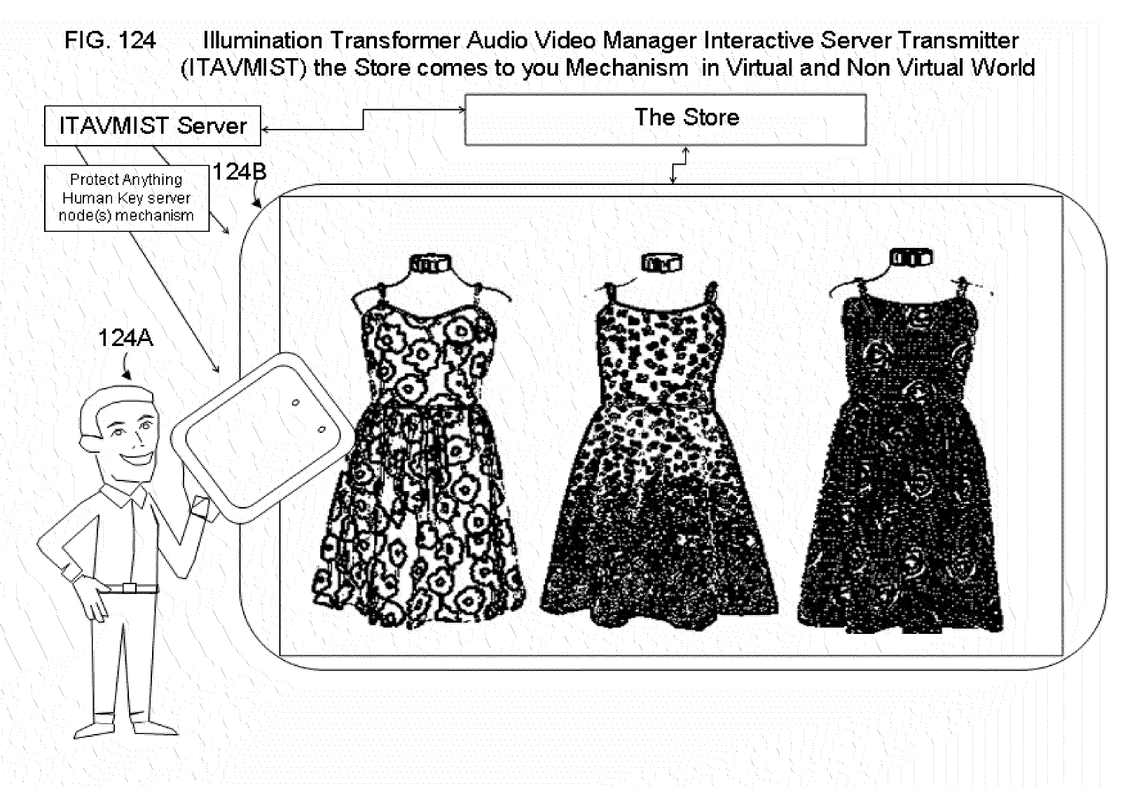

FIG. 124 is a conceptual diagram representative of Illumination Transformer Audio Video Manager Interactive Server Transmitter (ITAVMIST) the store comes to you mechanism.

FIG. 124A is an illustration representative showing the user with tablet PC hand held or no device free space viewing of store at any space managed by the apparatus part of the mechanism.

FIG. 124B is an illustration representative showing the store being projected in free space, for viewing and listening part of the mechanism.

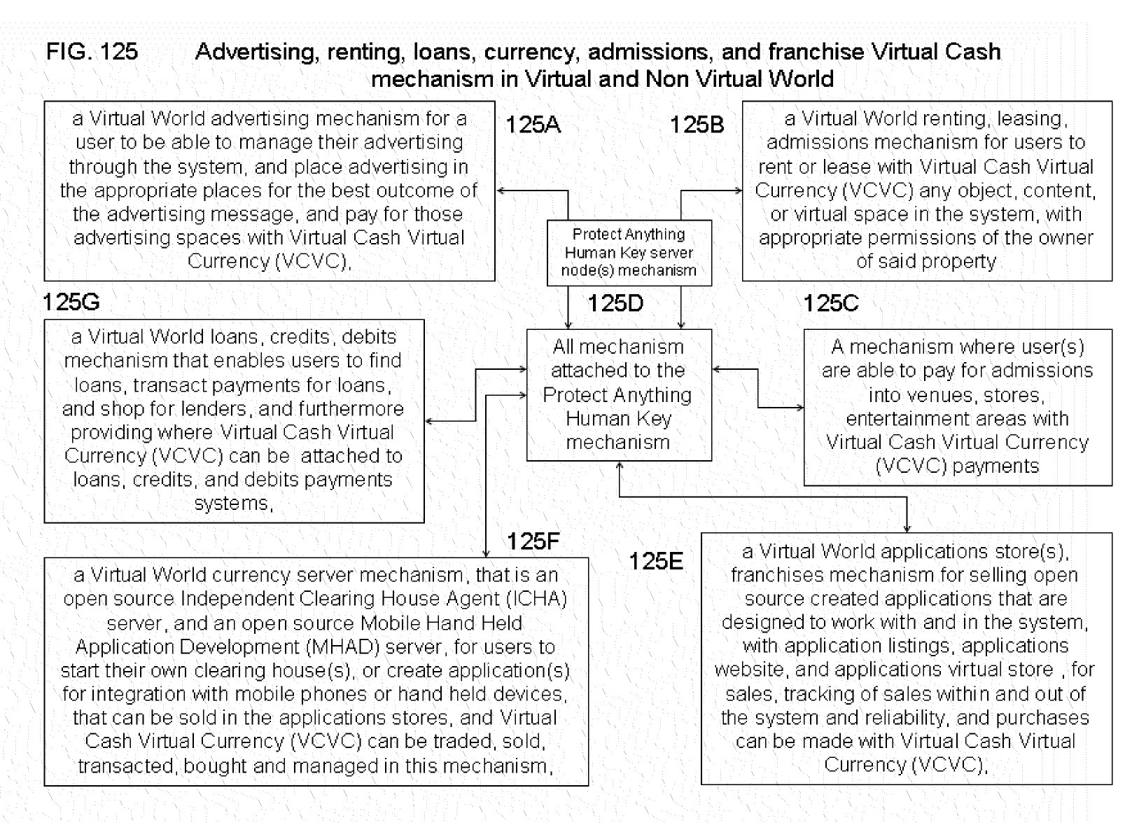

FIG. 125A illustrates advertising, renting, loans, currency, admissions, and franchise Virtual Cash mechanism in Virtual and Non Virtual World, and a Virtual World advertising mechanism for a user to be able to manage their advertising through the system, and place advertising in the appropriate places for the best outcome of the advertising message, and pay for those advertising spaces with Virtual Cash Virtual Currency (VCVC).

FIG. 125B illustrates a Virtual World renting, leasing, admissions mechanism for users to rent or lease with Virtual Cash Virtual Currency (VCVC) any object, content, or virtual space in the system, with appropriate permissions of the owner of said property.

FIG. 125C illustrates a mechanism where user(s) are able to pay for admissions into venues, stores, entertainment areas with Virtual Cash Virtual Currency (VCVC) payments.

FIG. 125D illustrates where all mechanisms are attached to the Protect Anything Human Key mechanism.

FIG. 125E illustrates a Virtual World applications store(s), franchises mechanism for selling open source created applications that are designed to work with and in the system, with application listings, applications website, and applications virtual store, for sales, tracking of sales within and out of the system and reliability, and purchases can be made with Virtual Cash Virtual Currency (VCVC).

FIG. 125F illustrates a Virtual World currency server mechanism, that is an open source Independent Clearing House Agent (ICHA) server, and an open source Mobile Hand Held Application Development (MHAD) server, for users to start their own clearing house(s), or create application(s) for integration with mobile phones or hand held devices, that can be sold in the applications stores, and Virtual Cash Virtual Currency (VCVC) can be traded, sold, transacted, bought and managed in this mechanism.

FIG. 125G illustrates a Virtual World loans, credits, debits mechanism that enables users to find loans, transact payments for loans, and shop for lenders, and furthermore providing where Virtual Cash Virtual Currency (VCVC) can be attached to loans, credits, and debits payments systems.

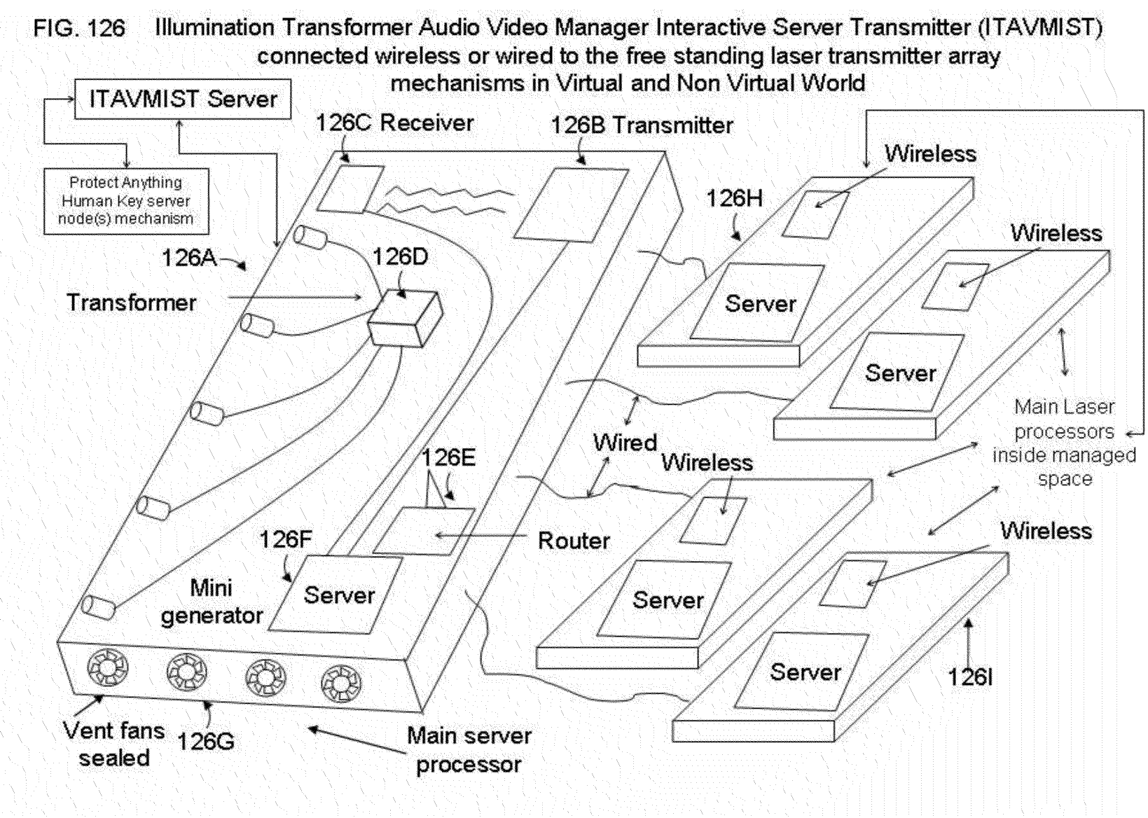

FIG. 126 is a conceptual diagram representative of Illumination Transformer Audio Video Manager Interactive Server Transmitter (ITAVMIST) connected wireless or wired to the free standing laser transmitter array mechanisms.

FIG. 126A is an illustration representative showing the Illumination Transformer Audio Video Manager Interactive Server Transmitter (ITAVMIST) part of the mechanism.

FIG. 126B is an illustration representative showing the wireless energy transmitter part of the mechanism.

FIG. 126C is an illustration representative showing the wireless energy receiver part of the mechanism.

FIG. 126D is an illustration representative showing the transformer mechanism attached to the multiple alternative generators part of the mechanism.

FIG. 126E is an illustration representative showing the computer wireless router part of the mechanism.

FIG. 126F is an illustration representative showing the main server motherboard part of the mechanism.

FIG. 126G is an illustration representative showing the sealed vent fans part of the mechanism.

FIG. 126H is an illustration representative showing the infrared light laser beam server apparatus with wired or wireless energy part of the mechanism.

FIG. 126I is an illustration representative showing the infrared light laser beam server apparatus projection into free space side of the mechanism.

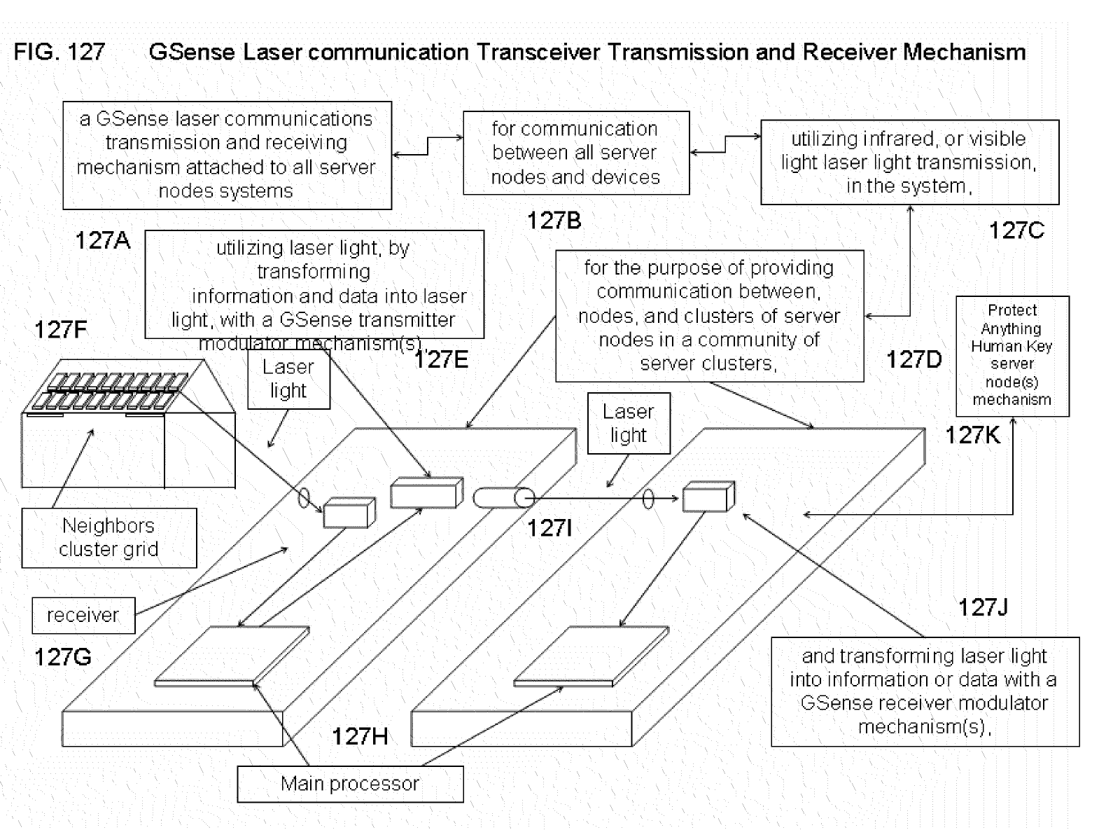

FIG. 127A illustrates GSense Laser communication Transceiver Transmission and Receiver Mechanism and a GSense laser communications transmission and receiving mechanism attached to all server nodes systems.

FIG. 127B illustrates where mechanism is used for communication between all server nodes and devices.

FIG. 127C illustrates where mechanism is utilizing infrared, or visible light laser light transmission, in the system.

FIG. 127D illustrates light communication laser for the purpose of providing communication between, nodes, and clusters of server nodes in a community of server clusters.

FIG. 127E illustrates communication utilizing laser light, by transforming information and data into laser light, with a GSense transmitter modulator mechanism(s).

FIG. 127F illustrates Neighbors cluster grid communicating with light.

FIG. 127G illustrates the transceiver receiver unit.

FIG. 127H illustrates the main server units.

FIG. 127I illustrates the communication being transmitted through laser light.

FIG. 127J illustrates communications and transforming laser light into information or data with a GSense receiver modulator mechanism(s).

FIG. 127K illustrates the mechanism linked to the Protect Anything Human Key server node(s) mechanism.

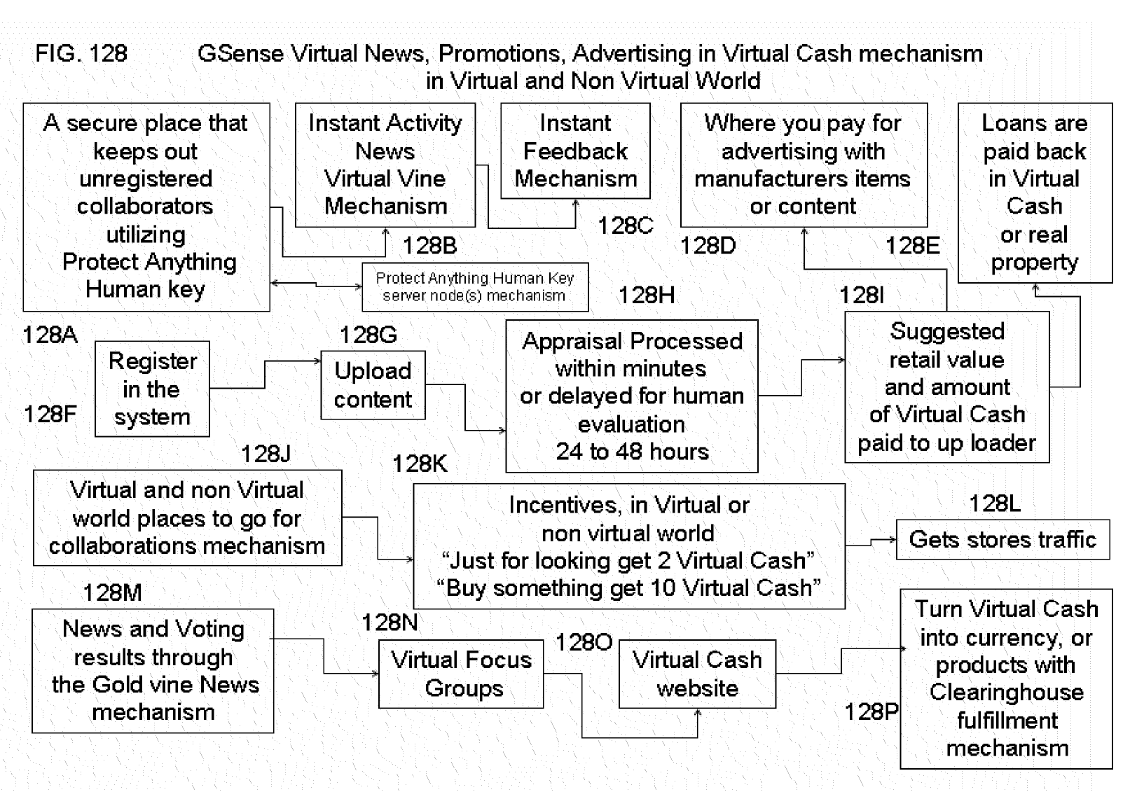

FIG. 128A illustrates GSense Virtual News, Promotions, Advertising in Virtual Cash mechanism in Virtual and Non Virtual World and A secure place that keeps out unregistered collaborators utilizing Protect Anything Human key.

FIG. 128B illustrates GSense Virtual News, Promotions, Advertising in Virtual Cash mechanism in Virtual and Non Virtual World and A secure place that keeps out unregistered collaborators utilizing Protect Anything Human key and Instant Activity, News, Virtual Vine Mechanism.

FIG. 128C illustrates GSense Virtual News, Promotions, Advertising in Virtual Cash mechanism in Virtual and Non Virtual World and A secure place that keeps out unregistered collaborators utilizing Protect Anything Human key and Instant Feedback Mechanism.

FIG. 128D illustrates GSense Virtual News, Promotions, Advertising in Virtual Cash mechanism in Virtual and Non Virtual World and A secure place that keeps out unregistered collaborators utilizing Protect Anything Human key and Where you pay for advertising with manufacturers items or content.

FIG. 128E illustrates GSense Virtual News, Promotions, Advertising in Virtual Cash mechanism in Virtual and Non Virtual World and A secure place that keeps out unregistered collaborators utilizing Protect Anything Human key and Loans are paid back in Virtual Cash or real property.

FIG. 128F illustrates GSense Virtual News, Promotions, Advertising in Virtual Cash mechanism in Virtual and Non Virtual World and A secure place that keeps out unregistered collaborators utilizing Protect Anything Human Key and Register in the system.

FIG. 128G illustrates GSense Virtual News, Promotions, Advertising in Virtual Cash mechanism in Virtual and Non Virtual World and A secure place that keeps out unregistered collaborators utilizing Protect Anything Human key and Upload content.

FIG. 128H illustrates GSense Virtual News, Promotions, Advertising in Virtual Cash mechanism in Virtual and Non Virtual World and A secure place that keeps out unregistered collaborators utilizing Protect Anything Human key and Appraisal Processed within minutes or delayed for human evaluation 24 to 48 hours.

FIG. 128I illustrates GSense Virtual News, Promotions, Advertising in Virtual Cash mechanism in Virtual and Non Virtual World and A secure place that keeps out unregistered collaborators utilizing Protect Anything Human key and Suggested retail value and amount of Virtual Cash paid to up loader.

FIG. 128J illustrates GSense Virtual News, Promotions, Advertising in Virtual Cash mechanism in Virtual and Non Virtual World and A secure place that keeps out unregistered collaborators utilizing Protect Anything Human key and Virtual and non Virtual world places to go for collaborations mechanism.

FIG. 128K illustrates GSense Virtual News, Promotions, Advertising in Virtual Cash mechanism in Virtual and Non Virtual World and A secure place that keeps out unregistered collaborators utilizing Protect Anything Human key and Incentives, in Virtual or non virtual world “Just for looking get 2 Virtual Cash” “Buy something get 10 Virtual Cash”.

FIG. 128L illustrates GSense Virtual News, Promotions, Advertising in Virtual Cash mechanism in Virtual and Non Virtual World and Gets stores traffic.

FIG. 128M illustrates GSense Virtual News, Promotions, Advertising in Virtual Cash mechanism in Virtual and Non Virtual World and News and Voting results through the Virtual Vine News mechanism.

FIG. 128N illustrates GSense Virtual News, Promotions, Advertising in Virtual Cash mechanism in Virtual and Non Virtual World and Virtual Focus Groups.

FIG. 128O illustrates GSense Virtual News, Promotions, Advertising in Virtual Cash mechanism in Virtual and Non Virtual World and Virtual Cash website.

FIG. 128P illustrates GSense Virtual News, Promotions, Advertising in Virtual Cash mechanism in Virtual and Non Virtual World and Turn Virtual Cash into currency, or products with Clearinghouse fulfillment mechanism.

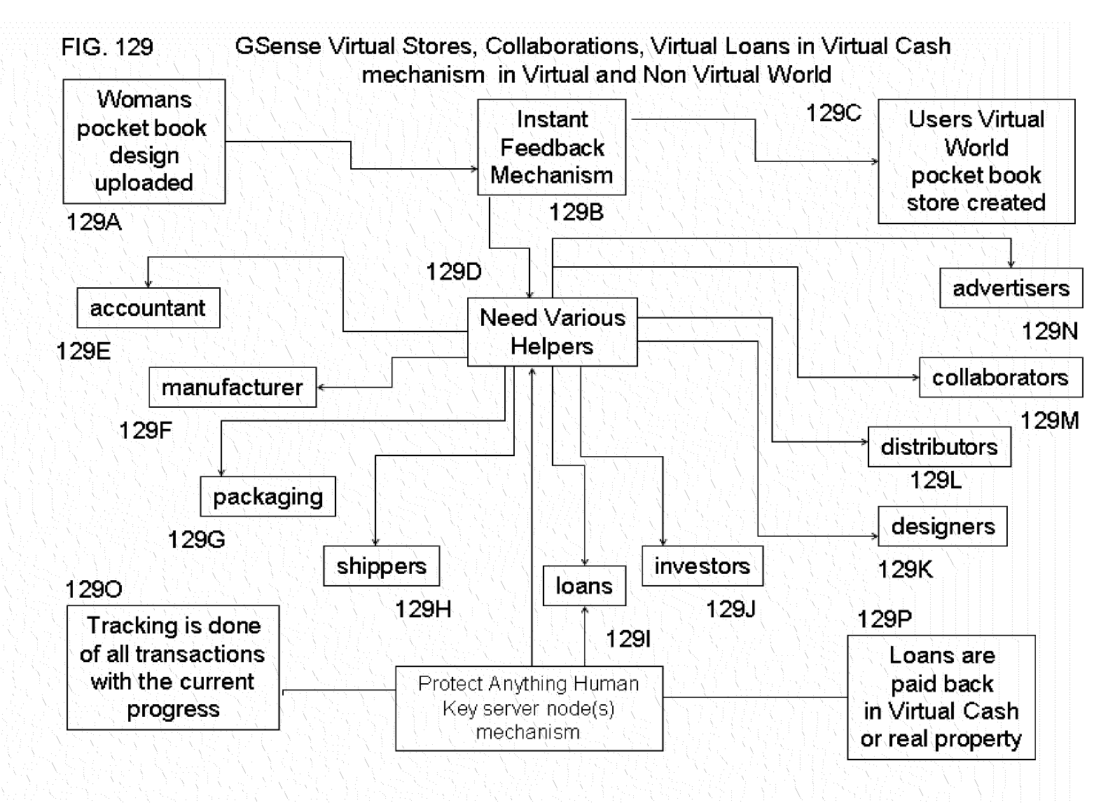

FIG. 129A illustrates GSense Virtual Stores, Collaborations, Virtual Loans in Virtual Cash mechanism in Virtual and Non Virtual World where Womans pocket book design uploaded.

FIG. 129B illustrates GSense Virtual Stores, Collaborations, Virtual Loans in Virtual Cash mechanism in Virtual and Non Virtual World and the Instant Feedback Mechanism.

FIG. 129C illustrates GSense Virtual Stores, Collaborations, Virtual Loans in Virtual Cash mechanism in Virtual and Non Virtual World and the Users Virtual World pocket book store created.

FIG. 129D illustrates GSense Virtual Stores, Collaborations, Virtual Loans in Virtual Cash mechanism in Virtual and Non Virtual World and the need for various helpers.

FIG. 129E illustrates GSense Virtual Stores, Collaborations, Virtual Loans in Virtual Cash mechanism in Virtual and Non Virtual World such as accountant.

FIG. 129F illustrates GSense Virtual Stores, Collaborations, Virtual Loans in Virtual Cash mechanism in Virtual and Non Virtual World such as manufacturer.

FIG. 129G illustrates GSense Virtual Stores, Collaborations, Virtual Loans in Virtual Cash mechanism in Virtual and Non Virtual World such as packaging.

FIG. 129H illustrates GSense Virtual Stores, Collaborations, Virtual Loans in Virtual Cash mechanism in Virtual and Non Virtual World such as shippers.

FIG. 129I illustrates GSense Virtual Stores, Collaborations, Virtual Loans in Virtual Cash mechanism in Virtual and Non Virtual World such as loans.

FIG. 129J illustrates GSense Virtual Stores, Collaborations, Virtual Loans in Virtual Cash mechanism in Virtual and Non Virtual World such as investors.

FIG. 129K illustrates GSense Virtual Stores, Collaborations, Virtual Loans in Virtual Cash mechanism in Virtual and Non Virtual World such as designers.

FIG. 129L illustrates GSense Virtual Stores, Collaborations, Virtual Loans in Virtual Cash mechanism in Virtual and Non Virtual World such as distributers.

FIG. 129M illustrates GSense Virtual Stores, Collaborations, Virtual Loans in Virtual Cash mechanism in Virtual and Non Virtual World such as collaborators.

FIG. 129N illustrates GSense Virtual Stores, Collaborations, Virtual Loans in Virtual Cash mechanism in Virtual and Non Virtual World such as advertisers.

FIG. 129O illustrates GSense Virtual Stores, Collaborations, Virtual Loans in Virtual Cash mechanism in Virtual and Non Virtual World and Tracking is done of all transactions with the current progress.

FIG. 129P illustrates GSense Virtual Stores, Collaborations, Virtual Loans in Virtual Cash mechanism in Virtual and Non Virtual World and Loans are paid back in Virtual Cash or real property.

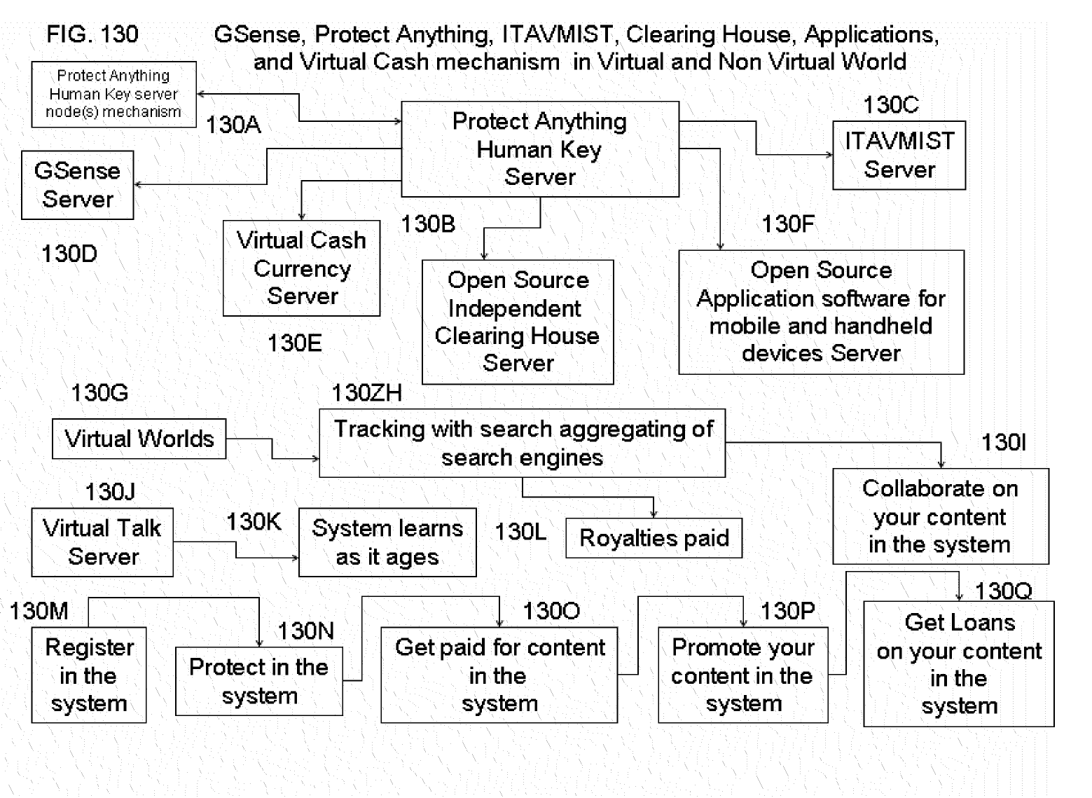

FIG. 130A illustrates GSense, Protect Anything, ITAVMIST, Clearing House, Applications, and Virtual Cash mechanism in Virtual and Non Virtual World and the Protect Anything Human Key server node(s) mechanism.

FIG. 130B illustrates GSense, Protect Anything, ITAVMIST, Clearing House, Applications, and Virtual Cash mechanism in Virtual and Non Virtual World and Protect Anything Human Key Server.

FIG. 130C illustrates GSense, Protect Anything, ITAVMIST, Clearing House, Applications, and Virtual Cash mechanism in Virtual and Non Virtual World and the ITAVMIST Server.

FIG. 130D illustrates GSense, Protect Anything, ITAVMIST, Clearing House, Applications, and Virtual Cash mechanism in Virtual and Non Virtual World and the GSense Server.

FIG. 130E illustrates GSense, Protect Anything, ITAVMIST, Clearing House, Applications, and Virtual Cash mechanism in Virtual and Non Virtual World and the Virtual Cash Currency Server.

FIG. 130F illustrates GSense, Protect Anything, ITAVMIST, Clearing House, Applications, and Virtual Cash mechanism in Virtual and Non Virtual World where Open Source Application software for mobile and handheld devices Server can be used.

FIG. 130G illustrates GSense, Protect Anything, ITAVMIST, Clearing House, Applications, and Virtual Cash mechanism in Virtual and Non Virtual World in Virtual Worlds.

FIG. 130H illustrates GSense, Protect Anything, ITAVMIST, Clearing House, Applications, and Virtual Cash mechanism in Virtual and Non Virtual World and shows Tracking with search aggregating of search engines.

FIG. 130I illustrates GSense, Protect Anything, ITAVMIST, Clearing House, Applications, and Virtual Cash mechanism in Virtual and Non Virtual World and where users can Collaborate on your content in the system.

FIG. 130J illustrates GSense, Protect Anything, ITAVMIST, Clearing House, Applications, and Virtual Cash mechanism in Virtual and Non Virtual World and the Virtual Talk server.

FIG. 130K illustrates GSense, Protect Anything, ITAVMIST, Clearing House, Applications, and Virtual Cash mechanism in Virtual and Non Virtual World where the system learns as it ages.

FIG. 130L illustrates GSense, Protect Anything, ITAVMIST, Clearing House, Applications, and Virtual Cash mechanism in Virtual and Non Virtual World where royalties are paid.

FIG. 130M illustrates GSense, Protect Anything, ITAVMIST, Clearing House, Applications, and Virtual Cash mechanism in Virtual and Non Virtual World where users register in the system.

FIG. 130N illustrates GSense, Protect Anything, ITAVMIST, Clearing House, Applications, and Virtual Cash mechanism in Virtual and Non Virtual World were content is protected in the system.

FIG. 130O illustrates GSense, Protect Anything, ITAVMIST, Clearing House, Applications, and Virtual Cash mechanism in Virtual and Non Virtual World where users get paid for content in the system.

FIG. 130P illustrates GSense, Protect Anything, ITAVMIST, Clearing House, Applications, and Virtual Cash mechanism in Virtual and Non Virtual World where a user can promote their content in the system.

FIG. 130Q illustrates GSense, Protect Anything, ITAVMIST, Clearing House, Applications, and Virtual Cash mechanism in Virtual and Non Virtual World where a user can get loans on content in the system.

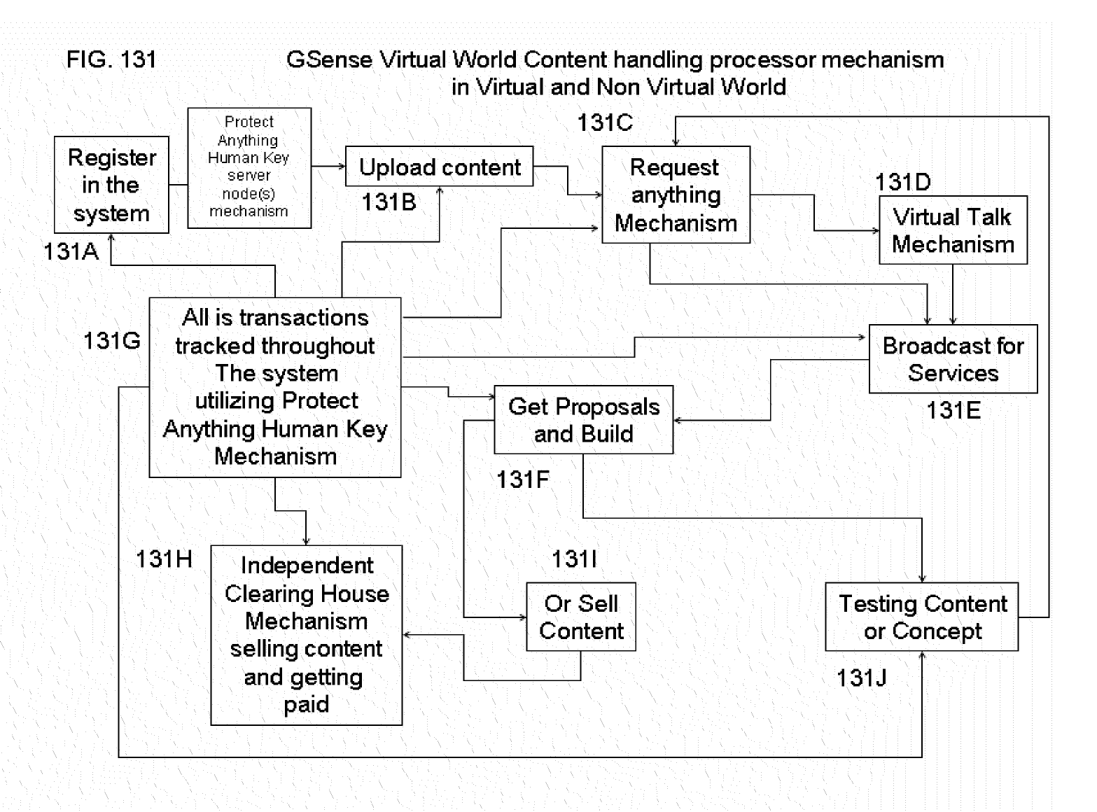

FIG. 131A illustrates GSense Virtual World Content handling processor mechanism in Virtual and Non Virtual World and where user registers in the system.

FIG. 131B illustrates GSense Virtual World Content handling processor mechanism in Virtual and Non Virtual World and where user uploads content.

FIG. 131C illustrates GSense Virtual World Content handling processor mechanism in Virtual and Non Virtual World and where user uses request anything mechanism.

FIG. 131D illustrates GSense Virtual World Content handling processor mechanism in Virtual and Non Virtual World and where user uses virtual talk mechanism.

FIG. 131E illustrates GSense Virtual World Content handling processor mechanism in Virtual and Non Virtual World and where user broadcasts for services.

FIG. 131F illustrates GSense Virtual World Content handling processor mechanism in Virtual and Non Virtual World and where user can get proposals and build.

FIG. 131G illustrates GSense Virtual World Content handling processor mechanism in Virtual and Non Virtual World and where all transactions tracked throughout The system utilizing Protect Anything Human Key Mechanism.

FIG. 131H illustrates GSense Virtual World Content handling processor mechanism in Virtual and Non Virtual World and the Independent Clearing House Mechanism selling content and getting paid.

FIG. 131I illustrates GSense Virtual World Content handling processor mechanism in Virtual and Non Virtual World and where user can sell content.

FIG. 131J illustrates GSense Virtual World Content handling processor mechanism in Virtual and Non Virtual World and where user can test content or a concept.

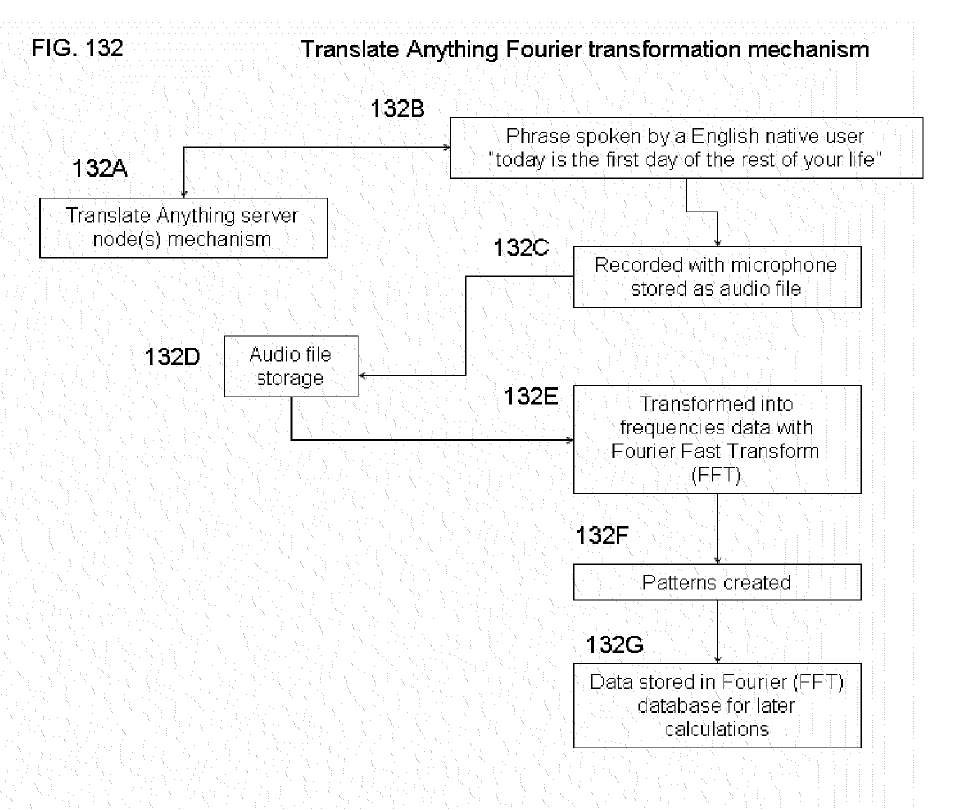

FIG. 132A illustrates Translate Anything Fourier transformation mechanism used in Translate Anything server node(s) mechanism.

FIG. 132B illustrates Translate Anything Fourier transformation mechanism where a Phrase spoken by a English native user “today is the first day of the rest of your life”.

FIG. 132C illustrates Translate Anything Fourier transformation mechanism where data is Recorded with microphone stored as audio file.

FIG. 132D illustrates Translate Anything Fourier transformation mechanism and the Audio file storage.

FIG. 131E illustrates Translate Anything Fourier transformation mechanism where data is Transformed into frequencies data with Fourier Fast Transform (FFT).

FIG. 132F illustrates Translate Anything Fourier transformation mechanism where data patterns are created.

FIG. 132G illustrates Translate Anything Fourier transformation mechanism where Data is stored in Fourier (FFT) database for later calculations.

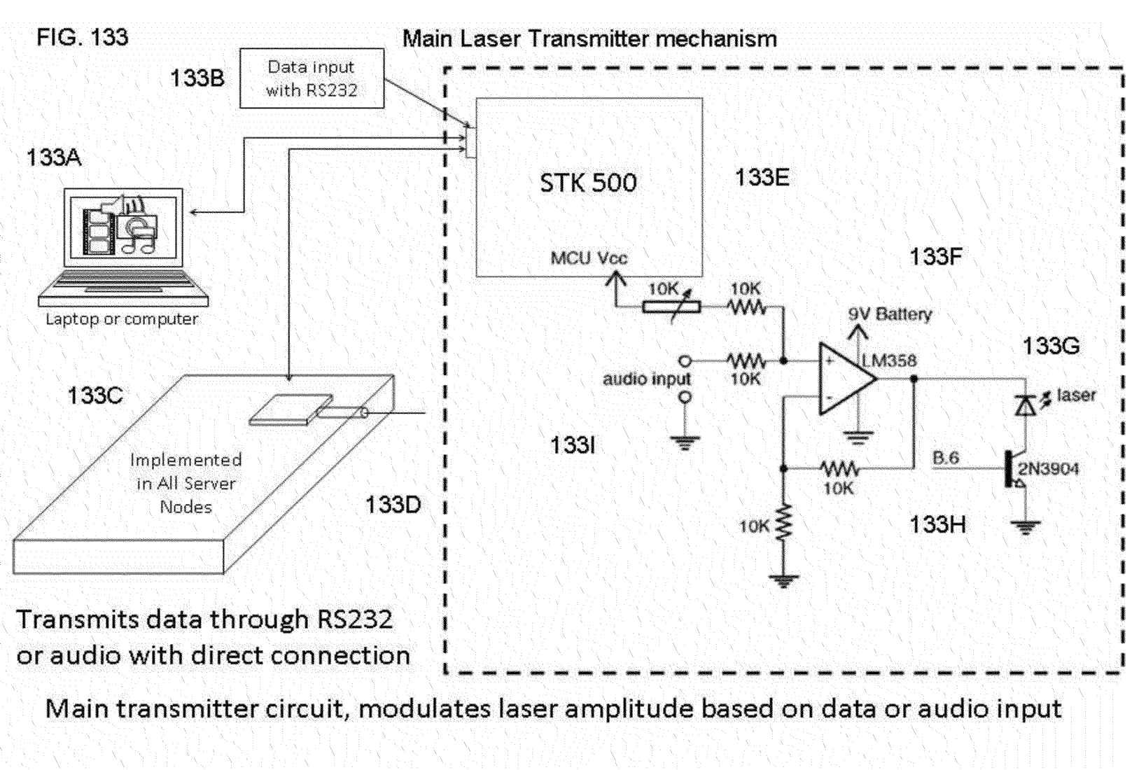

FIG. 133A illustrates Main Laser Transmitter mechanism component laptop or computer.

FIG. 133B illustrates Main Laser Transmitter mechanism component data input with RS232 port.

FIG. 133C illustrates Main Laser Transmitter mechanism component where communication is in all server mechanisms.

FIG. 133D illustrates Main Laser Transmitter mechanism component the main transmitter circuit.

FIG. 133E illustrates Main Laser Transmitter mechanism component the STK500 microcontroller.

FIG. 133F illustrates Main Laser Transmitter mechanism and the LM358 component.

FIG. 133G illustrates Main Laser Transmitter mechanism and the Laser component.

FIG. 133H illustrates Main Laser Transmitter mechanism and 2N3904 component.

FIG. 133I illustrates Main Laser Transmitter mechanism audio input component.

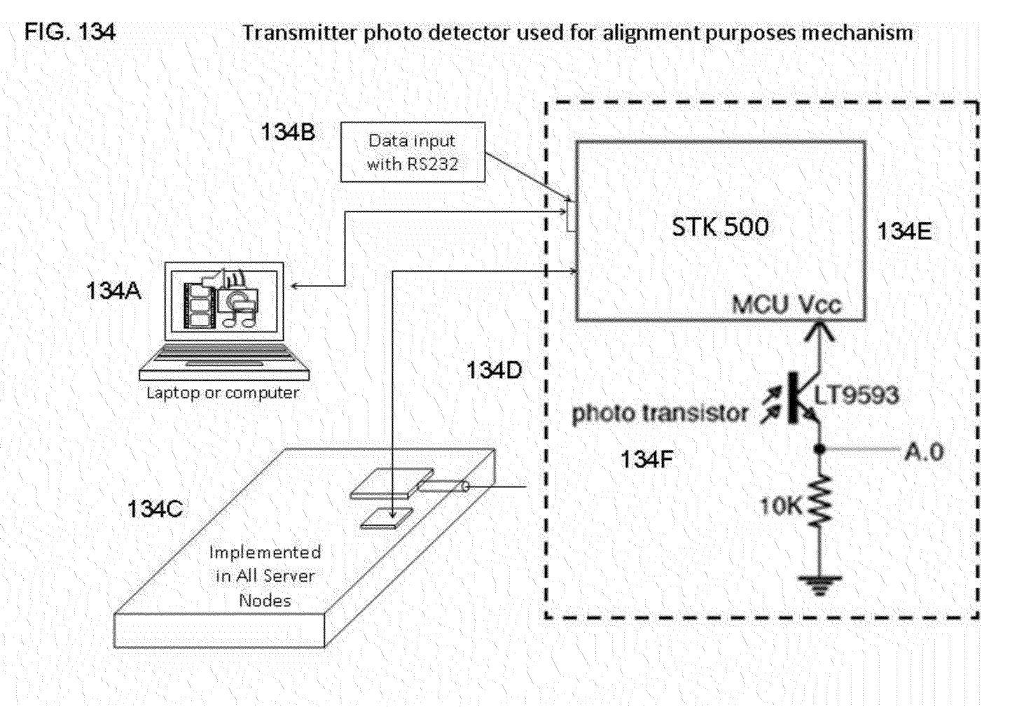

FIG. 134A illustrates Transmitter photo detector used for alignment purposes mechanism Laptop or computer component.

FIG. 134B illustrates Transmitter photo detector used for alignment purposes mechanism data input with RS232 port component.

FIG. 134C illustrates Transmitter photo detector used for alignment purposes mechanism which is implemented on all servers.

FIG. 134D illustrates Transmitter photo detector used for alignment purposes mechanism and alignment board component.

FIG. 134E illustrates Transmitter photo detector used for alignment purposes mechanism and the STK500 component.

FIG. 134F illustrates Transmitter photo detector used for alignment purposes mechanism and the photo transistor component.

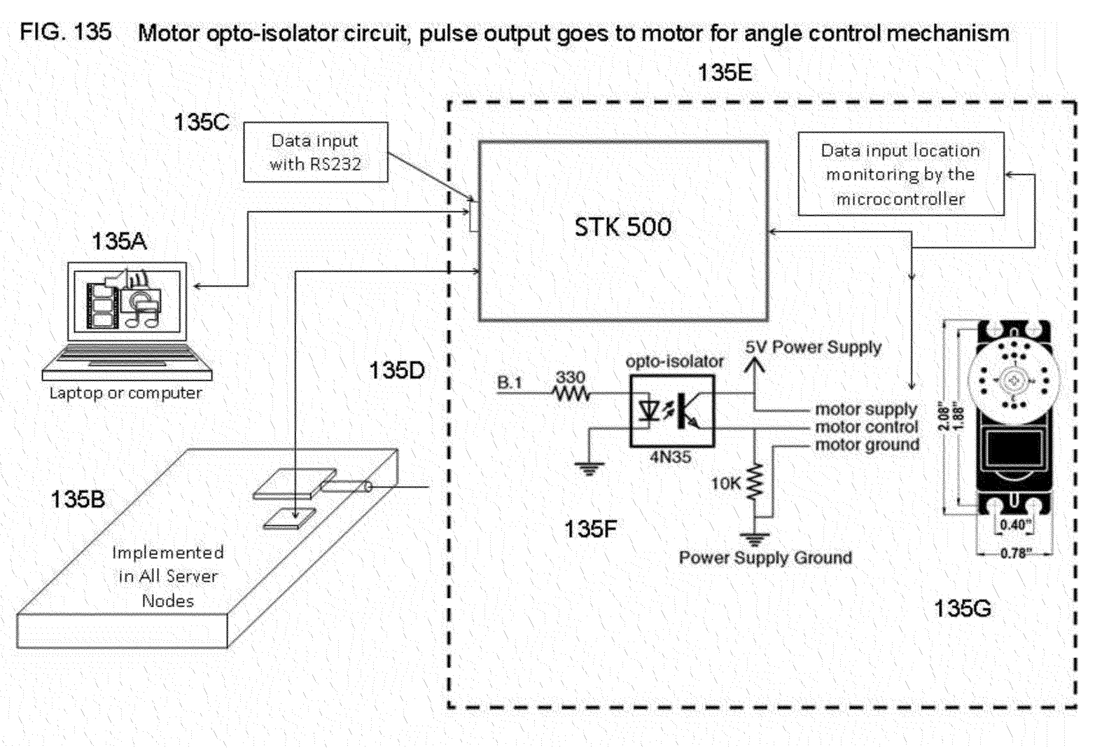

FIG. 135A illustrates Motor opto-isolator circuit, pulse output goes to motor for angle control mechanism laptop or computer component.

FIG. 135B illustrates Motor opto-isolator circuit, pulse output goes to motor for angle control mechanism which is implemented on all server nodes.

FIG. 135C illustrates Motor opto-isolator circuit, pulse output goes to motor for angle control mechanism and the data input with RS232 port component.

FIG. 135D illustrates Motor opto-isolator circuit, pulse output goes to motor for angle control mechanism circuit board component.

FIG. 135E illustrates Motor opto-isolator circuit, pulse output goes to motor for angle control mechanism and the STK500 component.

FIG. 135F illustrates Motor opto-isolator circuit, pulse output goes to motor for angle control mechanism and the opto-isolator component.

FIG. 135G illustrates Motor opto-isolator circuit, pulse output goes to motor for angle control mechanism and the servo laser alignment component.

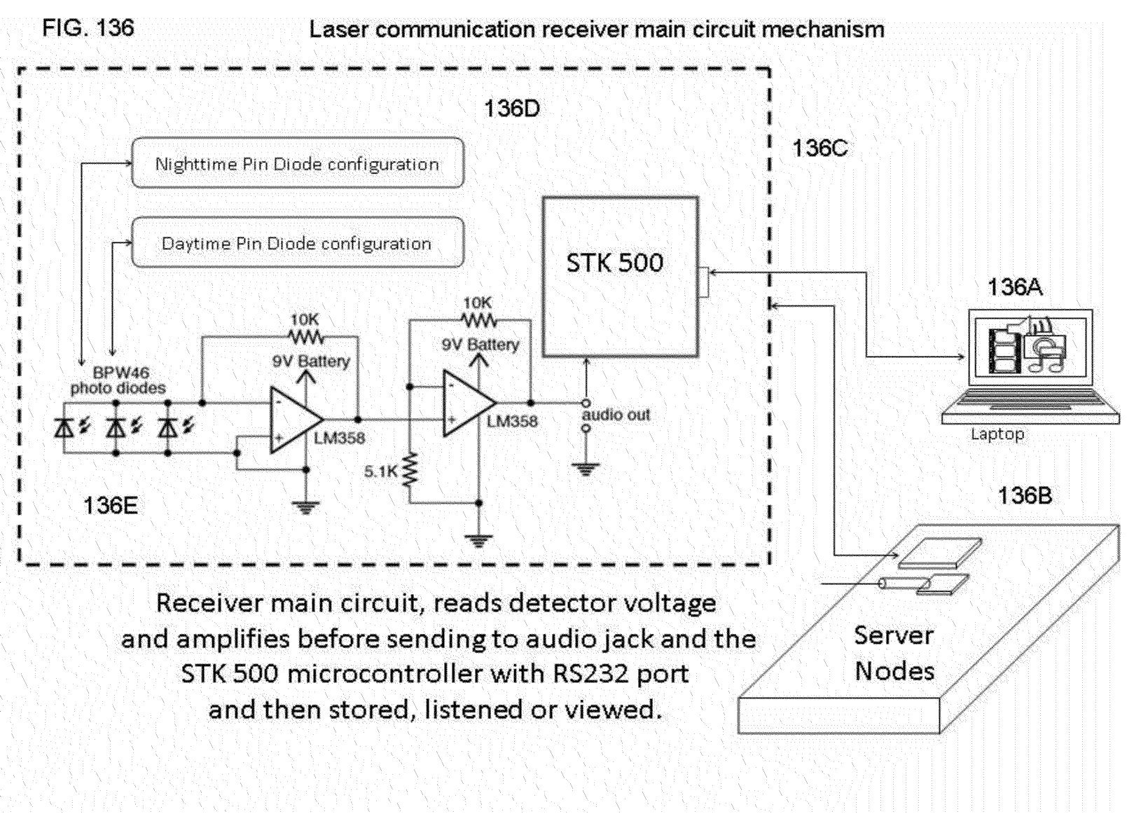

FIG. 136A illustrates Laser communication receiver main circuit mechanism and laptop and computer component.

FIG. 136B illustrates Laser communication receiver main circuit mechanism on all server nodes.

FIG. 136C illustrates Laser communication receiver main circuit mechanism circuit board component.

FIG. 136D illustrates Laser communication receiver main circuit mechanism daylight and nighttime component.

FIG. 136E illustrates Laser communication receiver main circuit mechanism and the 3 BPW46 photo diodes component.

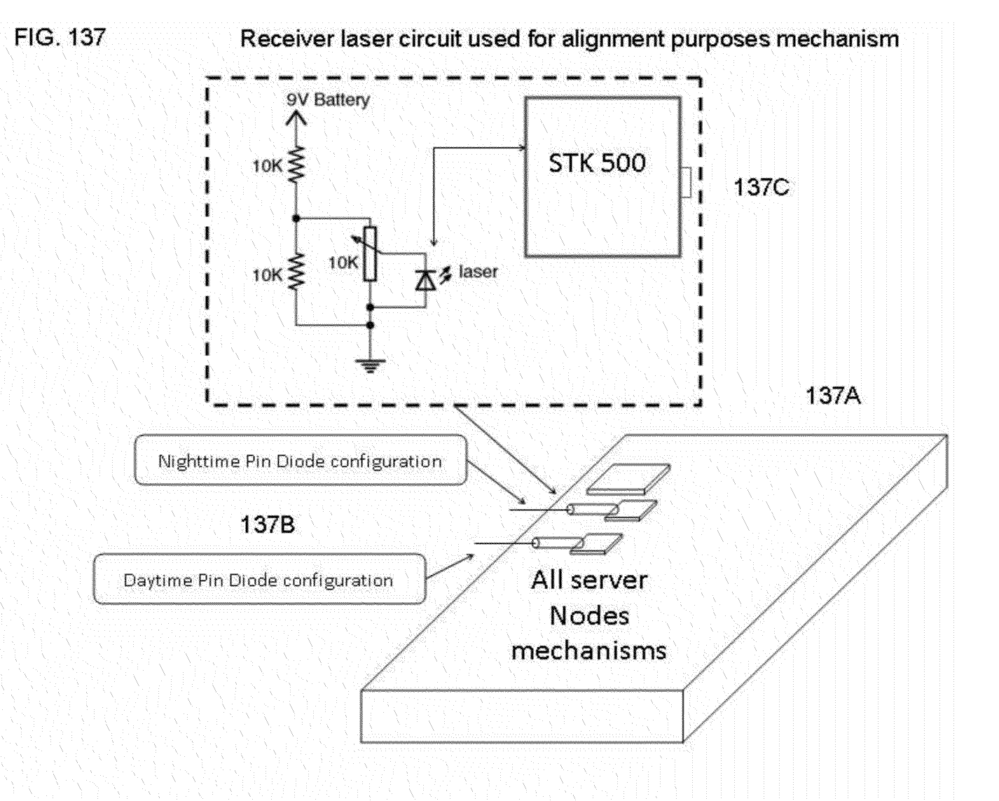

FIG. 137A illustrates Receiver laser circuit used for alignment purposes mechanism and where all server nodes have this component.

FIG. 137B illustrates Receiver laser circuit used for alignment purposes mechanism with the nighttime and daytime pin diode components.

FIG. 137C illustrates Receiver laser circuit used for alignment purposes mechanism and the circuit board, and STK500 component.

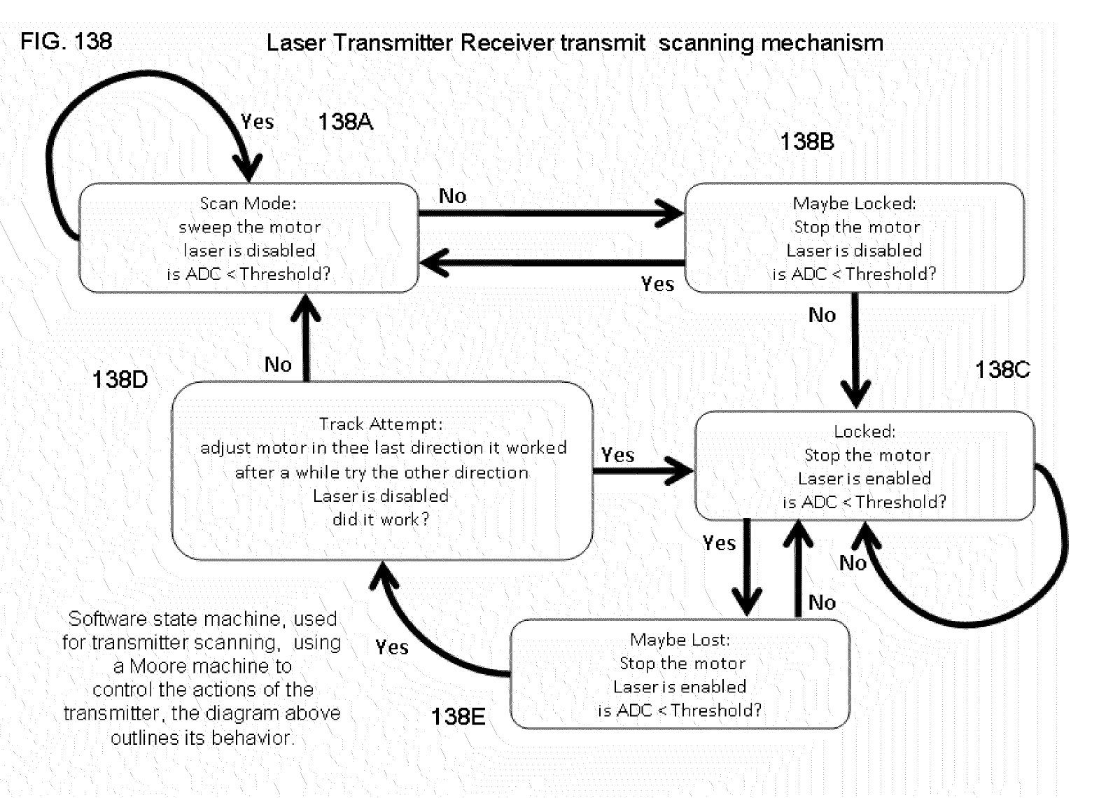

FIG. 138A illustrates the Laser Transmitter Receiver transmit scanning mechanism Software state machine, used for transmitter scanning, using a Moore machine to control the actions of the transmitter, the diagram above outlines its behavior, where the function is Scan Mode: sweep the motor laser is disabled is ADC <Threshold? Yes or No.

FIG. 138B illustrates the Laser Transmitter Receiver transmit scanning mechanism where the function is Maybe Locked: Stop the motor Laser is disabled is ADC <Threshold? Yes or No.

FIG. 138C illustrates the Laser Transmitter Receiver transmit scanning mechanism where the function is Locked: Stop the motor Laser is enabled is ADC <Threshold? Yes or No.

FIG. 138D illustrates the Laser Transmitter Receiver transmit scanning mechanism where the function is Track Attempt: adjust motor in the last direction it worked after a while try the other direction Laser is disabled did it work? Yes or No.

FIG. 138E illustrates the Laser Transmitter Receiver transmit scanning mechanism where the function is Maybe Lost: Stop the motor Laser is enabled is ADC <Threshold? Yes or No.

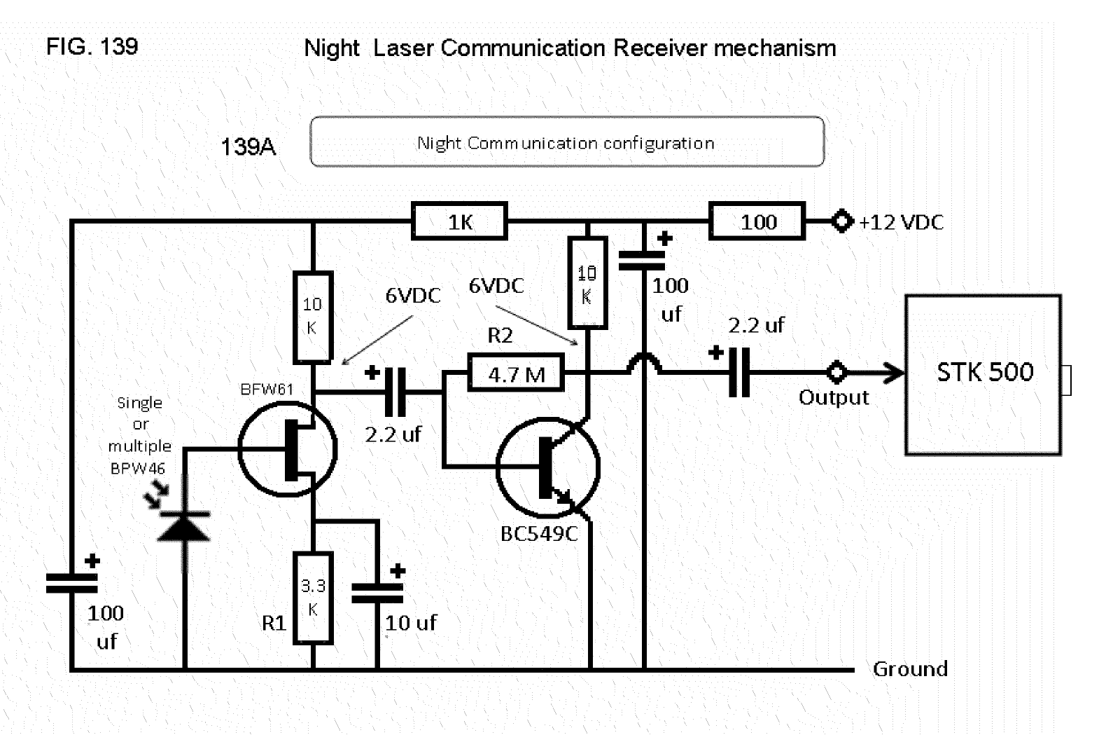

FIG. 139A illustrates Night Laser Communication Receiver mechanism configuration circuit board and components.

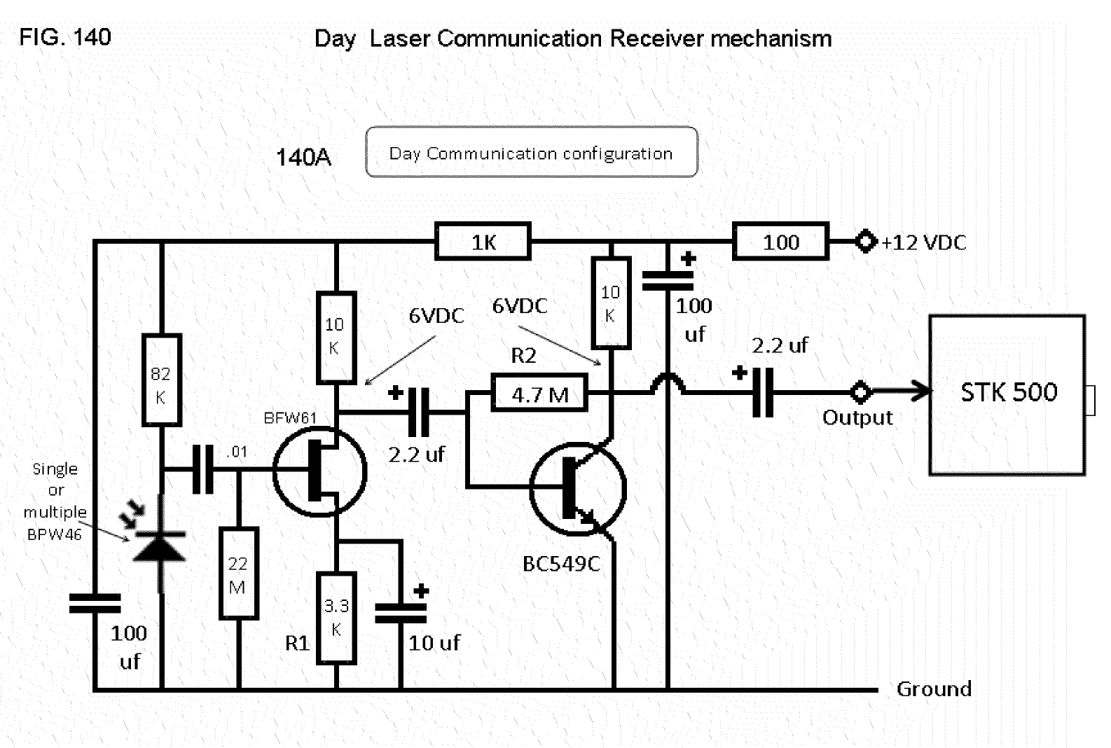

FIG. 140A illustrates Day Laser Communication Receiver mechanism configuration circuit board and components.

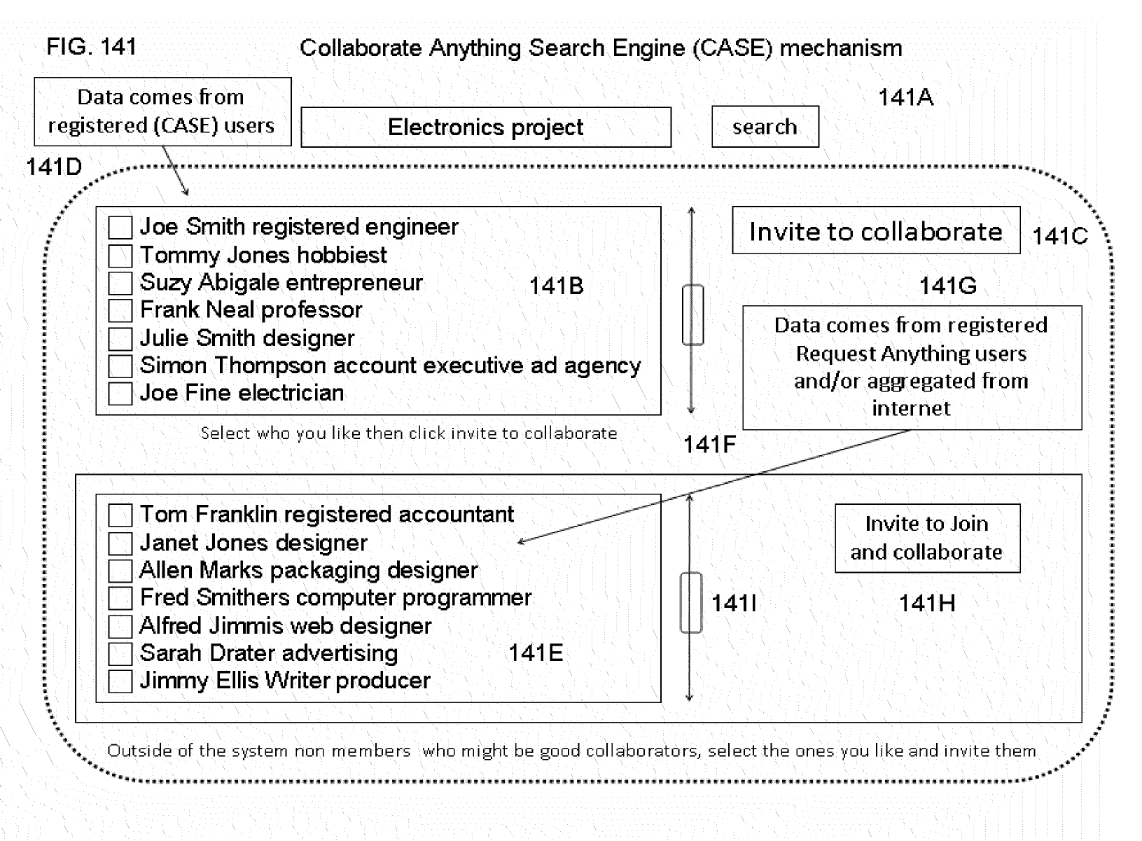

FIG. 141A illustrates the Collaborate Anything Search Engine (CASE) mechanism search form field.

FIG. 141B illustrates the Collaborate Anything Search Engine (CASE) mechanism results Data comes from registered (CASE) users.

FIG. 141C illustrates the Collaborate Anything Search Engine (CASE) mechanism invite to collaborate button.

FIG. 141D illustrates the Collaborate Anything Search Engine (CASE) mechanism response to search area.

FIG. 141E illustrates the Collaborate Anything Search Engine (CASE) mechanism where Data comes from registered Request Anything users and/or aggregated from internet is shown.

FIG. 141F illustrates the Collaborate Anything Search Engine (CASE) mechanism scroll button.

FIG. 141G illustrates the Collaborate Anything Search Engine (CASE) mechanism data information comes from users and internet.

FIG. 141H illustrates the Collaborate Anything Search Engine (CASE) mechanism invite to join (CASE) and collaborate.

FIG. 141I illustrates the Collaborate Anything Search Engine (CASE) mechanism scroll button.

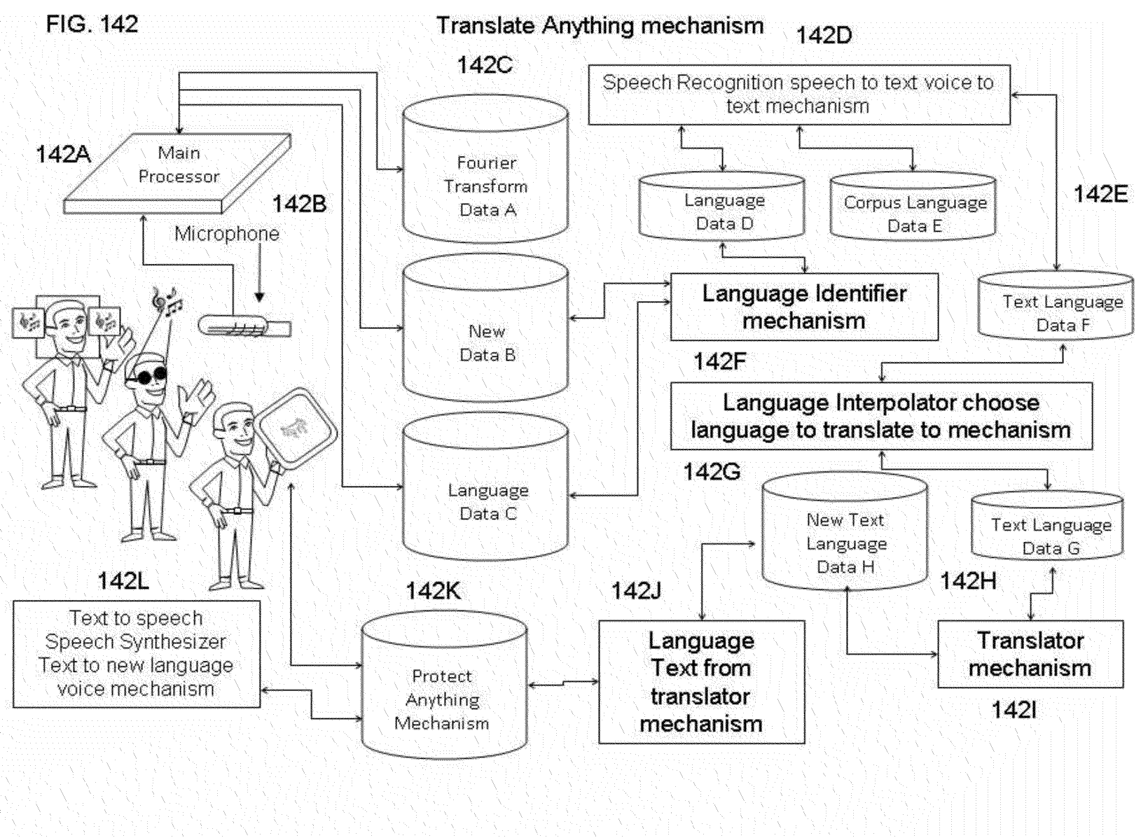

FIG. 142A illustrates the Translate Anything mechanism flow chart, showing main processor mechanism.

FIG. 142B illustrates the Translate Anything mechanism flow chart, showing microphone.

FIG. 142C illustrates the Translate Anything mechanism flow chart, showing 3 databases for storage.

FIG. 142D illustrates the Translate Anything mechanism flow chart, showing Speech Recognition speech to text voice to text mechanism.

FIG. 142E illustrates the Translate Anything mechanism flow chart, showing storage databases.

FIG. 142F illustrates the Translate Anything mechanism flow chart, showing the language identifier mechanism.

FIG. 142G illustrates the Translate Anything mechanism flow chart, showing Language Interpolator choose language to translate to mechanism.

FIG. 142H illustrates the Translate Anything mechanism flow chart, showing the language database storage units mechanism.

FIG. 142I illustrates the Translate Anything mechanism flow chart, showing translator mechanism.

FIG. 142J illustrates the Translate Anything mechanism flow chart, showing language text from translator mechanism.

FIG. 142K illustrates the Translate Anything mechanism flow chart, showing protect anything Human Key mechanism.

FIG. 142L illustrates the Translate Anything mechanism flow chart, showing the Text to speech and Speech Synthesizer Text to new language voice mechanism.

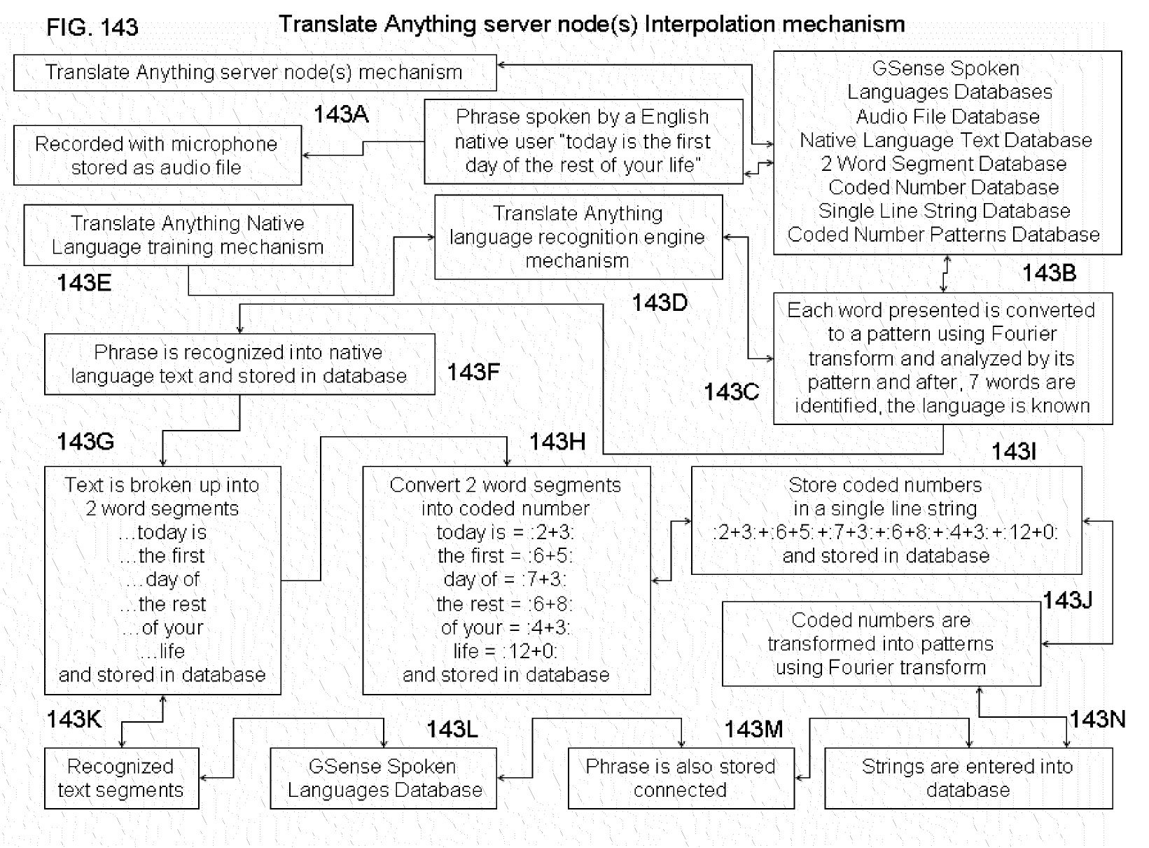

FIG. 143A illustrates Translate Anything server node(s) Interpolation mechanism where Recorded with microphone stored as audio file.

FIG. 143B illustrates Translate Anything server node(s) Interpolation mechanism where GSense Spoken Languages Databases Audio File Database Native Language Text Database 2 Word Segment Database Coded Number Database Single Line String Database Coded Number Patterns Database.

FIG. 143C illustrates Translate Anything server node(s) Interpolation mechanism where Each word presented is converted to a pattern using Fourier transform and analyzed by its pattern and after, 7 words are identified, the language is known.

FIG. 143D illustrates Translate Anything server node(s) Interpolation mechanism where Translate Anything language recognition engine mechanism.

FIG. 143E illustrates Translate Anything server node(s) Interpolation mechanism where Translate Anything Native Language training mechanism.

FIG. 143F illustrates Translate Anything server node(s) Interpolation mechanism where Phrase is recognized into native language text and stored in database.

FIG. 143G illustrates Translate Anything server node(s) Interpolation mechanism where Text is broken up into 2 word segments . . . today is . . . the first . . . day of . . . the rest . . . of your . . . life and stored in database.

FIG. 143H illustrates Translate Anything server node(s) Interpolation mechanism where Convert 2 word segments into coded number today is=:2+3: the first=:6+5: day of=:7+3: the rest=:6+8: of your=:4+3: life=:12+0: and stored in database.

FIG. 143I illustrates Translate Anything server node(s) Interpolation mechanism where Store coded numbers in a single line string :2+3:+:6+5:+:7+3:+:6+8:+:4+3:+:12+0: and stored in database.

FIG. 143J illustrates Translate Anything server node(s) Interpolation mechanism where Coded numbers are transformed into patterns using Fourier transform.

FIG. 143K illustrates Translate Anything server node(s) Interpolation mechanism where Recognized text segments are utilized.

FIG. 143L illustrates Translate Anything server node(s) Interpolation mechanism and the GSense Spoken Languages Database.

FIG. 143M illustrates Translate Anything server node(s) Interpolation mechanism where Phrase is also stored connected.

FIG. 143N illustrates Translate Anything server node(s) Interpolation mechanism where Strings are entered into database.

1. A method for human identification; registration; and protection executed by a computer comprising:
obtaining, processing, and storing valuations for use by a client computer generated by a virtual cash virtual currency server;
sending transaction data to an independent clearing house agent server;
processing transaction data by a client computer;
generating and managing energy and communications through a solar panel wind turbine communications server;
processing data in VOIP server;
utilizing a global system for mobile communication server, by the client computer;
sending electricity between a first server to a second server either wired or wirelessly;
processing and sending data into and from data storage for the purpose of later use;
delivering data to the client computer from and to a file server;
utilizing a temperature management cooling system manager for use in the system and as currency for use in a transaction;
storing energy as a currency in a kilowatt hour bank;
completing transactions using the stored energy currency;
using the stored energy currency for barter and trade in a virtual or non-virtual world;
protecting transactions and permissions with a human key;
using the human key client to process, transact, and to protect and track data;
enabling transactions between a plurality of human keys by the virtual cash virtual currency server;
projecting and recording media content utilizing an illumination transformer audio video manager interactive server;
processing media content data;
sending media content data from a server to a device for processing;
sending media content data to a client computer;
sending media content data to spatial point target;
sending media content data with permissions as verified and processed by a human key server;
creating applications using a mobile, handheld independent device application development server; for use by the server and client computer for data storage and image and media processing;
communicating utilizing a translation server; in a virtual world or non-virtual world to a spatial point target or a general area;
sending communication audio to the client computer;
sending communication audio to a spatial point target;
performing tasks in a universal virtual world;
creating places in the universal virtual world;
utilizing a solar panel wind turbine communications server for processing, storage, and delivery of data;
traveling utilizing a virtual world airport; for searching and visiting virtual world places;
sending data from the server in response to a client computer requesting data;
transforming and processing, by a virtual cash virtual currency server, the management of virtual world currencies;
a client server linked to the human key server;
transforming and processing, by an independent clearing house agent, management of transactions used with virtual world virtual cash currency, and virtual world objects or properties; and
enabling secure transferable transactions of properties from one user to another.

2. The method of claim 1 further comprising
charging a royalty, commission, fee, or split fee for sales of applications that are created by outside creators;
attaching the royalty, commission, fee, or split fee to the human key for tracking, security, and identification;
selling, renting, leasing, franchising, transacting, or bartering royalties, commissions, fees or split fees when applications are sold,
transferring profits from the virtual world to the real world;
retaining a percentage by the system; and
paying system owners a royalty, commission, fee or split fee percentage from the transaction.

3. The method of claim 1 further comprising
building properties in the virtual cash virtual currency worlds
establishing valuations and attaching them to a human key, for ownership authentication;
updating valuations of the properties periodically as traffic, interest, and viewers increase around that property's area; and
identifying a plurality of spots attached to the property to be allocated for promotions and advertising.

4. The method of claim 1 further comprising
using virtual cash virtual currency in a listings guide for determining valuations of properties;
attaching virtual cash virtual currency to the human key for tracking, security, and identification.

5. The method of claim 1 further comprising
requiring a virtual cash virtual currency when you register in the system;
establishing a virtual bank account with a set starting amount;
charging a certain amount of virtual currency for a user to be able to enter an area
attaching the virtual bank account to the human key for tracking, security, authentication, and identification;
connecting the virtual cash virtual currency server to a real currency mechanism for payments and transactions.

6. The method of claim 1 further comprising
using the virtual cash virtual currency for all promotions and advertising;
purchasing content from an outside independent clearing house-by an advertiser; and
providing the advertiser a specified amount of virtual cash virtual currency; to use.

7. The method of claim 1 further comprising
purchasing virtual cash virtual currency;
lending money for transacting with a user that is registered with a royalty agreement;
providing the purchaser an equal amount of virtual cash virtual currency based on the actual price paid at the independent clearing house;
adding the amount paid to the user's account; and
attaching all transactions to the human key for tracking, security, authentication, and identification.

8. The method and of claim 1 further comprising
paying virtual cash virtual currency to a registered user for any content added to the content bank, idea bank, or intellectual property bank
adding promotions to the payment package;
attaching all transactions to the human key for tracking, security, and identification connected to the virtual cash virtual currency server.

9. The method of claim 1 further comprising
creating virtual representatives of humans wandering the virtual world for advertising, news dispersal, and marketing;
attaching reminders, suggestions, proposals, requests, collaborations, participations, or request assistance, and general current news from the virtual world, or the outside world to the human key for tracking, security, authentication, and identification, connected to the virtual cash virtual currency server.

10. The method of claim 1 further comprising
providing a virtual world search engine;
entering a plurality of search criteria into the virtual world search engine;
creating a virtual world based on semantic keywords relationships based on the search criteria specified by the user(s);
the criteria including: a transaction listing directory pertaining to all transactions in the system, that are public and controlled by the virtual cash virtual currency server; transacted in accredited independent clearing houses; and and controlled by the human key.

11. The method of claim 1 further comprising
paying bills with virtual cash virtual currency;
selling, auctioning, consigning, bartering or trading virtual cash virtual currency outside of the system, in an independent clearing house;
charging the predetermined royalty, commission, or fee when the sale is finalized against the sale;
commission, or fee into virtual world real bank account;
depositing the exact amount into the sellers virtual cash virtual currency virtual bank account
attaching the virtual cash virtual currency to a sales payment system and to the human key for tracking, security, and identification connected to the virtual cash virtual currency server.

12. The method of claim 1 further comprising
providing a property management directory;
determining a virtual comparison of property values, between a plurality of properties;
determining a virtual comparison of property values graphically based on geographic location within the virtual world,
determining a virtual comparison of property values graphically based on virtual world or outside world properties;
searching for one or more property traits;
comparing property traits to assist in a buy, sell, rent, or lease, transaction; and
attaching the traits to the human key for tracking, security, and identification.

13. (canceled)

14. (canceled)

15. The method of claim 1 further comprising
lend lending virtual cash virtual currency;
charging interest for the lending;
attaching collateral to the virtual cash virtual currency for the lending, with all transactions, payments, and paybacks pertaining to the lending attached to the human key for tracking, security, and identification;
calculating and paying matching contributions, and investments, attached to the human key.

16. The method of claim 1 further comprising
creating virtual cash vouchers, coupons, rebates, and discounts transacted with virtual cash virtual currency in the Virtual or real world;
redeeming virtual cash vouchers, coupons, rebates, and discounts in the real world;
attaching virtual cash vouchers, coupons, rebates, and discounts to the human key for tracking, security, and identification;
creating a simulated virtual banking and market world
connecting the virtual banking and market world to the virtual cash virtual currency server.

17. The method of claim 1 further comprising
recording the virtual representation of a human, at any location in a Virtual World;
uploading the content to the main server for storage, transformation, and distribution;
attaching the content to the human key for tracking, security, and identification
connecting the content to the virtual cash virtual currency server.

18. The method of claim 1 further comprising
aggregating virtual world human medical information about a user;
uploading the information into to the main server for storage, transformation, and distribution
using the information as a what if testing of treatments
uploading information into the system by physicians and patients;
providing royalties, fees, payments, services, and commissions for use of the uploaded information;
programming real world data and information about past patient responses to treatments, for simulations of drug, therapy and other tests
providing virtual medical information for virtual testing;
attaching geo targeting and time information to every DNA in a human, for precise testing; and
generating what if treatment results in a virtual world.

19. The method of claim 1 further comprising
providing a virtual world sports exchange;
sporting teams to be managed, and documented;
allowing users to play sports, track scores, trade players, buy and sell teams, build stadiums, charge admission, sell merchandise, record and sell transmissions and re transmissions rights, create leagues, make schedules, and manage all sporting activities in the virtual world;
enabling group transactions utilizing virtual cash virtual currency server;
generating transactions through independent clearing houses connected to the virtual cash virtual currency server;
providing a real currency mechanism for payments, services and transactions with secure payments, identification, authorization, tracking, proposals, participations, suggestions, requests, reminders, collaborations, and social networking.

20. The method of claim 1 further comprising
providing a virtual communication world;
incorporating a language translator providing the ability to auto translate live dialog;
utilizing virtual cash virtual currency for transaction in the virtual world;
connecting the virtual cash virtual currency server to the independent clearing house for transactions;
providing a real currency mechanism for payments, services and transactions with secure payments, identification, authorization, tracking, proposals, participations, suggestions, requests,
reminders, collaborations, and social networking.
